(19) United States
(12) Patent Application Publication
(10) Pub. No.: US 2025/0065408 A1
(43) Pub. Date: Feb. 27, 2025

(54) MATERIAL CONVEYANCE IN MANUFACTURING SYSTEMS

(71) Applicant: Velo3D, Inc., Fremont, CA (US)

(72) Inventors: Alexander John Fisher, Campbell, CA (US); Sergey Korepanov, Los Altos, CA (US); Joseph Andrew Tralongo, El Cajon, CA (US); Rahul Korpu, San Jose, CA (US); Benyamin Buller, Cupertino, CA (US); Abraham Saldivar Valdes, Campbell, CA (US); William David Chemelewski, San Jose, CA (US)

(21) Appl. No.: 18/811,564

(22) Filed: Aug. 21, 2024

Related U.S. Application Data
(60) Provisional application No. 63/534,101, filed on Aug. 22, 2023.

(51) Int. Cl. B22F 10/37; B22F 10/28; B22F 10/85; B33Y 30/00; B33Y 40/00; B33Y 50/02

(52) U.S. Cl. CPC B22F 10/37; B22F 10/28; B22F 10/85; B33Y 30/00; B33Y 40/00; B33Y 50/02

(57) ABSTRACT

The present disclosure provides manufacturing systems, devices, apparatuses, methods, and non-transitory computer readable media for detection and/or prevention of harm caused at least in part by malfunction in section(s) of a material conveyance system operatively coupled with a manufacturing enclosure experiencing pressure fluctuation during manufacturing. Coupling or decoupling of pressure fluctuations sensed in various portions of the material conveyance system with those occurring in the manufacturing enclosure, may indicate harm to the section(s) of the material conveyance system. The various portions may or may not be similar to the section(s). The manufacturing system may comprise a three-dimensional printing system.

### CROSS-REFERENCE TO RELATED PATENT APPLICATIONS

This patent application is a U.S. non-Provisional patent application that claims priority to, and the benefit of, U.S. Provisional Patent Application No. 63/534,101, filed on Aug. 22, 2023 entitled “Material Conveyance in Manufacturing Systems,” which is incorporated herein by reference in its entirety for all purposes.

### BACKGROUND

Three-dimensional (3D) printing (e.g., additive manufacturing) is a process for making a three-dimensional object of any shape from a design. The design may be in the form of a data source such as an electronic data source or may be in the form of a hard copy. The hard copy may be a two-dimensional representation of a 3D object. The data source may be an electronic 3D model. 3D printing may be accomplished through an additive process in which successive layers of material are laid down one on top of another. This process may be controlled (e.g., computer controlled, manually controlled, or both). A 3D printer can be an industrial robot.

3D printing can generate custom parts. A variety of materials can be used in a 3D printing process including elemental metal, metal alloy, ceramic, an allotrope of elemental carbon, or polymeric material. In some 3D printing processes (e.g., additive manufacturing), a first layer of hardened material is formed (e.g., by welding powder), and thereafter successive layers of hardened material are added one by one, wherein each new layer of hardened material is added on a pre-formed layer of hardened material, until the entire designed three-dimensional structure (3D object) is layer-wise materialized.

3D models may be created with a computer aided design package, via 3D scanner, or manually. The manual modeling process of preparing geometric data for 3D computer graphics may be similar to plastic arts, such as sculpting or animating. 3D scanning is a process of analyzing and collecting digital data on the shape and appearance of a real object (e.g., real-life object). Based on this data, 3D models of the scanned object can be produced.

A number of 3D printing processes are currently available. They may differ in the manner layers are deposited to create the materialized 3D structure (e.g., hardened 3D structure). They may vary in the material or materials that are used to materialize the designed 3D object. Some methods melt, sinter, or soften material to produce the layers that form the 3D object. Examples for 3D printing methods include selective laser melting (SLM), selective laser sintering (SLS), direct metal laser sintering (DMLS) or fused deposition modeling (FDM). Other methods cure liquid materials using different technologies such as stereo lithography (SLA). In the method of laminated object manufacturing (LOM), thin layers (made inter alia of paper, polymer, or metal) are cut to shape and joined together.

A manufacturing system may utilize a starting material to generate manufactured object(s). The manufacturing system may comprise a 3D printer. The manufactured object(s) may comprise 3D object(s) printed by the 3D printer. A portion of the starting material not utilized for manufacturing the object(s) may remain in a manufacturing enclosure. The remainder material may be removed from the manufacturing enclosure. The removed remainder material may be recycled, e.g., for the purpose of reuse in a subsequent manufacturing operation. The conveyance of removed remainder material may be at least in part through a channel, e.g., hose or pipe. The recycling of the remainder material may comprise separating such as sieving and/or centrifuging. Malfunction may occur in the manufacturing system. Malfunction may occur (i) during removal of the remainder material and/or (ii) during recycling of the remainder material. The malfunction may lead to harm. Harm may comprise harm to the manufacturing system, to the manufactured object(s), to the facility in which the manufactured system is disposed in, and/or to personnel in the facility. In an example, the harm comprises an interruption of the manufacturing process. The interruption may cause a defect in the object(s) being manufactured, or abortion of the manufacturing process. The interruption may be caused at least in part (i) by the remainder material accumulating on the sieve during recycling, and/or (ii) by a damage (e.g., defect) that occurs in the channel. The accumulation of the remainder material may at least in part cause sieve blinding. The damage may be (e.g., at least in part) due to erosion of the channel by flow of the remainder material in the channel such as causing rupture of the channel.

### SUMMARY OF THE INVENTION

In some aspects, the present disclosure resolves the aforementioned hardships.

In some aspects, at least one prevention system is employed to counter the malfunction. The malfunction may be caused at least in part (i) by material accumulating on the sieve during recycling and/or (ii) by a damage (e.g., defect) that occurs in the channel. To counter malfunction caused by the accumulation of material on the sieve, the prevention system may be configured to sense the accumulation of material on the sieve (e.g., using various sensors) and initiate a prevention operation to counter such accumulation, e.g., to curtail sieve blinding. To counter harm due to channel defect, the channel (e.g., becoming an inner channel) may be encased by a casing (e.g., that forms an outer channel). The casing may be configured to facilitate (a) sensing the defect (e.g., rupture, hole, and/or crack) and/or (b) confinement of spilled material on rupture of the inner channel, the spillage being from the inner channel outwards. The casing may allow the material flow from the inner channel into the interstitial space disposed between an external surface of the inner channel and internal surface of the casing. The casing hinder (e.g., prevent) the material from being spilled to the ambient environment. The prevention may be configured to sense the defect (e.g., using various sensors) and initiate a prevention operation. The defect may result in spillage of the material. At times, an atmospheric pressure in the inner channel is greater than the ambient pressure in an ambient atmosphere external to the inner channel. At times, an atmospheric pressure in the inner channel is greater than the ambient pressure in an ambient atmosphere external to the casing in which the inner channel is disposed. A pressure differential between the inner atmosphere of the inner channel and the ambient atmosphere may exacerbate the harm caused due to a defect in the inner channel. At times, the defect may occur in the casing. At times defect may occur in the casing and in the inner channel. The prevention may be configured to sense defect (e.g., using various sensors) in the inner channel and/or in the casing, and initiate a prevention operation. The internal environment of the inner channel and/or of the casing may be less reactive with the material conveyed through the internal channel, as compared to its reactivity with reactive agents present in the ambient atmosphere, e.g., the internal environment may be more inert than the ambient atmosphere. The reactive agents may comprise oxygen or water.

In another aspect, a device for manufacturing object(s), the device comprises: a sensor operatively coupled with or being part of a separator, the sensor being configured to sense (I) a level of a remainder material when the remainder material accumulates in the separator above a first threshold and/or (II) a pressure over time in an internal atmosphere of the separator operatively coupled with a manufacturing enclosure, the pressure over time having a (e.g., substantial) repetition of a first pattern (e.g., sequence), the separator being configured to receive the remainder material initially disposed in the manufacturing enclosure, the remainder material comprising a starting material not used to print the one or more 3D objects, the manufacturing enclosure being configured to, during the manufacturing, enclose the object(s) manufactured from the starting material, the manufacturing enclosure being part of a manufacturing system; and a prevention system operatively coupled with the sensor, the prevention system being configured to initiate a prevention operation (i) when the sensor is configured to sense the level of the remainder material accumulating in the separator, and the sensor senses the remainder material above a second threshold indicative of greater level of material accumulation than the first threshold and/or (ii) when the sensor is configured to sense the pressure, and data sensed by the sensor comprises a second pattern, the second pattern comprising a portion that exhibits a substantial change as compared with the first pattern.

In another aspect (e.g., when the manufacturing system is a 3D printing system), a device for printing one or more three-dimensional (3D) objects, the device comprises: a sensor operatively coupled with or being part of a separator, the sensor being configured to sense (I) a level of a remainder material when the remainder material accumulates in the separator above a first threshold and/or (II) a pressure over time in an internal atmosphere of the separator operatively coupled with a printing enclosure, the pressure over time having a (e.g., substantial) repetition of a first pattern (e.g., sequence), the separator being configured to receive the remainder material initially disposed in the printing enclosure, the remainder material comprising a starting material not used to print the one or more 3D objects, the printing enclosure being configured to, during the printing, enclose the one or more 3D objects printed from the starting material, the printing enclosure being part of a three-dimensional (3D) printer; and a prevention system operatively coupled with the sensor, the prevention system being configured to initiate a prevention operation (i) when the sensor is configured to sense the level of the remainder material accumulating in the separator, and the sensor senses the remainder material above a second threshold indicative of greater level of material accumulation than the first threshold and/or (ii) when the sensor is configured to sense the pressure, and data sensed by the sensor comprises a second pattern, the second pattern comprising a portion that exhibits a substantial change as compared with the first pattern. In some embodiments, the prevention system is configured to initiate a prevention operation when the sensor is configured to sense the pressure, and data sensed by the sensor comprises a second pattern, the second pattern comprising a portion that exhibits a substantial change as compared with the first pattern, the substantial change comprising a damping characteristic as compared with the first pattern. In some embodiments, the damping characteristic comprises (i) reduced amplitude, (ii) smoothened waveform, or (iii) reduced deviation from a central tendency. In some embodiments, the central tendency is an average. In some embodiments, the first pattern comprises a first amplitude and the portion of the second pattern comprises a second amplitude, the first amplitude being the difference between a maximum value and a minimum value of the first pattern, the second amplitude being the difference between a maximum value and the minimum value of the second pattern, the second amplitude being smaller than the first amplitude by a third threshold. In some embodiments, third threshold is a value or a function. In some embodiments, the third threshold is within a range of from about 5 kPa to about 9 kPa. In some embodiments, the third threshold is within a range of from about 40% to about 75% of the first amplitude. In some embodiments, an inner surface of at least one component of the device comprises a coating having a hard material, or is made from the hard material, configured to prolong normal operation of the device. In some embodiments, the hard material has a hardness greater than that of the remainder material. In some embodiments, the second pattern comprises an irregular pattern. In some embodiments, pressure of the second pattern is below pressure inside the printing enclosure. In some embodiments, each of the first pattern corresponds to an operation of a layer dispensing mechanism, the layer dispensing mechanism being operatively coupled with the printing enclosure. In some embodiments, the first pattern comprises at least one peak. In some embodiments, the first pattern comprises a first peak and a second peak, the second peak having an amplitude different than that of the second peak. In some embodiments, the sensor comprises a pressure sensor and a level sensor, the pressure sensor being configured to sense the level of the remainder material, the material level sensor being configured to sense the pressure over time in the internal atmosphere of the separator. In some embodiments, the prevention system is configured to initiate the prevention operation when a correlation of the pressure sensed by the sensor is disrupted, the correlation begin with pressure fluctuations occurring in the printing enclosure. In some embodiments, disruption of the correlation comprises a diminished correlation or a lack of correlation. In some embodiments, the prevention system is configured to initiate the prevention operation (i) when the material level sensor senses the remainder material above the second threshold, or (ii) when the data sensed by the pressure sensor comprises the second pattern. In some embodiments, the printing enclosure is configured to, during the printing, enclose an atmosphere having at least one characteristic different than that of an ambient atmosphere external to the 3D printer. In some embodiments, the at least one characteristic comprises a pressure, or a level of reactive agent, the reactive agent being configured to react with the starting material and/or with the remainder material at least during the printing. In some embodiments, the reaction of the reactive agent with the starting material and/or with the remainder material, results in an unwanted reaction product. In some embodiments, the reactive agent comprises oxygen, water, or hydrogen sulfide. In some embodiments, the starting material comprises powder material. In some embodiments, the starting material comprises an elemental metal, a metal alloy, a ceramic, or an allotrope of elemental carbon. In some embodiments, the starting material comprises a polymer or a resin. In some embodiments, the separator comprises a sieve. In some embodiments, the sieve is enclosed by a sieve enclosure. In some embodiments, the sieve enclosure is configured to allow reversible extraction and reversible insertion of the sieve relative to the sieve enclosure. In some embodiments, the sieve enclosure is configured for sieve placement therein, the sieve placement being tilted with respect to a normal to the gravitational vector pointing towards the gravitational center of the environment (e.g., and tilted with respect to the horizon). In some embodiments, the sieve comprises or is operatively coupled with an agitation transmitter. In some embodiments, the agitation transmitter is configured to allow propagation of agitations comprising a sonic wave. In some embodiments, the agitation transmitter is configured to allow propagation of agitations comprising an ultra-sonic wave. In some embodiments, the sensor is configured to sense the pressure in the internal atmosphere of the sieve enclosure. In some embodiments, the sieve enclosure comprises an inlet, the inlet being configured to receive the remainder material. In some embodiments, the sieve is configured to allow at least a portion of the remainder material to pass through the sieve, the at least the portion of the remainder having a fundamental length scale of the starting material. In some embodiments, the three-dimensional printing system comprises a material reservoir (e.g., hopper), the sieve enclosure being operatively coupled with the material reservoir, the material reservoir being configured to receive the remainder material from the sieve enclosure. In some embodiments, the material reservoir is configured for fluidic communication with the sieve enclosure. In some embodiments, the sensor is configured to sense the pressure in the internal atmosphere of the material reservoir. In some embodiments, the material reservoir is operatively coupled with the sieve enclosure via a channel, the sensor being configured to sense the pressure in the internal atmosphere of the channel. In some embodiments, the sieve is configured to separate at least a portion of the debris. In some embodiments, the least the portion of the debris comprises a first fundamental length scale (FLS) larger than a central tendency of a second fundamental length scale (FLS) of the starting material. In some embodiments, the sieve enclosure is operatively coupled with a removal container, the remover container being configured to receive the at least the portion of the debris from the sieve enclosure. In some embodiments, the separator is a first separator, the device further comprises a second separator, the second separator being configured to separate the remainder material from gas, the gas carrying the remainder material into the second separator. In some embodiments, the first separator comprises a sieve enclosure and a sieve enclosed in the sieve enclosure. In some embodiments, the second separator is a cyclonic separator. In some embodiments, the second separator is operatively coupled with (i) the first separator and (ii) the printing enclosure. In some embodiments, the second separator is configured to (i) receive the remainder material initially disposed in the printing enclosure, and (ii) allow exit of the remainder material after the remainder material is separated by the second separator, the exit being to the first separator. In some embodiments, the gas carries the remainder material using dilute phase conveyance. In some embodiments, during operation, the second separator is configured to accommodate a pressure drop in the second separator. In some embodiments, the second separator is configured to, during operation, cause a pressure drop in the second separator. In some embodiments, the second separator is configured to utilize a pressure drop to separate the remainder material from the gas. In some embodiments, the second separator comprises or is operatively coupled with a gas channel, the gas channel being configured to receive the gas separated by the second separator. In some embodiments, an exit of the second separator is operatively coupled with an inlet of the first separator. In some embodiments, the second separator is directly coupled with the first separator without intervening component between the first separator and the second separator. In some embodiments, the second separator is operatively coupled with the first separator by at least one material conveyance channel. In some embodiments, the material conveyance channel is configured to facilitate flow of the remainder material separated by the first separator and conveyed to the second separator. In some embodiments, the first separator comprises a sieve enclosure, and the second separator comprises a cyclonic separator. In some embodiments, the remainder material separated by the cyclonic separator and exiting the cyclonic separator is introduced into the sieve enclosure, the sieve enclosure being configured to sieve the remainder material exiting from the cyclonic separator. In some embodiments, the sensor is a first sensor, the first sensor being configured to sense a first pressure in a first internal atmosphere of the separator, the device further comprises a second sensor, the second sensor being configured to sense a second pressure in a second internal atmosphere of a component other than the first internal atmosphere of the separator. In some embodiments, the separator is a first separator, the first separator comprising a sieve enclosure, the device further comprises a second separator operatively coupled with the first separator, the second separator comprising a cyclonic separator. In some embodiments, the device further comprises a gas channel, the gas channel being configured to operatively couple with the cyclonic separator. In some embodiments, the first atmosphere is an atmosphere of (i) the sieve enclosure, (ii) a material reservoir (e.g., hopper) operatively coupled with the first separator, or (iii) a channel connecting the sieve enclosure and the material reservoir. In some embodiments, the component comprises (i) the cyclonic separator, (ii) the gas channel, or (iii) a channel connecting the cyclonic separator and the sieve enclosure. In some embodiments, the prevention system is configured to initiate the prevention operation when a coefficient is below a third threshold, the coefficient being of a correlation between the first pressure and the second pressure. In some embodiments, the coefficient is normalized cross-correlation coefficient. In some embodiments, the coefficient is within a range of from about 0.70 to about 0.82. In some embodiments, the third threshold is a value or a function. In some embodiments, the prevention system is configured to track the coefficient at least during the printing. In some embodiments, the prevention system is configured to track the coefficient in real time. In some embodiments, the prevention system is configured to track the coefficient continuously. In some embodiments, the prevention system is configured to track the coefficient intermittently. In some embodiments, the prevention system is configured to track the coefficient in repetitive intervals. In some embodiments, the device is configured to operate while the first pressure and the second pressure change over time. In some embodiments, during the printing, the first pressure is greater than the second pressure. In some embodiments, the first pressure and the second pressure are within a range of from about-10 kPa to about +16 kPa, relative to a pressure of an ambient atmosphere external to the 3D printer. In some embodiments, the first pressure and the second pressure are within a range of (i) from about an atmospheric pressure (ii) to about +16 kPa relative to the atmospheric pressure, the atmospheric pressure being a pressure of an ambient atmosphere external to the 3D printer. In some embodiments, the first pressure and the second pressure are within a range of (i) from about-12 kPa relative to an atmospheric pressure (ii) to about the atmospheric pressure, the atmospheric pressure being a pressure of an ambient atmosphere external to the 3D printer. In some embodiments, the sensor is configured to sense the level of the remainder material when the remainder material accumulates in the separator above the first threshold, the prevention system being configured to initiate the prevention operation when the sensor senses the remainder material above the second threshold. In some embodiments, the sensor is configured to sense the level of the remainder material in real time during operation or the 3D printer. In some embodiments, the sensor comprises a material level sensor. In some embodiments, the material level sensor is a contact level sensor. In some embodiments, the material level sensor is a non-contact level sensor. In some embodiments, the sensor comprises a capacitance level sensor, float level sensor, silo-pilot level sensor, servo level sensor, displacer level sensor, ultrasonic level sensor, guide wave radar level sensor, laser level sensor, or radiometric level sensor. In some embodiments, the sensor comprises a guided wave radar. In some embodiments, the sensor comprises a waveguide configured to contact with the remainder material, the waveguide comprising pores (e.g., holes or perforations). In some embodiments, the waveguide comprises an inner member and an outer member, the outer member being configured to encase at least a side of the inner member, the outer member comprising the pores, the inner member and the outer member are separated by a gap, the inner member and the outer member being configured to form a space therebetween. In some embodiments, the pores of the waveguide are configured to facilitate (i) ingress of the remainder material into the waveguide and/or (ii) egress of the remainder material from the waveguide. In some embodiments, the separator comprises a sieve enclosure, the sieve enclosure being configured to enclose a sieve, the sieve enclosure comprising an inlet, the inlet being configured to receive the remainder material, at least a portion of the third sensor being configured to be located between the inlet and the sieve. In some embodiments, the sieve is planar. In some embodiments, the sensor is configured to overlap with a (e.g., horizontal) cross section of the inlet of the sieve enclosure. In some embodiments, the sensor is configured to overlap with a center of the cross section of the inlet of the sieve enclosure. In some embodiments, the sensor is configured to be disposed (e.g., substantially) normal with respect to the sieve. In some embodiments, the sensor is configured to be angled towards the sieve, the angle being different than (e.g., substantially) 90 degrees. In some embodiments, the prevention system is configured to monitor the sensor at least during the printing. In some embodiments, the prevention system is configured to monitor the sensor continuously. In some embodiments, the prevention system is configured to monitor the sensor intermittently. In some embodiments, the prevention system is configured to monitor the sensor in repetitive intervals. In some embodiments, the prevention system is configured to monitor the sensor in real time. In some embodiments, the prevention system is configured to (i) operate when a standard deviation of a pressure of the 3D printer is equal at least to a third threshold or higher, and (ii) deactivate when the standard deviation of the pressure of an internal atmosphere of the 3D printer is at most a fourth threshold or lower, the fourth threshold being smaller than the third threshold. In some embodiments, the fourth threshold comprises (i) a value or (ii) a function. In some embodiments, the fourth threshold comprises a value in a range of from about 1 kPa to about 5 kPa. In some embodiments, the prevention system is configured to initiate the prevention operation comprising (i) a notification or (ii) a procedure. In some embodiments, the prevention operation comprises (i) triggering an alarm, (ii) generating a report, (iii) generating an instruction, (iv) interrupting the printing, (vi performing an agitation scheme, or (vi) prescribing an other remedial operation. In some embodiments, the prevention system is configured to initiate the prevention operation at least in part automatically. In some embodiments, the prevention system is configured to initiate a prescribed agitation scheme as the prevention operation. In some embodiments, the prevention system is configured to agitate the separator as the prevention operation, the separator being a sieve. In some embodiments, the prevention system is configured to utilize acoustic vibrations to agitate the separator. In some embodiments, the prevention system is configured to utilize ultrasound to agitate the separator. In some embodiments, the agitation scheme comprises agitation periods separated by at least one intermission. In some embodiments, the agitation scheme comprises at least two agitation periods of a different agitation nature comprising different frequency or different amplitude. In some embodiments, the separator comprises a waveguide, the waveguide being configured to transmit the agitations to the separator and/or to the remainder material being separated. In some embodiments, the waveguide is flexible. In some embodiments, the separator comprises a sieve, and the waveguide is operatively coupled to the sieve. In some embodiments, the remainder material is conveyed to the separator by utilizing (i) an attractive force, (ii) a compressive force and/or (iii) a gravitational force. In some embodiments, the printing enclosure comprises one or more ports, the one or more ports being configured to allow exit of the remainder material from the printing enclosure. In some embodiments, the separator is operatively coupled with the one or more ports (e.g., holes) of the printing enclosure. In some embodiments, the one or more ports are located on a floor of the printing enclosure. In some embodiments, the printing enclosure comprises, or is operatively coupled with, a layer dispensing mechanism. In some embodiments, the layer dispensing mechanism comprises (i) a material dispensing mechanism or (ii) a material removal mechanism, the material dispensing mechanism being configured to dispense the starting material in the printing enclosure, the material removal mechanism being configured to remove the remainder material from the printing enclosure. In some embodiments, the layer dispensing mechanism is devoid of a leveler (e.g., knife and/or roller). In some embodiments, the starting material dispensed by the material dispensing mechanism forms at least a portion of a material bed, the material bed being enclosed by the printing enclosure during the printing, the material bed being utilized to print at least a portion of the one or more 3D objects. In some embodiments, the material bed is supported (e.g., and carried) by a build platform, the build platform being disposed in the printing enclosure. In some embodiments, the device is configured to facilitate the printing by facilitating vertical translation of the build platform comprising an error in vertical positioning of the vertical translation at most about 10%, 5%, or 2% of the vertical translation of the build platform. In some embodiments, the material removal mechanism is configured to generate a planar layer of the starting material as a part of the material bed, the planar layer having a planar exposed surface. In some embodiments, the material removal mechanism is configured to utilize an attractive force. In some embodiments, the attractive force comprises a magnetic, an electric, an electrostatic, or a vacuum source. In some embodiments, the attractive force comprises a vacuum source. In some embodiments, a portion of the remainder material removed by the material removal mechanism is at least about 70%, 50% or 30% of the remainder material initially disposed in the printing enclosure. In some embodiments, the material dispensing mechanism comprises or is operatively coupled with an agitator, the agitator being configured to cause at least a portion of the starting material to agitate (e.g., move such as vibrate). In some embodiments, the layer dispensing mechanism further comprises a leveling mechanism. In some embodiments, the printing enclosure is operatively coupled with an ancillary chamber, the ancillary chamber being configured to accommodate the layer dispensing mechanism. In some embodiments, the separator is operatively coupled with (i) the ancillary chamber and/or (ii) the layer dispensing mechanism. In some embodiments, the separator is operatively coupled with the material removal mechanism of the layer dispensing mechanism. In some embodiments, the printing enclosure and/or the ancillary chamber comprises one or more ports (e.g., holes), the one or more ports being configured to exit the remainder material from the printing enclosure and/or the ancillary chamber. In some embodiments, the separator is operatively coupled with the one or more ports of the printing enclosure and/or the ancillary chamber. In some embodiments, the one or more ports are located on a floor of the printing enclosure and/or the ancillary chamber. In some embodiments, the device is configured to facilitate the printing at least in part by being configured to control deposition of the starting material on a target surface. In some embodiments, the target surface comprises (i) an exposed surface of a material bed or (ii) an exposed surface of a build plate. In some embodiments, the deposition comprises a layer-wise deposition. In some embodiments, the printing enclosure comprises or is operatively coupled with a material removal wand, the material removal wand being configured to remove the remainder material from the printing enclosure, the material removal wand being configured to utilize an attractive force. In some embodiments, the attractive force comprises a vacuum force. In some embodiments, the 3D printer comprises a gas conveyance system, the gas conveyance system being operatively coupled with the printing enclosure, the gas conveyance system being configured to receive gas carrying the remainder material (e.g., gas borne remainder material), the gas conveyance system being configured to convey the remainder material carried by the gas to the separator. In some embodiments, the gas conveyance system comprises a filter, the filter being configured to filter the remainder material from the gas. In some embodiments, the separator is comprised in a recycling system, the material recycling system being operatively coupled with a layer dispensing mechanism, the recycling system being configured to (i) recycle at least a fraction of the remainder material initially disposed in the printing enclosure to generate a recycled material and/or (ii) provide the recycled material for utilization by a material dispensing mechanism in subsequent deposition as a portion of the starting material, the material dispensing mechanism being part of the layer dispensing mechanism. In some embodiments, at least a portion of the remainder material initially disposed in the printing enclosure is removed by a material removal mechanism of the layer dispensing mechanism. In some embodiments, the portion of the remainder material removed by the material removal mechanism is at least about 70%, 50% or 30% of the remainder material initially disposed in the printing enclosure. In some embodiments, the fraction of the remainder material recycled by the material recycling system is at least about 70% or 90% of the remainder material removed by the material removal mechanism. In some embodiments, the material recycling system is part of, or is operatively coupled with, a material conveyance system, the material conveyance system being operatively coupled with the printing enclosure. In some embodiments, the material conveyance system is configured to convey materials comprising (i) the remainder material or (ii) the starting material. In some embodiments, the material conveyance system is configured to utilize pressure differentials for conveyance of (a) the starting material and/or (b) the remainder material. In some embodiments, the material conveyance system comprises or is operatively coupled with a pressure regulator, the pressure regulator being configured to induce the pressure differentials. In some embodiments, the material recycling system is configured to at least in part utilize pressure differentials for conveyance of (a) the starting material and/or (b) the remainder material. In some embodiments, at least a portion of the printing comprises arc welding. In some embodiments, the arc welding is by an arc welder to facilitate the printing of the one or more 3D objects comprises: generating a powder stream and focusing an energy beam on the powder stream, the arc welder being part of or being operatively coupled with the 3D printer. In some embodiments, at least a portion of the printing comprises connecting particulate matter to facilitate the printing of the 3D objects. In some embodiments, the particulate matter comprises a super alloy. In some embodiments, the super alloy comprises Inconel, In Ti F Haynes GRCop-C CA6NM, or Hastelloy-X. In some embodiments, at least a portion of the printing comprises a fusing process. In some embodiments, the fusing comprises (i) sintering, (ii) melting, (iii) smelting, or (iv) any combination of (i)-(iii). In some embodiments, the prevention system is part of, or is operatively coupled with, a control system of the 3D printer that is configured to control the printing. In some embodiments, the sensor is a first sensor, the device further comprises: an inner channel configured for flow of the remainder material initially disposed in the printing enclosure; an outer channel encasing at least a portion of the inner channel such that an interstitial space (e.g., gap space) is disposed between an external surface of the inner channel, and an internal surface of the outer channel; and a second sensor configured to sense an interstitial pressure in the interstitial space; wherein the prevention system operatively coupled with the second sensor, the prevention system being configured to initiate the prevention operation when the interstitial pressure is above a third threshold.

In another aspect, a method for printing one or more three-dimensional (3D) objects, the method comprising (a) providing any of the above devices; and (b) using the device during the printing of the one or more 3D objects. In some embodiments, the method for printing the one or more three-dimensional (3D) objects, the method comprises: (a) providing the sensor operatively coupled with or being part of the separator; (b) using the sensor to sense (I) the level of the remainder material when the remainder material accumulates in the separator above the first threshold and/or (II) the pressure over time in the internal atmosphere of the separator operatively coupled with the printing enclosure, the pressure over time having the (e.g., substantial) repetition of the first pattern (e.g., sequence), the separator being configured to receive the remainder material initially disposed in the printing enclosure, the remainder material comprising the starting material not used to print the one or more 3D objects, the printing enclosure being configured to, during the printing, enclose the one or more 3D objects printed from the starting material, the printing enclosure being part of the three-dimensional (3D) printer; (c) providing the prevention system operatively coupled with the sensor; and (d) using the prevention system to initiate the prevention operation (i) when the sensor is configured to sense the level of the remainder material accumulating in the separator, and the sensor senses the remainder material above the second threshold indicative of greater level of material accumulation than the first threshold and/or (ii) when the sensor is configured to sense the pressure, and data sensed by the sensor comprises the second pattern, the second pattern comprising the portion that exhibits the substantial change as compared with the first pattern. In some embodiments, the method for printing one or more three-dimensional (3D) objects, the method comprises: sensing the first pressure in the first internal atmosphere of the separator at least in part by using the first sensor, the first sensor being operatively coupled with or being part of the separator, the separator being operatively coupled with a printing enclosure, the separator being configured to receive the remainder material initially disposed in the printing enclosure, the remainder material being the starting material not used for the printing of the one or more 3D objects, the printing enclosure being configured to, during the printing, enclose the one or more 3D objects printed from the starting material, the printing enclosure being part of the three-dimensional (3D) printer; sensing the second pressure in the second internal atmosphere of the component at least in part by using the second sensor, the component being other than the separator, the component being part of or being operatively coupled with the 3D printer, the second sensor being part of or being operatively coupled with the component; and when the coefficient is below the threshold, initiating the prevention operation at least in part by using the prevention system, the coefficient being of the correlation between the first pressure and the second pressure the prevention system being operatively coupled with the first sensor and with the second sensor.

In another aspect, an apparatus for printing one or more three-dimensional (3D) objects, the apparatus comprising at least one controller configured to (a) operatively couple with any of the above devices; and (b) use, or direct usage of, the device during the printing of the one or more 3D objects. In some embodiments, the at least one controller comprise at least one connector configured to connect to a power source. In some embodiments, the at least one controller being configured to operatively couple with a power source at least in part by (I) having a power socket and/or (II) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is included in a control system configured to control the 3D printer that prints the one or more 3D objects. In some embodiments, the device is a component of the 3D printer, and the at least one controller is configured to (i) operatively couple with an other component of the three-dimensional printing system and (ii) direct operation of the other component. In some embodiments, the at least one controller is configured to direct operation of the other component for the printing of the one or more 3D objects. In some embodiments, the at least one controller is operatively coupled to at least about 900 sensors, or 1000 sensors, operatively coupled with the 3D printer. In some embodiments, at least during the printing, the at least one controller is configured to control a pressure in the device and/or in the 3D printer to be above ambient pressure external to the three-dimensional printer. In some embodiments, the at least one controller is configured to control the internal atmosphere of the device and/or the 3D printer to be depleted of at least one reactive agent relative to its concentration in the ambient atmosphere external to the device, the reactive agent being configured to react at least during the printing with (i) a starting material of the three-dimensional objects and/or (ii) a byproduct of the printing. In some embodiments, the apparatus for printing one or more three-dimensional (3D) objects, the apparatus comprising at least one controller configured to: (a) operative couple to the sensor operatively coupled with or being part of the separator, and operatively coupled to, or include, the prevention system operatively coupled with the sensor (b) direct the sensor to sense (I) the level of the remainder material when the remainder material accumulates in the separator above the first threshold and/or (II) the pressure over time in the internal atmosphere of the separator operatively coupled with the printing enclosure, the pressure over time having the (e.g., substantial) repetition of the first pattern (e.g., sequence), the separator being configured to receive the remainder material initially disposed in the printing enclosure, the remainder material comprising the starting material not used to print the one or more 3D objects, the printing enclosure being configured to, during the printing, enclose the one or more 3D objects printed from the starting material, the printing enclosure being part of the three-dimensional (3D) printer; and (c) initiate, or direct the prevention system to initiate, the prevention operation (i) when the sensor is configured to sense the level of the remainder material accumulating in the separator, and the sensor senses the remainder material above the second threshold indicative of greater level of material accumulation than the first threshold and/or (ii) when the sensor is configured to sense the pressure, and data sensed by the sensor comprises the second pattern, the second pattern comprising the portion that exhibits the substantial change as compared with the first pattern. In some embodiments, the apparatus for printing one or more three-dimensional (3D) objects, the apparatus comprising at least one controller configured to: (a) operatively couple with the first sensor and the second sensor; (b) direct the first sensor to sense the first pressure in the first internal atmosphere of the separator, the first sensor being operatively coupled with or being part of the separator, the separator being operatively coupled with a printing enclosure, the separator being configured to receive the remainder material initially disposed in the printing enclosure, the remainder material being the starting material not used to print the one or more 3D objects, the printing enclosure being configured to, during the printing, enclose the one or more 3D objects printed from the starting material, the printing enclosure being part of the three-dimensional (3D) printer; (c) direct the second sensor to sense the second pressure in the second internal atmosphere of the component other than the separator, the second sensor being operatively coupled with or being part of the component, the component being part of or being operatively coupled with the 3D printer; and (d) when the coefficient is below the threshold, direct the prevention system to initiate the prevention operation, the coefficient being of the correlation between the first pressure and the second pressure, the prevention system being operatively coupled with the first sensor and with the second sensor, the prevention system being (i) comprised in the at least one controller or (ii) separate from the at least one controller. In some embodiments, the at least one controller is configured to (I) operatively couple with a material conveyance system and (II) direct conveyance of the remainder material in the material conveyance system at least during the printing. In some embodiments, the conveyance of the remainder material comprises a dense phase conveyance or a dilute phase conveyance. In some embodiments, the conveyance of the remainder material is continuous or intermittent.

In another aspect, non-transitory computer readable program instructions for printing one or more three-dimensional (3D) objects, the program instructions, when read by one or more processors operatively coupled to any of the above devices to cause the one or more processors to execute, or direct the execution of, one or more operations associated with the device during the printing of the one or more 3D objects. In some embodiments, the program instructions are inscribed in one or more media. In some embodiments, the non-transitory computer readable program instructions for printing one or more three-dimensional (3D) objects, the program instructions, when read by one or more processors, cause the one or more processors to execute, or direct the execution of, one or more operations comprises: (b) direct the sensor to sense (I) the level of the remainder material when the remainder material accumulates in the separator above the first threshold and/or (II) the pressure over time in the internal atmosphere of the separator operatively coupled with the printing enclosure, the pressure over time having the (e.g., substantial) repetition of the first pattern (e.g., sequence), the separator being configured to receive the remainder material initially disposed in the printing enclosure, the remainder material comprising the starting material not used to print the one or more 3D objects, the printing enclosure being configured to, during the printing, enclose the one or more 3D objects printed from the starting material, the printing enclosure being part of the three-dimensional (3D) printer; and (c) initiate, or direct the prevention system to initiate, the prevention operation (i) when the sensor is configured to sense the level of the remainder material accumulating in the separator, and the sensor senses the remainder material above the second threshold indicative of greater level of material accumulation than the first threshold and/or (ii) when the sensor is configured to sense the pressure, and data sensed by the sensor comprises the second pattern, the second pattern comprising the portion that exhibits the substantial change as compared with the first pattern, the one or more processors operative couples to the sensor operatively coupled with or being part of the separator, and operatively coupled to, or include, the prevention system operatively coupled with the sensor. In some embodiments, the non-transitory computer readable program instructions for printing one or more three-dimensional (3D) objects, the program instructions, when read by one or more processors operatively coupled with the first sensor and with the second sensor, cause the one or more processors to execute, or direct the execution of, one or more operations comprises: (a) sensing the first pressure in the first internal atmosphere of the separator at least in part by using the first sensor, the first sensor being operatively coupled with or being part of the separator, the separator being operatively coupled with the manufacturing enclosure, the separator being configured to receive the remainder material initially disposed in the printing enclosure, the remainder material being the starting material not used to print the one or more 3D objects, the printing enclosure being configured to, during the printing, enclose the one or more 3D objects printed from the starting material, the printing enclosure being part of the three-dimensional (3D) printer; (b) sensing the second pressure in the second internal atmosphere of the component at least in part by using the second sensor, the component being other than the separator, the second sensor being part of or being operatively coupled with the component, the component being part of or being operatively coupled with the 3D printer; and (c) when the coefficient is below the threshold, initiating the prevention operation by using the prevention system, the coefficient being of the correlation between the first pressure and the second pressure, the prevention system being operatively coupled with the first sensor and the second sensor, the prevention system being (i) comprised in the one or more processors or (ii) separate from the one or more processors.

In another aspect, a device for manufacturing object(s), the device comprises: an inner channel configured for flow of remainder material initially disposed in a manufacturing enclosure, the remainder material comprising a starting material not used to manufacture the object(s), the manufacturing enclosure being configured to, during the manufacturing, enclose the object(s) manufactured from the starting material, the manufacturing enclosure being comprised in a manufacturing system; an outer channel encasing at least a portion of the inner channel such that an interstitial space (e.g., gap space) is disposed between an external surface of the inner channel, and an internal surface of the outer channel; a sensor configured to sense an interstitial pressure in the interstitial space; and a prevention system operatively coupled with the sensor, the prevention system being configured to initiate a prevention operation when the interstitial pressure is above a threshold.

In another aspect (e.g., when the manufacturing system is a 3D printing system), a device for printing one or more three-dimensional (3D) objects, the device comprises: an inner channel configured for flow of remainder material initially disposed in a printing enclosure, the remainder material comprising a starting material not used to print the one or more 3D objects, the printing enclosure being configured to, during the printing, enclose the one or more 3D objects printed from the starting material, the printing enclosure being comprised in a three-dimensional (3D) printer; an outer channel encasing at least a portion of the inner channel such that an interstitial space (e.g., gap space) is disposed between an external surface of the inner channel, and an internal surface of the outer channel; a sensor configured to sense an interstitial pressure in the interstitial space; and a prevention system operatively coupled with the sensor, the prevention system being configured to initiate a prevention operation when the interstitial pressure is above a threshold. In some embodiments, the interstitial space is a closed space. In some embodiments, the interstitial space is closed comprising gas tight, or hermetically closed. In some embodiments, the interstitial space is closed such that the interstitial space can maintain an interstitial atmosphere having at least one characteristic different from the ambient atmosphere external to the outer channel and/or to the 3D printer. In some embodiments, the at least one characteristic comprises a pressure, or a level of reactive agent, the reactive agent being configured to react with the starting material and/or with the remainder material at least during the printing. In some embodiments, the at least one characteristic comprises an overpressure relative to the pressure of the ambient atmosphere. In some embodiments, the inner channel is configured to operatively couple with a material remover mechanism configured to remove the remainder material from the printing enclosure to print the one or more 3D objects. In some embodiments, the material removal mechanism is comprised in a layer dispensing mechanism, the layer dispensing mechanism being configured to operatively couple with the printing enclosure. In some embodiments, the layer dispensing mechanism comprises a material dispensing mechanism, the material dispensing mechanism being configured to dispense the starting material in the printing enclosure, the material removal mechanism being configured to remove the remainder material from the printing enclosure. In some embodiments, the layer dispensing mechanism is devoid of a leveling mechanism (e.g., knife and/or roller). In some embodiments, the layer dispensing mechanism further comprises a leveling mechanism. In some embodiments, the starting material dispensed by the material dispensing mechanism forms at least a portion of a material bed, the material bed being enclosed by the printing enclosure during the printing, the material bed being utilized to print at least a portion of the one or more 3D objects. In some embodiments, the material bed is supported (e.g., and carried) by a build platform, the build platform being disposed in the printing enclosure. In some embodiments, the device is configured to facilitate the printing by facilitating vertical translation of the build platform comprising an error in vertical positioning of the vertical translation at most about 10%, 5%, or 2% of the vertical translation of the build platform. In some embodiments, the material removal mechanism is configured to generate a planar layer of the starting material as a part of the material bed, the planar layer having a planar exposed surface. In some embodiments, the material removal mechanism is configured to utilize an attractive force. In some embodiments, the attractive force comprises a magnetic, an electric, an electrostatic, or a vacuum source. In some embodiments, the attractive force comprises a vacuum source. In some embodiments, a portion of the remainder material removed by the material removal mechanism is at least about 70%, 50% or 30% of the remainder material initially disposed in the printing enclosure. In some embodiments, the material dispensing mechanism comprises or is operatively coupled with an agitator, the agitator being configured to cause at least a portion of the starting material to agitate (e.g., move such as vibrate). In some embodiments, the printing enclosure is operatively coupled with an ancillary chamber, the ancillary chamber being configured to accommodate the layer dispensing mechanism. In some embodiments, the inner channel is configured to operatively couple with (i) the ancillary chamber and/or (ii) the layer dispensing mechanism. In some embodiments, the printing enclosure and/or the ancillary chamber comprises one or more ports (e.g., holes), the one or more ports being configured to exit the remainder material from the printing enclosure and/or ancillary chamber. In some embodiments, the inner channel is configured to operatively couple with the one or more ports of the printing enclosure and/or the ancillary chamber. In some embodiments, the one or more ports are located on a floor of the printing enclosure and/or the ancillary chamber. In some embodiments, the printing enclosure is configured to print the one or more 3D objects in an atmosphere having at least one characteristic different than that of an ambient atmosphere external to the 3D printer. In some embodiments, during flow of the remainder material, the inner channel is configured to facilitate flow of the remainder material carried by gas, the gas having the at least one characteristic different than that of an ambient atmosphere external to the 3D printer. In some embodiments, the at least one characteristic comprises a pressure, or a level of reactive agent, the reactive agent being configured to react with the starting material and/or with the remainder material at least during the printing. In some embodiments, the reaction of the reactive agent with the starting material and/or with the remainder material, results in an unwanted reaction product. In some embodiments, the reactive agent comprises oxygen, water, or hydrogen sulfide. In some embodiments, during flow of the remainder material, an inner pressure inside the inner channel is above an ambient pressure external to the 3D printer. In some embodiments, the inner pressure is within a range of (i) from about an ambient atmosphere external to the 3D printer (ii) to about 16 kilo pascals (kPa) above the ambient pressure. In some embodiments, the remainder material comprises an elemental metal, a metal alloy, a ceramic, or an allotrope carbon. In some embodiments, the remainder material comprises powder material. In some embodiments, the remainder material comprises a polymer or a resin. In some embodiments, the outer channel is configured to enclose and/or to flow the remainder material when the inner channel malfunctions such that the remainder material expels from the inner channel into the interstitial space. In some embodiments, the malfunction of the inner channel comprises a hole, a crack, or a puncture. In some embodiments, the interstitial space is configured to accommodate the interstitial pressure that is (i) (e.g., substantially) the same as an ambient pressure external to the 3D printer, or (ii) between the ambient pressure and an inner pressure inside the inner channel. In some embodiments, the interstitial pressure is (e.g., substantially) constant during normal operation. In some embodiments, the outer channel comprises at least one restrictor. In some embodiments, the at least one restrictor is configured to be opened to an ambient atmosphere external to the 3D printer at least during the printing. In some embodiments, the remainder material comprises a particulate material, the at least one restrictor comprising a fundamental length scale (FLS) smaller than a central tendency of a fundamental length scale (FLS) of the particulate material. In some embodiments, the at least one restrictor has the FLS smaller than about 20 micrometers (μm). In some embodiments, the restrictor is configured to allow permeation of gas between the interstitial space and an ambient atmosphere external to the 3D printer. In some embodiments, the at least one restrictor comprises an orifice. In some embodiments, the at least one restrictor is configured to equilibrate, or allow equilibration efforts with, the interstitial pressure with an ambient pressure external to the 3D printer. In some embodiments, the interstitial pressure is substantially same as an ambient pressure external to the 3D printer. In some embodiments, the at least one restrictor comprises (i) a linear flow restrictor or (ii) a quadratic flow restrictor. In some embodiments, the at least one restrictor comprises a flow rate within a range of (i) from about 0.1 milliliter/minute/kilopascal (mL/min/kPa) (ii) to about 10 mL/min/kPa. In some embodiments, the outer channel comprises a porous material. In some embodiments, the outer channel is configured to accommodate (e.g., hold) a positive interstitial pressure above an ambient pressure external to the 3D printer. In some embodiments, the interstitial pressure is above the ambient pressure external to the 3D printer and below an inner pressure inside the inner channel. In some embodiments, the interstitial pressure is within a range of (i) from about the ambient pressure (ii) to about 5 kPa above the ambient pressure. In some embodiments, the outer channel is gas tight, hermetic, and/or sealed. In some embodiments, the threshold is about 5 kPa above an ambient pressure of an ambient atmosphere external to the 3D printer. In some embodiments, the sensor is a first sensor, and the interstitial space is coupled with a second sensor configured to sense the remainder material in the interstitial space. In some embodiments, the second sensor is configured to sense the flowing remainder material in the interstitial space. In some embodiments, the second sensor is a proximity sensor. In some embodiments, the second sensor comprises an optical sensor, a sonic sensor, an electrical sensor, or a temperature sensor. In some embodiments, the second sensor is configured to sense the remainder material as it interacts with the internal surface of the outer channel and/or with the external surface of the inner channel. In some embodiments, the sensor is a first sensor, the device further comprises a second sensor, the second sensor being configured to sense an inner pressure inside the inner channel, the prevention system being configured to be operatively coupled with the second sensor. In some embodiments, inner pressure over time has a (e.g., substantial) repetition of a first pattern (e.g., sequence) during the printing, the first pattern comprising a first width. In some embodiments, the prevention system is configured to initiate the prevention operation when the interstitial pressure correlates to pressure fluctuations occurring in the printing enclosure. In some embodiments, the prevention system is configured to initiate the prevention operation when the interstitial pressure has a (e.g., substantial) repetition of a second pattern (e.g., sequence), the second pattern comprising a second width, the second width being (e.g., substantially) identical to the first width. In some embodiments, the first pattern has (i) an increasing tendency during a first time interval and (ii) a decreasing tendency during a second time interval, the second pattern having (i) an increasing tendency during the first time interval and (ii) a decreasing tendency during the second time interval. In some embodiments, the first pattern comprises a first amplitude, and the second pattern comprises a second amplitude, the second amplitude being smaller than the first amplitude. In some embodiments, the threshold is a first threshold, and the prevention system is configured to initiate when a coefficient of a correlation between the inner pressure and the interstitial pressure is above a second threshold. In some embodiments, the coefficient is a normalized correlation coefficient. In some embodiments, the prevention system is configured to initiate the prevention operation when the interstitial pressure has a repetitive pattern (e.g., sequence) over time. In some embodiments, an inner surface of at least one component of the device comprises a coating having a hard material, or comprises the hard material, configured to prolong normal operation of the device. In some embodiments, the hard material has a hardness greater than that of the remainder material. In some embodiments, the inner channel comprises the coating, or is made from the hard material, configured to prolong normal operation of the internal channel. In some embodiments, the inner channel and/or the outer channel comprise: (i) a flexible material or (ii) a discharging material. In some embodiments, the flexible material comprises a resin or a polymer. In some embodiments, the flexible material comprises Polyvinyl Chloride (PVC), Polyurethane, latex, or rubber. In some embodiments, the discharging material comprises a carbon black or a metal. In some embodiments, the metal comprises an elemental metal or a metal alloy. In some embodiments, the discharging material is in a form of a particulate matter. In some embodiments, the discharging material has a structural form, the discharging material being configured for disposition in an inner wall of the inner channel and/or the outer channel. In some embodiments, the structural form comprises a spiral or a mesh. In some embodiments, the discharging material has a hardness greater than that of the remainder material. In some embodiments, the discharging material is configured to be grounded. In some embodiments, the inner channel and/or the outer channel comprises a flexible structure. In some embodiments, the flexible structure comprises a bellow structure or an other folding structure. In some embodiments, the flexible structure comprises a solid. In some embodiments, the flexible structure comprises an elemental metal or a metal alloy. In some embodiments, the prevention system is configured to monitor the sensor at least during the printing. In some embodiments, the prevention system is configured to monitor the sensor continuously. In some embodiments, the prevention system is configured to monitor the sensor intermittently. In some embodiments, the prevention system is configured to monitor the sensor in repetitive intervals. In some embodiments, the prevention system is configured to monitor the sensor in real time. In some embodiments, the prevention system is configured to initiate the prevention operation comprising (i) a notification or (ii) a procedure. In some embodiments, the prevention operation comprises (i) triggering an alarm, (ii) generating a report, (iii) generating an instruction, (iv) prescribing a remedial operation, or (iv) interrupting the printing. In some embodiments, the device is configured to facilitate the printing at least in part by being configured to control deposition of the starting material on a target surface. In some embodiments, the target surface comprises (i) an exposed surface of a material bed or (ii) an exposed surface of a build plate. In some embodiments, the deposition comprises a layer-wise deposition. In some embodiments, the printing enclosure comprises or is operatively coupled with a material removal wand, the material removal wand being configured to remove the remainder material from the printing enclosure, the material removal wand being configured to utilize an attractive force. In some embodiments, the attractive force comprises a vacuum force. In some embodiments, the inner channel is configured to operatively couple with, or be comprised in, a material conveyance system or a gas conveyance system, the material conveyance system comprising a material recycling system, the gas conveyance system comprising a gas recycling system. In some embodiments, at least a portion of the printing comprises arc welding. In some embodiments, the arc welding is by an arc welder to facilitate the printing of the one or more 3D objects comprises: generating a powder stream and focusing an energy beam on the powder stream, the arc welder being part of or being operatively coupled with the 3D printer. In some embodiments, at least a portion of the printing comprises connecting particulate matter to facilitate the printing of the 3D objects. In some embodiments, the particulate matter comprises a super alloy. In some embodiments, the super alloy comprises Inconel, In Ti F Haynes GRCop-C CA6NM, or Hastelloy-X. In some embodiments, at least a portion of the printing comprises a fusing process. In some embodiments, the fusing comprises (i) sintering, (ii) melting, (iii) smelting, or (iv) any combination of (i)-(iii). In some embodiments, the prevention system is part of, or is operatively coupled with, a control system of the 3D printer that is configured to control the printing.

In another aspect, a method for printing one or more three-dimensional (3D) objects, the method comprising (a) providing any of the above devices; and (b) using the device during the printing of the one or more 3D objects. In some embodiments, the method for printing one or more three-dimensional (3D) objects, the method comprises: (a) providing the inner channel configured for flow of remainder material initially disposed in the printing enclosure, the remainder material comprising the starting material not used to print the one or more 3D objects, the printing enclosure being configured to, during the printing, enclose the one or more 3D objects printed from the starting material, the printing enclosure being comprised in the three-dimensional (3D) printer; (b) providing the outer channel encasing at least the portion of the inner channel such that the interstitial space (e.g., gap space) is disposed between the external surface of the inner channel, and the internal surface of the outer channel; (c) flowing the remainder material in the inner channel; (d) sensing the interstitial pressure in the interstitial space at least in part by using the sensor; and (c) providing the prevention system operatively coupled with the sensor; and (f) using the prevention system to initiate the prevention operation when the interstitial pressure is above the threshold. In some embodiments, the method for printing one or more three-dimensional (3D) objects, the method comprises: (a) sensing the interstitial pressure in the interstitial space at least in part by using the sensor, the interstitial space being disposed between (i) the external surface of the inner channel and (ii) the internal surface of the outer channel, the outer channel encasing at least the portion of the inner channel, the inner channel being configured for flow of the remainder material initially disposed in the manufacturing enclosure, the remainder material comprising the starting material not used for the printing of the one or more 3D objects, the printing enclosure being configured to, during the printing, enclose the one or more 3D objects printed from the starting material, the printing enclosure being part of the three-dimensional (3D) printer; and (b) when the interstitial pressure is above the threshold, initiating the prevention operation at least in part by using the prevention system, the prevention system being operatively coupled with the sensor. In some embodiments, the prevention system is part of, or is operatively coupled with, a control system of the 3D printer that controls the printing.

In another aspect, an apparatus for printing one or more three-dimensional (3D) objects, the apparatus comprising at least one controller configured to (a) operatively couple with any of the above devices; and (b) use, or direct usage of, the device during the printing of the one or more 3D objects. In some embodiments, the at least one controller comprise at least one connector configured to connect to a power source. In some embodiments, the at least one controller being configured to operatively couple with a power source at least in part by (I) having a power socket and/or (II) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is included in a control system configured to control the 3D printer that prints the one or more 3D objects. In some embodiments, the device is a component of the 3D printer, and the at least one controller is configured to (i) operatively couple with an other component of the three-dimensional printing system and (ii) direct operation of the other component. In some embodiments, the at least one controller is configured to direct operation of the other component for the printing of the one or more 3D objects. In some embodiments, the at least one controller is operatively coupled to at least about 900 sensors, or 1000 sensors, operatively coupled with the 3D printer. In some embodiments, at least during the printing, the at least one controller is configured to control a pressure in the device and/or in the 3D printer to be above ambient pressure external to the three-dimensional printer. In some embodiments, the at least one controller is configured to control the internal atmosphere of the device and/or the 3D printer to be depleted of at least one reactive agent relative to its concentration in the ambient atmosphere external to the device, the reactive agent being configured to react at least during the printing with (i) a starting material of the three-dimensional objects and/or (ii) a byproduct of the printing. In some embodiments, the apparatus for printing one or more three-dimensional (3D) objects, the apparatus comprising at least one controller configured to: (a) direct flow of remainder material in the inner channel configured for flow of remainder material initially disposed in the printing enclosure, the remainder material comprising the starting material not used to print the one or more 3D objects, the printing enclosure being configured to, during the printing, enclose the one or more 3D objects printed from the starting material, the printing enclosure being comprised in the three-dimensional (3D) printer, the inner channel at least partially encased by the outer channel such that the interstitial space (e.g., gap space) is disposed between the external surface of the inner channel, and the internal surface of the outer channel; (b) direct the sensor to sense the interstitial pressure in the interstitial space, the at least one controller begin configured to operatively couple with the sensor; and (c) initiate, or direct initiation of, the prevention operation when the interstitial pressure is above the threshold, the prevention operation being initiated by the prevention system the at least one controller being configured to operatively couple with, or include, the prevention system that is operatively coupled with the sensor. In some embodiments, the apparatus for printing one or more three-dimensional (3D) objects, the apparatus comprising at least one controller configured to: (a) operatively couple with the sensor; (b) direct the sensor to sense the interstitial pressure in the interstitial space, the interstitial space being disposed between the external surface of the inner channel and the internal surface of the outer channel, the outer channel encasing at least the portion of the inner channel, the inner channel being configured for flow of the remainder material initially disposed in the printing enclosure, the remainder material comprising the starting material not used for the printing of the one or more 3D objects, the printing enclosure being configured to, during the printing, enclose the one or more 3D objects printed from the starting material, the printing enclosure being part of the three-dimensional (3D) printer; and (c) when the interstitial pressure is above the threshold, direct the prevention system to initiate the prevention operation, the prevention system being operatively coupled with the sensor, the prevention system being (i) comprised in the at least one controller or (ii) separate from the at least one controller.

In another aspect, non-transitory computer readable program instructions for printing one or more three-dimensional (3D) objects, the program instructions, when read by one or more processors operatively coupled to any of the above devices, cause the one or more processors to execute, or direct the execution of, one or more operations associated with the device during the printing of the one or more 3D objects. In some embodiments, the program instructions are inscribed in one or more media. In some embodiments, the non-transitory computer readable program instructions for printing one or more three-dimensional (3D) objects, the program instructions, when read by one or more processors, cause the one or more processors to execute, or direct execution of, one or more operations comprises: (a) directing flow of remainder material in the inner channel configured for flow of remainder material initially disposed in the printing enclosure, the remainder material comprising the starting material not used to print the one or more 3D objects, the printing enclosure being configured to, during the printing, enclose the one or more 3D objects printed from the starting material, the printing enclosure being comprised in the three-dimensional (3D) printer, the inner channel at least partially encased by the outer channel such that the interstitial space (e.g., gap space) is disposed between the external surface of the inner channel, and the internal surface of the outer channel; (b) directing the sensor to sense the interstitial pressure in the interstitial space, the one or more processors operatively coupled with the sensor; and (c) initiating, or directing initiation of, the prevention operation when the interstitial pressure is above the threshold, the prevention operation being initiated by the prevention system the one or more processors operatively coupled with, or include, the prevention system that is operatively coupled with the sensor. In some embodiments, the non-transitory computer readable program instructions for printing one or more three-dimensional (3D) objects, the program instructions, when read by one or more processors operatively coupled with the sensor, cause the one or more processors to execute, or direct execution of, one or more operations comprises: (a) sensing the interstitial pressure in the interstitial space at least in part by using the sensor, the interstitial space being disposed between the external surface of the inner channel and the internal surface of the outer channel, the outer channel encasing at least the portion of the inner channel, the inner channel being configured to allow flow of the remainder material initially disposed in the printing enclosure, the remainder material comprising the starting material not used for the printing of the one or more 3D objects, the printing enclosure being configured to, during the printing, enclose the one or more 3D objects printed from the starting material, the printing enclosure being comprised in the three-dimensional (3D) printer; and (b) when the interstitial pressure is above the threshold, initiating the prevention operation at least in part by using the prevention system, the prevention system being operatively coupled with the sensor, the prevention system being (i) comprised in the one or more processors or (ii) separate from the one or more processors.

In another aspect, a system for effectuating the methods, operations of an apparatus, and/or operations inscribed by non-transitory computer readable program instructions (e.g., inscribed on a media/medium), disclosed herein.

In another aspect, a system for effectuating the methods, operations of an apparatus, operation of a device, and/or operations inscribed by non-transitory computer readable program instructions (e.g., inscribed on a media/medium), disclosed herein.

In another aspect, device(s) (e.g., apparatus) for effectuating the methods, operations of an apparatus, and/or operations inscribed by non-transitory computer readable program instructions (e.g., inscribed on a media/medium).

In other aspects, systems, apparatuses (e.g., controller(s)), and/or non-transitory computer-readable program instructions (e.g., software) that implement any of the methods disclosed herein. In some embodiments, the program instructions is inscribed on at least one medium (e.g., on a medium or on media).

In other aspects, methods, systems, apparatuses (e.g., controller(s)), and/or non-transitory computer-readable program instructions (e.g., software) that implement any of the devices disclosed herein and/or any operation of these devices. In some embodiments, the program instructions is inscribed on at least one medium (e.g., on a medium or on media).

In another aspect, an apparatus (e.g., for printing one or more 3D objects) comprises at least one controller that is configured (e.g., programmed) to direct a mechanism used in a 3D printing methodology to implement (e.g., effectuate) any of the method and/or operations disclosed herein, wherein the controller(s) is operatively coupled with the mechanism. In some embodiments, the controller(s) implements any of the methods and/or operations disclosed herein. In some embodiments, the at least one controller comprises, or be operatively coupled with, a hierarchical control system. In some embodiments, the hierarchical control system comprises at least three, four, or five, control levels. In some embodiments, at least two operations are performed, or directed, by the same controller. In some embodiments, at least two operations are each performed, or directed, by a different controller.

In another aspect, an apparatus (e.g., for printing one or more 3D objects) comprises at least one controller that is configured (e.g., programmed) to implement (e.g., effectuate), or direct implementation of, the method, process, and/or operation disclosed herein. In some embodiments, the at least one controller implements any of the methods, processes, and/or operations disclosed herein.

In another aspect, non-transitory computer readable program instructions (e.g., for printing one or more 3D objects), when read by one or more processors, are configured to execute, or direct execution of, the method, process, and/or operation disclosed herein. In some embodiments, the at least one controller implements any of the methods, processes, and/or operations disclosed herein. In some embodiments, at least a portion of the one or more processors is part of a 3D printer, outside of the 3D printer, or in a location remote from the 3D printer (e.g., in the cloud).

In another aspect, a system for printing one or more 3D objects comprises an apparatus (e.g., used in a 3D printing methodology) and at least one controller that is configured (e.g., programmed) to direct operation of the apparatus, wherein the at least one controller is operatively coupled with the apparatus. In some embodiments, the apparatus includes any apparatus or device disclosed herein. In some embodiments, the at least one controller implements, or direct implementation of, any of the methods disclosed herein. In some embodiments, the at least one controller directs any apparatus (or component thereof) disclosed herein.

In some embodiments, at least two of operations (e.g., instructions) of the apparatus are directed by the same controller. In some embodiments, at least two of operations (e.g., instructions) of the apparatus are directed by different controllers.

In some embodiments, at least two of operations (e.g., instructions) are carried out by the same processor and/or by the same sub-computer software product. In some embodiments, at least two of operations (e.g., instructions) are carried out by different processors and/or by different sub-computer software products.

In another aspect, a computer software product, comprising a (e.g., non-transitory) computer-readable medium/media in which program instructions are stored, which instructions, when read by a computer, cause the computer to direct a mechanism used in the 3D printing process to implement (e.g., effectuate) any of the method disclosed herein, wherein the non-transitory computer-readable medium is operatively coupled with the mechanism. In some embodiments, the mechanism comprises an apparatus or an apparatus component.

In another aspect, a computer system comprising one or more computer processors and non-transitory computer-readable medium/media coupled thereto. In some embodiments, the non-transitory computer-readable medium/media comprises machine-executable code that, upon execution by the one or more computer processors, implements any of the methods and/or operations (e.g., as disclosed herein), and/or effectuates directions of the controller(s) (e.g., as disclosed herein).

In another aspect, a method for three-dimensional printing, the method comprises executing one or more operations associated with at least one configuration of the device(s) disclosed herein.

In another aspect, an apparatus for three-dimensional printing, the apparatus comprising at least one controller is configured (i) operatively couple to the device, and (ii) direct executing one or more operations associated with at least one configuration of the device(s) disclosed herein.

In another aspect, at least one controller is associated with the methods, devices, and software disclosed herein. In some embodiments, the at least one controller comprise at least one connector configured to connect to a power source. In some embodiments, the at least one controller being configured to operatively couple to a power source at least in part by (I) having a power socket and/or (II) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is included in a control system configured to control a three-dimensional printer that prints the one or more three-dimensional objects. In some embodiments, the at least one controller is configured to control at least one other component of a 3D printing system. In some embodiments, the device disclosed herein is a component of a three-dimensional printing system, and wherein the at least one controller is configured to (i) operatively couple to another component of the three-dimensional printing system and (ii) direct operation of the other component. In some embodiments, the at least one controller is configured to direct operation of the other component at least in part for participation of the other component in three-dimensional printing. In some embodiments, the at least one controller is operatively coupled with at least about 900 sensors, or 1000 sensors operatively couple to the three-dimensional printer. In some embodiments, the at least one controller is configured to control a pressure in the three-dimensional printer to be above ambient pressure external to the three-dimensional printer. In some embodiments, the at least one controller is configured to control an internal atmosphere of the three-dimensional printer to be depleted of a reactive agent relative to its concentration in an ambient atmosphere external to the device, the reactive agent being configured to react with a starting material of the three-dimensional printing at least during the three-dimensional printing.

In another aspect, non-transitory computer readable program instructions for three-dimensional printing, the non-transitory computer readable program instructions, when read by one or more processors operatively coupled to the device, cause the one or more processors to direct executing one or more operations associated with at least one configuration of the device(s) disclosed herein.

In some embodiments, the program instructions are of a computer product.

In another aspect, a system for three-dimensional printing, the system comprising: the any of the devices above; and an energy beam configured to irradiate powder material (e.g., a planar layer of powder material) to print at least a portion of at least one three-dimensional object at least in part by using three-dimensional printing. In some embodiments, the system further comprising a scanner configured to translate the energy beam along a target surface, wherein the device is operatively coupled with the scanner disposed in an optical system enclosure. In some embodiments, the system further comprises an energy source configured to generate the energy beam, wherein the device is operatively coupled with the energy source. In some embodiments, the energy source comprises a laser source or an electron beam source. In some embodiments, the system further comprises at least one controller that (i) is operatively coupled with the device and (ii) direct one or more operations associated with the device. In some embodiments, the system is configured to operatively couple to at least one controller configured to (i) operatively couple to the system and (ii) direct one or more operations associated with the system.

The various embodiments in any of the above aspects are combinable (e.g., within an aspect), as appropriate.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

All publications, patents, and patent applications mentioned in this specification are herein incorporated by reference to the same extent as if each individual publication, patent, or patent application was specifically and individually indicated to be incorporated by reference. Each such reference is incorporated herein in their entireties respectively and for all purposes.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, in which the principles of the present disclosure are utilized, and the accompanying drawings or figures (also “Fig.” and “Figs.” herein), of which:

FIG. 1 schematically illustrates a front view of components of a three-dimensional (3D) printing system, and a path;

FIG. 2 schematically illustrates a perspective view of components of a 3D printing system;

FIG. 3 schematically illustrates various views of components of a 3D printing system;

FIG. 4 schematically illustrates various components of a 3D printing system;

FIG. 5 schematically illustrate operations in forming a 3D object;

FIG. 6 schematically illustrates components of a 3D printing system;

FIG. 7 schematically illustrates components of a 3D printing system;

FIG. 8 schematically illustrates components of a 3D printing system in perspective view;

FIG. 9 schematically illustrates components of a 3D printing system in perspective view;

FIG. 10 schematically illustrates various views of components of a 3D printing system;

FIG. 11 schematically illustrates various views of components of a 3D printing system;

FIG. 12 schematically illustrates a perspective view of a sieve and associated components;

FIG. 13 schematically illustrates components of a 3D printing system and a pressure fluctuation as a function of time;

FIG. 14 schematically illustrates components of a 3D printing system and a pressure fluctuation as a function of time;

FIG. 15 schematically illustrates a pressure graph as a function of time in normal operation;

FIG. 16 schematically illustrates a pressure graph as a function of time in faulty operation;

FIG. 17 schematically illustrates components of a sensing system;

FIG. 18 schematically illustrates components of a sensing system;

FIG. 19 schematically illustrates various components of a 3D printing system;

FIG. 20 schematically illustrates components of 3D printing system, and a pressure fluctuation over time;

FIG. 21 schematically illustrates various components of a 3D printing system;

FIG. 22 schematically illustrates side views of various components of a 3D printing system;

FIG. 23 schematically illustrates an example passage (e.g., channel) and associated components;

FIG. 24 schematically illustrates an example passage (e.g., channel) and associated components;

FIG. 25 schematically illustrates a pressure graph as a function of time in normal operation;

FIG. 26 schematically illustrates a pressure graph as a function of time in faulty operation; and

FIG. 27 schematically illustrates a processing (e.g., computer) system.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed. The various embodiments disclosed herein are combinable, as appropriate.

Terms such as “a”, “an” and “the” are not intended to refer to only a singular entity but include the general class of which a specific example may be used for illustration. The terminology herein is used to describe specific embodiments in the present disclosure, but their usage does not delimit to the specific embodiments of the present disclosure. The term “includes” means includes but not limited to, the term “including” means including but not limited to, and the term “based on” means based at least in part on.

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.” When ranges are mentioned (e.g., between, at least, at most, and the like) the endpoint(s) of the range is/are also claimed. For example, when the range is from X to Y, the values of X and Y are also claimed. For example, when the range is at most Z, the value of Z is also claimed. For example, when the range is at least W, the value of W is also claimed.

The conjunction “and/or” as used herein in “X and/or Y”—including in the specification and claims—is meant to include the options (i) X, (ii) Y, and (iii) X and Y, as applicable. The conjunction of “and/or” in the phrase “including X, Y, and/or Z” is meant to include any combination and any plurality thereof, as applicable. For example, it is meant to include the following: (1) a single X, (2) a single Y, (3) a single Z, (4) a single X and a single Y, (5) a single X and a single Z, (6) a single Y and a single Z, (7) a single X, a single Y, and a single Z, (8) a plurality of X, (9) a plurality of Y, (10) a plurality of Z, (11) a plurality of X and a single Y, (12) a plurality of X, a single Y and a single Z, (13) a plurality of X and a single Z, (14) a plurality of Y and a single X, (15) a plurality of Y, a single X, and a single Z, (16) a plurality of Y and a single Z, (17) a plurality of Z and a single X, (18) a plurality of Z, a single X, and a single Y (19) a plurality of Z and a single Y, (20) a plurality X and a plurality Y, (21) a plurality X and a plurality Z, (22) a plurality Y and a plurality Z, and (23) a plurality X, a plurality Y, and a plurality Z. The phrase “including X, Y, and/or Z” is meant to have the same meaning as the phrase “comprising X, Y, or Z.”

The term “operatively coupled” or “operatively connected” refers to a first mechanism that is coupled (or connected) to a second mechanism to allow the intended operation of the second and/or first mechanism. The coupling may comprise physical or non-physical coupling. The non-physical coupling may comprise signal induced coupling (e.g., wireless coupling).

The phrase “is/are structured” or “is/are configured,” when modifying an article, refers to a structure of the article that is able to bring about the referred result.

Fundamental length scale (abbreviated herein as “FLS”) comprises any suitable scale (e.g., dimension) of an object. For example, an FLS of an object may comprise a length, a width, a height, a diameter, a spherical equivalent diameter, a diameter of a bounding circle, a diameter of a bounding sphere, a radius, a spherical equivalent radius, or a radius of a bounding circle, or a radius of a bounding sphere.

A central tendency as understood herein comprises mean, median, or mode. The mean may comprise a geometric mean.

“Real time” as understood herein may be during at least part of the printing of a 3D object. Real time may be during a print operation. Real time may be during a print cycle. Real time may comprise: during formation of a 3D object.

Performing a reversible first operation is understood herein to mean performing the first operation and being capable of performing the opposite of that first operation (e.g., which is a second operation). For example, when a controller directs reversibly opening a shutter, that shutter can also close, and the controller can optionally direct a closure of that shutter. For example, when a layer dispensing mechanism (e.g., recoater) reversibly translates in a first direction, that layer dispensing mechanism (e.g., recoater) can also translate in a second direction opposite to the first direction. For example, when a controller directs reversibly translating a recoater in a first direction, that recoater can translate in the first direction and can also translate in a second direction opposite to the first direction, e.g., when the controller directs the recoater to translate in the second direction.

Where suitable, one or more of the features shown in a figure comprising a 3D printer and/or components thereof can be combined with one or more of the various features of other 3D printers and/or components thereof described herein. A figure shown herein may not show certain features of a 3D printer and/or components thereof described herein. It should be understood that any such features can be incorporated within the 3D printer as requested and where suitable.

Any of the apparatuses and/or their components disclosed herein may be built by a material disclosed herein. The apparatuses and/or their components comprise a transparent or non-transparent (e.g., opaque) material. For example, the apparatuses and/or their components may comprise an organic or an inorganic material. For example, the apparatuses and/or their components may comprise an elemental metal, metal alloy, ceramic, or an allotrope of elemental carbon. For example, the enclosure, platform, recycling system, or any of their components may comprise an elemental metal, metal alloy, ceramic, or an allotrope of elemental carbon.

The present disclosure provides three-dimensional (3D) printing apparatuses, systems, software, and methods for forming a 3D object. For example, a 3D object may be formed by sequential addition of material or joining of starting material (e.g., pre-transformed material or source material) to form a structure in a controlled manner (e.g., under manual or automated control).

Transformed material, as understood herein, is a material that underwent a physical change. The physical change can comprise a phase change. The physical change can comprise fusing (e.g., melting or sintering), connecting, or bonding (e.g., physical, or chemical bond). The physical change can be a phase transformation such as from a solid to a partially liquid, or to a liquid phase.

The 3D printing process may comprise printing one or more layers of hardened material in a building cycle, e.g., in a printing cycle. A building cycle (e.g., printing cycle), as understood herein, comprises printing the (e.g., hardened, or solid) material layers of a print job (e.g., all, or substantially all, the layers of a printing job), which may comprise printing one or more 3D objects above a platform (e.g., in a single material bed). The one or more 3D object(s) may or may not be physically anchored to the platform (e.g., a build platform) above which it/they are printed.

Pre-transformed material (also referred to herein as “starting material”), as understood herein, is a material before it has been transformed (e.g., once transformed) by an energy beam during an upcoming 3D printing process, e.g., it is a starting material for an upcoming 3D printing process. The pre-transformed material may be a material that was, or was not, transformed prior to its use in the upcoming 3D printing process. The pre-transformed material may be a material that was partially transformed prior to its use in the upcoming 3D printing process. The pre-transformed material may be a starting material for the upcoming 3D printing process. The pre-transformed material may be liquid, solid, or semi-solid (e.g., gel). The pre-transformed material may be a particulate material. For example, the particulate material may be a powder material. The powder material may comprise solid particles of material(s). The particulate material may comprise vesicles (e.g., containing liquid or semi-solid material). The particulate material may comprise solid or semi-solid material particles. The pre-transformed material may be in the form of a powder, wires, sheets, or droplets. The pre-transformed material may be pulverous. The pre-transformed material may have been transformed by a 3D printer process prior to the upcoming 3D printing process. For example, in a first 3D printing process (having a first build cycle), powder material was used to form a 3D object. A remainder of the powder material of the first 3D printing process may become a pre-transformed material for an upcoming second 3D printing process (having a second build cycle). Thus, even though the remainder powder of the first 3D printing process may comprise transformed material (e.g., bits of sintered powder), it is still considered a pre-transformed material relative to the second 3D printing process. The remainder can be filtered and otherwise recycled for use as a pre-transformed material in the second 3D printing process.

In some embodiments, in a 3D printing process, the deposited pre-transformed material may be fused (e.g., sintered or melted), bound, or otherwise connected to form at least a portion of the requested 3D object. Fusing, binding, or otherwise connecting the material is collectively referred to herein as “transforming” the material. Fusing the material may refer to melting, smelting, or sintering a pre-transformed material.

In some embodiments, melting may comprise liquefying the material (i.e., transforming to a liquefied state). A liquefied state refers to a state in which at least a portion of a transformed material is in a liquid state. Melting may comprise liquidizing the material (i.e., transforming to a liquidus state). A liquidus state refers to a state in which an entire transformed material is in a liquid state. The apparatuses, methods, software, and/or systems provided herein are not limited to the generation of a single 3D object but may be utilized to generate one or more 3D objects simultaneously (e.g., in parallel) or separately (e.g., sequentially). The plurality of 3D objects may be formed in one or more material beds (e.g., powder bed). In some embodiments, a plurality of 3D objects is formed in one material bed.

At times, the printing of a (e.g., complex) 3D object involves using a combination of methodologies (e.g., having respective process parameters). In some cases, different methodologies may be used to transform different portions of the object. In some examples, 3D printing methodologies comprise extrusion, wire, granular, laminated, light polymerization, or powder bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), arc welding (e.g., powder based arc welding), electron beam melting (EBM), selective laser melting (SLM), selective heat sintering (SHS), or selective laser sintering (SLS). Powder bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise, Laser Metal Deposition (LMD, also known as, Laser deposition welding). 3D printing methodologies can comprise powder feed, or wire deposition. Various apparatuses (e.g., controllers), systems (e.g., 3D printers), software, methods related to types of energy beam and formation of 3D objects, as well as various control schemes are described in U.S. patent application Ser. No. 15/435,128; International Patent Application number PCT/US17/18191; European Patent Application number EP17156707.6; and International Patent Application number PCT/US18/20406, each of which is entirely incorporated herein by reference.

In some examples, 3D printing methodologies differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

In an aspect provided herein is a system for generating a 3D object comprising: a manufacturing enclosure for accommodating at least one planar layer of pre-transformed material (e.g., powder); at least one energy (e.g., energy beam) capable of transforming the pre-transformed material to form a transformed material; and at least one controller (e.g., as part of a control system) that directs the energy beam(s) to impinge on the exposed surface of the layer of pre-transformed material and translate along a path (e.g., as described herein). The transformed material may be capable of hardening to form at least a portion of a 3D object. The system may comprise at least one energy source generating the energy beam(s), at least one optical system, a layer dispensing mechanism such as a recoater, gas source(s), pump(s), nozzle(s), valve(s), sensor(s), display(s), chamber(s), processor(s) comprising or software inscribed on a computer readable media/medium. The control system may be configured to control attributes including temperature, pressure, gas flow, optics, actuator(s), energy source(s), energy beam(s), and/or atmosphere(s). The chamber may comprise a base (e.g., also referred to herein as “build platform,” or “build plate”) and a substrate. The substrate may comprise a piston. The system for generating at least one 3D object (e.g., in a printing cycle) and its components may be any 3D printing system. Examples of 3D printers, their components, and associated methods, software, systems, devices, and apparatuses, can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the deposited pre-transformed material within the manufacturing enclosure is a liquid material, semi-solid material (e.g., gel), or a solid material (e.g., powder). The deposited pre-transformed material within the manufacturing enclosure can be in the form of a powder, wires, sheets, or droplets. The material (e.g., pre-transformed, transformed, and/or hardened) may comprise elemental metal, metal alloy, ceramics, or an allotrope of elemental carbon. The allotrope of elemental carbon may comprise amorphous carbon, graphite, graphene, amorphous carbon, carbon fiber, carbon nanotube, diamond, or fullerene. The fullerene may be selected from the group consisting of a spherical, elliptical, linear, and tubular fullerene. The fullerene may comprise a buckyball, or a carbon nanotube. The ceramic material may comprise cement. The ceramic material may comprise alumina, zirconia, or carbide (e.g., silicon carbide, or tungsten carbide). The ceramic material may include high performance material (HPM). The ceramic material may include a nitride (e.g., boron nitride or aluminum nitride). The material may comprise sand, glass, or stone. In some embodiments, the material may comprise an organic material, for example, a polymer or a resin (e.g., 114 W resin). The organic material may comprise a hydrocarbon. The polymer may comprise styrene or nylon (e.g., nylon 11). The polymer may comprise a thermoplast. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon-based polymer or a resin. The material may comprise an organosilicon-based material. The material may comprise silicon and hydrogen atoms. The material may comprise silicon and carbon atoms. In some embodiments, the material may exclude a silicon-based material. The powder material may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) and/or wires. The bound material can comprise chemical bonding. Transforming can comprise chemical bonding. Chemical bonding can comprise covalent bonding.

The printed 3D object can be made of a single material (e.g., single material type) or a plurality of materials (e.g., a plurality of material types). Sometimes one portion of the 3D object and/or of the material bed may comprise one material, and another portion may comprise a second material different from the first material. The material may be a single material type (e.g., a single alloy or a single elemental metal). The material may comprise one or more material types. For example, the material may comprise two alloys, an alloy and an elemental metal, an alloy and a ceramic, or an alloy and an elemental carbon. The material may comprise an alloy and alloying elements (e.g., for inoculation). The material may comprise blends of material types. The material may comprise blends with elemental metal or with metal alloy. The material may comprise blends excluding (e.g., without) elemental metal or including (e.g., with) metal alloy. The material may comprise a stainless steel. The material may comprise a titanium alloy, aluminum alloy, and/or nickel alloy.

In some cases, a layer within the 3D object comprises a single type of material. In some examples, a layer of the 3D object may comprise a single elemental metal type, or a single alloy type. In some examples, a layer within the 3D object may comprise several types of material (e.g., an elemental metal and an alloy, an alloy and a ceramic, an alloy and an elemental carbon). In certain embodiments, each type of material comprises only a single member of that type. For example: a single member of elemental metal (e.g., iron), a single member of metal alloy (e.g., stainless steel), a single member of ceramic material (e.g., silicon carbide or tungsten carbide), or a single member of elemental carbon (e.g., graphite). In some cases, a layer of the 3D object comprises more than one type of material. In some cases, a layer of the 3D object comprises more than one member of a type of material.

In some examples, the material bed, and/or 3D printing system (or any component thereof such as a build platform) may comprise any material disclosed herein. The material may comprise a material type which constituents (e.g., atoms) readily lose their outer shell electrons, resulting in a free-flowing cloud of electrons within their otherwise solid arrangement. The material bed may comprise a particulate material (e.g., powder). In some examples the material (e.g., powder, and/or 3D printer component) may comprise a material characterized in having high electrical conductivity (e.g., at least about 1*105 Siemens per meter (S/m)), low electrical resistivity (e.g., at most about 1*10-5 ohm times meter (Ω*m)), high thermal conductivity (e.g., at least about 10 Watts per meter times Kelvin (W/mK)), or high density (e.g., at least about 1.5 grams per cubic centimeter (g/cm3)). The density can be measured at ambient temperature (e.g., at R.T., or 20° C.) and at ambient atmospheric pressure (e.g., at 1 atmosphere).

In some embodiments, the elemental metal is an alkali metal, an alkaline earth metal, a transition metal, a rare-earth element metal, a precious metal, or another elemental metal. The elemental metal may comprise Titanium, Copper, Platinum, Gold, Aluminum, or Silver.

In some embodiments, the metal alloy comprises iron-based alloy, nickel-based alloy, cobalt-based alloy, chrome-based alloy, cobalt chrome-based alloy, titanium-based alloy, magnesium-based alloy, or copper-based alloy. The alloy may comprise an oxidation or corrosion resistant alloy. The alloy may comprise a super alloy (e.g., Inconel, In718, Ti64, F357, Haynes282, GRCop-42, C22, CA6NM, Hastelloy-X). The alloy may comprise an alloy used for aerospace applications, automotive application, surgical application, or implant applications. The metal may include a metal used for aerospace applications, automotive application, surgical application, or implant applications.

In some embodiments, the metal alloys are refractory alloys. The refractory metals and alloys may be used for heat coils, heat exchangers, furnace components, or welding electrodes. The refractory alloys may comprise a high melting points, low coefficient of expansion, high mechanical strength, low vapor pressure at elevated temperatures, high thermal conductivity, or high electrical conductivity.

In some embodiments, the material (e.g., alloy or elemental) comprises a material used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The material may comprise an alloy used for products comprising, devices, medical devices (human & veterinary), machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, tablet), air conditioning, generators, furniture, musical equipment, art, jewelry, cooking equipment, or sport gear. The material may comprise an alloy used for products for human or veterinary applications comprising implants, or prosthetics. The metal alloy may comprise an alloy used for applications in the fields comprising human or veterinary surgery, implants (e.g., dental), or prosthetics.

In some embodiments, the alloy includes a high-performance alloy. The alloy may include an alloy exhibiting at least one of excellent mechanical strength, resistance to thermal creep deformation, good surface stability, resistance to corrosion, and resistance to oxidation. The alloy may include a face-centered cubic austenitic crystal structure. The alloy can be a single crystal alloy. Examples of materials, 3D printers, and associated methods, software, systems, devices, materials (e.g., alloys), and apparatuses, can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the material comprises powder material (also referred to herein as a “pulverous material”). The powder material may comprise a solid comprising fine particles. The powder may be a granular material. The powder can be composed of individual particles. At least some of the particles can be spherical, oval, prismatic, cubic, or irregularly shaped. At least some of the particles can have a fundamental length scale (e.g., diameter, spherical equivalent diameter, length, width, depth, or diameter of a bounding sphere). The central tendency of the fundamental length scale (abbreviated herein as “FLS”) of the particles can be from about 5 micrometers (μm) to about 100 μm, from about 10 μm to about 70 μm, or from about 50 μm to about 100 μm. The particles can have central tendency of the FLS of at most about 75 μm, 65 μm, 50 μm, 30 μm, 25 μm or less. The particles can have a central tendency of the FLS of at least 10 μm, 25 μm, 30 μm, 50 μm, 70 μm, or more. A central tendency of the distribution of an FLS of the particles (e.g., range of an FLS of the particles between largest particles and smallest particles) can be about at least about 5 μm, 10 μm, 20 μm, 30 μm, 40 μm, 53 μm, 60 μm, or 75 μm. The particles can have a central tendency of the FLS of at most about 65 μm. In some cases, the powder particles may have central tendency of the FLS between any of the afore-mentioned FLSs.

In some embodiments, the powder comprises a particle mixture, which particle comprises a shape. The powder can be composed of a homogenously shaped particle mixture such that all the particles have substantially the same shape and FLS magnitude within at most about 1%, 5%, 8%, 10%, 15%, 20%, 25%, 30%, 35%, or 40% distribution of FLS.

At times, a plurality of build modules may be situated in a manufacturing enclosure comprising the processing chamber. At times, the build module may be connected to, or may comprise an autonomous guided vehicle (AGV). The AGV may have at least one of the following: a movement mechanism (e.g., wheels), positional (e.g., optical) sensor, and controller. The controller may enable self-docking (e.g., to a docking station) and/or self-driving of the AGV. The self-docking and/or self-driving may be to and from the processing chamber. The build module may reversibly engage with (e.g., couple to) the processing chamber. The engagement of the build module with the processing chamber may be controlled (e.g., by a controller). The control may be automatic and/or manual. The engagement of the build module with the processing chamber may be reversible. In some embodiments, the engagement of the build module with the processing chamber may be permanent.

In some embodiments, the pre-transformed material (e.g., starting material for the 3D printing) is deposited in a manufacturing enclosure, e.g., a build module. The build module container can contain the pre-transformed material (e.g., without spillage). Material may be placed in or inserted to the container. The material may be deposited in, pushed to, sucked into, or lifted to the container. The material may be layered (e.g., spread) in the manufacturing enclosure such as by using a layer dispensing mechanism. The build module container may be configured to accommodate a substrate (e.g., an elevator piston). The substrate may be situated adjacent to the bottom of the build module container. Bottom may be relative to the gravitational field along gravitational vector pointing towards gravitational center, or relative to the position of the footprint of the energy beam on the layer of pre-transformed material as part of a material bed. The build module container may comprise a platform comprising a substrate or a base (e.g., a build plate). The platform may be situated within the build module container. The base may be situated within the build module container. The base may reside adjacent to the substrate. For example, the base may (e.g., reversibly) connect to the substrate. The pre-transformed material may be layer-wise deposited adjacent to a side of the build module container, e.g., above and/or on the bottom of the build module container. The pre-transformed material may be layered adjacent to the substrate and/or adjacent to the base. Adjacent to may be above. Adjacent to may be directly above, or directly on. The substrate may have one or more seals that enclose the material in a selected area within the build module container. The one or more seals may be flexible or non-flexible. The seal may be a hermetic seal such as a gas tight seal. The one or more seals may comprise a polymer or a resin. One or more components of the manufacturing enclosure may comprise (I) a window (e.g., an optical window and/or a viewing window) or (II) an optical system. The one or more components may comprise the processing chamber, or the building module. The optical window may allow the energy beam to pass through without (e.g., substantial) energetic loss. The viewing window may be any window disclosed herein. The viewing window may be a single or a double pane window. The viewing window may be an insulated glass unit (IGU). The viewing window may be configured to withstand positive pressure within the processing chamber, e.g., during printing. The positive pressure is above ambient pressure external to the build module, e.g., the ambient pressure may be about one atmosphere. During the 3D printing, a ventilator and/or gas flow may prevent debris (e.g., spatter) from accumulating on the surface of the optical window that is disposed within the manufacturing enclosure (e.g., within the processing chamber). A portion of the manufacturing enclosure that is occupied by the energy beam (e.g., during the 3D printing) can define a processing cone (e.g., a truncated processing cone). During the 3D printing may comprise during the entire 3D printing. The processing cone can be the space that is occupied by a non-reflected energy beam during the (e.g., entire) 3D printing. The processing cone can be the space that is occupied by an energy beam that is directed towards the material bed during the (e.g., entire) 3D printing. During the 3D printing may comprise during printing of a layer of hardened material.

In some embodiments, the 3D printer comprises a gas flow mechanism. The gas flow mechanism may be in fluidic contact with one or more enclosures of the 3D printer. For example, the gas flow mechanism may be in fluidic contact with (i) a processing chamber, (ii) a build module, (iii) an optical system enclosure, or (iv) any combination thereof. The gas flow mechanism may be in fluidic contact with a processing chamber and/or a build module. The gas flow mechanism may be in fluid communication with the optical system enclosure. At times, a gas flow assembly may be in fluid communication with the optical system enclosure. The gas flow assembly may be configured to flow gas into and out of the optical system enclosure. The gas flow assembly may be separate from the gas flow mechanism. For example, the gas flow mechanism and the gas flow assembly may be isolated (e.g., fluidically separate) from each other. The gas flow mechanism may be configured to flow gas into and out of the processing chamber. The gas flow mechanism may or may not be included in the gas conveyance system, e.g., as disclosed herein. In an example, the gas flow mechanism and the gas conveyance system can be separate from each other. In an example, the gas flow mechanism can be included in the gas conveyance system.

In some embodiments, the 3D printer comprises a layer dispensing mechanism. The pre-transformed material may be deposited in the manufacturing enclosure by a layer dispensing mechanism (also referred to herein as a “layer dispenser,” “layer forming apparatus,” or “layer dispensing mechanism”). The layer dispensing mechanism may comprise a recoater. In some embodiments, the layer dispensing mechanism includes one or more material dispensers (also referred to herein as “dispensers” or “material dispensing mechanism”), and/or at least one powder removal mechanism (also referred to herein as material “remover” or “material remover”) to form a layer of pre-transformed material (e.g., starting material) as at least a portion of material bed, e.g., within the manufacturing enclosure. The deposited starting material may be shaped (e.g., leveled) by a shaping operation (e.g., leveling operation). Shaping the material bed may comprise altering a shape of the exposed surface of the material bed. In some embodiments, the layer dispensing mechanism includes a leveler to planarize (e.g., smooth, such as substantially planarize) an exposed surface of a material bed within the manufacturing enclosure. In some embodiments, the layer dispensing mechanism is devoid of a leveler to planarize (e.g., smooth, such as substantially planarize) an exposed surface of a material bed within the manufacturing enclosure. The leveling operation may comprise using a material removal mechanism that does not contact the exposed surface of the material bed. The material removed can comprise a pre-transformed material or debris. The layer dispensing mechanism and energy beam(s) can translate and form the 3D object adjacent to (e.g., above) the platform and/or within the material bed (e.g., as described herein), while the platform gradually (e.g., sequentially and/or stepwise) lowers its vertical position to facilitate layer-wise formation of the 3D object. The material dispensing mechanism (e.g., the dispenser) can comprise a reservoir configured to retain a volume of pre-transformed material. The volume of pre-transformed material may be equivalent to about the volume of pre-transformed material sufficient for at least one or more dispensed layers above the platform. For example, the volume of pre-transformed material may be equivalent to about the volume of starting material sufficient for at least an integer number of dispensed layers above the platform. For example, the volume of pre-transformed material retained within the reservoir can be at least about 2 cubic centimeters (cc), 15 cc, 20 cc, 50 cc, 100 cc, 250 cc, 1500 cc, 2000 cc, or 2500 cc. The material dispensing mechanism can comprise a reservoir configured to retain a volume of pre-transformed material can be between any of the afore-mentioned amounts, for example, from about 2 cc to about 2500 cc. The material dispensing mechanism can dispense material at a dispensing rate (e.g., flow rate from the material dispensing mechanism) of at least 0.2 cubic centimeters per second (cm3/sec) or (cc/sec), 0.5 cc/sec, 2 cc/sec, 2.5 cc/sec, 3.5 cc/sec, 5 cc/sec, 10 cc/sec, 30 cc/sec, 50 cc/sec, 75 cc/sec, 90 cc/sec, 100 cc/sec, 110 cc/sec, 125 cc/sec, or 150 cc/sec. The dispensing rate can be between any of the afore-mentioned dispensing rates (e.g., from about 2 cc/sec to about 150 cc/sec). The layer dispensing mechanism may include components comprising a material dispensing mechanism, material leveling mechanism, material removal mechanism, or any combination or permutation thereof. Examples of 3D printing systems, apparatuses, devices, components (e.g., material dispensing mechanisms and material removal mechanisms), controllers, software, and 3D printing processes can be found in Patent Application serial number PCT/US15/36802 filed on Jun. 19, 2015; in U.S. patent application Ser. No. 17/881,797, filed Aug. 5, 2022; or in International Patent Application serial number PCT/US16/66000 filed on Dec. 9, 2016; each of which is incorporated herein in its entirety.

In some embodiments, a the layer dispensing mechanism is utilized for the 3D printing. The layer dispensing mechanism can be in a layer forming mode when dispensing the material and/or shaping the material bed. The layer dispensing mechanism can be in a parked mode when the layer dispensing mechanism is in an idle position such as a parked position. In some embodiments, the layer dispensing mechanism may reside within an ancillary chamber. The layer dispenser may be physically secluded from the processing chamber when residing in the ancillary chamber. The ancillary chamber may be connected (e.g., reversibly) to the processing chamber. The ancillary chamber may be connected (e.g., reversibly) to the build module. The ancillary chamber may convey the layer dispensing mechanism adjacent to a platform (e.g., that is disposed within the build module). The layer dispensing mechanism may be retracted into the ancillary chamber (e.g., when the layer dispensing mechanism does not perform dispensing). Examples of 3D printing systems, apparatuses, devices, components (e.g., material dispensing mechanisms and material removal mechanisms), controllers, software, and 3D printing processes can be found in Patent Application serial number PCT/US15/36802 filed on Jun. 19, 2015; in Provisional Patent Application Ser. No. 62/317,070 filed Apr. 1, 2016; in International Patent Application serial number PCT/US16/66000 filed on Dec. 9, 2016; in International Patent Application Ser. No. 62/265,817, filed Dec. 10, 2015; or in Provisional Patent Application Ser. No. 63/357,901, filed on Jul. 1, 2022; each of which is incorporated herein in its entirety.

In some embodiments, the 3D object(s) are printed from a material bed. At least one FLS (e.g., width, depth, and/or height) of the material bed can be at least about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m, or 5 m. The at least one FLS (e.g., width, depth, and/or height) of the material bed can be at most about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m, or 5 m. The at least one FLS of the material bed can be between any of the afore-mentioned values (e.g., from about 50 mm to about 5 m, from about 250 mm to about 500 mm, from about 280 mm to about 1 m, or from about 500 mm to about 5 m). In some embodiments, a FLS of the material bed is in the direction of the gas flow. The build module may be configured to accommodate the material bed, e.g., having the at least one FLS disclosed herein.

In some embodiments, the 3D printer has a capacity to complete at least 1, 2, 3, 4, or 5 printing cycles before requiring human intervention. Human intervention may be required for refilling the pre-transformed (e.g., powder) material, unloading the build modules, unpacking the 3D object, removing the debris byproduct of the 3D printing, or any combination thereof. The 3D printer operator may condition the 3D printer at any time during operation of the 3D printing system (e.g., during the 3D printing process). Conditioning of the 3D printer may comprise refilling the pre-transformed material that is used by the 3D printer, replacing gas source, or replacing filters. The conditioning may be with or without interrupting the 3D printing system. For example, refilling and unloading from the 3D printer can be done at any time during the 3D printing process without interrupting the 3D printing process. Conditioning may comprise refreshing the 3D printer.

In some examples, the 3D printing system requires operation of maximum an operator during a single standard daily work shift. The 3D printing system may require operation by a human operator working at most of about 8 hours (h), 7 h, 6 h, 5 h, 4 h, 3 h, 2 h, 1 h, or 0.5 h a day. The 3D printing system may require operation by a human operator working between any of the afore-mentioned time frames (e.g., from about 8 h to about 0.5 h, from about 8 h to about 4 h, from about 6 h to about 3 h, from about 3 h to about 0.5 h, or from about 2 h to about 0.5 h a day).

In some embodiments, the manufacturing enclosure (e.g., processing chamber) of the manufacturing system may be opened to the ambient environment sparingly. In some embodiments, the manufacturing enclosure may be opened by an operator (e.g., human) sparingly. Sparing opening may be at most once in at most every 1, 2, 3, 4, or 5 weeks. The weeks may comprise weeks of standard operation of the 3D printer. In some embodiments, the 3D printer has a capacity of 1, 2, 3, 4, or 5 full prints in terms of pre-transformed material (e.g., starting material such as powder) reservoir capacity. The 3D printer may have the capacity to print a plurality of 3D objects in parallel, e.g., in one material bed. For example, the 3D printer may be able to print at least 2, 3, 4, 5, 6, 7, 8, 9, or 10 3D objects in parallel.

In some embodiments, the printed 3D object is retrieved soon after terminating the last transformation operation of at least a portion of the material bed. Soon after terminating may be at most about 1 day, 12 hours, 6 hours, 3 hours, 2 hours, 1 hour, 30 minutes, 15 minutes, 5 minutes, 240 seconds (sec), 220 sec, 200 sec, 180 sec, 160 sec, 140 sec, 120 sec, 100 sec, 80 sec, 60 sec, 40 sec, 20 sec, 10 sec, 9 sec, 8 sec, 7 sec, 6 sec, 5 sec, 4 sec, 3 sec, 2 sec, or 1 sec. Soon after terminating may be between any of the afore-mentioned time values (e.g., from about Is to about 1 day, from about 1 s to about 1 hour, from about 30 minutes to about 1 day, or from about 20 s to about 240 s).

Ambient refers to a condition to which people are generally accustomed. For example, ambient pressure may be about 1 atmosphere. Ambient temperature may be a typical temperature to which humans are generally accustomed. For example, from about 15° C. to about 30° C., from about −30° C. to about 60° C., from about −20° C. to about 50° C., from 16° C. to about 26° C., from about 20° C. to about 25° C. “Room temperature” may be measured in a confined or in a non-confined space. For example, “room temperature” can be measured in a room, an office, a factory, a vehicle, a container, or outdoors. The vehicle may be a car, a truck, a bus, an airplane, a space shuttle, a spaceship, a ship, a boat, or any other vehicle. Room temperature may represent the small range of temperatures at which the atmosphere feels neither hot nor cold, approximately 24° C. “Room temperature” may denote 20° C., 25° C., or any value from about 20° C. to about 25° C.

In some embodiments, a time lapse between the end of printing in a first material bed, and the beginning of printing in a second material bed is at most about 60 minutes (min), 40 min, 30 min, 20 min, 15 min, 10 min, or 5 min. The time lapse between the end of printing in a first material bed, and the beginning of printing in a second material bed may be between any of the afore-mentioned times (e.g., from about 60 min to about 5 min, from about 60 min to about 30 min, from about 30 min to about 5 min, from about 20 min to about 5 min, from about 20 min to about 10 min, or from about 15 min to about 5 min). The speed during which the 3D printing process proceeds is disclosed in Patent Application serial number PCT/US15/36802 that is incorporated herein in its entirety.

In some embodiments, at least one (e.g., each) energy source of the 3D printing system is able to transform (e.g., print) at a throughput of at least about 6 cubic centimeters of material per hour (cc/hr), 12 cc/hr, 35 cc/hr, 50 cc/hr, 120 cc/hr, 480 cc/hr, 600 cc/hr, 1000 cc/hr, or 2000 cc/hr. The at least one energy source may print at any rate within a range of the aforementioned values (e.g., from about 6 cc/hr to about 2000 cc/hr, from about 6 cc/hr to about 120 cc/hr, or from about 120 cc/hr to about 2000 cc/hr). At times, the 3D printing increases in efficiency when a plurality of energy beams (e.g., at least two energy beams) is used for the 3D printing. In some embodiments, the plurality of energy beams incident on a target surface may increase (i) the (e.g., total) processing field available for printing (e.g., in a X-Y plane) and/or (ii) the rate of 3D printing completion for a given print cycle (as compared to using a single energy beam). For example, the plurality of energy beams may be useful in providing a relatively larger processing area (e.g., build platform and/or material bed) in which one or more 3D objects (e.g., larger 3D object) may be generated. The processing field may be larger in relation to a 3D printing system that comprises (e.g., only) a single energy beam, which processing area is limited to the areal extent (e.g., the processing field) of the single energy beam (e.g., as guided by an optical system), which is not arbitrarily sized. For example, the time for 3D printing may be shortened when at least two of the plurality of energy beams operate simultaneously at least in part (e.g., in parallel). For example, the time for 3D printing may be shortened by at least about 25%, 50%, 75% or 95% when at least two of the plurality of energy beams operate simultaneously at least in part. The time for 3D printing may be shortened by any value of the afore-mentioned values (e.g., by from about 25% to about 95%, about 25% to about 50%, or about 50% to about 95%) when at least two of the plurality of energy beams operate simultaneously at least in part. A shortened time may be relative to a 3D printing system that does not use a plurality of energy beams (e.g., uses only a single energy beam). Examples of 3D printing systems, apparatuses, devices, components, controllers, software, and 3D printing processes (e.g., speed of printing, throughput of printing processes) can be found in International Patent Application Serial No. PCT/US15/36802, and in International Patent Application Serial No. PCT/US19/226364, filed on May 16, 2019, each of which is incorporated herein by reference in its entirety.

In some embodiments, the at least one 3D object is removed from the material bed after the completion of the 3D printing process. For example, the 3D object(s) may be removed from the material bed when the transformed material that formed the 3D object hardens. For example, the 3D object may be removed from the material bed when the transformed material that formed the 3D object is no longer susceptible to deformation under standard handling operation (e.g., human and/or machine handling).

In some examples, the generated 3D object adheres (e.g., substantially) to a requested model of the 3D object. Substantially may be with relation to the intended purpose of the 3D object. The 3D object (e.g., solidified material) that is generated can be formed with high fidelity, e.g., having a high fidelity (e.g., high accuracy) of one or more characteristics (e.g., dimensions) of the generated 3D object when compared to a model or simulation of the intended 3D object. For example, have an average deviation percentage from intended dimensions that are at most about 5%, 2%, 1%, 0.5%, 0.25%, 0.1%, 0.05%, or less. For example, the 3D object that is generated can have an average deviation value from the intended dimensions (e.g., of a requested 3D object) of at most about 0.5 microns (μm), 1 μm, 3 μm, 10 μm, 30 μm, 100 μm, 300 μm or less from a requested model of the 3D object. The deviation can be any value between the afore-mentioned values. The average deviation can be from about 0.5 μm to about 300 μm, from about 10 μm to about 50 μm, from about 15 μm to about 85 μm, from about 5 μm to about 45 μm, or from about 15 μm to about 35 μm. The 3D object can have a deviation from the intended dimensions in a specific direction, according to the formula D_v+L/K_dv, wherein D_v is a deviation value, L is the length of the 3D object in a specific direction, and K_dv is a constant. D_v can have a value of at most about 300 μm, 200 μm, 100 μm, 50 μm, 40 μm, 30 μm, 20 μm, 10 μm, 5 μm, 1 μm, or 0.5 μm. D_v can have a value of at least about 0.5 μm, 1 μm, 3 μm, 5 μm, 10 μm, 20 μm, 30 μm, 50 μm, 70 μm, 100 μm, 300 μm or less. D_v can have any value between the afore-mentioned values. For example, D_v can have a value that is from about 0.5 μm to about 300 μm, from about 10 μm to about 50 μm, from about 15 μm to about 85 μm, from about 5 μm to about 45 μm, or from about 15 μm to about 35 μm. K_dv can have a value of at most about 3000, 2500, 2000, 1500, 1000, or 500. K_dv can have a value of at least about 500, 1000, 1500, 2000, 2500, or 3000. K_dv can have any value between the afore-mentioned values. For example, K_dv can have a value that is from about 3000 to about 500, from about 1000 to about 2500, from about 500 to about 2000, from about 1000 to about 3000, or from about 1000 to about 2500.

At times, the generated 3D object (i.e., the printed 3D object) does not require further processing following its generation (e.g., retrieval) by a method described herein. The printed 3D object may require reduced amount of processing after its generation by a method described herein. For example, the printed 3D object may not require removal of auxiliary support (e.g., since the printed 3D object was generated as a 3D object devoid of auxiliary support) and/or removal of transformed material. The printed 3D object may not require smoothing, flattening, polishing (e.g., sanding), leveling, trimming, annealing, or curing. The printed 3D object may not require further machining. In some examples, the printed 3D object may require one or more treatment operations following its generation (e.g., post generation treatment, or post printing treatment). The further treatment step(s) may comprise surface scraping, machining, polishing, grinding, blasting (e.g., sand blasting, bead blasting, shot blasting, or dry ice blasting), annealing, or chemical treatment. Examples of 3D printing systems, apparatuses, devices, components, controllers, software, and 3D printing processes (e.g., post-processing, post-generation treatment, and post-printing treatment) can be found in U.S. patent application Ser. No. 17/835,023, filed on Jun. 8, 2022, and U.S. Provisional Patent Application Ser. No. 63/289,787, filed Dec. 15, 2021, each of which are entirely incorporated herein by reference.

In some embodiments, the 3D printer comprises a chamber having an interior space. The chamber may be referred to herein as a “processing chamber.” The processing chamber may facilitate ingress of at least one energy beam into the processing chamber. The energy beam(s) may be directed towards a target surface, e.g., an exposed surface of a material bed. The 3D printer may comprise one or more modules, e.g., build modules. At times, at least one build module may be situated in the manufacturing enclosure and coupled with the processing chamber. At times, at least one build module may reversibly engage with (e.g., couple to) the processing chamber to expand an interior volume of the processing chamber, e.g., to form at least a portion of the chamber.

In some embodiments, the 3D printing system comprises a build module. The build module may be mobile or stationary. The build module may comprise an elevation mechanism, e.g., comprising a build platform assembly. The build module may comprise the build platform (e.g., base) that may be coupled with the build platform assembly. The build platform may be disposed within the build module. The build platform may reside adjacent to the substrate, e.g., above the substrate relative to a gravitational center of the environment (e.g., Earth). The elevation mechanism may be reversibly connected to (and disconnected from) at least a portion of the build platform. The elevation mechanism may comprise a portion that vertically translates the build platform with respect to a gravitational center (e.g., a gravitational center of the Earth). The build platform may be disposed on the substrate. The build platform and the substrate may operatively couple (e.g., physically connect). The material bed may be disposed above build platform. The build platform may support the material bed. The build platform may comprise, or be configured to operatively couple to, an engagement mechanism. The substrate may comprise, or be configured to operatively couple to, an engagement mechanism. The engagement mechanism may facilitate engagement and/or dis-engagement between a base (e.g., of the build platform) and the substrate. The build platform may be configured to support one or more layers of pre-transformed material (e.g., as part of the material bed). The build platform may be configured to support at least a portion of the 3D object (e.g., during forming of the 3D object). The substrate and/or the base (e.g., build platform) may be removable or non-removable (e.g., from the 3D printing system and/or relative to each other). The substrate and/or base may be fastened (I) to the build module and/or (II) to each other. The build platform and/or substrate may be translatable, e.g., before, during, and/or after printing one or more 3D objects in a print cycle. The translation of the build platform may be effectuated (e.g., controlled and/or regulated) by the build platform assembly and/or an actuator (e.g., by at least one controller and/or by a control system). The build platform assembly may be configured to provide a high precision platform for building one or more 3D objects in a printing cycle with high fidelity. The translation of the substrate may be controlled and/or regulated by at least one controller (e.g., by a control system). The build platform and/or substrate may be translatable horizontally, vertically, or at an angle (e.g., planar or compound angle). The translation may be in both directions (e.g., back and forth such as up and down relative to a gravitational vector). The control system may be any control system disclosed herein, e.g., a control system of the 3D printer such as the one controlling an energy beam. The substrate may comprise a piston. At times, the 3D printing system may comprise more than one substrate. At times, the 3D printing system may comprise more than one piston. The disclosure herein relating to the substrate may apply to the substrates.

In some embodiments, the one or more components of the manufacturing enclosure comprise one or more seals. The seal may be a sliding seal or a stationary (e.g., top) seal. For example, the build module and/or processing chamber may comprise a sliding seal that meets with the exterior of the build module upon engagement of the build module with the processing chamber. During at least a portion of the 3D printing process, the atmospheres of the build module and processing chamber may be separate. For example, the processing chamber may comprise a top seal that faces the build module and is pushed upon engagement of the processing chamber with the build module. For example, the build module may comprise a top seal that faces the processing chamber and is pushed upon engagement of the processing chamber with the build module. The seal may be a face seal, or compression seal. The seal may comprise an O-ring. For example, the build module and the processing chamber may be separated by a load lock. The seal may be impermeable or substantially impermeable to at least one gas. The seal may be permeable to at least one gas. The seal may be impermeable to a solid material (e.g., the pre-transformed material and/or the transformed material). The seal may be flexible. The seal may be elastic. The seal may be bendable. The seal may be compressible. The seal may include a material comprising rubber (e.g., latex), Teflon, plastic, or silicon. The seal may comprise a mesh, membrane, sieve, paper (e.g., filter paper), cloth such as felt (e.g., Aramid felt, or another high temperature felt or fiber), or a brush. The mesh, membrane, paper and/or cloth may comprise randomly or non-randomly arranged fibers. The paper may comprise a HEPA filter.

In some embodiments, the substrate is separated from the base (e.g., build platform) assembly by a seal. The base and/or the substrate may be separated from the internal surface (e.g., side walls) of the build module by one or more seals. The seal may be attached to the moving build platform and/or substrate (e.g., while the walls of the build module are devoid of a seal). The seal may be attached to the (e.g., vertical) walls of the build module (e.g., while the build platform and/or substrate is devoid of a seal). In some embodiments, both the build platform and/or substrate and the walls of the build module comprise a seal. The seal may be placed laterally (e.g., horizontally) between one or more walls (e.g., side walls) of the build module. The seal may be connected to a bottom plane of the build platform and/or substrate. The seal may be connected to a side (e.g., circumference) of the build platform and/or substrate.

The seal may be permeable to at least one gas. The seal may be impermeable or substantially impermeable to at least one gas. The seal may be impermeable to a solid material (e.g., the pre-transformed material and/or the transformed material). The seal may be impermeable to particulate material (e.g., powder). The seal may not allow permeation of particulate material into the build platform assembly and/or piston assembly. The build platform assembly may comprise a piston and a build platform. The piston assembly may comprise a piston. The seal may be flexible. The seal may be elastic. The seal may be bendable. The seal may be compressible. The seal may include a material comprising a polymeric material (e.g., nylon, polyurethane), Teflon, plastic, rubber (e.g., latex), or silicon. The seal may comprise a mesh, membrane, sieve, paper (e.g., filter paper), cloth (e.g., felt, or wool), or brush. The mesh, membrane, paper and/or cloth may comprise randomly and/or non-randomly arranged fibers. The paper may comprise a HEPA filter.

In some embodiments, the 3D printing system comprises a build module, e.g., as disclosed herein. The build module may accommodate a material bed having at least one (e.g., two or more) FLS (e.g., diameter, width, and/or height) of at most about 200 mm, 250 mm, 300 mm, 350 mm, 400 mm, 450 mm, 500 mm, 550 mm, 600 mm, 650 mm, 700 mm, 800 mm, 900 mm, 1000 mm, 1200 mm, 1500 mm, 2000 mm, 2500 mm, 3000 mm, 3500 mm, 4000 mm, or 4500 mm. The FLS of the material bed accommodated by the build module may have a FLS value between any of the aforementioned values (e.g., from about 100 mm to about 4500 mm, from about 100 mm to about 2000 mm, from about 100 mm to about 700 mm, or from about 300 mm to about 4000 mm). In addition to the material bed, the build module may be configured to accommodate a base (e.g., build platform) and at least one substrate (e.g., piston). The build module may accommodate a build platform having an FLS (e.g., diameter or width) of at least about 100 millimeters (mm), 200 mm, 300 mm, 400 mm, 500 mm, 600 mm, 700 mm, 800 mm, 900 mm, 1000 mm, 1500 mm, or 2000 mm, 2500 mm, 3000 mm, 3500 mm, or 4000 mm. The build module may accommodate a build platform having at least one FLS (e.g., diameter, height and/or width), the FLS being of at most about 200 mm, 250 mm, 300 mm, 350 mm, 400 mm, 450 mm, 500 mm, 550 mm, 600 mm, 650 mm, 700 mm, 800 mm, 900 mm, 1000 mm, 1200 mm, 1500 mm, 2000 mm, 4000 mm, or 4500 mm. The FLS of the build platform accommodated by the build module may have a FLS value between any of the aforementioned values (e.g., from about 100 mm to about 4500 mm, from about 100 mm to about 1200 mm, from about 100 mm to about 1500 mm, or from about 300 mm to about 2000 mm). The build platform assembly may be able to translate in a continuous and/or discrete manner. The build platform assembly may be able to translate in discrete increments of at most about 5 micrometers (μm), 20 μm, 30 μm, 40 μm, 50 μm, 60 μm, 70 μm, or 80 μm. The build platform assembly may be able to translate in discrete increments having a value between any of the aforementioned values (e.g., from about 5 μm to about 80 μm, from about 10 μm to about 60 μm, or from about 40 μm to about 80 μm). The build platform assembly may have a precision (e.g., error+/−) of at most about 0.25 μm, 0.5 μm, 1 μm, 1.5 μm, 2 μm, 2.5 μm, 3 μm, 4 μm, or 5 μm. The build platform assembly may have a precision value between any of the aforementioned precision value (e.g., from about 0.25 μm to about 5 μm, from about 0.25 μm to about 2.5 μm, or from about 1.5 μm to about 5 μm). The build platform assembly may have a precision (e.g., error+/−) of at most about 0.5%, 1%, 2%, 3%, 4%, 5%, 6%, 8% or 10% of its incremental movement. The build platform assembly may have a precision value between any of the aforementioned precision value relative to its incremental movement (e.g., from about 0.5% to about 10%, from about 0.5% to about 5%, or from about 1% to about 10%). The weight of the material bed (e.g., including any printed 3D object therein) may be at least about 300 Kilograms (Kg), 500 Kg, 800 Kg, 1000 Kg, 1200 Kg, 1500 Kg, 1800 Kg, 2000 Kg, 2500 Kg, or 3000 Kg. The weight of the material bed (e.g., including any printed 3D object therein) may be between any of the aforementioned values (e.g., from about 300 Kg to about 3000 Kg, from about 300 Kg to about 1500 Kg, or from about 1000 Kg to about 3000 Kg). The build platform assembly may be configured to translate the build module at a speed of at most 3 millimeters per second (mm/sec), 5 mm/sec, 10 mm/sec, 20 mm/sec, 30 mm/sec, or 50 mm/sec. The build platform assembly may be configured to translate the build module at a speed of at least 1 mm/sec, 3 mm/sec, 5 mm/sec, 10 mm/sec, 20 mm/sec, 30 mm/sec, or 40 mm/sec. The build platform assembly may be configured to translate the build module at a speed between any of the aforementioned speeds (e.g., from about 1 mm/sec to about 50 mm/sec, from about 1 mm/sec to about 20 mm/sec, or from about 5 mm/sec to about 50 mm/sec). The build platform assembly may be configured to translate the build module at a speed of at most 1 millimeter per second squared (mm/sec\hat{ }2), 2.5 mm/sec\hat{ }2, 5 mm/sec\hat{ }2, 7.5 mm/sec\hat{ }2, 10 mm/sec\hat{ }2, or 20 mm/sec\hat{ }2. The build platform assembly may be configured to translate the build module at an acceleration of at least 0.5 mm/sec\hat{ }2, 1 mm/sec\hat{ }2, 2 mm/sec\hat{ }2, 3 mm/sec\hat{ }2, 5 mm/sec\hat{ }2, 10 mm/sec\hat{ }2, or 15 mm/sec\hat{ }2. The build platform assembly may be configured to translate the build module at a speed between any of the aforementioned speeds (e.g., from about 0.5 mm/sec\hat{ }2 to about 20 mm/sec\hat{ }2, from about 0.5 mm/sec\hat{ }2 to about 10 mm/sec\hat{ }2, or from about 4 mm/sec\hat{ }2 to about 20 mm/sec\hat{ }2). The build platform assembly may be configured such that a time to complete a translation of a first portion of the build platform assembly relative to a second portion of the build platform assembly (e.g., to perform a block movement) is at most about 120 seconds (sec), 60 sec, 50 sec, 45 sec, 40 sec, 35 sec, 30 sec, 25 sec, 20 sec, 15 sec, or less. The build platform assembly may be configured such that a time to complete a translation of a first portion of the build platform assembly relative to a second portion of the build platform assembly is any value between the aforementioned values, for example, from about 120 sec to 40 sec, from about 60 sec to 25 sec, or from about 35 sec to 15 sec.

In some embodiments, the pre-transformed material (e.g., starting material for the 3D printing) is deposited in a manufacturing enclosure to form a material bed. The pre-transformed material may be layered on a target surface, e.g., on an exposed surface of a material or on a surface of the build platform. The deposited layer of pre-transformed material may be substantially planar. For example, the deposited layer may have a central tendency of planarity (e.g., a surface roughness R_a) that is from about 15% to about 65% of a second central tendency of thickness of the deposited layer. The second central tendency of thickness of the deposited layer may be about equal to a discrete increment of vertical translation of the platform. The second central tendency of thickness of the deposited layer may be about equal to any discrete increment of vertical translation of the build platform assembly, e.g., as disclosed herein.

In some embodiments, the 3D printer comprises an energy source that generates an energy beam. The energy beam may project energy to the material bed. The apparatuses, systems, and/or methods described herein can comprise at least one energy beam. In some cases, the 3D printing system can comprise at least two, three, four, five, eight, twelve, sixteen, twenty-four, thirty-two, or more energy beams. The energy beam may include radiation comprising electromagnetic, electron, positron, proton, plasma, or ionic radiation. The electromagnetic beam may comprise microwave, infrared, ultraviolet or visible radiation. The ion beam may include a cation or an anion. The electromagnetic beam may comprise a laser beam. The energy beam may derive from a laser source. In some embodiments, the energy source is an energy beam source. The energy source may be a laser source. The laser may comprise a fiber laser, a solid-state laser or a diode laser (e.g., diode pumped fiber laser).

In some embodiments, the energy source is a laser source. The laser source may comprise a Nd:YAG, Neodymium (e.g., neodymium-glass), or an Ytterbium laser. The laser beam may comprise a corona laser beam, e.g., a laser beam having a footprint similar to a doughnut shape. The laser may comprise a carbon dioxide laser (CO2 laser). The laser may be a fiber laser. The laser may be a solid-state laser. The laser can be a diode laser. The energy source may comprise a diode array. The energy source may comprise a diode array laser. The laser may be a laser used for micro laser sintering. Examples of 3D printing systems, apparatuses, devices, components (e.g., energy beams), controllers, software, and 3D printing processes can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the energy beam (e.g., transforming energy beam) comprises a Gaussian energy beam. The energy beam may have any cross-sectional shape comprising an ellipse (e.g., circle), or a polygon (e.g., as disclosed herein). The energy beam may be continuous or non-continuous (e.g., pulsing). The energy beam may be modulated before and/or during the formation of a transformed material as part of the 3D object. The energy beam may be modulated before and/or during the 3D printing process. In some embodiments, the energy beam (e.g., laser) has a power of at least about 150 Watt (W), 200 W, 250 W, 350 W, 500 W, 750 W, 1000 W, or 1500 W. The energy source may have a power between any of the afore-mentioned energy beam power values (e.g., from about from about 150 W to about 1000 W, or from about 1000 W to about 1500 W). The energy beam may derive from an electron gun.

In some embodiments, the 3D printer includes a plurality of energy beam, e.g., laser beams. The 3D printer may comprise at least 2, 4, 6, 8, 10, 12, 16, 20, 24, 32, 36, 64, or more energy beams. Each of the energy beam may be coupled with its own optical window. At times, at least two energy beams may shine through the same optical window. At times, at least two energy beams may shine through different optical windows.

In some embodiments, the energy beam (e.g., transforming energy beam) comprises a Gaussian energy beam. The energy beam may have any cross-sectional shape comprising an ellipse (e.g., circle), or a polygon (e.g., as disclosed herein). The energy beam may be continuous or non-continuous (e.g., pulsing). The energy beam may be modulated before and/or during the formation of a transformed material as part of the 3D object. The energy beam may be modulated before and/or during the 3D printing process.

In some embodiments, the beam profile of the energy beam is altered, e.g., during printing. Any of the 3D printing methodologies disclosed herein can include altering the beam profile. Alteration of the beam profile can be using a physical component and/or a computational scheme (e.g., algorithm). Alteration of the beam profile can comprise manual and/or automatic methods. The automatic methods may comprise usage of at least one controller directing the beam profile alteration. The beam profile may be altered during the 3D printing, e.g., during printing of a layer of transformed material that forms at least a portion of the 3D object. Alteration of the beam profile can comprise alteration of a type of an energy profile utilized. The type of the beam profile comprises: a gaussian beam profile, a top hat beam profile, or a ring (e.g., corona or doughnut) beam profile. For example, the energy beam may print a first portion of the 3D object using a gaussian beam profile, and then print a second portion of the 3D object using a ring shaped beam profile.

In some embodiments, the beam profile of the energy beam is altered, e.g., during printing. Any of the 3D printing methodologies disclosed herein can include altering the beam profile. Alteration of the beam profile can be using a physical component and/or a computational scheme (e.g., algorithm). Alteration of the beam profile can comprise manual and/or automatic methods. The automatic methods may comprise usage of at least one controller directing the beam profile alteration. The beam profile may be altered during the 3D printing, e.g., during printing of a layer of transformed material that forms at least a portion of the 3D object. Alteration of the beam profile can comprise alteration of a type of an energy profile utilized. The type of the beam profile comprises: a gaussian beam profile, a top hat beam profile, or a doughnut (e.g., corona) beam profile. For example, the energy beam may print a first portion of the 3D object using a gaussian beam profile, and then print a second portion of the 3D object using a doughnut shaped beam profile.

In some embodiments, the energy beam(s) is/are utilized for the 3D printing. The energy beam(s) can translate vertically, horizontally, or in an angle (e.g., planar or compound angle). The energy beam(s) can be modulated. The energy beam(s) emitted by the energy source(s) can be modulated.

In some embodiments, at least one of the energy beams is moveable with respect to a material bed and/or 3D printing system. Movable can be relative to the processing chamber, the build module, the target surface, or any combination thereof. The energy beam can be moveable such that it can translate relative to the material bed (e.g., across the top surface of the material bed), e.g., during the printing. The energy beam can be moved by an optical system (e.g., comprising a scanner). The movement of the energy beam can comprise utilization of a scanner e.g., optical scanner to move the energy beam, or mechanical stage type scanner to move the target surface on which the energy beam impinges. The energy beams can be translated independently of each other. In some cases, at least two energy beams can be translated at different rates, and/or along different paths. For example, the movement of a first energy beam may be faster (e.g., at a greater rate) as compared to the movement of a second energy beam. At times, the energy beam(s) are modulated. The energy (e.g., beam) emitted by the energy source can be modulated. The modulator can comprise an amplitude modulator, a phase modulator, or polarization modulator. The modulation may alter the intensity of the energy beam. The modulation may alter the shape (e.g., footprint) of the energy beam. The modulation may alter the current supplied to the energy source (e.g., direct modulation). The modulation may affect (e.g., alter) the energy beam, e.g., external modulation such as external light modulator. The modulator can comprise an acousto-optic modulator or an electro-optic modulator. The modulator can comprise an absorptive modulator or a refractive modulator. The modulation may alter the absorption coefficient of the material that is used to modulate the energy beam. The modulator may alter the refractive index of the material that is used to modulate the energy beam. The energy beam, and/or the platform can be moved by at least one scanner, e.g., optical scanner can move the energy beam, or mechanical stage type scanner to move the target surface on which the energy beam impinges such as moving a material bed having an exposed. The scanner can be included in an optical system that is configured to direct energy beam from the energy source to a predetermined position on the (target) surface, e.g., an exposed surface of the material bed. At least two scanners may be operably coupled with a single energy source and/or energy beam. In some embodiments, at least two energy beams are moved by the same scanner. At least two (e.g., each) energy sources and/or beams may have a separate scanner. In some embodiments, at least two energy beams are moved with different scanners, e.g., are each moved with a different scanner. The scanner may comprise one or more optical elements, e.g., mirrors. The scanner may comprise a galvanometer scanner (e.g., a two-axis galvanometer scanner), a polygon, a mechanical-stage (e.g., X-Y-stage), a piezoelectric device, gimbal, or any combination thereof. The galvanometer scanner may comprise a mirror. The scanner may comprise a modulator. The scanner may comprise a polygonal mirror. The systems and/or apparatuses disclosed herein may comprise one or more shutters (e.g., safety shutters). The energy source(s) can project energy using a DLP modulator, a one-dimensional scanner, a two-dimensional scanner, or any combination thereof.

In some embodiments, the energy source is used to generate the energy beam. The energy source can be stationary. In some embodiments, the energy beam (e.g., laser beam) impinges onto an exposed surface of a material bed to generate at least a portion of a 3D object. The energy beam may be a focused beam. The energy beam may be a dispersed beam. The energy beam may be an aligned beam. The apparatus and/or systems described herein may comprise a focusing coil, a deflection coil, or an energy beam power supply. The optical system may be configured to direct at least one energy beam from the at least one energy source to a position on a target surface such as an exposed surface of the material bed within the manufacturing enclosure, e.g., to a predetermined position on the target surface. The 3D printing system may comprise a processor (e.g., a central processing unit). The processor can be programmed to control a trajectory of the at least one energy beam and/or energy source e.g., with the aid of the optical system and/or optical actuator(s). The systems and/or the apparatus described herein can comprise a control system in communication with the energy source(s) and/or energy beam(s). The control system can regulate a supply of energy from the energy source(s) to the material (e.g., to the pre-transformed material), e.g., to form the transformed material. The control system may control the various components of the optical system. The various components of the optical system may include optical components comprising a mirror(s), a lens (e.g., concave or convex), a fiber, a beam guide, a rotating polygon, or a prism. The optical system may be enclosed in an optical system enclosure, e.g., of the system of optical assemblies. Examples of 3D printing systems, apparatuses, devices, and components (e.g., optical housing and optical system), controllers, software, and 3D printing processes can be found Patent Application serial number PCT/US17/64474, filed Dec. 4, 2017, in International Patent Application serial number PCT/US18/12250, filed Jan. 3, 2018, in International Patent Application Serial No. PCT/US19/226364, filed on May 16, 2019, or in U.S. Provisional Patent Application 63/348,901 filed on Jun. 3, 2022, each of which is incorporated herein by reference in its entirety.

In some embodiments, the 3D printer comprises a power supply. The power supply to any of the components described herein can be supplied by a grid, generator, local, or any combination thereof. The power supply can be from renewable or non-renewable sources. The renewable sources may comprise solar, wind, hydroelectric, or biofuel. The power supply can comprise rechargeable batteries.

In some embodiments, the 3D printing system can comprise two, three, four, five, eight, ten, sixteen, eighteen, twenty, twenty-four, thirty-two, thirty-six, or more energy sources that each generates an energy beam (e.g., laser beam). An energy source can be a source configured to deliver energy to an area (e.g., a confined area). The energy can be in the form of an energy beam such as a laser beam or an electron beam. An energy source can deliver energy to the confined area through radiative heat transfer. The energy source may comprise a laser source or an electron beam source.

In some embodiments, the 3D printing system can comprise at least one (e.g., a plurality of) optical windows. The optical window(s) may be arranged on a roof of the processing chamber. The optical window(s) may be arranged on a side wall of the processing chamber. The optical window(s) may be arranged with respect to the processing chamber to allow transmittance of energy beam(s) directed by the array of optical assemblies into the processing chamber. The optical window(s) may be arranged with respect to the processing chamber to allow transmittance of energy beam(s) directed by the array of optical assemblies into the processing chamber and incident on the target surface supported by the build platform. During the 3D printing, a ventilator and/or gas flow may deter (e.g., measurably and/or substantially prevent) debris from accumulating on the surface of optical window(s) that are disposed within the manufacturing enclosure (e.g., within the processing chamber). The debris may comprise soot, spatter, or splatter. The optical window may be supported by (or supportive of) a nozzle that directs debris away from the optical window, e.g., at towards the material bed. The processing cone may assume a shape of a truncated cone withing the processing chamber.

In some embodiments, the manufacturing system comprises one or more sensors. The one or more sensor may be at least about 500, 600, 900, or 1000 sensors. At least two of the sensors may be of the same type. At least two of the sensors may be of different type. The manufacturing system includes at least one enclosure. In some embodiments, the manufacturing system (e.g., its manufacturing enclosure) comprises one or more sensors (alternatively referred to herein as one or more sensors). The enclosure described herein may comprise at least one sensor. The manufacturing enclosure may comprise, or be operatively coupled with, the build module, the filtering mechanism, gas recycling system, the processing chamber, or the ancillary chamber. The sensor may be connected and/or controlled by the control system (e.g., computer control system, or controller(s)). The control system may be able to receive signals from the at least one sensor. The control system, e.g., through a control scheme, may act upon at least one signal received from the at least one sensor. The control scheme may comprise a feedback and/or feed forward control scheme, e.g., that has been pre-programmed. The feedback and/or feed forward control may rely on input from at least one sensor that is connected to the controller(s).

In some embodiments, the 3D printing system comprises one or more sensors. The one or more sensors can comprise a pressure sensor, a temperature sensor, a gas flow sensor, or an optical density sensor. The pressure sensor may measure the pressure of the chamber (e.g., pressure of the chamber atmosphere). The pressure sensor can be coupled with the control system. The pressure can be electronically and/or manually controlled. The controller may regulate the pressure (e.g., with the aid of one or more vacuum pumps) according to input from at least one pressure sensor. The sensor may comprise light sensor, image sensor, acoustic sensor, vibration sensor, chemical sensor, electrical sensor, magnetic sensor, fluidity sensor, movement sensor, speed sensor, position sensor, pressure sensor, force sensor, density sensor, metrology sensor, sonic sensor (e.g., ultrasonic sensor), or proximity sensor. The metrology sensor may comprise measurement sensor (e.g., height, length, width, depth, angle, and/or volume). The metrology sensor may comprise a magnetic, acceleration, orientation, or optical sensor. The sensor may comprise a material level sensor such as a powder level sensor. The sensor (e.g., material level sensor) may comprise a guided wave radar. The optical sensor may comprise a camera. The metrology sensor may measure the gap. The metrology sensor may measure at least a portion of the layer of material (e.g., pre-transformed, transformed, and/or hardened). The layer of material may be a pre-transformed material (e.g., powder), transformed material, or hardened material. The metrology sensor may measure at least a portion of the 3D object. The sensor may comprise a temperature sensor, weight sensor, powder level sensor, gas sensor, or humidity sensor. The gas sensor may sense any gas enumerated herein. The temperature sensor may measure the temperature without contacting the material bed (e.g., non-contact measurements). The weight of the manufacturing enclosure (e.g., container), or any components within the manufacturing enclosure can be monitored by at least one weight sensor in or adjacent to the material. One or more position sensors (e.g., height sensors) can measure the height of the material bed relative to the substrate. The position sensors can be optical sensors. The position sensors can determine a distance between one or more energy sources and a surface of the material bed. The exposed surface of the material bed can be the upper surface of the material bed relative to a gravitational center of the environment. Examples of 3D printing systems, apparatuses, devices, material beds, and components (e.g., sensors), controllers, software, and 3D printing processes can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the 3D printer comprises one or more valves. The methods, systems and/or the apparatus described herein may comprise at least one valve. The valve may be shut or opened based at least in part on an input from the at least one sensor (e.g., automatically), or manually. The degree of valve opening or shutting may be regulated by the control system, for example, according to at least one input from at least one sensor. The systems and/or the apparatus described herein can include one or more valves, such as throttle valves or butterfly valves. The valve may or may not comprise a sensor sensing the open/shut position of the valve. The valve may be a component of a gas conveyance system, e.g., operable to control a flow of gas of the gas conveyance system. A valve may be a component of the gas conveyance system, e.g., operable to control a flow of gas in the gas conveyance system. The valve(s) may comprise a proportional valve or a discrete valve.

In some embodiments, the manufacturing system comprises one or more actuators such as motors. The motor may be controlled by the controller(s) (e.g., by the control system) and/or manually. The motor may alter (e.g., the position of) the substrate and/or the base. The motor may alter (e.g., the position of) the build platform assembly. The actuator may facilitate translation (e.g., propagation) of the layer dispenser, e.g., the actuator may facilitate reversible translation of the layer dispenser. The motor may alter an opening of the manufacturing enclosure (e.g., its opening or closure). The motor may be a step motor or a servomotor. The actuator (e.g., motor) may alter (e.g., a position of) one or more optical components, e.g., mirrors, lenses, prisms, and the like. The servomotors may comprise actuated linear lead screw drive motors. The motors may comprise belt drive motors. The motors may comprise rotary encoders. The encoder may comprise an absolute encoder. The encoder may comprise an incremental encoder. The apparatuses and/or systems may comprise switches. The switches may comprise homing or limit switches. The motors may comprise actuators. The motors may comprise linear actuators. The motors may comprise belt driven actuators. The motors may comprise lead screw driven actuators. The actuators may comprise linear actuators.

In some embodiments, the 3D printer (e.g., its components) comprises one or more nozzles. The systems and/or the apparatus described herein may comprise at least one nozzle. For example, the material remover may comprise a nozzle. The nozzle may be regulated according to at least one input from at least one sensor. The nozzle may be controlled automatically or manually. The controller(s) may control the nozzle. The controller(s) may any controller(s) disclosed herein, e.g., as part of the control system of the 3D printer. The nozzle may include jet (e.g., gas jet) nozzle, high velocity nozzle, propelling nozzle, magnetic nozzle, spray nozzle, vacuum nozzle, or shaping nozzle (e.g., a die). The nozzle can be a convergent or a divergent nozzle. The spray nozzle may comprise an atomizer nozzle, an air-aspirating nozzle, or a swirl nozzle. The material dispenser can comprise a nozzle, e.g., through which material is removed from the material bed. The gas flow system may comprise a nozzle, e.g., that facilitates adjustment to the gas flow. The optical window may be supported by a nozzle that directs debris away from the optical window, e.g., at towards the material bed. The nozzle may comprise a venturi nozzle.

In some embodiments, the 3D printer comprises one or more pumps. The systems and/or the apparatus described herein may comprise at least one pump. The pump may be regulated according to at least one input from at least one sensor. The pump may be controlled automatically or manually. The controller may control the pump. The one or more pumps may comprise a positive displacement pump. The positive displacement pump may comprise rotary-type positive displacement pump, reciprocating-type positive displacement pump, or linear-type positive displacement pump.

In some embodiments, the 3D printer comprises at least one filter. The filter may comprise a ventilation filter. The ventilation filter may capture debris and/or other gas-borne material (e.g., fine powder) from the 3D printing system. The filter may comprise a paper filter such as a high-efficiency particulate air (HEPA) filter (a.k.a., high-efficiency particulate arresting filter). The ventilation filter may capture debris comprising soot, splatter, spatter, gas borne pre-transformed material, or gas borne transformed material. The debris may result from the 3D printing process. The filter and/or gas flow may direct the debris in a requested direction (e.g., by using positive and/or negative gas pressure). For example, the filter and/or gas flow may use vacuum, overpressure, and/or gas pulsing. For example, the ventilator may use gas flow.

At times, it may be advantageous to allow for easy installation and/or component maneuvering of the 3D printing system. For example, it may be advantageous if one or more components of the 3D printing system are easily maneuvered, e.g., insertable and/or removed. Easy maneuvering (e.g., removal and/or insertion) may include actions of a user facing the 3D printing system, and maneuvering (e.g., pulling and/or pushing) the one or more components to facilitate their maneuver, e.g., removal and/or insertion, respectively. For example, easy maneuvering (e.g., removal and/or insertion) may include actions of a personnel facing a front, a back, a side, a top, or a bottom of the 3D system, and maneuvering (e.g., pulling and/or pushing) the one or more components to facilitate their maneuver (e.g., removal and/or insertion, respectively). The one or more components may comprise: an optical system (e.g., including an array of optical assemblies, a laser generator), a detection system, an optical system enclosure, a side cover, or a door. The front of the 3D printing system can include a door to the processing chamber. The top of the 3D printing system can face the platform, e.g., through the optical window(s). The one or more components can be reversibly secured to and release from the rest of the 3D printing system using a (e.g., flexible) fastener. The flexible fastener may facilitate reversible maneuvering of a component (e.g., retraction and insertion of the component Into a designated location in the 3D printing system. The fastener may comprise any material disclosed herein, e.g., an elemental metal, a metal alloy, or a polymer. The fastener may comprise a lock assembly. The fastener may comprise a snap (e.g., snap fit) assembly, or a latch assembly. The fastener may comprise interlocking portions that engage and/or disengage using human exerted force. The fastener may comprise a cantilever, torsional or annular. The fastener may be devoid of loose parts. The fastener may or may not comprise a spring. In some embodiments, a component may be configured to (e.g., reversibly) snap into and/or out of a cavity in the 3D printing system, e.g., without any fastener, and rather due to the geometric configuration of the cavity edge and component edge that fit together. The fastener may comprise a screw, a peg, or a pin. The component (e.g., energy source) may be disposed on a rack (e.g., an electronic rack). The component may be engaged with a sliding mechanism (e.g., similar to a drawer). For example, the component may comprise at least one wheel (e.g., wheels) configured to couple to at least one rail (e.g., two rails) disposed in 3D printing system cavity. For example, the component may comprise at least one rail (e.g., two rails) configured to couple to the 3D printing system cavity (e.g., wheel(s) configured to engage with the at least one rail. The component and/or 3D printing system cavity may comprise bracket(s) as part of the engagement mechanism between the 3D printing system cavity and the component. The engagement mechanism may comprise a rail, a wheel, or a bracket. The engagement mechanism may facilitate linear and/or tilting sliding of the component with respect to the 3D printing system. Any parts of the components may remain stable (e.g., configured to remain stable) during the maneuvering. For example, one or more parts (e.g., all parts) of the optical system may be stable during extraction of the optical system and/or one or more components of the optical system (e.g., an optical assembly of the array of optical assemblies) from the 3D printing system and/or insertion of the optical system into the 3D printing system. Such (e.g., reversible) maneuvering methodology may allow easy assembly, and/or maintenance of the 3D printing system (e.g., of the component thereof).

At times, maneuvering the optical system with respect to the 3D printing system causes no, or minimum (e.g., non-material), alternation of the optical system(s) disposed in the optical system enclosure. For example, one or more parts (e.g., all parts) of the optical system, optical assembly/ies, or of the optical system enclosure may be stable during extraction of the optical system, optical assembly/ies, (or optical system enclosure comprising the optical system) from the 3D printing system and/or insertion of the optical system or optical assembly/ies into the 3D printing system. Such (e.g., reversible) maneuvering methodology may allow easy assembly, and/or maintenance of the 3D printing system (e.g., of the component thereof).

At times, the energy beam follows a path. The path of the energy beam may be a vector. The path of the energy beam may comprise a raster, a vector, or any combination thereof. The path of the energy beam may comprise an oscillating pattern. The path of the energy beam may comprise a zigzag, wave (e.g., curved, triangular, or square), or curve pattern. The curved wave may comprise a sine or cosine wave. The path of the energy beam may comprise a sub-pattern. The path of the energy beam may comprise an oscillating (e.g., zigzag), wave (e.g., curved, triangular, or square), and/or curved sub-pattern. The curved wave may comprise a sine or cosine wave.

The path of the energy beam may comprise a sub-pattern. The sub-pattern of the energy beam may comprise a wave (e.g., sine or cosine wave) pattern. The sub-pattern may be a small path that forms the large path. The sub-pattern may be a component (e.g., a portion) of the large path. The path that the energy beam follows may be a predetermined path. A model may predetermine the path by utilizing a controller or an individual (e.g., human). The controller may comprise a processor. The processor may comprise a computer, computer program, drawing or drawing data, statue or statue data, or any combination thereof. The hatch lines or paths may be straight or curved. The hatch lines or paths may be winding. At times, the path comprises successive lines. The successive lines may touch each other. The successive lines may overlap each other in at least one point. The successive lines may substantially overlap each other. The successive lines may be spaced by a first distance (e.g., hatch spacing). Examples of 3D printing systems, apparatuses, devices, and any component thereof; controllers, software, and 3D printing processes (e.g., hatch spacings) can be found in International Patent Application Serial No PCT/US16/34857 filed on May 27, 2016, titled “THREE-DIMENSIONAL PRINTING AND THREE-DIMENSIONAL OBJECTS FORMED USING THE SAME” that is entirely incorporated herein by reference.

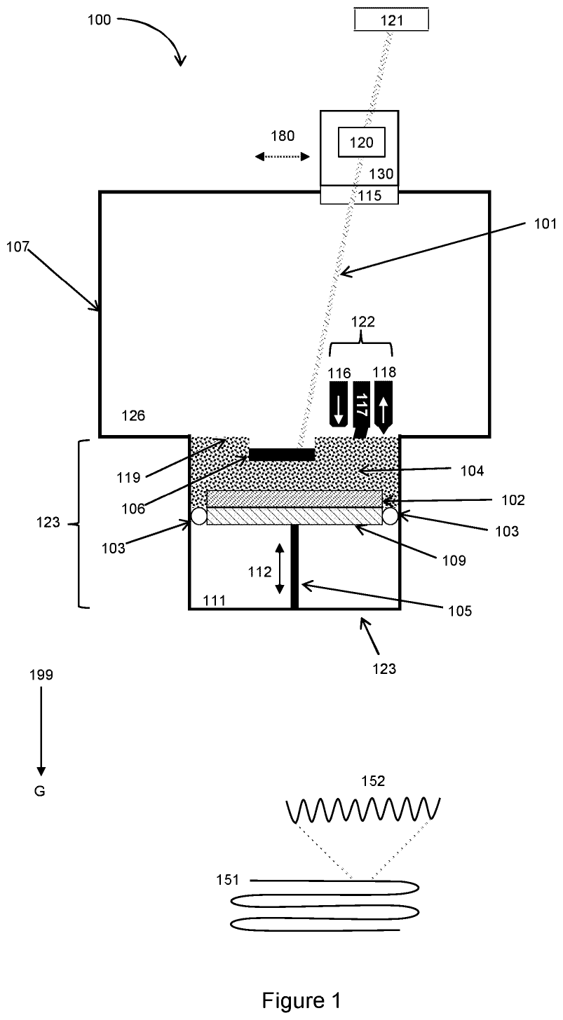

FIG. 1 shows an example of a manufacturing system that is a 3D printing system 100 having a processing chamber 107 coupled with a build module 123 as part of the manufacturing enclosure. The build module comprises an elevation mechanism 105 (e.g., as part of a build platform assembly) that vertically translate a substrate 109 (e.g., piston) along arrow 112. A build platform 102 is disposed on substrate 109 (e.g., piston). Material bed 104 is disposed above build platform 102 (e.g., also referred herein as “base”, or “build plate”). The 3D printing system 100 comprises an optical system 120 (e.g., a guidance system) for energy beam 101 (e.g., a galvanometer scanner). The optical system 120 is disposed in optical system enclosure 130 coupled with optical window 115. Optical system 120 can optionally be translatable along axis 180, e.g., translatable along an axis perpendicular to gravitational vector 199. Energy source (e.g., laser source) 121 generates energy beam 101 that traverses through the optical system 120 (e.g., comprising a guidance system such as a scanner) and through an optical window 115 into processing chamber 107 enclosing interior space 126 that can include an atmosphere. The optical window 115 is configured to allow the energy beam to pass through with minimal energetic loss, e.g., without (e.g., substantial) energetic loss. Processing chamber 107 can include an optional temperature adjustment device (e.g., cooling plate), not shown. Seal 103 encircles the substrate and/or base, e.g., to deter (e.g., prevent) migration of material of the material bed from reaching elevation mechanism 105. Energy beam 101 impinges upon an exposed surface 119 of material bed 104, to form at least a portion of a 3D object 106. FIG. 1 shows an example of a build module 123. Build module 123 contains the pre-transformed (e.g., starting) material in a material bed 104. As depicted in FIG. 1, the 3D printer comprises a layer dispensing mechanism 122. The layer dispensing mechanism 122 includes a material dispenser 116 and a powder removal mechanism 118 to form a layer of pre-transformed material (e.g., starting material) within the manufacturing enclosure. Layer dispensing mechanism 122 includes an optional leveler 117. The material may be layered (e.g., spread) in the manufacturing enclosure such as by using the layer dispensing mechanism 122. Build module 123 is configured to enclose a substrate 109 (e.g., piston) and arranged adjacent to a floor 111 at the bottom of build module 123. Floor 111 is defined relative to the gravitational field along gravitational vector 199 pointing towards gravitational center G, and/or relative to the position of the footprint of the energy beam 101 on the layer of pre-transformed material as part of a material bed 104. Build module 123 comprises build platform 102. The substrate is coupled with one or more seals 103 that enclose the material in a selected area within the build module to form material bed 104. One or more components of 3D printing system 100 are controlled by a control system (not shown in FIG. 1). The energy beam 101 can travel along a path such as path 151. FIG. 1 shows an example of a path of an energy beam path 151 comprising a zigzag sub-pattern. Sub-pattern 152 is an expansion (e.g., blow-up) of a portion of path 151.

In some embodiments, the formation of the 3D object includes transforming (e.g., fusing, binding and/or connecting) the pre-transformed material (e.g., 3D printing starting material such as a powder material) using an energy beam. The energy beam may be projected on to the starting material (e.g., disposed in the material bed), thus causing the pre-transformed material to transform (e.g., fuse). The pre-transformed or transformed material can absorb the energy from the energy source (e.g., energy beam, diffused energy, and/or dispersed energy), and as a result, a localized region of that pre-transformed or transformed material can increase in temperature (e.g., and at least partially transform). The energy beam may cause at least a portion of the pre-transformed material to transform from its present state of matter to a different state of matter. For example, the pre-transformed material may transform at least in part (e.g., completely) from a solid to a liquid state. The energy beam may cause at least a portion of the pre-transformed material to chemically transform. For example, the energy beam may cause chemical bonds to form or break. The chemical transformation may be an isomeric transformation. The transformation may comprise a magnetic transformation or an electronic transformation. The transformation may comprise coagulation of the material, cohesion of the material, or accumulation of the material. Transformation of the material may comprise connecting disconnected starting materials. For example, connecting various powder particles. The connection may comprise phase transfer, or chemical bonding. The connection may comprise fusing the starting material, e.g., sintering or melting the starting material.

In some embodiments, the methods described herein comprise repeating the operations of material deposition and material transformation operations to produce (e.g., print) a 3D object (or a portion thereof) by at least one 3D printing (e.g., additive manufacturing) method. For example, the methods described herein may comprise repeating the operations of depositing a layer of pre-transformed material and transforming at least a portion of the pre-transformed material to connect to the previously formed 3D object portion (e.g., repeating the 3D printing cycle), thus forming at least a portion of a 3D object. The transforming operation may comprise utilizing energy beam(s) to transform the material. In some instances, the energy beam is utilized to transform at least a portion of the material bed.

In some embodiments, the term “auxiliary support,” as used herein, generally refers to at least one feature that is a part of a printed 3D object, but not part of the requested, intended, designed, ordered, and/or final 3D object. Auxiliary support may provide structural support during and/or after the formation of the 3D object. The auxiliary support may be anchored to the manufacturing enclosure. For example, an auxiliary support may be anchored to the build platform (e.g., build platform such as a build plate), to the side walls of the material bed, to a wall of the manufacturing enclosure, to an object (e.g., stationary or semi-stationary) within the manufacturing enclosure, or any combination thereof. The auxiliary support may be the build platform or the bottom of the manufacturing enclosure. The auxiliary support may enable the removal of energy from the 3D object (e.g., or a portion thereof) that is being formed. The removal of energy (e.g., heat) may be during and/or after the formation of the 3D object. Examples of auxiliary support comprise a fin (e.g., heat fin), anchor, handle, pillar, column, frame, footing, wall, build platform, or another stabilization feature. In some instances, the auxiliary support may be mounted, clamped, or situated on the build platform. The auxiliary support can be anchored to the build platform, to the sides (e.g., walls) of the build platform, to the manufacturing enclosure, to an object (stationary or semi-stationary) within the manufacturing enclosure, or any combination thereof. Sometimes, the generated 3D object may comprise one or more auxiliary supports. The auxiliary support may be suspended in the pre-transformed material (e.g., powder material). The auxiliary support may provide weight or stabilizer. The auxiliary support can be suspended in the material bed such as within the layer of pre-transformed material in which the 3D object (or a portion thereof) has been formed. The auxiliary support may touch the build platform. The auxiliary support may be suspended in the material bed and not touch (e.g., contact) the build platform. The auxiliary support may be anchored to the build platform.

In some examples, the generated 3D object(s) can be printed without auxiliary support in a material bed in which it/they are formed. In some examples, low overhanging feature and/or hollow cavities of the generated 3D object can be printed without (e.g., without any) auxiliary support. The low overhanging features may be shallow overhanging features with respect to an exposed surface of the material bed. The low overhanging features may form an angle of at most about 40 degrees (°), 35°, or 25° with the exposed surface of the material bed (or a plane parallel thereto). The printed 3D object can be devoid of auxiliary supports. The printed 3D object may be suspended (e.g., float anchorlessly) in the material bed (e.g., powder bed). The term “anchorlessly,” as used herein, generally refers to without, or in the absence of, an auxiliary anchor. In some examples, an object is suspended in a material bed anchorlessly without attachment to a support. For example, the object floats in the material bed. A portion of the printed 3D object can be devoid of auxiliary supports. The portion of the 3D object may be suspended over a volume of the material bed. For example, a portion of the object defines an enclosed cavity which may be temporarily filled with powder material during a build process. The generated 3D object may be suspended in the layer of pre-transformed material (e.g., powder material). The pre-transformed material can offer support to the printed 3D object (or the object during its generation).

In some examples, the at least 3D object may be generated above a build platform, which at least one 3D object comprises auxiliary supports. In some examples, the auxiliary support(s) adhere (e.g., connect) to the build platform, e.g., the upper surface of the build platform). In some examples, the auxiliary supports of the printed 3D object may touch the build platform (e.g., the bottom of the manufacturing enclosure, the substrate, or the base. In some embodiments, the auxiliary supports are an integral part of the build platform. At times, auxiliary support(s) of the printed 3D object, do not touch the build platform. In any of the methods described herein, the printed 3D object may be supported only by the pre-transformed material within the material bed. Any auxiliary support(s) of the printed 3D object, if present, may be suspended adjacent to the build platform. Occasionally, the build platform may have a pre-hardened (e.g., pre-solidified) amount of material. Such pre-solidified material may provide support to the printed 3D object. At times, the build platform may provide adherence to the material. At times, the build platform does not provide adherence to the material. The build platform may comprise elemental metal, metal alloy, elemental carbon, or ceramic. The build platform may comprise a composite material (e.g., as disclosed herein). The build platform may comprise glass, stone, zeolite, or a polymeric material. The polymeric material may include a hydrocarbon or fluorocarbon. The build platform (e.g., base) may include Teflon. The build platform may include compartments for printing small objects. Small may be relative to the size of the manufacturing enclosure. The compartments may form a smaller compartment within the manufacturing enclosure, which may accommodate a layer of pre-transformed material.

In some examples, when the energy source is in operation, the material bed reaches a certain (e.g., average) temperature. The average temperature of the material bed can be an ambient temperature or “room temperature.” The average temperature of the material bed can have an average temperature during the operation of the energy (e.g., beam(s)). The average temperature of the material bed can be an average temperature during the formation of the transformed material, the formation of the hardened material, or the generation of the 3D object. The average temperature can be below or just below the transforming temperature of the material. Just below can refer to a temperature that is by at most about 1° C., 2° C., 3° C., 4° C., 5° C., 6° C., 7° C., 8° C., 9° C., 10 C, 15° C., or 20° C. below the transforming temperature. The average temperature of the material bed (e.g., pre-transformed material) can be by at most about 25° C. (degrees Celsius), 50° C., 100° C., 150° C., 200° C., 250° C., 300° C., 400° C., 500° C., 600° C., 700° C., 800° C., 900° C., 1000° C., 1200° C., 1400° C., 1600° C., 1800° C., or 2000° C. The average temperature of the material bed (e.g., pre-transformed material) can be at least about 20° C., 25° C., 50° C., 100° C., 150° C., 200° C., 250° C., 300° C., 400° C., 500° C., 600° C., 700° C., 800° C., 900° C., 1000° C., 1200° C., 1400° C., 1600° C., or 1800° C. The average temperature of the material bed (e.g., of the pre-transformed material therein) can be any temperature between the afore-mentioned material average temperatures. The temperature of the material bed can be conditioned (e.g., heated or cooled) before, during, or after forming (e.g., printing) the 3D object (e.g., hardened material). The material bed temperature can be controlled (e.g., substantially maintained) at a predetermined value. The temperature of the material bed can be monitored. The material temperature can be controlled manually and/or by a control system (e.g., such as any control system disclosed herein).

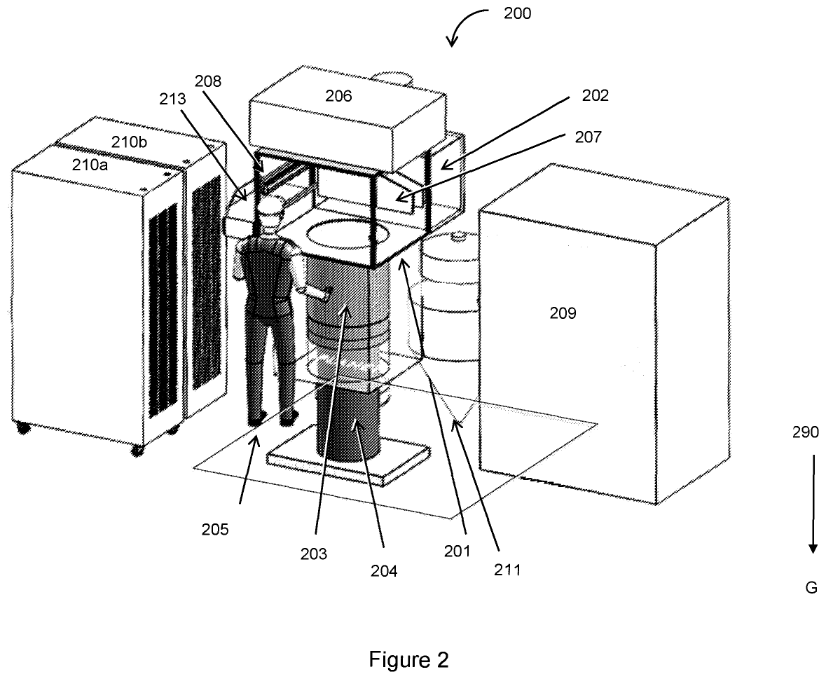

FIG. 2 shows an example of a 3D printing system 200 disposed in relation to gravitational vector 290 directed towards gravitational center G. The 3D printing system comprises processing chamber 201 coupled with an ancillary chamber (e.g., garage) 202 configured to accommodate a layer dispensing mechanism (e.g., recoater), e.g., in its resting (e.g., idle) position. The processing chamber is coupled with a build module 203 that extends 204 under a plane (e.g., floor) at which user 205 stands on (e.g., can extend under-grounds). The processing chamber may comprise a door (not shown) facing user 205. 3D printing system 200 comprises optical system enclosure 206 that can comprise an energy beam alignment system, e.g., comprising at least one optical array comprising at least one guidance system (e.g., scanner) . . . . A layer dispensing mechanism (not shown) may be coupled with framing 207 as part of a movement system that facilitate movement of the layer dispensing mechanism along the material bed and garage, e.g., in a reversible back-and-forth movement. The movement system comprises a translation inducer system, e.g., comprising a belt or a chain 208. 3D printing system 200 comprises a filter unit 209, heat exchangers 210a and 210b, pre-transformed material (e.g., powder) reservoir 211, and gas conveyance system (e.g., comprising gas inlets and gas inlet portions) disposed in gas enclosure 213. The filtering system may filter gas and/or pre-transformed material. The filtering system may be configured to filter debris, e.g., comprising byproduct(s) of the 3D printing.

In some embodiments, 3D printing system comprises a pre-transformed material (e.g., starting material such as powder) conveyor system (e.g., also referred to as “conveyance system” or “powder conveyance system”). The pre-transformed material conveyor system may be coupled with a processing chamber having a layer dispensing mechanism (e.g., recoater). Pre-transformed material (e.g., powder) from a reservoir (e.g., hopper) can be introduced into the layer dispensing mechanism disposed in the processing chamber. Once the layer dispensing mechanism dispenses a layer of pre-transformed material to layerwise form a material bed utilized for the three-dimensional printing, excess pre-transformed material may be attracted away from the material bed. In this process, excess pre-transformed material may be attracted away from the material bed using layer dispensing mechanism and introduced into separator (e.g., cyclone), and optionally to an overflow separator (e.g., cyclone). The pre-transformed material may undergo separation (e.g., cyclonic separation) in separator(s), and may be introduced into sieve(s), followed by gravitational flow into a lower reservoir (e.g., hopper). The separated and sieved pre-transformed material can be then delivered into separator(s), and into a reservoir that can deliver the pre-transformed material back into the layer dispensing mechanism. The separator may be coupled with sieve(s) instead of to the reservoir. The pre-transformed material conveyor system may comprise pumps (e.g., displacement pump and/or compressor pumps), and a temperature regulator (e.g., heater or radiator such as a radiant plane). The pre-transformed material conveyor system may comprise a venturi nozzle, for example, to facilitate suction of the pre-transformed material from the reservoir into separator(s). The pre-transformed material conveyance system can include a condensed gas source (e.g., a blower or a cylinder of condensed gas). The pre-transformed material conveyance system may include a heat exchanger. The pre-transformed material conveyance system may include one or more filters. The pre-transformed material conveyance system may operate at a positive pressure above ambient pressure external to the pre-transformed material conveyance system (e.g., above about one atmosphere). The gas conveyance system may be configured to circulate (e.g., recirculate) gas also in the processing chamber. The gas conveyance system may sweep debris (e.g., soot) away from the process area in which the 3D object is being printed. At times, a pressure differential is required to convey pre-transformed material from one compartment of the 3D printer to another. The pressure differential may be established via pressurizing or vacuuming one or more compartments. For example, pre-transformed material from the layer dispensing system to the recycling system (e.g., including the separator(s), sieve(s), and/or reservoirs) may be conveyed using (a) induced pressure differential among components, (b) pressure isolation of the components, and (c) induced pressure equilibration of components.

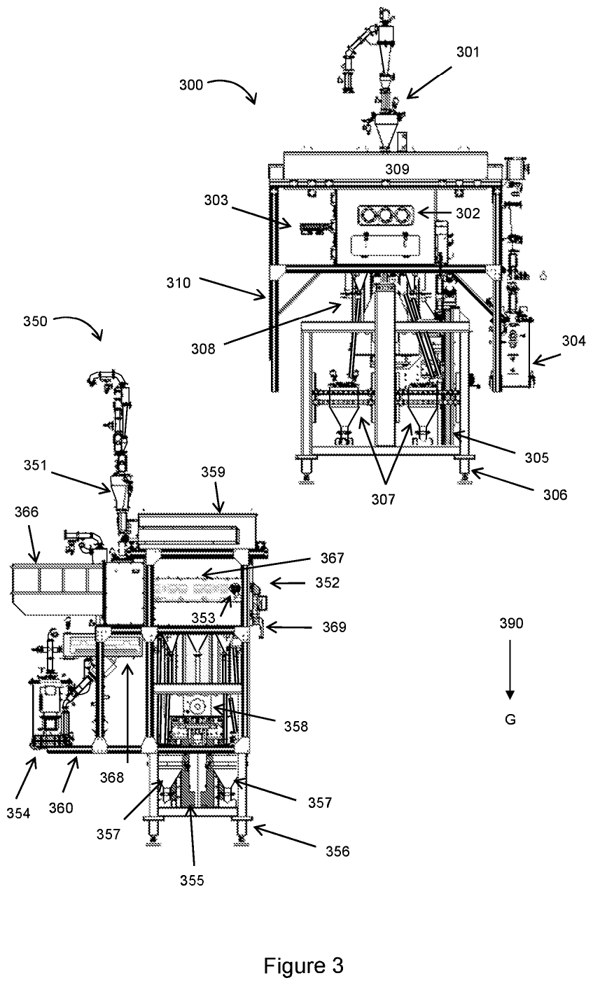

FIG. 3 shows in example 300 a front side example of a portion of a 3D printing system comprising a material reservoir 301 configured to feed pre-transformed material to a layer dispensing mechanism, and an optical system enclosure 309 configured to enclose, e.g., one or more optical system including scanner(s) and/or director(s) of at least one energy beam (e.g., laser beam) configured to transform the pre-transformed material into a transformed material to print one or more 3D object in a printing cycle. Example 300 of FIG. 3 shows processing chamber 302 having a primary door with three circular viewing windows and a secondary door, e.g., having a glove box type arrangement. Example 300 show a material reservoir 304 configured to accumulate a remainder pre-transformed material. The remainder may be from the layer dispensing mechanism, post 305 as part of a build platform assembly of build module 308, two material reservoirs 307 for accumulating a remainder of the material bed that did not form the 3D object, and actuator 303 configured to translate the layer dispensing mechanism to dispense a layer of pre-transformed material as part of a material bed. Supports 306 are planarly stationed in a first horizontal plane, which supports 306 and associated framing support one section of the 3D printing system portion 300 and framing 310 is disposed on a second horizontal plane higher than the first horizontal plane. FIG. 3 shows in 350 an example side view example of a portion of the 3D printing system shown in example 300, which side view comprises a material reservoir 351 configured to feed pre-transformed material to a layer dispensing mechanism (not shown), an optical system enclosure 359 enclosing an optical system (e.g., including scanners and/or directors) of at least one energy beam (e.g., laser beam) configured to transform the pre-transformed material into a transformed material to print one or more 3D object in a printing cycle. Example 350 of FIG. 3 shows an example of a processing chamber 352 having a door comprising handle 369 (as part of a handle assembly). 3D printing system portion 350 shows a material reservoir 354 configured to accumulate recycled remainder from the layer dispensing process to form a material bed and/or a remainder of the material bed that did not form one or more 3D objects during a printing cycle, and a portion of the material conveyance system 368 configured to convey the material to reservoir 354. The remainder material conveyed to reservoir 354 may be separated (e.g., sieved) before reaching reservoir 354. The example shown in 350 shows post 355 as part of a build platform assembly of build module 358, two material reservoirs 357 for accumulating a remainder of the material bed that did not form the 3D object, and actuator 353 configured to translate the layer dispensing mechanism to dispense a layer of pre-transformed material as part of a material bed, e.g., along railing 367 in processing chamber and into garage 366 in a reversible (e.g., back and forth) movement. Supports 356 are planarly stationed in a first horizontal plane, which supports 356 and associated framing support one section of the 3D printing system portion 350 and framing 360 is disposed on a second horizontal plane higher than the first horizontal plane. In the example shown in FIG. 3, the 3D printing system components is aligned with respect to gravitational vector 390 pointing towards gravitational center G.

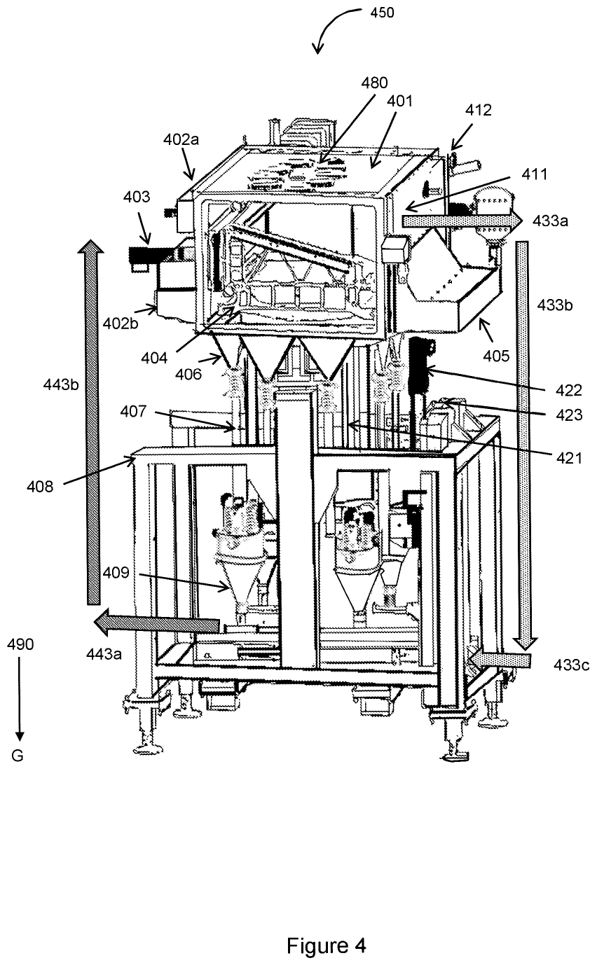

FIG. 4 shows a perspective view example of a portion of a 3D printing system including a processing chamber having a roof 401 in which eight optical windows 480 are disposed to each facilitate penetration of each of eight energy beam respectively into the interior space of processing chamber having side wall 411 comprising a gas exit port covering 405 coupled thereto. The processing chamber has two gas entrance port coverings 402a and 402b coupled with a wall opposing side wall 411. The opposing wall to wall 411 is coupled with actuator 403 configured to facilitate translation of a layer dispensing mechanism mounted on framing 404 above a base disposed adjacent to a floor of the processing chamber (e.g., the base can be flush with the floor), which framing is configured to translate reversibly back and forth in the processing chamber along railings. The processing chamber floor has slots through which remainder material can flow downwards towards gravitational center G along gravitational vector 490. The slots are coupled with funnels such as 406, which are connected by channels (e.g., pipes) such as 407 to material reservoir such as 409. The processing chamber is coupled with a build module 421 that comprises a substrate to which the base is attached, which substrate is configured to vertically translate with the aid of actuator 422 coupled with an elevator motion stage (e.g., supporting plate) 423 via a bent arm. The elevator motion stage 423 and its coupled components are supported by framing 408. An atmosphere (e.g., content and/or pressure) may be equilibrated between the material reservoirs 409 and the processing chamber via schematic channel (e.g., pipe) portions 433a-c. Remainder material in the material reservoirs may be conveyed via schematic channels (e.g., pipes) 443a-b to a material recycling system, e.g., at least in part for future use in printing and/or debris removal. The components of the 3D printing system are disposed relative to gravitational vector 490 pointing to gravitational center G.

At times, the methods described herein are performed in a manufacturing enclosure (e.g., container, processing chamber, and/or build module). One or more 3D objects can be formed (e.g., generated, and/or printed) in the manufacturing enclosure (e.g., simultaneously, and/or sequentially). The manufacturing enclosure may have a predetermined and/or controlled (e.g., maintained) pressure. The manufacturing enclosure may have a predetermined and/or controlled atmosphere, e.g., during the 3D printing. The control may be manual or via a control system. The atmosphere may comprise at least one gas.

In some embodiments, the manufacturing enclosure comprises an atmosphere having an ambient pressure (e.g., 1 atmosphere), or positive pressure above ambient pressure in an ambient environment external to the manufacturing enclosure. The atmosphere may have a negative pressure (i.e., vacuum). Different (e.g., compartmentalized) portions of the manufacturing enclosure may have different atmospheres. The different atmospheres may comprise different gas compositions. The different atmospheres may comprise different atmosphere temperatures. The different atmospheres may comprise ambient pressure (e.g., 1 atmosphere), negative pressure (i.e., vacuum) or positive pressure. The different portions of the manufacturing enclosure may comprise the processing chamber, build module, or manufacturing enclosure volume excluding the processing chamber and/or build module. The vacuum may comprise pressure below 1 bar, below 1 atmosphere, or below ambient pressure in the ambient environment. The positively pressurized environment may comprise pressure above 1 bar, above 1 atmosphere, or above the ambient pressure. In some cases, the chamber pressure can be (e.g., substantially) standard atmospheric pressure. The pressure may be measured at an ambient temperature, e.g., room temperature such as 20° C., or 25° C.

In some embodiments, the manufacturing enclosure comprises an atmosphere. The atmosphere within the manufacturing enclosure may comprise a positive pressure above ambient pressure in an ambient environment external to the manufacturing enclosure. The atmosphere within the manufacturing enclosure may be different than an atmosphere outside the manufacturing enclosure. At times, a differential atmosphere (e.g., a difference in atmospheres between the inside of the manufacturing enclosure and the outside of the manufacturing enclosure) depends in part on a processing condition of the three-dimensional printing. Processing conditions can include, for example, (i) a composition of the pre-transformed material, (ii) an internal temperature of the material bed during the three-dimensional processing, (iii) a number of energy beams (e.g., an average number of energy beams) transforming (e.g., incident on) the target surface during the three-dimensional processing, (iv) an amount of contamination by debris during the three-dimensional processing, (v) temperature in the material bed during 3D printing, (vi) temperature in the processing chamber during the printing, (vii) amount of energy supplied by the energy beams to the material bed, or (vii) any combination thereof. For example, a differential atmosphere between the interior of the manufacturing enclosure (e.g., within the processing chamber) and an ambient environment external to the manufacturing enclosure may depend at least in part on an average number of energy beams utilized during the three-dimensional process.

In some embodiments, the manufacturing enclosure includes an atmosphere that is greater than (e.g., at a positive pressure with respect to) an ambient atmosphere external to the manufacturing enclosure. The atmosphere within the manufacturing enclosure may comprise a positive pressure of at least about 20 Kilo Pascal (KPa), 18 KPa, 16 KPa, 14 KPa, 12 KPa, 10 KPa, or 5 KPa above ambient atmospheric pressure, e.g., above 101 KPa. The pressure in the manufacturing enclosure can be at a range between any of the afore-mentioned pressure values above atmospheric pressure, e.g., from about 5 KPa to about 20 KPa, the values representing a pressure difference above atmospheric pressure, e.g., above 101 KPa. The pressure can be measured by a pressure gauge. The pressure can be measured at ambient temperature (e.g., room temperature (R.T.)). In some cases, the chamber pressure can be standard atmospheric pressure. The pressure may be measured at an ambient temperature (e.g., room temperature such as about 20° C., or about 25° C.). The composition of the atmosphere within the manufacturing enclosure's internal environment may comprise any one or more of the gases described herein, for example, clean dry air (CDA), argon, and/or nitrogen. The gas may comprise a reactive agent (e.g., comprising oxygen or humidity). The atmosphere may comprise a v/v percent of the reactive agent (gas) of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of the reactive agent (gas) between the aforementioned percentages of hydrogen gas. The manufacturing enclosure may comprise a gas flow, e.g., before, after, and/or during three-dimensional printing. The gas flow within the manufacturing enclosure may comprise at least about 150 liters per minute (LPM), 200 LPM, 250 LPM, 300 LPM, 350 LPM, 400 LPM, 450 LPM, 500 LPM, 550 LPM, 600 LPM, 650 LPM, 700 LPM, 750 LPM, 800 LPM, 900 LPM, 1000 LPM, or 1200 LPM. The gas flow within the manufacturing enclosure may comprise any value between the aforementioned values, for example, from about 150 LPM to about 500 LPM, from about 450 LPM to about 750 LPM, or from about 700 LPM to about 1200 LPM.

In some embodiments, the manufacturing enclosure includes an atmosphere. The manufacturing enclosure may comprise a (e.g., substantially) inert atmosphere. The atmosphere in the manufacturing enclosure may be (e.g., substantially) depleted by one or more gases present in the ambient atmosphere. The atmosphere in the manufacturing enclosure may include a reduced level of one or more gases relative to the ambient atmosphere. For example, the atmosphere may be substantially depleted, or have reduced levels of water (i.e., humidity), oxygen, nitrogen, carbon dioxide, hydrogen sulfide, or any combination thereof. The level of the depleted or reduced level gas may be at most about 0.1 parts per million (ppm), 1 ppm, 3 ppm, 10 ppm, 50 ppm, 100 ppm, 500 ppm, 1000 ppm, 3000 ppm, or 5000 ppm volume by volume (v/v). The level of the depleted or reduced level gas may be at least about 1 ppm, 10 ppm, 50 ppm, 100 ppm, 500 ppm, 1000 ppm, or 5000 ppm (v/v). The level of the oxygen gas may be at most about 1 ppm, 10 ppm, 50 ppm, 100 ppm, 500 ppm, 1000 ppm, or 2000 ppm (v/v). The level of the water vapor may be at most about 1 ppm, 10 ppm, 50 ppm, 100 ppm, 500 ppm, 700 ppm, 800 ppm, 900 ppm, or 1000 ppm (v/v). The level of the gas (e.g., depleted or reduced level gas, oxygen, or water) may be between any of the afore-mentioned levels of gas. The atmosphere may comprise air. The atmosphere may be inert. The atmosphere in the manufacturing enclosure (e.g., processing chamber) may have reduced reactivity (e.g., be non-reactive) as compared to the ambient atmosphere external to the processing chamber and/or external to the printing system. The atmosphere may have reduced reactivity with the material (e.g., the pre-transformed material deposited in the layer of material (e.g., powder) or with the material comprising the 3D object), which reduced reactivity is compared to the reactivity of the ambient atmosphere. The atmosphere may hinder (e.g., prevent) oxidation of the generated 3D object, e.g., as compared to the oxidation by an ambient atmosphere external to the 3D printer and/or processing chamber. The atmosphere may hinder (e.g., prevent) oxidation of the pre-transformed material within the layer of pre-transformed material before its transformation, during its transformation, after its transformation, before its hardening, after its hardening, or any combination thereof. The atmosphere may comprise an inert gas. For example, the atmosphere may comprise argon or nitrogen gas. The atmosphere may comprise a Nobel gas. The atmosphere can comprise a gas selected from the group consisting of argon, nitrogen, helium, neon, krypton, xenon, hydrogen, carbon monoxide, and carbon dioxide. The atmosphere may comprise hydrogen gas. The atmosphere may comprise a safe amount of hydrogen gas. The atmosphere may comprise a v/v percent of hydrogen gas of at least about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise a v/v percent of hydrogen gas of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of hydrogen between the afore-mentioned percentages of hydrogen gas. The atmosphere may comprise a v/v hydrogen gas percent that is at least able to react with the material (e.g., at ambient temperature and/or at ambient pressure), and at most adhere to the prevalent work-safety standards in the jurisdiction (e.g., hydrogen codes and standards). The material may be the material within the layer of pre-transformed material (e.g., powder), the transformed material, the hardened material, or the material within the 3D object. Ambient refers to a condition to which people are generally accustomed. For example, ambient pressure may be about one (1) atmosphere.

In some embodiments, material utilized in the 3D printing undergoes passivation, e.g., using a passivation system. A passivation system may comprise (A) an in-situ passivation system (e.g., to passivate filtered debris and/or any other gas borne material before their disposal), (B) an ex-situ passivation system, or (C) a combination thereof. The passivation system may control a level of the oxidizing agent below a threshold. The oxidizing agent in the oxidizing mixture (e.g., oxygen) may be kept below a threshold (e.g., below 2000 ppm), e.g., by using one or more controllers such as the control system disclosed herein.

In some embodiments, the gas in the gas conveyance system and/or manufacturing enclosure comprises a robust gas. The robust gas may comprise an inert gas enriched with reactive agent(s). At least one reactive agent in the robust gas may be in a concentration below that present in the ambient atmosphere external to the gas conveyance system and/or manufacturing enclosure. The reactive agent(s) may comprise water or oxygen. The robust gas (e.g., gas mixture) may be more inert than the gas present in the ambient atmosphere. The robust gas may be less reactive than the gas present in the ambient atmosphere. Less reactive may be with debris, and/or pre-transformed material, e.g., during and/or after the printing. In some embodiments, humidity levels and/or oxygen levels in at least a portion of the manufacturing enclosure (e.g., processing chamber, ancillary chamber, and/or build module) can be regulated such that an oxygenation and/or humidification of powder in the powder conveyance system is controlled. Oxygenation and/or humidification levels of recycled pre-transformed material (e.g., recycled powder material) can be about 5 parts per million (ppm) to about 1500 ppm. The gas composition of the chamber can contain a level of oxygen that is at most about 4000 parts per million (ppm), 3000 ppm, 2000 ppm, 1500 ppm, 1000 ppm, 500 ppm, 400 ppm, 100 ppm, 50 ppm, 10 ppm, or 5 ppm. The gas composition of the chamber can contain an oxygen level between any of the afore-mentioned values (e.g., from about 4000 ppm to about 5 ppm, from about 2000 ppm to about 500 ppm, from about 1500 ppm to about 500 ppm, or from 500 ppm to about 50 ppm). Oxygenation and/or humidification levels of pre-transformed material can be about zero ppm. For example, oxygen content in pre-transformed material can be about 0 weight percent (wt %), 0.1 wt %, 0.25 wt %, 0.3 wt %, 0.5 wt %, 0.75 wt %, 1.0 wt %, or more. At times, atmospheric conditions can, in part, influence a flowability of pre-transformed material (e.g., powder material) from the layer dispensing mechanism. A dew point of an internal atmosphere of a manufacturing enclosure (e.g., of the processing chamber) can be (I) below a level in which the powder particles absorb water such that they become reactive under condition of 3D printing process(es) and/or sufficient to cause measurable defects in a 3D object printed from the powder particles and (II) above a level of humidity below which the powder agglomerates, (e.g., electrostatically). In some embodiments, conditions (I) and/or (II) may depend in part on a type of powder material and/or on processing condition(s) of the 3D printing process(es). The gas composition of the chamber can contain a level of humidity that corresponds to a dew point of at most about −10° C., −15° C., −20° C., −25° C., −30° C., −35° C., −40° C., −50° C., −60° C., or −70° C. The gas composition of the chamber can contain a level of humidity that correspond to a dew point of between any of the aforementioned values, e.g., from about −70° C. to abokilopascals 60° C. to about −10° C. or from about −30° C. to about −20° C. A dew point of an internal atmosphere of the manufacturing enclosure (e.g., of the processing chamber) can be from about −80° C. to about −30° C., from about −65° C. to about −40° C., or from about −55° C. to about-45° C., at an atmospheric pressure of at least about 10 kilo-Pascals (kPa), about 12 kPa, about 14 kPa, about 16 kPa, about 18 kPa, about 20 kPa above ambient pressure external to the manufacturing enclosure. A dew point of an internal atmosphere of the manufacturing enclosure can be any value within or including the afore-mentioned values. Examples of gas conveyance system and components (including control components), in-situ passivation systems, controlled oxidation methods and systems, 3D printing systems, control systems, software, and related processes, can be found in International Patent Application Serial Nos. PCT/US17/60035 and PCT/US21/35350, each of which is incorporated herein by reference in its entirety.

In some embodiments, a 3D printing system includes, or is operationally coupled with, one or more gas recycling systems. The gas recycling system can be at least a portion of the gas conveyance system. The processing chamber may include gas inlet(s) and gas outlet(s). The gas recycling system can be configured to recirculate the flow of gas from gas outlet(s) back into processing chamber via the gas inlet(s). Gas flow through a channel exiting a gas outlet can include solid and/or gaseous contaminants such as debris (e.g., soot). A filtration system can be configured to filter out at least some of the solid and/or gaseous contaminants, thereby providing a clean gas (e.g., cleaner than gas flow through channel exiting the gas outlet). The filtration system can include one or more filters. The filters may comprise physical filters or chemical filters. The clean gas exiting the filtering mechanism (also herein “filtration system”) can be under lower pressure relative to the incoming gas pressure into the filtering mechanism. The lower pressure and the pressure of the incoming gas pressure may be above ambient pressure external to the 3D printing system. The clean gas can be directed through a pump to regulate (e.g., increase) its relative pressure prior to entry to the processing chamber. Clean gas with a regulated pressure that exits the pump can be directed through one or more sensors. The one or more sensors may comprise a flow meter, which can measure the flow (e.g., pressure) of the pressurized clean gas. The one or more sensors may comprise temperature, humidity, oxygen sensors, or any other sensor disclosed herein. In some cases, the clean gas can have an ambient pressure or higher. The higher pressure may provide a positive pressure within the processing chamber (see example values of positive pressure described herein). A first portion of the clean gas can be directed through at least one inlet of a gas inlet portion of the manufacturing enclosure, while a second portion of the clean gas can be directed to first and/or second window holders that provide gas purging of optical window areas, as described herein. That is, the gas recycling system can provide clean gas to provide a primary gas flow for the 3D printing system, as well as a secondary gas flow (e.g., window purging). In some embodiments, the pressurized clean gas is further filtered through a filter prior to reaching one or both of the window holders. In some embodiments, the one or more filters (e.g., as part of one or more filters and/or a filtration system) are configured to filter out particles having nanometer-scale (e.g., about 10 nm to about 500 nm) diameters. In some embodiments, the gas recycling system may provide clean gas to a recessed portion of the manufacturing enclosure. In some embodiments, gas flow from the recessed portion of the manufacturing enclosure can be directed through the gas recycling system. In some embodiments, gas flow from the recessed portion can be directed through one or more filters of a filtration system. In some embodiments, the gas recycling system provides clean gas directed to first and/or second window holders.

In some embodiments, the manufacturing system has various components. The manufacturing system may comprise a manufacturing enclosure, a gas conveyance system, an optical system, and an energy source. The manufacturing enclosure may comprise a processing chamber and a build module. The processing chamber may or may not be connected to the build module. In an example, the build module is reversibly connected (e.g., during the printing) and disconnected (e.g., after the printing) from the manufacturing enclosure. The 3D printing system may comprise the optical system enclosure and the energy source. The optical system enclosure may be operatively coupled with at least one energy source. The optical system enclosure comprises various components including the optical system (e.g., scanner). The optical system can translate the energy beam along a path, which the energy beam travels through the optical windows into the manufacturing enclosure. The 3D printing system may comprise one or more energy beams and respective optical systems and optical windows. The manufacturing enclosure (e.g., processing chamber) may comprise one or more (i) gas inlets and (ii) gas outlets. The 3D printing system may comprise the gas conveyance system. The gas conveyance system may be connected to the manufacturing enclosure. One end of the gas conveyance system may be connected to the gas outlets, and the other end of the gas conveyance system may be connected to (i) the gas inlets, (ii) optical windows, and/or (iii) the optical system. The gas conveyance system may comprise various components comprising filter, gas line, discharge container, pump, gas enriching system, temperature conditioning system, or valve. Each of the components may be singular or plural. Gas egressed (e.g., expelled) from the manufacturing enclosure (e.g., over pressured gas above a threshold) may be ingressed (e.g., introduced) into the filter. The filter may be configured to facilitate streaming gas with a higher degree of purity, such as a HEPA filter. Debris included in the egressed gas from the manufacturing enclosure can be removed with the filter. The debris may be collected in the discharge container. The egressed gas stream from the manufacturing enclosure may split and diverted to (i) the pump in the gas conveyance system and/or (ii) an exhaust location. The egressed gas from the manufacturing enclosure may be (i) ingressed into the pump and/or (ii) egressed to the exhaust location. The exhaust location can comprise an ambient atmosphere or a reservoir (e.g., pressure reservoir). The pump may pressurize the gas passing through it. In an example, a portion of the filtered gas from the filter is ingressed into the pump and pressurized until the pressure of the gas conveyance system reaches its maximum. The rest of the filtered gas may be egressed to the exhaust location. The gas conveyance system may comprise one or more valves. The one or more valves may comprise valves located (i) upstream of the pump or (ii) upstream of the exhaust location. “Upstream” are based on the direction of the gas flow. The valves may control (i) the gas flow direction (e.g., to the pump and/or to the exhaust location), and/or (ii) the gas flow rate at each direction. In an example, the gas conveyance system may comprise valve(s) (e.g., an outlet valve assembly) located upstream of the exhaust location. The outlet valve assembly may comprise one or more valves, e.g., proportional valve(s) and/or discrete valves. The number of the valves of the outlet valve assembly may depend, e.g., on the pressure difference between the gas conveyance system and the exhaust location. The gas conveyance system comprises a gas enriching system. The gas enriching system may be connected in series or in parallel with the pump. The gas enriching system can enrich the gas with controlled level of a reactive agent. The reactive agent may comprise oxygen or humidity. The gas enriching system can enrich the gas with controlled level of a reactive agent. In an example, the gas enriching system comprises a humidity enriching system, e.g., enriching the gas flow with a controlled level of humidity. In an example, the gas enriching system is configured to enrich the gas flow with oxygen, e.g., with a controlled level of oxygen. One or more valves may be located (i) upstream of the gas enriching system and/or (ii) downstream of the gas enriching system. “Upstream” and “downstream” are based on the gas flow direction. The gas conveyance system may comprise a temperature conditioning system. The temperature conditioning system (e.g., cooler) may control (e.g., drop) the temperature of the gas flow.

In some embodiments, a manufacturing (e.g., 3D printing) system comprises a manufacturing enclosure. One or more 3D objects may be manufactured (e.g., printed) in the manufacturing enclosure. The manufacturing enclosure may enclose an atmosphere. The atmosphere may have one or more characteristics different from those of the ambient atmosphere external to the manufacturing enclosure. The one or more characteristics may comprise pressure, temperature, gas flow, or gas makeup. The gas makeup may comprise a reactive agent in a level lower than that in the ambient atmosphere. The reactive agent(s) may comprise oxygen, water, hydrogen, or hydrogen sulfide. The gas makeup may comprise an inert gas at a concentration greater than that of the ambient atmosphere. The gas makeup may comprise a robust gas. The inert gas may comprise a noble gas. The inert gas may comprise nitrogen or argon. The atmosphere may have a pressure above an ambient pressure in the ambient atmosphere external to the 3D printing system. The atmosphere may have a lower concentration of at least one reactive agent. The reactive agent may be configured to react with (i) a starting material (e.g., pre-transformed material) of the one or more 3D objects and/or (ii) a byproduct of the printing. The byproduct of the printing may comprise a remainder material or debris. The remainder material may comprise a residual starting material that is not utilized to form the one or more 3D objects. The manufacturing enclosure may comprise a processing chamber or a build module. The manufacturing enclosure may comprise, or operatively couple with, an ancillary chamber (e.g., garage). The manufacturing enclosure may comprise, or operatively couple with, a layer dispensing mechanism (e.g., recoater). The layer dispensing mechanism may comprise a material dispensing mechanism (e.g., dispenser). The material dispensing mechanism may dispense the starting material of the one or more 3D objects. The material dispensing mechanism may dispense (i) the starting material that is converted during the printing to become at least a portion of the 3D object(s) and/or (ii) excess material (e.g., remainder material) that is not converted during the printing to become at least a portion of the 3D object(s). The (starting) material dispensed by the material dispensing mechanism may form at least a portion of a material bed. The material bed may be supported by a build platform. The material bed may comprise an exposed surface. The exposed surface may be in contact with the atmosphere of the manufacturing enclosure. The manufacturing enclosure may comprise, or operatively couple with, an optical system. The optical system may be operatively coupled to at least one energy source generating at least one energy beam. The at least one energy (beam may impinge on the exposed surface of the material bed. The optical system may be located on and/or above a ceiling of the manufacturing enclosure. The at least one energy beam may be translated along a path, e.g., at least in part by the optical system such as one comprising a scanner. The at least one energy beam may be capable of transforming at least a portion of the material bed to a transformed material. The transformed material harden to form at least a portion of a 3D object. The remainder material may be disposed in the manufacturing enclosure, e.g., during and/or after the printing process. The remainder material may comprise the excess starting material, or debris (e.g., including soot, splatter, and/or spatter). The debris may comprise particulate matter having FLS smaller than a central tendency (e.g., average) of the FLS of the starting material, or particulate matter having FLS larger than a central tendency of the FLS of the starting material. The remainder material may be attracted away (e.g., removed) from the manufacturing enclosure. The removal may be at least in part by using (a) a material remover mechanism (also referred to herein as “remover”) as a part of the layer dispensing mechanism (e.g., recoater), (b) a removal wand (e.g., vacuum wand), (c) slots (e.g., holes) in a floor of the manufacturing enclosure (e.g., processing chamber) and/or of the ancillary chamber, or (d) via a gas conveyance system (e.g., via filters thereof). The remainder material may be carried at least in part by gas. The remainder material may be recycled by a recycling system, e.g., material recycling system. In some embodiments, a floor of the processing chamber and/or ancillary chamber comprises holes that are operatively coupled with the recycling system. In some embodiments, the remainder material is removed by the material remover mechanism and/or the removal wand. In some embodiments, the remainder material is carried into the gas conveyance system at least in part by gas. The remainder material may be filtered by the filter of the gas conveyance system. The filtered remainder material may be conveyed to the material conveyance system and/or material recycling system. The material remover mechanism may be a part of the layer dispensing mechanism (e.g., recoater). The material remover mechanism and/or removal wand may be configured to utilize an attractive force, e.g., vacuum force. The material remover mechanism and/or removal wand may attract the remainder material from the manufacturing enclosure and/or the ancillary chamber. The remainder material may be initially disposed in the manufacturing enclosure, e.g., during and/or after the manufacturing process such as the printing. The removed material may be accumulate (also) in the layer dispensing mechanism e.g., in the material removal mechanism portion thereof. The ancillary chamber may accommodate the layer dispensing mechanism, e.g., when idle. The layer dispensing mechanism (e.g., comprising the material remover mechanism) may reversibly move (e.g., laterally) between the manufacturing enclosure and an ancillary chamber (e.g., garage). The ancillary chamber may be coupled with the manufacturing enclosure (e.g., processing chamber). The layer dispensing mechanism may be parked in the ancillary chamber in its resting (e.g., idle) position. The layer dispensing mechanism may move into the manufacturing enclosure (e.g., processing chamber) in its operating position, e.g., to dispense a planar layer of starting material. The remainder material removed may be conveyed (e.g., using an attractive force) from the layer dispensing mechanism to the recycling system. The remainder material removed by the removal wand may be conveyed away from the removal wand to the recycling system, e.g., using an attractive force such as vacuum. The remainder material may flow away from the (i) ancillary chamber, (ii) manufacturing enclosure (e.g., processing chamber), (iii) material removal mechanism (as a part of the layer dispensing mechanism), and/or (iv) removal wand, to the recycling system. Flow away may comprise utilizing an attractive force, a compressive force, and/or a gravitational force. The remainder material may be recycled in the recycling system. The recycled remainder material may be re-used for manufacturing process such as printing. The remainder material may be carried at least in part by gas. The gas may differ from the ambient atmosphere by one or more characteristics, e.g., as disclosed herein. The gas and the remainder material may be conveyed into the (e.g., material) recycling system. In the recycling system, the remainder material may be separated from gas. The separation may comprise an inertial separation. The separation may comprise centrifugation. The separation may occur in cyclone(s) as part of the material recycling system. The separated remainder material may be sieved (e.g., filtered) in the recycling system. The recycled remainder material may be provided to the layer dispensing mechanism, e.g., for a subsequent layer dispensing operation. The manufacturing enclosure may be operatively coupled with the gas conveyance system. The gas conveyance system may be coupled via fluidic communication with the manufacturing enclosure. The gas conveyance system may exchange at least a portion of the atmosphere of the manufacturing enclosure, e.g., during the manufacturing such as printing. The gas conveyance system may operatively couple with (i) the layer dispensing mechanism, (ii) the removal wand, (iii) the material conveyance system (e.g., and the recycling system within), (iv) the ancillary chamber, and/or (v) the manufacturing enclosure. The gas conveyance system may be in fluidic communication with (i) the layer dispensing mechanism, (ii) the removal wand, (iii) the material conveyance system comprising the recycling system, (iv) the ancillary chamber, and/or (v) the manufacturing enclosure. Components of the 3D printing system may be connected by one or more channels, e.g., of the gas conveyance system and/or of the material conveyance system. The channels may comprise a pipe or hose. The channel may comprise an opaque or a transparent material. The channel may comprise a flexible or a rigid material. The channel may comprise flexible or rigid structure. The channels may enclose an internal atmosphere. The internal atmosphere of the channels may have a pressure. The pressure may be above the ambient pressure in the ambient atmosphere external to the manufacturing system such as a 3D printing system. The channel may be (e.g., directly or indirectly) coupled with pneumatic loop(s), such as of the material conveyance system and/or of the gas conveyance system. The pneumatic loops may be interconnected to the manufacturing enclosure, e.g., to the processing chamber. Content of the pneumatic loops may be dynamic. The content of pneumatic loop may alter (e.g., fluctuate) the pressure inside the channels. In some embodiments, the pressure inside the channels exhibits a (e.g., substantially) regular repetition of a pressure pattern over time.

The material conveyance system may comprise the recycling system, also referred to herein as the “material recycling system”. The material recycling system may filter the remainder material initially disposed in the manufacturing enclosure, e.g., the filtering being during and/or after the printing. The material recycling system may facilitate reuse of the remainder material as the starting material for the manufacturing such as printing. The material conveyance system may be connected to various components of the (e.g., rest of the) manufacturing system. The material conveyance system may operatively couple with the layer dispensing mechanism. The material conveyance system may comprise, or operatively couple with, the material recycling system. The material conveyance system may receive the reminder material from the (a) material remover mechanism as a part of the layer dispensing mechanism, (b) removal wand (e.g., vacuum wand), (c) slots in a floor of the manufacturing enclosure (e.g., processing chamber) and/or of the ancillary chamber, and/or (d) gas conveyance system, such as filters thereof. The material recycling system may recycle the remainder material. The material recycling system may comprise at least one separator. The separator may be configured to separate the remainder material from (i) gas (e.g., material carrying gas) and/or (ii) material that is unsuitable for reuse for the manufacturing, e.g., printing. The unsuitable material may comprise a particulate matter (e.g., agglomerates) having FLS larger than a central tendency of the FLS of the starting material. The separator may comprise (i) a cyclone (e.g., cyclonic separator), (ii) a sieve, or (iii) a material reservoir, e.g., hopper. The sieve may be enclosed by a sieve enclosure. The material reservoir may be operatively coupled with the sieve enclosure and/or the cyclonic separator. The separator (e.g., cyclone) may be operatively coupled (e.g., connected) with the (i) manufacturing enclosure, (ii) ancillary chamber, (iii) removal wand and/or (iv) material remover mechanism of the layer dispensing mechanism. The separator may accommodate at least a portion of the remainder material initially disposed in the manufacturing enclosure. The separator may be configured to separate the remainder material from gas, e.g., using centrifugation. The separator (e.g., cyclone) may be configured to utilize (e.g., and cause) pressure drop. The cyclone may be operatively coupled (e.g., connected) with (i) the sieve enclosure and/or (ii) a gas channel. In some embodiments, the cyclone is operatively coupled with the sieve enclosure directly without an intervention of an intervening component such as a channel. In some embodiments, the connection between the cyclone and the sieve enclosure is at least in part by a channel. One or more components of the three-dimensional manufacturing system may be couple with each other at least in part by a channel, such as material conveying channel. The channel may facilitate flow of the remainder material and/or the starting material. The channel may be configured to hold an atmosphere different than that of the ambient atmosphere by one or more characteristics, e.g., as disclosed herein. The channel may be configured to hold an atmosphere (e.g., substantially) similar to the atmosphere presiding in the manufacturing enclosure, e.g., during operation such as during manufacturing. In an example, the channel is configured to enclose a pressure above the atmospheric pressure external to the 3D printer. The pressure inside the channel may fluctuate, e.g., during operation such as during manufacturing. In some embodiments, the material removal mechanism (e.g., remover) of the layer dispensing mechanism uses negative pressure (e.g., vacuum) to remove remainder material from the manufacturing enclosure. The operation of the remover may at least in part contribute to the fluctuation of the pressure in the channel's atmosphere. In some embodiments, the gas conveyance system comprises a compressor (e.g., pump) that facilitates flow of the gas in the gas conveyance system. The compressor may at least in part contribute to the fluctuation of the pressure in the atmosphere of the channel. The material conveyance system may be configured to utilize pressure differentials to convey and/or recycle materials along a path, e.g., material conveyance path. The path may be disposed in at least one (covered) channel such as a tube and/or a hose. The material conveyance system may comprise, or be operatively coupled with, the material recycling system. The material recycling system may comprise the separator. The separator may comprise a sieve (e.g., sieve enclosure) or a cyclone (e.g., cyclonic separator). The separator may be configured to utilize and/or cause the pressure differentials. In some embodiments, the cyclone separates the remainder material from the gas at least in part by utilizing a pressure differential. The separated remainder material from the cyclone may be introduced into the sieve enclosure. The separated gas from the cyclone may be conveyed into a gas channel, e.g., of a gas conveyance system. The separated remainder material may be sieved by a sieve in the sieve enclosure. The sieved remainder material may be conveyed to the material reservoir, such as a hopper. The material reservoir may be configured to accommodate the recycled remainder material. The recycled remainder material may be utilized for a subsequent layer dispensing operation. The recycled material may be conveyed to a layer dispensing mechanism, e.g., through the material conveyance system. The remainder material may be at least in part conveyed by (1) the pressure differentials in the material conveyance system and/or (2) gravity. The material in the recycling system may be disposed in an internal atmosphere that is different by at least one characteristic from the ambient atmosphere. The at least one characteristic may be as disclosed herein, e.g., comprising a pressure different (e.g., greater) than the ambient pressure, a reactive agent (e.g., water and/or oxygen) at a lower concentration that a corresponding concentration in the ambient atmosphere, gas flow direction, gas makeup, or a temperature. The gas content may comprise an inert gas such as a Nobel gas, e.g., Argon.

The material conveyance system may comprise a material recycling system. The material recycling system may comprise a separator. The separator may comprise a cyclone, a sieve (e.g., sieve enclosure), or a material reservoir (e.g., hopper). The separator may use and/or cause a pressure differential within the separator. The separator may comprise a first internal atmosphere. The first internal atmosphere may have a first pressure. The first pressure may change (e.g., fluctuate) over time, e.g., during normal operation. The separator may comprise, or operatively couple with, a first sensor. The first sensor may be configured to sense one or more characteristics of the first internal atmosphere. The one or more characteristics may comprise a temperature, pressure, gas makeup, or gas flow. In some embodiments, the first sensor senses the first pressure of the first internal atmosphere. The first sensor may be comprised in, or be operatively coupled with, (i) the sieve enclosure, (ii) the material reservoir (e.g., hopper), or (iii) a channel connecting the sieve enclosure and the material reservoir. The three-dimensional printing system (e.g., 3D printer) may comprise a component having a second internal atmosphere different than the first internal atmosphere. The second internal atmosphere may have a second pressure. The second pressure may change (e.g., fluctuate) over time, e.g., during normal operation. The component may comprise, or operatively couple with, a second sensor. The second sensor may be configured to sense the one or more characteristics of the second internal atmosphere. In some embodiments, the second sensor senses the second pressure of the second internal atmosphere. The second sensor may be disposed at a location distinct from the first sensor. The second sensor may be comprised in, or be operatively coupled with, (i) the sieve enclosure, (ii) the cyclone (e.g., exit of the cyclone), (iii) a gas conveying channel (e.g., a gas channel operatively coupled with the cyclone), or (iv) a material conveying channel (e.g., a channel connecting the cyclone and the sieve enclosure). The first pressure and the second pressure may alter (e.g., fluctuate) over time. The pressure fluctuations may be at least in part caused by the content of pneumatic loops. The pneumatic loops may comprise (i) the gas conveyance system or (ii) the material conveyance system. The layer dispensing mechanism and/or removal wand may be operatively coupled with the pneumatic loop(s). Pressure fluctuations may occur at least during normal operation such as manufacturing or printing. The pressure inside the 3D printing system may be within a range of from about −10 kilopascal (kPa) to about +16 kilopascal (kPa), or from about 0.5 kilopascal (kPa) to about +16 kilopascal (kPa), relative to ambient pressure—an atmospheric pressure external to the 3D printing system. In some embodiments, the first pressure and the second pressure are within a range of (i) from about the atmospheric pressure (ii) to about +16 kPa relative to the atmospheric pressure. In some embodiments, the first pressure and the second pressure are within any of the aforementioned pressure ranges.

In some embodiments, the pressure inside the three-dimensional printing system exhibits a (e.g., substantially) regular increase and decrease, e.g., during normal operation. The pressure inside the three-dimensional printing system may exhibit a (e.g., substantial) repetition of a unit pattern (e.g., sequence) over time. The unit pattern may exhibit a pressure change (e.g., alteration or fluctuation) over time. The unit pattern may comprise an increase, a peak, a plateau, a decrease, or a dip. The unit pattern may be associated with a printing operation, e.g., a layer dispensing operation. For example, the first pressure and the second pressure may each exhibit a (e.g., substantial) repetition of a unit pattern (e.g., sequence) over time. The first pressure may be measured in one component of the recycling system and the second pressure may be measured in another component of the recycling system. The second pressure may be measured downstream relative to where the first pressure is measured. The first pressure may be a pressure (measured) inside the material reservoir. The second pressure may be a pressure (measured) inside the gas channel operatively coupled with the cyclone. The first pressure may exhibit a (e.g., substantial) repetition of a first pattern. The second pressure may exhibit a (e.g., substantial) repetition of a second pattern. The first pressure and the second pressure may be correlated. A correlation between two pressure patterns may comprise having a (e.g., substantially) identical pressure change (e.g., pattern or sequence) over time. Two or more correlated pressure patterns may or may not be indicative of a pressure gap between them. The correlated pressure patterns may have a coefficient of correlation. The correlation coefficient may be a value in a range between −1 and +1, inclusive. The correlation coefficient may indicate a strength and direction of a linear relationship between the two pressures. In some embodiments, the strength of the correlation becomes stronger when every change in one pressure of the first pressure pattern is met with a corresponding change in the other pressure in the second pressure pattern. The direction of the correlation may comprise a positive correlation or a negative correlation. A positive correlation coefficient (e.g., between 0 and +1, inclusive) may indicate that as one pressure of the first pressure pattern increases, the other pressure of the second pressure pattern tends to increase as well. The strength of the correlation becomes stronger when the coefficient approaches +1. For example, the correlation coefficient of +1 indicates a positive linear relationship, where every increase in the one pressure is met with a corresponding increase in the other pressure. A negative correlation coefficient (e.g., from −1 and to below 0) may indicate that as the one pressure increases, the other pressure tends to decrease. The strength of the correlation becomes stronger when the coefficient approaches −1. For example, a correlation coefficient of −1 indicates a negative linear relationship, where every increase in the one pressure is met with a corresponding decrease in the other pressure. The correlation coefficient may be measured by analyzing the similarity between two pressure patterns as they shift over time. In some embodiments, the correlation coefficient is measured by using a method of normalized cross-correlation. The correlation coefficient between the first pressure and the second pressure may be above a threshold, e.g., during normal operation. The threshold may comprise (i) a value (e.g., predetermined value) or (ii) a function. In some embodiments, the threshold comprises a value within a range of from about 0.70 to about 0.82. The correlation coefficient between the first pressure and the second pressure, e.g., during normal operation, may be at least about 0.750, 0.800, 0.820, 0.850, 0.900, 0.920, or more. The correlation coefficient between the first pressure and the second pressure, e.g., during normal operation, may be at most about 0.900, 0.920, 0.950, 0.990, 0.995, 0.997, or less. The correlation coefficient may be any value between the afore-mentioned values. The correlation coefficient may be from about 0.750 to about 0.997, or from about 0.800 to about 0.995.

In some embodiments, the 3D printer comprises, or is operatively coupled with (a) a gas conveyance system and/or (b) a material conveyance system. The material conveyance system may convey material via dense phase or dilute phase conveyance. The material conveyance system may convey the starting material and/or the remainder material. The material conveyance system may convey pre-transformed material, such as powder. The dilute phase conveyance may convey material (e.g., powder) continuously, semi continuously, or intermittently. Semi-continuous conveyance refers to conveyance of material (e.g., powder) when there is a material loss and/or degradation. Semi-continuous conveyance may be referred to in “just in time conveyance.” Semi-continuous conveyance may react to real time material loss in the system, e.g., as the material loss is detected by a control system, e.g., by one or more sensors measuring the material level. The dense phase conveyance may convey the material (e.g., powder) intermittently or semi continuously, e.g., as packets or pellets of dense powder pressed forward by pressurized gas. The dilute phase conveyance may use gas at a pressure comprising pressure below ambient pressure, (e.g., substantially) at ambient pressure, or above ambient pressure. For example, the dilute gas conveyance conveys the powder at a pressure above ambient pressure. The material (e.g., powder) conveyance system may convey the powder along pressure differential, e.g., and against gravitational force of the ambient environment. The dense phase conveyance may require less gas to convey a mass of the powder as compared to the dilute phase conveyance. Less gas may be by at least about 1, 2, or 3 orders of magnitude less gas to convey a unit mass of powder. In an example, the dense phase conveyance requires 10 grams of gas (e.g., robust gas such as Argon) to convey 1000 grams of powder (e.g., metallic powder). In an example, the dilute phase conveyance requires between about 3000 grams to about 100 grams of gas to convey the 1000 grams of powder (e.g., metallic powder). In the dense phase conveyance, the mass of powder may be pushed by the gas. In the dilute phase conveyance, the mass of powder is carried (e.g., gas borne) by the gas. The material conveyance system may comprise gravitational conveyance, dense phase conveyance, dilute phase conveyance, or any combination thereof. A first portion of the material conveyance system may comprise gravitational conveyance. A second portion of the material conveyance system may comprise dense phase conveyance. A third portion of the material conveyance system may comprise dilute phase conveyance. The material conveyance system may meet safety standards in one or more jurisdictions, e.g., regarding harm such as due to powder combustion. A harmful event may occur in the event of a harmful reaction. Harmful may be to the user, to the 3D object, to equipment, and/or to the facility. The harmful event may comprise combustion, ignition, flaring, fuming, burning, bursting, explosion, eruption, smelting, flaming, explosion, or any other safety violation per jurisdictional standards. Such harm is exacerbated the larger the 3D object printed becomes, e.g., by requiring use of a larger powder bed comprising a larger amount of powder. The one or more jurisdictions may comprise the jurisdiction in which the printer is manufactured, or the jurisdiction in which the printer operates. The conveyance system (e.g., material conveyance system and/or gas conveyance system) may be configured to hold an atmosphere different than that of the ambient atmosphere by one or more characteristics, e.g., as disclosed herein. The conveyance system may be configured to hold an atmosphere (e.g., substantially) similar to the atmosphere presiding in the manufacturing enclosure, e.g., during operation such as during manufacturing. In an example, the conveyance system is configured to enclose a pressure above the atmospheric pressure external to the conveyance system. In an example, the conveyance system is configured to convey reactive agent(s) at a concentration lower than those in the ambient atmosphere external to the conveyance system. The material conveyance system may comprise a recycling system. The material conveyance system may comprise a channel, a reservoir, a separator, or a pump. The material conveyance system may comprise a valve or a motor. The material conveyance system may be operatively coupled with the control system, e.g., as disclosed herein. The control system may control conveyance in the conveyance system, e.g., automatically.

A manufacturing system (e.g., three-dimensional printing system) may comprise a manufacturing enclosure. One or more objects may be manufactured (e.g., printed) in the manufacturing enclosure. The manufacturing enclosure may comprise a processing chamber, a build module, or an ancillary chamber. The three-dimensional printing system may comprise or operatively couple with (i) a gas conveyance system and/or (ii) a material conveyance system. The manufacturing enclosure may be operatively coupled with (i) the gas conveyance system and/or (ii) material conveyance system, e.g., by one or more channels. The conveyance systems (e.g., gas conveyance system and/or material conveyance system) may be configured to facilitate flow of gas, a remainder material and/or a starting material. The conveyance systems may be configured to have fluidic communication with the manufacturing enclosure. The material conveyance system may comprise a (e.g., material) recycling system. The material recycling system may comprise a separator. The separator may separate the remainder material from materials unsuitable for reuse for the printing. The remainder material may comprise pre-transformed material of the printed objects, such as powder. The remainder material may be disposed (e.g., enclosed) in the manufacturing enclosure, e.g., during and/or after operation such as printing. The remainder material may flow away from the manufacturing enclosure into the material recycling system, e.g., through one or more channels. The separator may comprise a sieve, a cyclone, or a material reservoir. The remainder material may be filtered through the cyclone and the sieve. The filtered remainder material may be accommodated in the material reservoir. The filtered remainder material may be utilized for a subsequent layer dispensing operation as at least a portion of the starting material. One or more components of the conveyance system may be operatively coupled with each other, e.g., by one or more channels. Materials (e.g., comprising the remainder material or the starting material) may flow through the one or more channels. At times, a malfunction may occur in the manufacturing system. The malfunction may comprise (i) a blockage in a portion of an internal space of the three-dimensional printing system, or (ii) a rupture in one or more components of the three-dimensional printing system. The blockage may be (e.g., at least in part) caused by a material accumulating in a conveyance path. The conveyance path may comprise a material conveyance path or a gas conveyance path. The conveyance path may comprise at least a portion of the internal space of the one or more components of the three-dimensional printing system. In some embodiments, the conveyance path comprises an inner space of a channel, a separator, an enclosure, or a reservoir of the manufacturing (e.g., 3D printing) system. The rupture may comprise a hole or a puncture in one or more components of the three-dimensional system. The wall (e.g., inner wall) of the one or more components may define at least a portion of the conveyance path. The rupture may be (e.g., at least in part) caused by friction between the conveyed material (e.g., pre-transformed material) and a wall (e.g., inner wall) of the one or more components. The material may have a mechanical strength equal or greater than that of the wall of the one or more components. In some embodiments, the material comprises a metallic powder. The rupture may be at least in part caused by a pressure of the material and/or gas that flows the conveyance path. The material and/or gas that flows the conveyance path may have a pressure above an atmospheric pressure external to the three-dimensional printing system. The rupture may be at least in part caused by a collision between the materials such as a metallic powder. The malfunction may lead to a disruption to the manufacturing process and/or a harmful event. The harmful event may comprise explosion, eruption, or bursting. Harmful may be to the user, to the three-dimensional object, to equipment, and/or to the facility. The manufacturing system (e.g., 3D printing system) may comprise a prevention system. The prevention system may predict and/or detect malfunction in the printing system. The prevention system may be configured to perform, or direct performance of, a prevention operation. The prevention operation may be performed automatically or manually. The prevention operation may be configured to prevent or resolve the malfunction. The prevention system may reduce the possibility of the disruption of the manufacturing process and/or the harmful event.

In some embodiments, a remainder material flows away from the manufacturing enclosure and into a material recycling system. The remainder material may be initially disposed in a manufacturing enclosure, e.g., at least during the manufacturing such as the printing. The manufacturing enclosure may be configured to enclose a printed object, e.g., at least during manufacturing such as the printing. The object may be printed from a starting material. The remainder material may comprise the starting material that did not form the printed object. The remainder material may be conveyed into the material recycling system. The material recycling system may be configured to recycle the remainder material. The recycled remainder material may be utilized as a portion of the starting material during a subsequent operation. The material recycling system may comprise a separator. The separator may comprise a cyclonic separator (e.g., cyclone), a sieve enclosure (e.g., enclosing a sieve), or a material reservoir. The remainder material may be carried into the cyclone, e.g., by gas. The cyclone may separate the remainder material from the gas. The separated remainder material may be introduced into the sieve enclosure, e.g., through an inlet of the sieve enclosure. The separated gas may be introduced into a gas channel. The gas channel may be operatively coupled with the cyclone. The remainder material may be filtered (e.g., sieved) through the sieve in the sieve enclosure. The remainder material may have a fundamental length scale (FLS) (e.g., substantially) same as the size of pores in the sieve. Aggregates having a fundamental length scale (FLS) larger than the size of the pores may be filtered out by the sieve. At times, the remainder material may be accumulated on the sieve. The accumulation may be at least in part caused by a sieve blockage, e.g., sieve blinding. The sieve blockage may be caused by the blockage of sieve pores by the remainder material (e.g., powder) and/or the aggregates of the remainder material. The accumulation may be at least in part caused by an inflow rate of the remainder material being faster than a sieving rate. The accumulated remainder material may block at least a portion of the conveyance path. In some embodiments, the accumulated remainder material reaches the inlet (e.g., entrance or port) of the sieve enclosure. The entrance of the sieve enclosure may be operatively coupled with the cyclone, e.g., with or without an intervening channel. The blockage may interrupt conveyance of the remainder material. The blockage may disrupt the manufacturing (e.g., printing) process. The prevention system may be configured to prevent or resolve the disruption.

In some embodiments, the manufacturing system comprises a prevention system. The prevention system may prevent and/or detect the malfunction such as the blockage and/or the rupture. The prevention system may be configured to monitor the internal pressure of one or more components of the manufacturing system. The material reservoir may comprise an internal atmosphere. The internal atmosphere of the material reservoir may have a reservoir pressure. The material reservoir may be operatively coupled with the sieve enclosure. The material reservoir may be configured to accommodate the sieved remainder material from the sieve enclosure. The material reservoir may be in fluidic communication with the sieve enclosure. The material reservoir may have (e.g., substantially) identical or similar pressure with the sieve enclosure. The material reservoir may comprise, or operatively couple with, a reservoir sensor configured to measure pressure in the internal atmosphere of the reservoir. The reservoir sensor may be configured to sense the reservoir pressure of the reservoir's internal atmosphere. The reservoir's atmosphere pressure may alter (e.g., fluctuate) over time to generate a reservoir pressure pattern, e.g., during normal operation. Regular increase and decrease of the reservoir's pressure may occur under normal manufacturing operation. The regular increase and decrease of the reservoir's pressure may be linked to the manufacturing process taking place in the manufacturing enclosure, e.g., in the processing chamber. The material reservoir may be fluidly coupled with the manufacturing enclosure under normal operation, and its reservoir atmosphere may be affected by the regular increase and decrease in pressure in the manufacturing enclosure (e.g., processing chamber). During normal operation, the reservoir's pressure pattern may exhibit a (e.g., substantially) regular increase and decrease of reservoir pressure. During normal operation, the reservoir pressure may exhibit a (e.g., substantial) repetition in the reservoir pressure pattern, e.g., pressure sequence. Content of the reservoir's pressure pattern may be any pressure pattern disclosed herein. In an example, the reservoir pressure pattern comprises a peak or a dip. The reservoir's pressure pattern may be associated with a manufacturing operation, such as a layer dispensing operation in a 3D printing. The reservoir's internal atmosphere may be in fluidic communication with the internal atmosphere of the manufacturing enclosure. The reservoir's sensor may be operatively coupled with the prevention system. The prevention system may be configured to monitor the first pressure continuously or intermittently. The prevention system may be configured to monitor the reservoir's pressure at least during manufacturing such as during the printing. The reservoir's pressure may deviate from the regular pressure pattern during a faulty operation, e.g., on clogging of the sieve disposed in the sieve enclosure. The faulty operation may comprise a blockage in the printing system. The blockage may occur in the sieve enclosure. The sieve may be blocked (e.g., blinded) with the remainder material and/or aggregates of the remainder material. The blockage of the sieve may cause the remainder material to accumulate on the sieve. The accumulation of the remainder material may block (e.g., clog) the inlet of the sieve enclosure where the remainder material is introduced. The blockage of the inlet may disrupt the fluidic communication between the sieve enclosure and the manufacturing enclosure (e.g., processing chamber). The clogging of the sieve may disrupt the pressure equilibration between the internal atmospheres of the reservoir and that of the manufacturing enclosure. The material reservoir may be in fluidic communication with the sieve enclosure. The disruption in fluidic communication may (e.g., at least in part) cause reservoir's pressure to deviate from its regular pressure pattern. The reservoir's sensor may measure a pressure of an environment after the (e.g., clogged) sieve-downstream of the clogged sieve, thus at least partially disrupting the equilibration between the second environment and the manufacturing enclosure environment. Disruption of the equilibration may manifest as a disruption in the reservoir's pressure pattern as measured by the reservoir's sensor. The reservoir's pressure may exhibit damping (e.g., attenuating) characteristic during faulty operation. The damping characteristic may comprise (i) reduced amplitude, (ii) smoothened waveform, or (iii) reduced deviation from the central tendency. In some embodiments, the reservoir's pressure pattern during faulty operation does not exhibit a repetition of a pattern or a sequence as in normal operation. In some embodiments, the amplitude of the reservoir's pressure (e.g., and of the reservoir's pressure pattern) decreases during faulty operation. In some embodiments, the reservoir's pressure reaches a state of equilibrium. The equilibrium pressure may fall within the range of (a) the internal pressure of the manufacturing enclosure and (b) the internal pressure of the gas conveyance channel operatively coupled with the cyclone. The prevention system may be configured to determine the malfunction at least in part by detecting the deviation (e.g., damping characteristic) of the reservoir's pressure from the regular pressure pattern. In some embodiments, the prevention system determines the malfunction when the amplitude decreases by a threshold. The threshold may comprise a value or a function. In some embodiments, the threshold is in a range of from about 5 kilopascal (kPa) to about 9 kilopascal (kPa). In some embodiments, the threshold is in a range of from about 40% to about 75% of the amplitude during the normal operation. In an example, the amplitude of 12 kPa during normal operation decreases to about 5 kPa during faulty operation. The prevention system may be configured to initiate a prevention operation when it determines malfunction in the printing system. While this paragraph describes using the environment of the material reservoir to detect sieve clogging, any atmosphere downstream (e.g., after) the clogged sieve may be utilized. For example instead, or in addition to, the reservoir's pressure sensor; a pressure sensor may be disposed (a) in the sieve enclosure, and/or (b) in a channel, disposed downstream (e.g., after) the sieve to sense a pressure reaction similar to the one sensed by the reservoir's pressure sensor. Instead, or in addition to, the reservoir's pressure sensor; a pressure sensor may be disposed in a recycling system's component disposed downstream (e.g., after) the sieve, to sense a pressure reaction similar to the one sensed by the reservoir's pressure sensor, the recycling system's component being (A) fluidly coupled with the sieve enclosure, and (B) enclosing an atmosphere.

In some embodiments, the manufacturing system (e.g., 3D printer) comprises, or is operatively coupled with, (i) a first sensor and (ii) a second sensor. The manufacturing system may comprise one or more components. The one of the one or more components may comprise a first internal atmosphere. A second of the one or more components may comprise a second internal atmosphere. The first sensor may be configured to sense pressure of a first environment downstream of the sieve, e.g., as disclosed herein. The first sensor may be configured to sense pressure of the first environment of the sieve enclosure, downstream of the sieve, or downstream of the sieve enclosure. The second sensor may be configured to sense pressure of a second environment upstream of the sieve, e.g., as disclosed herein. The second sensor may be configured to sense pressure of the second environment upstream of the sieve, or upstream of the sieve enclosure. The second internal atmosphere may be different than the first internal atmosphere. The second internal atmosphere may have a second pressure, e.g., second set of pressure fluctuations. The component may comprise, or be operatively coupled with, the second sensor. The second sensor may be configured to sense the second pressure of the second internal atmosphere. The component may be other than the sieve enclosure and/or the material reservoir. The component may be operatively coupled with the manufacturing enclosure. The component may be in fluidic communication with the manufacturing enclosure. The component may comprise (i) a gas channel (e.g., that is operatively coupled with the cyclone), (ii) the cyclone (e.g., an exit of the cyclone), (iii) the manufacturing enclosure, (iv) a material conveyance channel (e.g., coupling the cyclone and the sieve enclosure), or (v) a gas conveyance channel. The first pressure and the second pressure may alter (e.g., fluctuate) over time, e.g., during normal operation. The first pressure and the second pressure may exhibit a (e.g., substantially) regular increase and decrease, respectively. The first pressure may exhibit a (e.g., substantial) repetition of a first pressure pattern (e.g., pressure sequence), during normal operation. The second pressure may exhibit a (e.g., substantial) repetition of a second pressure pattern (e.g., pressure sequence), during normal operation. Content of the reservoir's pressure pattern may be any pressure pattern disclosed herein. In an example, the first pressure pattern and the second pressure pattern may comprise a peak or a dip, respectively. The first pressure pattern and the second pressure pattern may be associated with a manufacturing operation, such as a layer dispensing operation in 3D printing. The first sensor and the second sensor may be operatively coupled with the prevention system. The prevention system may be (i) a part of a control system, or (ii) separate from the control system. During normal operation, the first pressure and the second pressure may exhibit a similar or (e.g., substantially) identical pattern over time. In some embodiments, under normal operation a change in the first pressure tends to be met with a corresponding change in second pressure. Changes may comprise increase, decrease, a peak, or a dip. Changes in the first pressure and the second pressure may occur at and/or during (e.g., substantially) identical or similar times. Under normal operation, the first pressure and the second pressure may correlate with each other. A correlation coefficient between the first pressure and the second pressure may indicate the strength of correlation between the first pressure and the second pressure. The correlation coefficient may be measured by normalized cross-correlation. The correlation coefficient may be above a threshold during normal operation. The first internal atmosphere and the second internal atmosphere may be in fluidic communication with the manufacturing enclosure, during normal operation. At times, a disruption may occur. For example, the sieve is blinded with the remainder material. This sieve blockage (e.g., sieve blind) may cause accumulation of the remainder material. The accumulated remainder material may block the inlet of the sieve enclosure. This blockage may disrupt fluidic communication between the manufacturing enclosure and the material reservoir. The first pressure may not follow the pressure change (e.g., fluctuation) of the manufacturing enclosure. A clog in one component of the recycling system may disrupt (e.g., and disconnect) pressure equilibrium between an environment measured by the first sensor and environment measured by the second sensor. In an example, normal pressure fluctuation occur in the manufacturing enclosure. The second sensor may measure a pressure of a second environment disposed between the manufacturing enclosure and the (e.g., clogged) sieve, which second environment is fluidly coupled with the manufacturing enclosure atmosphere allowing the second sensor to measure the regular fluctuations. The first sensor may measure a pressure of an environment after the (e.g., clogged) sieve, thus at least partially disrupting the equilibration between the second environment and the manufacturing enclosure environment. Disruption of the equilibration may manifest as a disruption in the first pressure pattern measured by the first sensor. The strength of correlation between the first pressure and the second pressure may decrease. In some embodiments, the first pressure may exhibit a damping characteristic during faulty operation. The damping characteristic may comprise (i) reduced amplitude, (ii) smoothened waveform, or (iii) reduced deviation from a central tendency (e.g., average). The correlation coefficient may be below the threshold during faulty operation. The prevention system may monitor (e.g., track) data from the first sensor and the second sensor. The prevention system may monitor (e.g., track) the correlation coefficient between the first pressure and the second pressure. The monitoring (e.g., tracking) of the prevention system may be performed continuously or intermittently. The prevention system may determine the sieve blockage when it detects the change (e.g., decrease) in the correlation coefficient. The prevention system may initiate a prevention operation when the correlation coefficient is below the threshold. The prevention operation may comprise (i) a notification or (ii) a procedure. The prevention operation may comprise (i) triggering an alarm, (ii) generating a report, (iii) generating an instruction, (iv) prescribing a remedial operation, (v) interrupting the printing or (vi) performing a (e.g., prescribed) remedial operation. The remedial operation may be performed automatically or manually (e.g., by an operator). The remedial operation may comprise an agitation scheme. The agitation scheme may be configured to vibrate the sieve. The agitation scheme may facilitate the accumulated remainder material passing through the sieve. The agitation scheme may facilitate unblocking the sieve. In some embodiments, the agitation scheme is performed without interrupting the printing operation. The agitation scheme may comprise utilizing vibrations, e.g., acoustic vibrations, e.g., ultrasound. The vibrations may be transmitted to the sieve, e.g., through an agitation transmitter. The agitation transmitter may comprise one or more waveguides. The agitation transmitter may be a part of, or operatively couple with, the sieve. While this paragraph describes using the environments of two different components of the material recycling system to detect sieve clogging, any atmosphere downstream (e.g., after) the clogged sieve, as compared to any atmosphere upstream (e.g., before) the clogged sieve, may be utilized for the comparison. For example, a first pressure sensor may be disposed in the sieve enclosure downstream of (e.g., after) the sieve, and a second pressure sensor may be disposed in the sieve enclosure upstream of (e.g., before) the sieve, with before and after being with respect to the direction of the material flowing route in the sieve enclosure relative to placement of the sieve. The second sensor may be disposed in an upstream component disposed between the sieve and the manufacturing enclosure. The second sensor may be disposed in the cyclone, or in a channel such as a channel between the cyclone and the sieve enclosure. The first sensor may be disposed in a downstream component disposed after the sieve. The first sensor may be disposed in the material reservoir, or in a channel such as a channel between the material reservoir and the sieve enclosure.

In some embodiments, the material recycling system (e.g., sensors thereof) are operatively coupled with a prevention system. The prevention system may be part of, or operatively coupled with the control system of the manufacturing system. The prevention system may monitor a degree of pressure fluctuations, e.g., according to one or more sensors. Monitoring the degree of pressure fluctuations may comprise utilizing a central tendency of pressures inside one or more components of the three-dimensional printing system. Monitoring the degree of pressure fluctuations may comprise utilizing standard deviation of pressures inside one or more components of the three-dimensional printing system. The internal channel may be in fluid (gas) connection with an internal environment of the processing chamber. In an example, normal pressure fluctuation occur in the manufacturing enclosure. The normal pressure fluctuation may manifest in the pressure of the internal atmosphere of the inner channel. The interstitial space may be fluidly disconnected from the manufacturing enclosure, e.g., in a manner such that the pressure fluctuation of the manufacturing enclosure do not (e.g., detectibly) influence the interstitial pressure. When the inner channel wall(s) is/are in tact, the interstitial pressure may be separated, isolated, and/or not (e.g., greatly) influenced by the pressure fluctuations in occurring in the manufacturing enclosure, e.g., during the manufacturing operation. When wall(s) of the inner channel are damaged such that equilibration can occur between the inner channel and the interstitial space, the interstitial pressure may become influenced by the pressure fluctuations in the manufacturing enclosure. The prevention system may monitor pressure detected by the interstitial pressure sensor. The prevention system may act upon detection of pressure and/or pressure fluctuation above the threshold. The one or more components of the manufacturing (e.g. 3D printing) system may comprise the (i) manufacturing enclosure, (ii) gas conveyance system, (iii) material conveyance system, or (iv) recycling system. The material conveyance system may convey remainder material from the layer dispensing mechanism to the recycling system, e.g., through the inner channel. The prevention system may monitor standard deviation of the internal pressure of the one or more components. The prevention system may monitor a central tendency of the internal pressure of the one or more components. The prevention system may be deactivated when the standard deviation is below a threshold. The threshold may comprise (i) a value or (ii) a function. In some embodiments, the threshold comprises a value within a range of from about 1 kPa to about 5 kPa. The deactivation of the prevention system may be automatic and/or manual. In some embodiments, the prevention system is deactivated when the manufacturing system (e.g., three-dimensional printing system) is in an idle state.

In some embodiments, the material conveyance system comprises, or is operatively coupled with, one or more sensors. The sensors may sense at least one characteristic of an internal environment of a component of the material conveyance system. The at least one characteristic may comprise a temperature, pressure, gas makeup, gas flow or material. In some embodiments, the sieve enclosure comprises one or more sensors. The sieve enclosure and/or the material reservoir may comprise a pressure sensor. The pressure sensor may detect pressure inside the sieve enclosure. The pressure sensor may be configured to detect a sieve blockage and/or an accumulation of a remainder material on the sieve. The sieve enclosure may comprise a material (e.g., powder) level sensor. The material level sensor may sense a level (e.g., surface level) of the remainder material accumulated on the sieve. The material level sensor may comprise a contact material level sensor or a non-contact material level sensor. The material level sensor may comprise a capacitance material level sensor, float material level sensor, silo-pilot material level sensor, servo material level sensor, displacer material level sensor, ultrasonic material level sensor, guide wave radar material level sensor, laser material level sensor, or radiometric material level sensor. In an example, the material level senso is a guide wave radar (GWR) material level sensor. The material level sensor may comprise a waveguide. Pulses (e.g., electromagnetic wave pulses) may be conducted along the waveguide of the material level sensor. In some embodiments, the waveguide is configured to facilitate permeation of the remainder material (e.g., powder) inside the casing portion of the waveguide. At least a portion of the waveguide (e.g., the hollow member—the casing) may comprise pores. The one or more sensors may be operatively coupled with the prevention system. In some embodiments, the pressures sensor and the material level sensor are operatively coupled with the prevention system. The prevention system may initiate a prevention operation when the prevention system detects a disruption. In some embodiments, the disruption is detected when the level of the remainder material is above a threshold level. In some embodiments, the disruption is detected when the pressure inside the material reservoir deviates from the regular pressure (e.g., pressure pattern) during normal operation. In some embodiments, the disruption is detected when the strength of correlation between two or more pressures (e.g., between two or more pressure patterns) decreases below a threshold.

In some embodiments, the manufacturing enclosure is operatively coupled with (i) the material conveyance system and/or (ii) the gas conveyance system. The layer dispensing mechanism may be operatively coupled with (i) the material conveyance system and/or (ii) the gas conveyance system. The coupling (e.g., connection such as fluid connection) may be either with or without the intervention of at least one channel. The manufacturing system, e.g., three-dimensional (3D) printing system, may comprise a plurality of components. The component(s) may be coupled with or without a channel. The channel may comprise a single layered channel. The channel may comprise a plurality of layers, e.g., a plurality of casings. In some embodiments, the channel comprises two layers, e.g., an inner channel and an outer channel encasing at least a portion of the inner channel. The inner channel may be configured to enclose gas and a remainder material. The remainder material may be initially in the manufacturing enclosure. e.g., during, and/or after a manufacturing operation. The remainder material may flow through the inner channel—from one end of the channel to its opposing end. The remainder material may be carried by gas during its transit in the inner channel. The gas may comprise at least one characteristic different from an ambient atmosphere external to the 3D printing system, e.g., as disclosed herein. The at least one characteristic may comprise a temperature, pressure, gas makeup or gas flow. In some embodiments, the pressure inside the inner channel is greater than (e.g., about 16 kilopascal (kPa) above) the pressure of the ambient atmosphere. The remainder material may comprise a residual starting material of one or more 3D objects. The starting material may comprise elemental a metal, a metal alloy, a ceramic, an allotrope of elemental carbon, or a polymeric material. The starting material may comprise a metallic powder, e.g., comprising elemental metal or metal alloy. The gas and the remainder material may (e.g., at least in part) cause damage to the inner pressure. The damage may comprise friction, erosion, hole, or puncture. The outer channel may encase (e.g., surround) at least a portion of the inner channel. The outer channel may be configured to enclose and/or flow the remainder material when the inner channel malfunctions. A malfunction of the inner channel may cause a spillage of the remainder material and/or gas from the inner channel outwards and into an interior space of the outer channel, the outer channel having a larger FLS (e.g., diameter) compared to the FLS (e.g., diameter) of the inner channel. In some embodiments, the inner channel and the outer channel are concentric. The inner channel and the outer channel may form an interstitial space (e.g., gap space) between an external surface of the inner channel and an internal surface of the outer channel. The interstitial space may be configured to (i) hold a pressure different from an ambient pressure of the ambient environment (e.g., overpressure) or (ii) be open to an ambient environment external to the outer channel, e.g., an external to the manufacturing system such as a 3D printer. In some embodiments, the interstitial pressure is configured to hold a pressure different from an ambient pressure of the ambient environment, e.g., overpressure. The outer and/or inner passage may be gas tight, hermetic, and/or sealed. The pressure in the interstitial space (also herein “interstitial pressure”) may be established upon and/or before an operation. The interstitial pressure may be above the pressure of the ambient atmosphere. The interstitial pressure may be at most about 8 kPa, 6 kPa, 5.5 kPa, 5 kPa, 4.5 kPa, 4 kPa, 3 kPa, or less, above the pressure of the ambient atmosphere. The interstitial pressure may comprise any value between the aforementioned values, e.g., from about 3 kPa to about 8 kPa, or from about 4.5 kPa to about 5.5 kPa. In some embodiments, the interstitial space (e.g., interstitial volume) is open to the ambient environment.

In some embodiments, the outer channel is equipped with one or more restrictors configured to restrict flow of gas therethrough. The one or more restrictors may be configured to enhance the accuracy of damage detection within the prevention system. The one or more restrictors may comprise one or more orifices, e.g., respectively. The one or more restrictors may be configured to facilitate the interstitial pressure equilibration efforts with the pressure of the ambient atmosphere. The one or more restrictors may have a smaller FLS compared to materials (e.g., particulate matters such as powder) flowing in the channel (e.g., inner channel). In an example, the restrictors have FLS smaller than about 80 μm, 50 μm, 40 μm, or 20 μm. The inner channel may comprise damage comprising a defect or other type of (e.g., structural) damage. The damage may be (i) a harmful damage or (ii) an insignificant damage. An insignificant damage in the internal channel wall(s) may allow pressure equilibration efforts between the inner atmosphere of the inner channel and the interstitial atmosphere, e.g., allow gas flow therebetween. Such equilibration efforts may cause the interstitial atmosphere to have coupled and/or associated pressure alteration with internal atmosphere of the inner channel and/or of the manufacturing enclosure, e.g., which pressure fluctuations may be sensed by the interstitial pressure sensor. The sensed interstitial pressure change(s) may cause triggering of the detection system, and since the damage is insignificant, this may constitute a false trigger. Implementation of the restrictor(s) disposed between the interstitial space and the ambient atmosphere, may reduce such false triggering the detection system. The restrictors equipped in the outer channel may be configured to (i) equilibrate the pressure changes in the interstitial space caused by the insignificant damage with the ambient pressure, and (ii) confine the pressure changes in the interstitial space caused by the harmful damage within the interstitial space. The harmful damage may comprise a hole or a puncture having larger FLS than a particle of the material, e.g., central tendency thereof. The particle may be a powder particle, wherein the flowing material is powder. The harmful damage may cause an ejection from the inner channel, the ejection being of gas and of the material transiting through the internal channel. The ejection may cause the interstitial pressure to rise. The channel may comprise, or may be operatively couple with, a pressure sensor sensing the interstitial pressure. The pressure sensor may be operatively coupled with the prevention system. The prevention system may initiate a prevention operation (e.g., as disclosed herein) when the interstitial pressure is above a threshold. The insignificant damage may comprise damage that excludes ejection of material (e.g., particle) from the inner channel. The insignificant damage may comprise damage (e.g., hole or puncture) smaller than a single particle (e.g., powder) of material, e.g., or a central tendency thereof. The inner channel may facilitate gas permeation excluding ejection of material from the inner channel. The restrictor(s) may be configured to facilitate equilibration efforts between the interstitial pressure and the pressure of the ambient atmosphere. The insignificant damage and/or gas permeation may or may not be detected by the prevention system. The insignificant damage may not cause interruption to the operation of the manufacturing system. The restrictor(s) may comprise a linear flow restrictor or quadratic flow restrictors. The linear flow restrictor may be based at least in part on viscous flow restriction. The amount of fluid (e.g., gas) that flows through the restrictor from the interstitial space to the ambient atmosphere (e.g., external to the manufacturing system) per unit time may depend at least in part (i) on the flow rate of the restrictor(s) and/or (ii) on the pressure difference between the interstitial pressure and the ambient pressure. In an example, the amount of fluid (e.g., gas) that flows through the restrictor from the interstitial space to the ambient atmosphere per unit time may depend at least in part (i) on the flow rate of the restrictor(s) and (ii) on the pressure difference between the interstitial pressure and the ambient pressure. The flow rate of the restrictor may be defined as fluid velocity flowing through the restrictor between two distinct spaces with a pressure differential. The flow rate of the restrictor may be at least about 0.05 milliliter/minute/kilopascal (ml/min/kPa), 0.1 ml/min/kPa, 0.2 mL/min/kPa, 0.5 mL/min/kPa, 1 mL/min/kPa, or more. The flow rate may be at most about 8 mL/min/kPa, 9 mL/min/kPa, 9.5 mL/min/kPa, 10 mL/min/kPa, 10.5 mL/min/kPa 11 mL/min/kPa, or less. The flow rate may have any value between the aforementioned values e.g., between about 0.05 mL/min/kPa and about 11 mL/min/kPa, or between about 1 mL/min/kPa and about 10 mL/min/kPa, “between” being inclusive. The fluid velocity of flow from the interstitial space to the ambient atmosphere may be defined as the product of (i) the flow rate of the restrictor(s) and (ii) the pressure difference between the interstitial space and the atmosphere. In some embodiments, when the flow rate of the restrictor is about 1.25 mL/min/kPa and the pressure difference between the interstitial pressure and the ambient pressure is about 8 kilopascals (kPa), the fluid velocity from the interstitial space to the ambient atmosphere is about 10 mL/min. The fluid velocity may be appropriate to (i) equalize the pressure changes within the interstitial pressure caused by gas permeation or insignificant variation with the ambient pressure, and (ii) confine the pressure changes within the interstitial pressure caused by harmful damage. The flow restrictor may comprise a linear flow restrictor or a quadratic flow restrictor.

In some embodiments, the channel comprises, or is operatively coupled with, one or more sensors. The one or more sensors may sense at least one characteristic of (i) an internal atmosphere of the inner channel, and/or (ii) an atmosphere of the interstitial space between the inner channel and an outer channel encasing at least a portion of the inner channel. The one or more characteristic may be any disclosed herein, e.g., the one or more characteristic may comprise a temperature, a pressure, gas flow, gas makeup, flow rate, or concentration of remainder material. In some embodiments, the channel comprises one or more interstitial sensors. The interstitial sensors may comprise a pressure sensor, an optical sensor, a sonic sensor, an electrical sensor, a temperature sensor, or any combination thereof. The interstitial sensors may comprise a proximity sensor. The interstitial sensors may comprise a sensor configured to sense the remainder material in the interstitial space, e.g., a chemical sensor. In some embodiments, the interstitial sensor is configured to sense the remainder material as it interacts with the internal surface of the outer channel and/or with the external surface of the inner channel. The interstitial sensors may comprise (a) a pressure sensor configured to sense the interstitial pressure of the interstitial space, or (b) a sensor configured to sense static electricity. The interstitial pressure may alter (e.g., rise) when the inner channel malfunctions. The malfunction of the inner channel may comprise ejection of the material and/or gas from the inner channel into the interstitial space. The ejection may be (e.g., at least in part) caused by the harmful damage. The harmful damage may comprise a hole or a puncture having larger FLS than a single particle (e.g., powder) of the material. During normal operation, the interstitial pressure may (i) be (e.g., substantially) same as the pressure of the ambient atmosphere, or (ii) be greater than the pressure of the ambient atmosphere. The interstitial pressure may change when there is harmful damage in the inner channel. In some embodiments, the interstitial pressure is, during normal operation, at most about 5 kPa above the pressure of the ambient atmosphere. In some embodiments, the interstitial pressure rises, during faulty operation, to about 16 kPa above the pressure of the ambient atmosphere external to the 3D printing system. The interstitial sensor(s) may be operatively coupled with the prevention system. The prevention system may monitor (e.g., track) the interstitial pressure. The prevention system may be configured to initiate a prevention operation when the pressure in the interstitial space changes above a threshold value and/or function. The prevention operation may comprise (i) triggering an alarm, (ii) generating a report, (iii) generating an instruction, (iv) prescribing a remedial operation, or (vi) performing a (e.g., prescribed) remedial operation. The remedial operation may be performed automatically and/or manually, e.g., by an operator. The remedial operation may be performed before a subsequent manufacturing cycle, e.g., between the manufacturing cycles such as printing cycles. The prevention operation may not interrupt the operation of the printing system.

In some embodiments, the inner channel comprises, or is operatively coupled with, one or more inner sensors. The inner sensors may comprise a sensor configured to sense an inner pressure of the inner atmosphere of the inner channel. The inner channel may be operatively coupled with (i) the manufacturing enclosure, (ii) pneumatic loop(s), and/or (iii) a layer dispensing mechanism. The pneumatic loop(s) may be part of a gas conveyance system and/or a material conveyance system. The inner pressure may change (e.g., fluctuate) over time, the inner pressure being of (i) the manufacturing enclosure, (ii) pneumatic loop(s), and/or (iii) a layer dispensing mechanism. During normal operation, the remainder material flowing inside the inner channel may be enclosed by the inner channel. During normal operation, the interstitial pressure may be (e.g., substantially) stable over time. The interstitial pressure may be different than the ambient pressure. The interstitial pressure may be (i) (e.g., substantially) identical to the ambient pressure external to the manufacturing system, or (ii) above the atmospheric pressure and below the inner pressure of the inner channel. In some embodiments, the outer channel comprises one or more restrictors. The interstitial pressure may equilibrate with the pressure of the ambient atmosphere. The interstitial pressure may be (e.g., substantially) same as the pressure of the ambient atmosphere. The interstitial pressure may not correlate with the inner pressure during normal operation. The normal operation may comprise having insignificant damage in the inner channel. The insignificant damage may comprise (i) damage (e.g., a hole or crack) excluding ejection of the remainder material (e.g., powder) from the inner channel, or (ii) damage smaller than the restrictors (e.g., orifice) in the outer channel. At times, the inner channel may malfunction. The malfunction may be caused by harmful damage in the inner channel. The harmful damage may comprise (i) damage (e.g., a hole or crack) causing ejection of the material (e.g., powder) from the inner channel, or (ii) damage having a FLS that is (e.g., substantially) the same as or larger than the FLS of the restrictor (e.g., orifice) of the outer channel. The malfunction may cause ejection of the remainder material and/or gas from the inner channel to the interstitial space. During such faulty operation, the interstitial pressure may correlate with the inner pressure. The prevention system may be operatively coupled with the inner sensor and the interstitial sensor. The prevention system may initiate the prevention operation when the prevention system detects faulty operation. Faulty operation that has a high likelihood to lead to harm, or that are harmful, may be detected as a larger pressure difference between the pressure measure in the interstitial space and the ambient pressure. Faulty operation that has a low likelihood of leading to harm may be detected as a smaller pressure difference between the pressure measure in the interstitial space and the ambient pressure. The prevention system may be configured to react to the larger pressure difference detected, and avoid the lower pressure difference detected. In some embodiments, the larger difference in pressure may be a difference of at least about 1.5*, 2*, 5*, 10*, or 50* the smaller pressure difference, with “*” designating the mathematical operation of “times”. The prevention system may be configured to determine the faulty operation when (i) the interstitial pressure rises above a threshold or (ii) the interstitial pressure correlates with the inner pressure of the inner channel and/or of the manufacturing enclosure. The prevention system may be configured avoid detecting (e.g., not to detect) insignificant damage in the inner channel wall(s), and/or mere gas permeation through the channel wall(s), The prevention system may be configured to detect harmful damage, e.g., as disclosed herein. The restrictor(s) operatively coupled with the outer channel may be configured to facilitate the selective detection of harmful damage. In some embodiments, the restrictor(s) operatively coupled with the outer channel are configured to (i) equilibrate (or allow equilibration efforts of) pressure in the interstitial space caused by insignificant damages with the ambient pressure, and (ii) allow detection of pressure changes in the interstitial space caused by harmful damages, e.g., by confining sufficient extent (e.g., the substantial amount) of pressure changes to within the outer channel such as to the interstitial space. The prevention system may be configured to initiate the prevention operation when it detects the pressure changes in the interstitial space. The restrictor(s) may (e.g., at least in part) facilitate enhancing the accuracy of the prevention system in detecting damage in the inner channel wall(s) that are harmful or have a high likelihood to lead to harm. The prevention system may be configured to minimize the possibility for unwarranted disruptions (e.g., of low likelihood to result in harm) to the manufacturing system, with the aid of the restrictor(s) operatively coupled with the outer channel.

In some embodiments, a manufacturing system utilizes a starting material to manufacture one or more objects. A three-dimensional printing system may utilize a starting material to print one or more objects. The starting material may travel through one or more components of the manufacturing system. The starting material may be initially disposed in a manufacturing enclosure, e.g., at least during the manufacturing such as the printing. The starting material not utilized in the manufacturing may constitute a remainder material. The remainder material may travel through one or more components of the manufacturing system. The remainder material may travel through (i) the manufacturing enclosure, (ii) a material conveyance system, and/or (iii) a gas conveyance system. The manufacturing enclosure may be operatively coupled with (i) the material conveyance system and/or (ii) the gas conveyance system. The manufacturing enclosure may be in fluidic communication with (i) the material conveyance system and/or (ii) the gas conveyance system. The remainder material may be carried by a gas. The gas may comprise at least one characteristic that is different from that of the ambient atmosphere external to the printing system. In some embodiments, the gas comprises a lower concentration of a reactive agent compared to that of an ambient atmosphere external to the 3D printing. The reactive agent may comprise oxygen, water, hydrogen sulfide. The remainder material may be conveyed at least in part by pressure such as gas pressure. The remainder material may collide with (e.g., internal) surfaces of the mechanical (e.g. structural) components of the manufacturing system. The remainder material may comprise an elemental metal, a metal alloy, a ceramic, or an allotrope of elemental carbon. In some embodiments, the remainder material comprises a metallic powder. The one or more components of the manufacturing system may comprise (e.g., be made of) a material that has a hardness smaller than that of the starting material. In some embodiments, the channels comprise a flexible material, such as a polymer or a resin. Without wishing to be bound to theory, the flowing material may damage the surface of the structural components. The damage may comprise tear and/or wear. The damage may comprise scratching, marring, gouging, erosion, corrosion, abrasion, or otherwise chemically reacting. The structural component may comprise a coating on the (e.g., inner) surface. The coating may be configured to facilitate improvement of functionality of the components. The improvement of functionality may comprise (i) increasing hardness, (ii) increasing durability, (iii) increasing damage (e.g., corrosion) resistance, (iv) reducing adherence of the material to a surface of the coating, (v) generating a smooth surface of the coating, or (vi) any combination thereof. The smooth surface of the coating may facilitate improving cleanability of the coating. The coating may be applied by a method comprising anodizing, electroplating, galvanizing, or deposition. The deposition may comprise powder deposition, thermal deposition, thin layer deposition, or plasma deposition. The coating may comprise one or more materials. The coating may comprise a ceramic, an elemental metal, or a metal alloy. The coating may comprise a material that has a hardness (e.g., substantially) the same as, or greater than, the hardness of the flowing material, e.g., starting material and/or remainder material. The coating may comprise a material that has hardness of at least about 50 Rockwell Hardness scale C (HRc), 55 HRc, 60 HRc, 65 HRc, 70 HRc, 75 HRc, 80 HRc, 85 HRc, or 90 HRc. The hardness of the material may comprise any aforementioned values, for example, from about 50 HRc to about 90 HRc. The coating may comprise a durable metallic coating that is harder, stiffer, and/or more resilient, than an interior (e.g., bulk) of the components. More resilient may be relative to the damage (e.g., friction) of the surface by the flowing material (e.g., remainder material and/or starting material) during operation of the manufacturing system. The coating may comprise titanium nitride (TiN), chromium (e.g., hard chromium), or nickel (e.g., heat treated). The coating may adhere to the surface of the component exposed to the starting material and/or remainder material. The coating may be configured to adhere to a material from which the component is made of. The coating may be configured to withstand normal operation for a prolonged period of time. The prolonged period of time may be at least about 0.5 year (yr), 1 y, 5 y, or 10 y of standard operation of the manufacturing system such as the 3D printing system. The coating may comprise an exposed surface, e.g., exposed to the starting material and/or remainder material. The exposed surface of the coating may have a planarity having arithmetic average of roughness profile (Ra) of at least about 10 micrometer (μm), 20 μm, 50 μm, or 70 μm. The arithmetic average of roughness profile may comprise any aforementioned values, for example, from about 10 μm to about 70 μm. In some embodiments, the components comprise (e.g., are made of) a hardened tool steel. In an example, a cyclonic separator of the material conveyance system comprises the hardened tool steel. The hardened tool steel may be resilient to the damage caused by the flowing material. The components that comprise (e.g., are made of) hardened tool steel may be devoid of the coating.

In some embodiments, one or more components of the manufacturing system comprises the coating. One or more components of the three-dimensional (3D) printing system may comprise the coating. In some embodiments, the coating is applied to a surface of the components of (i) a material conveyance system and/or (ii) a gas conveyance system. The material conveyance system and/or the gas conveyance system may comprise a channel. The channel may convey the remainder material, the starting material, and/or gas between components. In some embodiments, a channel comprises an inner channel and an outer channel. The outer channel may encase at least a portion of the inner channel. The coating may be applied to (i) an internal surface of the inner channel, (ii) an external surface of the inner channel, (iii) an internal surface of the outer channel, and/or (iv) an external surface of the outer channel. The coating may be configured to protect the surfaces from damage. The damage may be caused (e.g., at least in part by) the pre-transformed material (e.g., remainder and/or starting material) flowing through the component(s). The inner channel and/or the outer channel comprise one or more materials. The inner channel may comprise a flexible material or a rigid material. The outer channel may comprise a flexible material or a rigid material. The inner channel and/or the outer channel may comprise a resin or a polymer. In some embodiments, the inner channel and/or the outer channel comprise PVC, polyurethane, or rubber. The inner channel and/or the outer channel may comprise a composite material. The inner channel and/or the outer channel may comprise two or more materials that do not constitute a composite material. The inner channel and the outer channel may comprise (e.g., substantially) the same material. The inner channel and the outer channel may comprise different materials. The inner channel may comprise a flexible structure or a rigid structure. The outer channel may comprise a flexible structure or a rigid structure. The inner channel and/or the outer channel may comprise a bellow. The inner channel and the outer channel may comprise (e.g., substantially) the same structure. The inner channel and the outer channel may comprise different structures. The inner channel and/or the outer channel may comprise a discharging material. The discharging material may be configured to discharge electricity such as static electricity. The electricity may be (e.g., at least in part) caused by the pre-transformed material flowing inside the channel, such as collision between particles and/or rubbing the particles onto a surface of the channel. The electricity (e.g., static electricity) may induce sparks. The material may comprise metallic particulates such as metallic powder. The discharging material may be configured to absorb and/or disperse the electricity caused by the material. The discharging material may facilitate reducing (e.g., preventing) static electricity and sparks. The discharging material may or may not conduct electricity. The discharging material may comprise (i) insulators, (ii) conductors, (iii) resistors, (iv) carbon-based materials, or (v) composite materials. In some embodiments, the discharging material comprises carbon black. In some embodiments, the discharging material comprises a metal, e.g., comprising an elemental metal or a metal alloy. The discharging material may have a structure comprising mesh, spiral, lattice, honeycomb, polygon, particulate, layer, pad, film, tape, or sheet. In some embodiments, the discharging material is in a structural configuration of mesh or spiral. The discharging material may be configured to (i) reinforce the channel and/or (ii) discharge unwanted electricity. The reinforcement may comprise (i) increasing hardness, (ii) increasing durability, (iii) increasing damage (e.g., corrosion) resistance, (iv) reducing adherence of the material to a surface of the channel, or (v) any combination thereof. The discharging material may be added to the surface of the channel. In some embodiments, the discharging material is applied to the internal surfaces of the inner channel and to the outer channel. The discharging material may be configured to reduce (e.g., at least during operation) the static electricity and sparks. The static electricity and/or sparks may be induced by flow (e.g., collision) of the remainder material through the channel. The discharging material may be grounded, e.g., to the ground or to grounding system.

In some embodiments, at least one object (e.g., 3D object(s)) is manufactured (e.g., printed) during the manufacturing (e.g., printing) procedure. The 3D object(s) may be printed in a manufacturing enclosure of a 3D printing system. The manufacturing enclosure may comprise a material bed such as a powder bed. The material bed may be supported by a build platform disposed in the manufacturing enclosure. The material bed may comprise a starting material, e.g., pre-transformed material such as powder. The manufacturing enclosure may be operatively coupled with one or more energy sources such as lasers. The one or more energy sources may provide one or more energy beams such as laser beams. The energy beam(s) may transform at least a portion of the material bed (e.g., a layer (e.g., first layer) of the starting material) to print at least a portion of the 3D object. The energy beam(s) may be directed to a target surface, e.g., surfaces of the starting material, an exposed surface of the material bed, and/or a surface of the 3D object. The material bed may have a (e.g., substantially) planar exposed surface. The exposed (e.g., top) surface of the material bed may be leveled, e.g., before the energy beam is applied. Any suitable technique of leveling operation (e.g., as described herein) may be used. In some embodiments, the leveling operation comprises use of a leveling mechanism or use of a material removal mechanism. In an example, the leveling mechanism comprises vibrating the material bed and/or material dispensed by a dispenser, e.g., as part of a layer dispensing mechanism. The energy beam may impinge on the exposed surface of the material bed to transform a portion (e.g., a portion of a layer) of the starting material (e.g., pre-transformed material) to form a portion (e.g., corresponding layer) of transformed material that hardens to generate a portion of the 3D object. The transformation process may generate debris as a byproduct. The debris may be disposed on the material bed, within the material bed, and/or on the 3D object. In some embodiments, the energy of the energy beam(s) facilitates an ejection of the pre-transformed, transformed, and/or transforming material from the target surface and land (e.g., splatter) on surrounding regions of the material bed and/or 3D object. The debris may comprise transformed (e.g., hardened) material, partially transformed (e.g., partially hardened) material, soot, or any combination thereof. The debris may comprise aggregated, agglomerated, sintered and/or fused starting material, e.g., pre-transformed material such as powder. The debris particles may have a shape and a size. The debris particles may have regular and/or irregular (non-symmetric) shapes. In some embodiments, the debris particles have globular (e.g., spherical or non-spherical) shapes. The debris particles may be smaller (e.g., have smaller FLS) than the 3D object. The debris may have a FLS that is smaller and/or larger than a central tendency (e.g., average) FLS of the pre-transformed material that is a particulate material. In some embodiments, the debris particles are larger (e.g., have larger FLS) than the pre-transformed particles, as described herein. Larger may be by at least two times the FLS of the pre-transformed material particles. The debris particles may be smaller (e.g., have smaller cross-sections (e.g., diameters)) than a central tendency of a height of a layer (e.g., first layer) of the starting material, e.g., as described herein. In some embodiments, the debris particles have a central tendency of the FLS of at least about 50 micrometers (μm), 80 μm, 100 μm, 110 μm, 120μ, 130 μm, 140μ, 150 μm, 200 μm, 250 μm, 300 μm, 400 μm, 500 μm, 800 μm, 1000 μm, or 2000 μm. The debris particles may have a FLS ranging between any of those listed above (e.g., from about 50 μm to about 2000 μm, from about 50 μm to about 250 μm, or from about 250 μm to about 2000 μm). The debris may interfere with subsequent formation (e.g., printing) of the 3D object. In some embodiments, the debris causes defects (e.g., voids, inconsistencies, and/or surface roughness) in a subsequently formed portion (e.g., subsequent layer(s)) of the 3D object. The 3D object may be suspended in the material bed between layering procedures of a 3D printing operation. At least a portion of the 3D object may (i) be buried within the material bed, (ii) have a surface exposed to an atmosphere inside the manufacturing enclosure, or (iii) protrude from the exposed surface of the material bed. In some embodiments, a portion of the 3D object protrudes from the exposed surface of the material bed, e.g., by a distance such as a vertical distance. A new layer (also referred to as a layer, an additional layer or a second layer) may be deposited on the material bed (e.g., above the layer (e.g., first layer) corresponding to the previous exposed surface of the material), such as for a succeeding operation. Any suitable material deposition process can be used, e.g., as described herein. In some embodiments, a material dispensing mechanism (e.g., material dispenser, e.g., as described herein) is used. The material dispensing mechanism may utilize gravitational force and/or gas flow that (also) displaces (e.g., and partially planarizes) the newly added material. The additional layer may be deposited over at least a portion of the 3D object and/or the debris. In some embodiments, the additional layer does not have a planar exposed surface. A succeeding optional leveling (e.g., planarization) operation may planarize the exposed surface of the additional layer. Any suitable material deposition process may be used, e.g., as disclosed herein. In some embodiments, the leveling mechanism (e.g., leveler) is used. In some embodiments, the leveling mechanism contacts (e.g., by shearing) the additional layer, e.g., using an edge (e.g., sharp edge or knife) or a roller. In some embodiments, the layer dispensing mechanism includes, or is operatively coupled with, a vibrating mechanism that vibrates the and/or the material bed. The leveling mechanism may reduce a thickness of the additional layer. A succeeding material removal mechanism may remove a portion of the additional layer. Any suitable material removal process, as described herein, may be used. The material removal mechanism may be part of a leveling operation. The removed material may be recycled using a material recycling system, as described herein. In some embodiments, the material removal mechanism is operatively coupled with the material recycling system. The removed material may be directed to the material recycling system via the material removal mechanism. The material removal mechanism may contact the additional layer, or not contact (e.g., hover above) the additional layer. The material removal mechanism may provide an attractive force provided by an attractive force source. The attractive force may create an attractive flow (e.g., comprising a vertical flow component) within the material bed and/or surrounding gas proximate to the material removal mechanism. The attractive flow may remove a portion of the material from the material bed and into the material removal mechanism (e.g., nozzle). The attractive force may comprise vacuum force, magnetic force, electric force, electrostatic force, or any other suitable type of attractive force as described herein. In some embodiments, the attractive flow forms a chaotic flow (e.g., comprising turbulence), in a proximity of the attractive flow (e.g., vertical flow) into the material removal mechanism. In some embodiments, the attractive flow forms a non-turbulent (e.g., laminar) flow in a proximity of the attractive flow (e.g., vertical flow) into the material removal mechanism. The chaotic flow and/or non-turbulent flow may be (i) on and/or in the material bed, (ii) within an upper portion (e.g., near or at the exposed surface) of the additional layer, (iii) within one or more previously deposited layers (e.g., first layer) of the material bed, (iv) within an atmosphere above the material bed (e.g., above the additional layer), or (v) any combination of (i) to (iv). The chaotic flow may be in a volume comprising the exposed surface of the material bed. The chaotic flow and/or non-turbulent flow may (i) introduce flows of gas (e.g., from the surrounding atmosphere) on and/or into the material bed (e.g., the additional layer), (ii) introduce flows of material (e.g., from the material bed) into the adjacent atmosphere, (iii) cause mixing (e.g., reshuffling) of at least an outermost (e.g., top) portion of the material bed (e.g., additional layer), (iv) cause mixing within the additional layer or a portion thereof, (v) cause mixing within previously deposited layers (e.g., first layer) of the material bed. The chaotic flow and/or non-turbulent flow may cause at least a portion of the debris to (i) move on and/or within the material bed, or (ii) be removed from the material bed by the flow (e.g., vertical flow) into the material removal mechanism. In some embodiments, the chaotic flow and/or non-turbulent flow causes at least a portion of the debris to move to within a region affected by the attractive flow (e.g., vertical flow) and into the material removal mechanism. The debris may become entrained within the attractive flow and into the material removal mechanism. At least a portion of the debris from (e.g., the exposed surface of) may be removed from the material bed. This removal of the at least a portion of the debris may reduce (e.g., prevent) an occurrence of defects in and/or on the 3D object (e.g., final 3D object). The removed material may be recycled in the material recycling system. The material recycling system may filter out at least some of the debris, e.g., using one or more separators (e.g., sieves and/or cyclones). The recycled material may (e.g., substantially) include the starting material, e.g., pre-transformed material such as powder. The recycled material may (e.g., substantially) preclude the debris. The recycled material may be used in subsequent layer forming operations. The material removal mechanism may remove at least about 70%, 80%, 90%, 95%, 97%, 98%, 99%, 99.5%, 99.8% or 99.9% of the debris within the material bed based on weight. The percentages may be calculated (i) volume per volume, or (ii) weight per weight. The material removal mechanism may remove the debris within the material bed to a percentage between any of the afore-mentioned values. In an example, the material removal mechanism removes from about 70% to about 99.9%, from about 80% to about 99.9%, from about 90% to about 99.9%, from 95% to 99.9%, or from 99.0% to 99.9% of the debris within the material bed based on weight. The exposed surface of the material bed may be (e.g., substantially) planar. The leveling mechanism that is performed previous to the material removal mechanism may (e.g., at least in part) facilitate forming of the (substantially) planar exposed surface. The material removal operation may or may not expose a portion (e.g., a protruding portion) of the 3D object. The thickness of the additional layer after the material removal mechanism (e.g., prior to a subsequent transformation operation) may vary depending on process requirements and/or system limitations. In some embodiments, a (e.g., central tendency such as average) thickness of the leveled additional layer is at least about 5 μm, 10 μm, 50 μm, 100 μm, 150 μm, 200 μm, 250 μm, 300 μm, 350 μm, 400 μm, 450 μm, or 500 μm. In some embodiments, the average thickness of the leveled additional layer can be at most about 700 μm, 500 μm, 450 μm, 400 μm, 350 μm, 300 μm, 250 μm, 200 μm, 150 μm, 100 μm, 50 μm, 10 μm, or 5 μm. The (e.g., central tendency of) thickness of the leveled additional layer is between any of the afore-mentioned (e.g., central tendency of) thickness values. The (e.g., central tendency of) thickness may be from about 5 μm to about 500 μm, from about 10 μm to about 100 μm, from about 20 μm to about 300 μm, or from about 25 μm to about 250 μm. After the additional layer is complete, another transformation operation may be performed (e.g., using an energy beam) to form another layer of the 3D object. The sequences may be subsequently until the printing of the 3D object is complete.

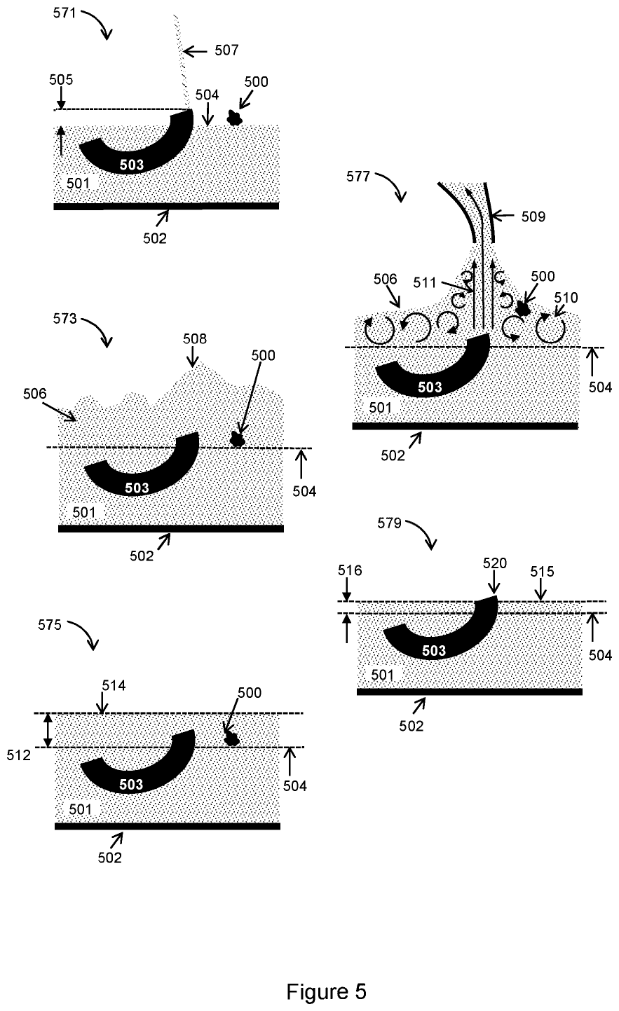

FIG. 5 show schematic examples of various stages of a layering method described herein. Example 571 shows a material bed 501 disposed on a build platform 502. The material bed 501 comprises an exposed surface 504. Energy beam 507 is directed to a target surface to form a 3D object 503. The 3D object 503 is suspended in the material bed 501. A portion of the 3D object 503 protrudes from the exposed surface 504 of the material bed 501 by a distance 505. The formation (e.g., printing) of the 3D object 503 causes debris 500 to form on the material bed 501. Example 573 shows an additional layer 506 deposited on plane 504 of the material bed 501. The plane 504 corresponds to the exposed surface of the material bed 501 in example 571. The additional layer 506 has an uneven surface 508. The debris 500 is buried in the additional layer 506. Example 575 shows the additional layer after a succeeding leveling mechanism. The additional layer on the plane 504 has a (e.g., substantially) planar exposed surface 514. The additional layer on the plane 504 has a reduced thickness 512 compared to example 573. Example 577 shows an example of a succeeding material removal operation. A portion of the additional layer 506 is removed from the material bed 501 by a material removal mechanism 509—depicting a nozzle thereof. The material removal mechanism 509 creates an attractive force. The attracted force creates an attractive flow 511 into the material removal mechanism 509. The attractive flow 511 forms a chaotic flow 510 such as a turbulent flow, in a proximity of the attractive flow 511. The debris 500 is entrained into the material removal mechanism 509 by the attractive flow 511 and/or the chaotic flow 510. Example 579 shows the additional layer after the material removal process. The additional layer of the material bed 501 has an exposed surface 515. The additional layer of the material bed 501 has a thickness 516. The thickness 516 of the additional layer in example 579 (e.g., after the material removal operation) is smaller than the thickness 512 of the additional layer in example 575, e.g., before the material removal operation.

In some embodiments, a 3D printing system comprises a material conveyance system. The material conveyance system may be operatively coupled with a manufacturing enclosure (e.g., comprising a processing chamber or a build module), an ancillary chamber, and/or a layer dispensing mechanism (also referred to herein as “layer dispenser”). The material conveyance system may comprise one or more components, e.g., structural components. The one or more components may comprise an external material source (e.g., a bulk feed), a bulk reservoir, one or more channels, or one or more valves. The one or more components of the material conveyance system may be replaceable, exchangeable, and/or modular. The material conveyance system may comprise, or is operatively coupled with, a material recycling mechanism. The material conveyance system may comprise, or be operatively coupled with, a material recycling system. The material recycling system may comprise a separator. The separator may comprise a cyclone (e.g., cyclonic separator), a sieve, or a pressure container such as a material reservoir. The sieve may be enclosed by a sieve enclosure. The pressure container comprises a remainder material and/or starting material, e.g., pre-transformed material such as powder. The material in the pressure container may be provided to the manufacturing enclosure for printing of at least one or more three-dimensional (3D) objects. The material may be conveyed into the pressure container from (i) the external material source (e.g., a bulk feed), (ii) the layer dispensing mechanism, (iii) the manufacturing enclosure, and/or (iv) the ancillary chamber. The layer dispensing mechanism may be configured to entrain the remainder material that is initially disposed in the manufacturing enclosure. The remainder material may be disposed in the manufacturing enclosure, e.g., at least during an operation. The remainder material may comprise the starting material that does not form a printed object. The ancillary chamber and/or the manufacturing enclosure may be operatively coupled with the material recycling system. The ancillary chamber and/or the manufacturing enclosure may comprise holes. The holes may be configured to flow away the remainder material to the material recycling system. The material recycling system may filter (i) the remainder material initially disposed in the manufacturing enclosure and/or (ii) the starting material from the external material source, e.g., before being introduced into the pressure container. The material recycling system may comprise a sieve or a cyclone. The cyclone may be operatively coupled with (i) the layer dispensing mechanism, (ii) the manufacturing enclosure, and/or (iii) the ancillary chamber. The cyclone may separate the remainder material from gas. The remainder material may be carried by gas. The gas may flow away into a gas conveying channel. The gas may be recycled by a gas recycling system. A gas conveyance system may comprise, or be operatively coupled with, the gas recycling system. The sieve may be enclosed by a sieve enclosure. The sieve enclosure may be operatively coupled with the cyclone, e.g., directly or by a channel. The sieve enclosure may be configured to accommodate the remainder material separated from the cyclone. The sieve may filter (e.g., sieve) the remainder material from debris. The debris may comprise a portion that has a fundamental length scale (FLS) smaller or larger than a central tendency of the FLS of the starting material. The sieved remainder material may be configured to flow away into the pressure container. The material accommodated in the pressure container may be utilized for a subsequent layer dispensing operation. The pressure container may be operatively coupled with the layer dispensing mechanism. In some embodiments, the pressure container is operatively coupled with a bulk container. The bulk container may be configured to contain the material from the pressure container. The bulk container may be operatively coupled with the pressure container, e.g., through a material conveying channel. The bulk container may be operatively coupled with another separator. The separator may be operatively coupled with the layer dispensing mechanism. The separator may comprise a sieve enclosure (e.g., comprising a sieve) or a cyclone. The cyclone may be operatively coupled with the bulk container. The cyclone may separate the material from the bulk container from gas. The cyclone may be operatively coupled with the layer dispensing mechanism, e.g., directly, through a channel, and/or through a sieve enclosure. In some embodiments, the separated material may be introduced into the sieve enclosure. The sieve may filter (e.g., sieve) the material from the debris. The sieved enclosure may be operatively coupled with the layer dispensing mechanism. The sieved material may be introduced into the layer dispensing mechanism, e.g., for the subsequent layer dispensing operation. The sieved material may be dispensed in the manufacturing enclosure by the layer dispensing mechanism. The material conveyance system may comprise one or more material conveying channels. The one or more components of the material conveyance system may be operatively coupled through the material conveying channels. In some embodiments, the sieve is operatively coupled with the external material source via a material conveying channel. The material conveyance system may comprise a plurality of material conveying channels. At least two of the plurality of material conveying channels may be (e.g., substantially) the same in at least one of channel characteristics. The channel characteristic may comprise a material from which the channel is constructed, cross-section, flow capacity, or internal surface finish. At least two of the plurality of material conveying channels may be different in at least one of the channel characteristics. The material conveying channel may convey the starting material and/or remainder material to one or more components of the material conveyance system. The material conveyance system may comprise a gas conveying channel. In some embodiments, the material conveyance system may comprise a plurality of gas conveying channels. The gas conveying channels may be fluidly coupled with the material conveyance system, e.g., to allow the flow of the remainder material. The gas conveying channel may facilitate conveyance of gas to one or more components of the material conveyance system. The gas may comprise a pressure. The gas conveying channel may equilibrate pressure and/or content within one or more components of the material conveyance system. In some embodiments, the gas conveying channel equilibrates a first atmosphere of the manufacturing enclosure with a second atmosphere of the external material source, separator, and/or pressure container. The first atmosphere and/or second atmosphere may be depleted of a reactive agent relative to its concentration in an ambient atmosphere external to the 3D printing system. The reactive agent (e.g., any reactive agent disclosed herein) may react with the starting material at least during the 3D printing. The reactive agent may comprise oxygen or humidity. The gas conveying channel may be operatively coupled with the one or more components of the material conveyance system. The gas conveying channel and/or material conveying channel may be a tube, hose, tunnel, duct, chute, or conduit.

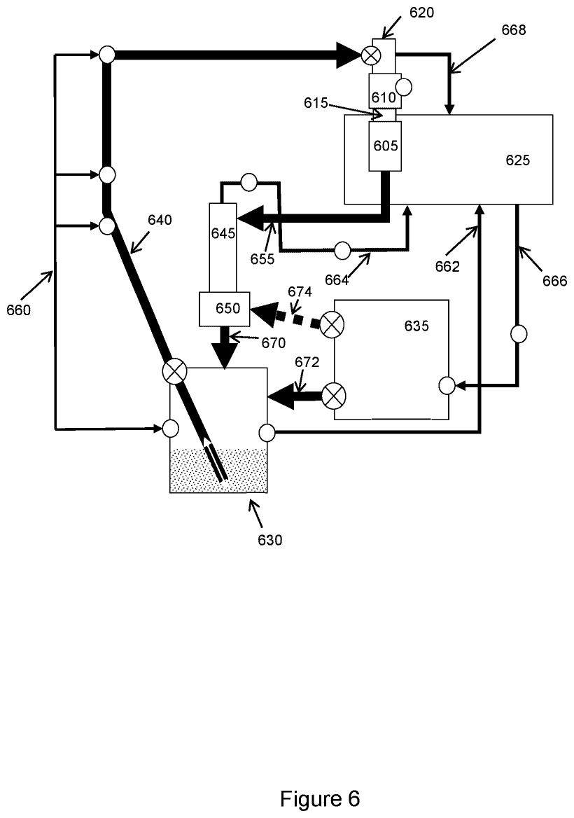

FIG. 6 shows an example of a material conveyance system. The material conveyance system is coupled with a manufacturing enclosure 625. The material conveyance system comprises (e.g., pressure) container 630. Container 630 comprises a pre-transformed material from (i) an external material source 635 and/or from (ii) a layer dispensing mechanism 605. The pre-transformed material is conveyed from the external material source 635 to the container 630 via a material conveying channel 672. The pre-transformed material is conveyed from the layer dispensing mechanism 605 to container 630. The pre-transformed material is conveyed (i) from the layer dispensing mechanism 603 to a first cyclone 645 via a material conveying channel 655, (ii) from the first separator 645 to a sieve 650, and (iii) from the sieve 650 to the pressure container 630 via a material conveying channel 670. The sieve 650 may filter the pre-transformed material conveyed from the external material source 635 to the sieve 650 via a material conveying channel 674. The pre-transformed material is conveyed from container 630 to the manufacturing enclosure 625. The pre-transformed (e.g., starting) material is conveyed (i) from container 630 to a secondary separator 620 via a material conveying channel 640, (ii) from the secondary separator 620 to a bulk reservoir 610, (iii) from the bulk reservoir 610 to the layer dispensing mechanism 605 via a channel 615. The material conveyance system comprises a plurality of gas conveying channels 660, 662, 664, 666, and 668. The material conveyance system comprises a plurality of valves. Each valve is coupled with (i) the material conveying channel or (ii) the gas conveying channel. In FIG. 6, material conveying channel valves are denoted by a white circle comprising an X, and gas conveying channel valves are denoted by a white circle.

In some embodiments, a material conveyance system is coupled with a manufacturing enclosure (e.g., a processing chamber) of a manufacturing system. The manufacturing enclosure may comprise, or be operatively coupled with, a layer dispensing mechanism. The starting material (e.g., pre-transformed material such as powder) from a material reservoir (e.g., pressure container) may be introduced into the layer dispensing mechanism. The layer dispensing mechanism may dispense a layer of the starting material to form at least a portion of a material bed. The material bed may be utilized for printing of one or more three-dimensional (3D) objects. Excess (e.g., residual) starting material (also referred to herein as “remainder material”) that is not utilized for the printing may be attracted away from the manufacturing enclosure, e.g., by using a material removal mechanism (also referred to herein as “remover”) the layer dispensing mechanism. The remainder material may be introduced into one or more separators. The separator may comprise a centrifuge. The separator may comprise a cyclone (e.g., cyclonic separator) or a sieve. The cyclone may comprise a centrifuge, or operate as a centrifuge. The separator may further comprise a material reservoir configured to accommodate the recycled remainder material. The sieve may be enclosed by a sieve enclosure. The material reservoir may be operatively coupled with the sieve enclosure. The remainder material may be introduced into the cyclone. The cyclone may be configured to separate the remainder material from gas. The gas may carry the remainder material into the cyclone. The gas may comprise at least one characteristic different than that of an ambient atmosphere external to the 3D printing system. The at least one characteristic may comprise a pressure, a temperature, a gas makeup, or a level of reactive agent. In some embodiments, the gas comprises less concentration of the reactive agent than that of the ambient atmosphere external to the 3D printing system. The reactive agent may be configured to react with the starting material and/or with the remainder material, e.g., at least during the printing. The reactive agent may comprise water, oxygen, or hydrogen sulfide. In some embodiments, the cyclone comprises an overflow cyclone. The gas separated from the remainder material through the cyclone may flow through a gas conveying channel. The separated gas may (i) be released to the outside of the 3D printer, (ii) recirculate through gas conveying channels, and/or (iii) be introduced into one or more components of the manufacturing system (e.g., of the manufacturing enclosure thereof). The separated remainder material may be introduced into a sieve. The sieve may filter (e.g., sieve) the remainder material from debris. The debris may comprise material (e.g., particulate matter) having a fundamental length scale (FLS) larger than a central tendency of the FLS of the starting material. The sieved remainder material may be introduced into a material reservoir, e.g., followed by gravitational flow. In some embodiments, the recycling system comprises a plurality of separators. The recycling process may be performed multiple times. The recycling process may comprise a separation (e.g., by the cyclone) or a filtration (e.g., by a sieve). The recycled remainder material may flow back into the layer dispensing mechanism. The material conveyance system may comprise one or more material conveying channels. The material conveying channels may be coupled with one or more components of the manufacturing system such as a 3D printing system. The one or more components of the manufacturing system may comprise the layer dispensing mechanism, cyclone, sieve enclosure, material reservoir, or manufacturing enclosure. The material conveyance system may comprise, or be operatively coupled with, one or more pumps (e.g., displacement pump and/or compressor). The pumps may facilitate (e.g., partially enable) the flow of the starting material. The material conveyance system may comprise, or be operatively coupled with, one or more temperature regulators. The temperature regulators may comprise a heat exchanger, heater, or radiator such as a radiant plane. The temperature regulators may facilitate (e.g., partially enable) regulating (e.g., maintaining) the temperature of the starting material to a requested temperature. Conveyance of the remainder material may utilize and/or cause pressure differentials. The material conveyance system may comprise, or be operatively coupled with, one or more venturi nozzles. The venturi nozzle may be configured to facilitate suction of the remainder material from the material reservoir to the separator. The suction may comprise, at least in part, flow of the starting material against gravitational force. The material conveyance system may comprise a condensed gas source, e.g., a blower or a cylinder of condensed gas. The condensed gas source may facilitate (e.g., partially enable) the flow of the material against gravitational force. The material may be conveyed by using (i) dilute phase conveyance and/or (ii) dense phase conveyance. The material conveyance system may comprise one or more heat exchangers. The material conveyance system may comprise one or more filters. The material conveyance system may be operatively coupled with a gas conveyance system. The gas conveyance system may comprise a gas recycling system. The gas conveyance system may comprise one or more gas conveying channels, pumps, or filters. The gas conveyance system may be configured to circulate (e.g., recirculate) gas with respect to the manufacturing enclosure. The gas conveyance system may sweep at least a portion of debris away from the process area (e.g., manufacturing enclosure). The debris may be collected on a filter of the gas conveyance system. Cleaner gas may be sent back (e.g., using a pump) through one or more gas conveying channels of the gas conveyance system to the manufacturing enclosure. The cleaner gas may comprise a lower concentration of debris (e.g., gas borne debris) compared to the gas exiting from the manufacturing enclosure. The gas conveyance system may comprise, or be operatively coupled with, one or more pumps, such as a displacement pump or compressor. The gas conveyance system may comprise, or be operatively coupled with, one or more temperature regulators. The temperature regulators may comprise a heat exchanger, heater, or radiator such as a radiant plane. The temperature regulators may facilitate (e.g., partially enable) regulating (e.g., maintaining) the temperature of the gas to a requested temperature. In some embodiments, the temperature regulators are operatively coupled with the gas conveying channels between the pumps. The material conveyance system and/or the gas conveyance system may operate at a pressure above the pressure of the ambient atmosphere external to the 3D printer. In some embodiments, the pressure in the material conveyance system and the gas conveyance system is at least about 3 kilopascal (kPa), 5 kPa, 8 kPa, 10 kPa, 12 kPa, 14 kPa, 16 kPa, 18 kPa, or 20 kPa, above atmospheric pressure. The pressure may be controlled (e.g., maintained) in the manufacturing enclosure, ancillary chamber, gas conveyance system, and/or material conveyance system. At times, a pressure differential may be required to convey the material from one compartment of the 3D printer to another. The pressure differential may be established via pressurizing or vacuuming one or more compartments. In some embodiments, the remainder material from the layer dispensing system to the material recycling system is conveyed using pressure differentials. The pressure differential may comprise (i) induced pressure differential among components, (ii) pressure isolation of the components, and (iii) induced pressure equilibration of components.

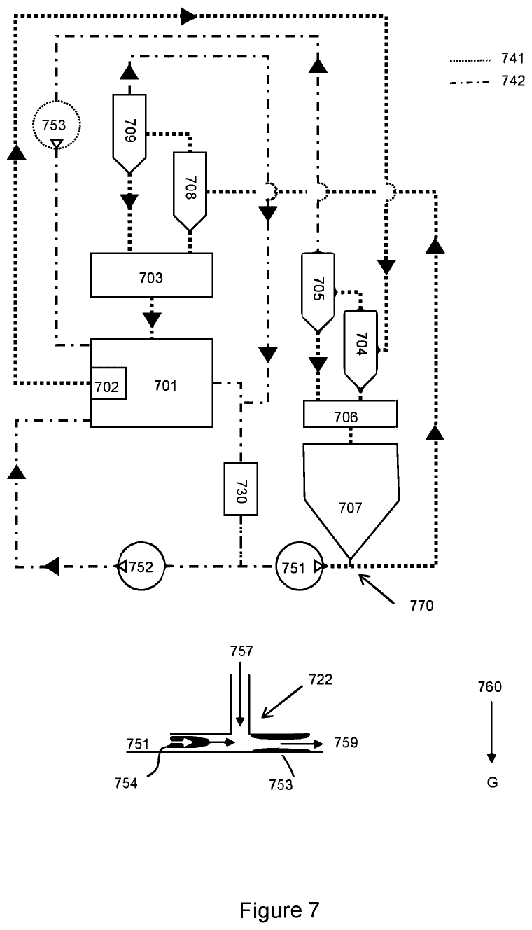

FIG. 7 shows an example of a portion of a manufacturing system that is a 3D printing system. A manufacturing enclosure is operatively coupled with a material conveyance system. A layer dispensing mechanism 702 is operatively coupled with manufacturing enclosure 701. The layer dispensing mechanism 702 may dispense a starting material to form at least a portion of a 3D object. Excess of the starting material (e.g., residual material or remainder material) that does not form the 3D object is entrained away from manufacturing enclosure 701 by the layer dispensing mechanism 702. The remainder material is moved through a material conveying channel 741. The remainder material is introduced into cyclones 704 and 705. The remainder material is moved from the cyclones 704 and 705 into a sieve 706 through a material conveying channel 741. The remainder material is moved from the sieve 706 into a reservoir 707 through a material conveying channel 741. Gas separated from the remainder material by the cyclones 704 and 705 is introduced into the manufacturing enclosure 701 through a gas conveying channel 742. A pump 753 is operatively coupled with the gas conveying channel 742. The remainder material in the reservoir 707 is moved into cyclones 708 and 709, through a material conveying channel 741. The remainder material is delivered into a reservoir 703 through a material conveying pipe 741. The remainder material in the reservoir 703 is delivered back into the layer dispensing mechanism 702, through a material conveying pipe 741. The gas separated from the remainder material by the cyclones 708 and 709 flows through a gas conveying channel 742. The gas is (i) introduced into manufacturing enclosure 701 and/or (ii) incorporated into a gas flow of another gas conveying pipe 742. The gas conveying channel 742 is operatively coupled with a pump 752 and a filter 730. A venturi nozzle 753 is disposed near junction 770. A magnified view of junction 770 is shown in 722. The venturi nozzle 753 is introduced in a channel. The channel is opposing to a gas inlet 754 and normal to a material inlet 757. The remainder material descends gravitationally towards gravitational center G along vector 760 through the material inlet 757. A pump 751 is operatively coupled with gas inlet 754. The remainder material flows in a direction of 759.

In some embodiments, a manufacturing (e.g., three-dimensional printing) system comprises a material conveyance system. The material conveyance system may comprise a bounceable plate enclosure, or at least one separator. The separator may comprise a sieve, a cyclone, or a material reservoir, e.g., hopper. A bounceable plate may be disposed in the bounceable plate enclosure. The bounceable plate enclosure may form a pressure boundary that encloses an atmosphere different from an ambient atmosphere external to the printing system. An internal atmosphere within the bounceable plate enclosure may comprise a lower concentration of one or more reactive agents compared to the ambient atmosphere external to the printing system. The reactive agents may be configured to react with a starting material and/or a remainder material. The reactive agents may comprise oxygen, water or hydrogen sulfide. The internal atmosphere within the bounceable plate enclosure may have a pressure greater than the pressure of the ambient atmosphere external to the bounceable plate. The bounceable plate enclosure may be configured to accommodate the remainder material. The remainder material may be initially disposed in the manufacturing enclosure, e.g., during and/or after the printing. The remainder material may be entrained from (i) the manufacturing enclosure, (ii) an ancillary chamber, and/or (iii) a layer dispensing mechanism. The layer dispensing mechanism may be disposed in the ancillary chamber, e.g., during its resting position. The bounceable plate enclosure may comprise at least one inlet opening. The at least one inlet opening may be configured to operatively couple with one or more components of the three-dimensional (3D) printing system. The at least one inlet opening may be operatively coupled with (I) the manufacturing enclosure, (II) the ancillary chamber, (III) the layer dispensing mechanism, and/or (IV) the separator (e.g., cyclone(s)). The bounceable plate enclosure may comprise at least one outlet opening. The at least one outlet opening may operatively be coupled with a sieve enclosure. The sieve enclosure may enclose the sieve. The material (e.g., remainder material) disposed on the bounceable plate may be displaced during its operation (e.g., during its bouncing motion). The sieve enclosure may comprise a closure (e.g., door or window) that closes an opening of the sieve enclosure. The closure may engage and/or disengage with the sieve enclosure. The closure may be gas tight. The closure and/or sieve enclosure may comprise at least one section that is transparent section. The transparent section may comprise a glass or a polymer. A sensor may be employed to sense the remainder material (e.g., powder) falling off from the bounceable plate in a material fall. The sensor may comprise a temperature sensor, an optical density sensor, a pulsed waveguide, a reader, a proximity sensor, a contact sensor, or a weight sensor. Examples of powder sensors such as pulsed waveguides, 3D printers, related control system, related methods, apparatuses, systems, and program instructions (e.g., software), can be found in International Patent Application Serial No. PCT/US22/53881 filed on December 22, titled “MATERIAL DETECTION, CONVEYANCE, AND CONDITIONING SYSTEMS,” which is incorporated herein by reference in its entirety.

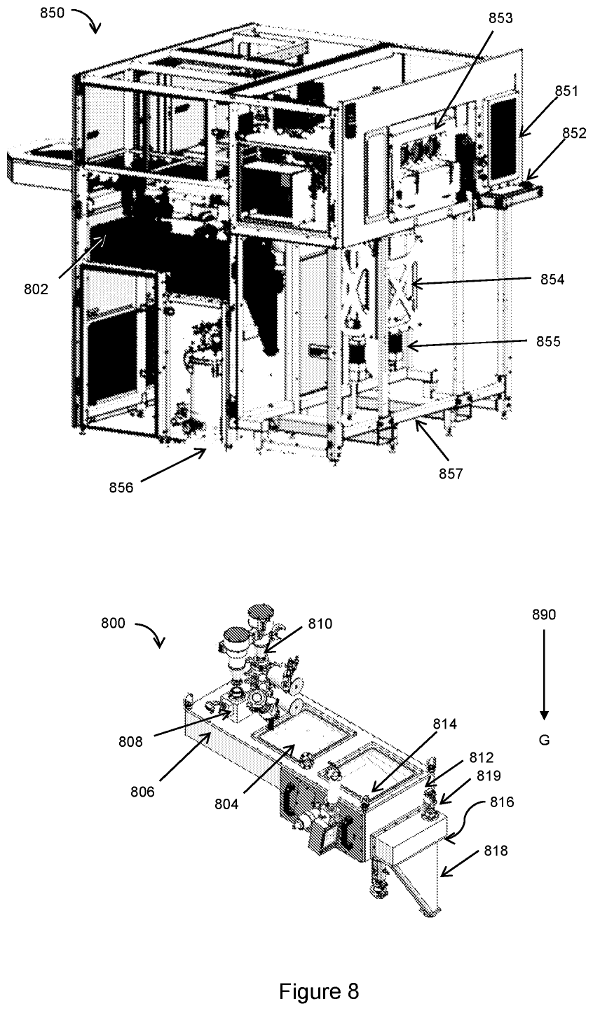

FIG. 8 shows various example views of portions of a manufacturing system that is a three-dimensional printing system. Example 850 shows a three-dimensional printing system. Example 800 shows a portion of the 3D printing system 850. The portion 800 of the 3D printing system 850 is depicted in silhouette 802 in perspective view 850 of the 3D printing system. The portion 800 of the 3D printing system 850 comprises a bounceable plate 804 disposed in a bounceable plate enclosure 806. The bounceable plate enclosure 806 comprises a top opening 808. The top opening 808 is operatively coupled with one or more cyclones 810. The bounceable plate enclosure 806 overlaps with a sieve enclosure 812 enclosing a sieve 814. Material sieved from the sieve enclosure 812 is delivered into a material reservoir 856 in example 800. The sieve enclosure 812 has an exit opening 816 disposed at its bottom. The exit opening 816 is operatively coupled with a container (e.g., funnel) 818. The container 818 may lead to a removal container, e.g., accommodating material for trashing. The sieve enclosure is operatively coupled with a sensor 819. The three-dimensional printing system is depicted with respect to gravitational vector 890 pointing towards the environmental center G. The 3D printing system 850 comprises a display (e.g., monitor) 851 and an input station (e.g., keyboard) 852. The 3D printing system 850 comprises a door 853 to a manufacturing enclosure (e.g., processing chamber). The door 853 comprises three viewing windows and a secondary door (e.g., a glovebox). The 3D printing system comprises a build module 854 operatively coupled with the processing chamber. The build module comprises one or more actuators that are operatively coupled with encoders 855. The 3D printing system 850 comprises structural supports 857. Up, down, below, above, top, and bottom in relation to FIG. 8, are with respect to gravitational vector 890 pointing toward an environmental gravitational center G, e.g., Earth's gravitational center.

In some embodiments, a manufacturing (e.g., three-dimensional printing) system comprises a material conveyance system. The material conveyance system may comprise a bounceable plate enclosure, or a separator. The separator may comprise a sieve, a cyclone, or a material reservoir, e.g., hopper. The sieve may be enclosed by a sieve enclosure. The bounceable plate enclosure may be configured to receive remainder material. In an example, a floor of the bounceable plate enclosure is a bounceable plate. The remainder material may initially be disposed in a manufacturing enclosure, e.g., during and/or after the printing. One or more 3D objects may be printed in the enclosure. The bounceable plate enclosure may comprise at least one inlet opening. The at least one inlet opening may be operatively coupled with (I) the manufacturing enclosure, (II) an ancillary chamber (e.g., garage), (III) a layer dispensing mechanism, and/or (IV) at least one separator (e.g., cyclone(s)). The ancillary chamber may be operatively coupled with the manufacturing enclosure. The ancillary chamber may be configured to accommodate the layer dispensing mechanism, e.g., in its resting position. In some embodiments, the bounceable plate enclosure comprises at least one outlet opening. The at least one outlet opening may operatively be coupled with the sieve enclosure. The inlet opening(s) and/or the outlet opening(s) may be (e.g., each) coupled with a respective vertical extension. The vertical extension may serve as a coupler, e.g., connector. The vertical extension may facilitate coupling of the sieve enclosure to other components of the 3D printing system. In some embodiments, the vertical extension connected to the inlet opening is coupled with (I) the manufacturing enclosure, (II) an ancillary chamber (e.g., garage), (III) a layer dispensing mechanism, and/or (IV) at least one separator (e.g., cyclone(s)). In some embodiments, the vertical extension of the outlet opening is coupled with the sieve enclosure. The vertical extension may comprise a flexible material or a rigid material. In an example, the vertical extension comprises silicone. The vertical extension may comprise a flexible structure or a rigid structure. In an example, the vertical extension comprises a bellow structure. At least two of the vertical extension(s) may comprise at least one characteristic that is the (e.g., substantially) same. At least two of the vertical extension(s) may comprise at least one characteristic that is different. The at least one characteristic of the vertical extension(s) may comprise thickness, fundamental length scale (FLS), structure, or material. The vertical extension may comprise a seal, e.g., any seal disclosed herein. The seal may be configured to enclose (i) the atmosphere and/or (ii) the material (e.g., remainder material) within the bounceable plate enclosure. The vertical extension may facilitate compensation for any misalignment between (a) a body of the bounceable plate, and (b) any other components with which it is coupled. Operations of the bounceable plate and/or sieve may generate vibrations. The vibrations may propagate to one or more other components of the 3D printing system. The vertical extension may be configured to reduce (e.g., damp) the vibrations from propagating throughout other components of the 3D printing system. The vertical extension may be operatively coupled with one or more O-rings. The sieve enclosure may be configured to accommodate the remainder material from the bounceable plate enclosure. The sieve enclosure may sieve the remainder material. The sieve enclosure may sieve at least a portion of debris. The debris may comprise a particulate matter that a FLS larger than a central tendency of the FLS of the remainder material. The sieve enclosure may be configured to move the remainder material from the sieve enclosure to the rest of the material conveyance system, e.g., to a material reservoir such as a hopper. The sieve enclosure may be operatively coupled with a removal container and a material reservoir. The material reservoir may comprise a pressure reservoir. The debris filtered out by the sieve may be moved to the removal container. The remainder material passed through the sieve may be moved to the material reservoir.

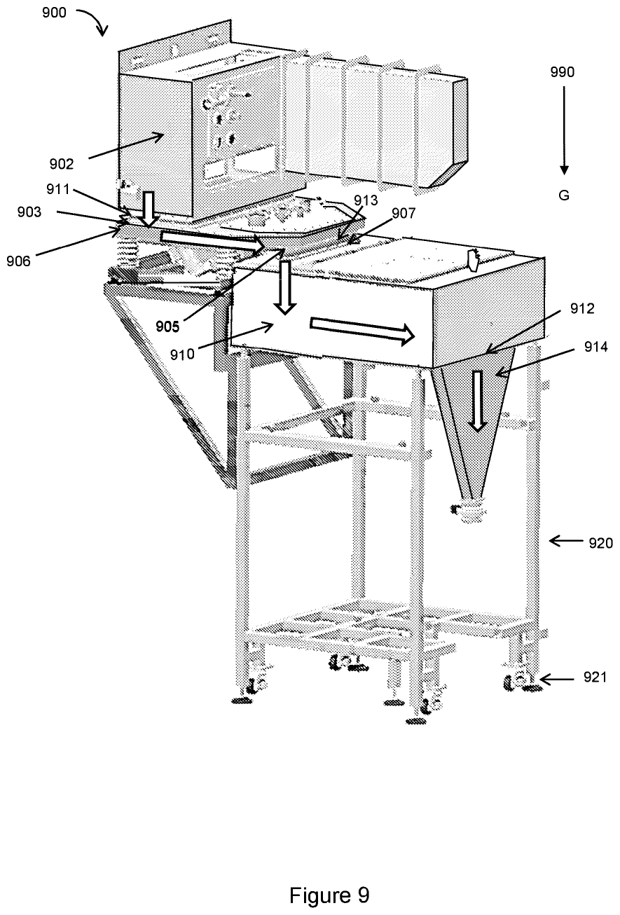

FIG. 9 shows an example perspective view of a portion of a 3D printing system 900. The 3D printing system portion 900 comprises a manufacturing enclosure, an ancillary chamber 902, a bounceable plate enclosure 906, and a sieve enclosure 910. Material (e.g., powder) flows from the ancillary chamber 902 to a material conveyance system, as indicated by hollow arrows. The bounceable plate enclosure 906 comprises a first opening 903 and a second opening 905. The first opening 903 is operatively coupled with an opening the ancillary chamber 902 via a vertical extension 911. The second opening 905 is operatively coupled with an opening 907 of the sieve enclosure 910 via a vertical extension 913. An opening 912 of the sieve enclosure 910 is operatively coupled with a container (e.g., funnel) 914. The 3D printing system portion 900 comprises structural supports 920 that are aligned via aligning screws 921. Up, down, below, above, top, and bottom in relation to FIG. 9, are with respect to gravitational vector 990 pointing toward an environmental gravitational center (e.g., Earth's gravitational center) G.

In some embodiments, a manufacturing (e.g., three-dimensional printing) system comprises a material conveyance system. The material conveyance system may comprise a bounceable plate enclosure, or at least one separator. The separator may comprise a sieve or a cyclone. The separator may further comprise, or is operatively coupled with, a removal container or a material reservoir (e.g., hopper). The bounceable plate enclosure may be operatively coupled with (i) a manufacturing enclosure, (ii) an ancillary chamber, (iii) a layer dispensing mechanism, and/or (ii) the separator (e.g., cyclone). The bounceable plate enclosure may be operatively coupled with the sieve enclosure. The sieve enclosure may be operatively coupled with (I) the material reservoir (e.g., hopper) and/or (II) a removal container. Each of the components may overlap with another component. In some embodiments, the sieve enclosure overlaps at least in part with the bounceable palate enclosure. The bounceable plate may move the remainder material to the sieve enclosure. The remainder material may pass through the sieve in the sieve enclosure. The remainder material may be conveyed from the sieve enclosure to the material reservoir. The material reservoir may be a pressure container. At least a portion of debris may be filtered out by the sieve. The filtered debris may be conveyed (e.g., delivered) from the sieve enclosure to the removal container. A bounceable plate may be disposed in, or be a part of, the bounceable plate enclosure. The bounceable plate may extend in a direction from one side of its bounceable plate enclosure to the other side. The bounceable plate may or may not be in contact with a wall of its bounceable plate enclosure. In some embodiments, the bounceable plate extends to leave a gap between a side of the bounceable plate and an inner wall of its bounceable plate enclosure. The bounceable plate may comprise, or be operatively coupled with, one or more actuators via the bounceable plate enclosure. The one or more actuators may comprise at least a portion that is external to the internal atmosphere of the bounceable plate enclosure. The one or more actuators may be disposed externally to the bounceable plate enclosure. The bounceable plate may be operatively coupled with a moving element (e.g., spring), e.g., via the bounceable plate enclosure. The moving element may be external to the internal atmosphere of the bounceable plate enclosure. The moving element (e.g., spring) may comprise an elemental metal or a metal alloy, e.g., steel. In some embodiments, the bounceable plate comprises, or is operatively coupled with, at least 2, 3, 5, or 10 actuators. At least two of the actuators may be of the same type. At least two of the actuators may be of a different type. The actuators may be of an even number. The actuators may be symmetrically or asymmetrically arranged with respect to each other. The actuators may comprise pneumatic, magnetic, or electronic actuating force. The actuators may comprise one or more properties that are tunable. The tunable properties may comprise tunable frequency or tunable force. In some embodiments, the actuators comprise a rotary electric motor. The actuators may be configured to rotate (e.g., clockwise or counterclockwise). The tunable properties may comprise a direction of rotation, a velocity or rotation, or an acceleration of rotation. In some embodiments, at least two of the actuators rotate in the same direction. In some embodiments, at least two of the actuators rotate in opposing directions. The at least two actuators may actuate in respective rotary motion to generate a combined motion incident on the bounceable plate. In some embodiments, the two rotary electric motors actuate in respective rotary motion with paired (e.g., matching or counter-matched) frequencies and/or forces, e.g., to generate a combined linear motion incident on the bounceable plate. At least two of the actuators may be oriented at an angle with respect to a plane (e.g., bottom surface) of the bounceable plate. The angle of incidence of the actuating motion may not be non-normal, e.g., less than about 90° (degrees) or greater than about 90°. The angle of incidence of the actuating motion relative to a plane normal of the bounceable plate, may be at most about 85°, 75°, 60°, 45°, or 30°. The angle of incidence of the actuating motion relative to a plane normal of the bounceable plate, may be between the aforementioned values, e.g., from about 85° to about 45°, or from about 75° to about 30°. The frequency of rotation may comprise a pattern in which the period in which the actuator's motion push the plate is (e.g., substantially) the same as the period in which the actuator's motion release the plate. The one or more actuators may (e.g., collectively) press upon the bounceable plate with a frequency of at least about 20 Hertz (Hz), 30 Hz, 60 Hz, or 90 Hz. The one or more actuators may press upon the bounceable plate with a (e.g., collective) force of at least about 50 Kilogram Force (KgF), 100 KgF, 200 KgF, 300 KgF, or 500 KgF. The actuator may comprise a rotating actuator such as a rotating motor. The actuator may rotate at a speed of at least about 2000 revolutions per minute (RPM), 2400 RPM, 3000 RPM, 3600 RPM, or 4000 RPM. The material conveyance system may comprise one or more sensors. In some embodiments, the bounceable plate enclosure comprises at least one sensor, e.g., at its top. In some embodiments, the sieve enclosure comprises at least one sensor, e.g., at its top. The sensor of the bounceable plate enclosure may extend from the bounceable plate enclosure to the sieve enclosure, e.g., through an opening. An outlet opening of the bounceable plate enclosure may be coupled with an inlet opening of the sieve enclosure. The sensor of the sieve enclosure may extend from the sieve enclosure to (i) a channel and/or (ii) the removal container. The sieve enclosure may be (i) directly coupled with the removal container, or (ii) coupled with the removal container through the channel. The channel may lead debris to the removal container for trashing. The sieve enclosure may comprise one or more outlet openings. At least one of the outlet openings of the sieve enclosure may be coupled with (i) an inlet opening of the channel, and/or (ii) an inlet opening of the removal container. The outlet openings of the sieve enclosure may be located in a floor or a wall. The material conveyance system may comprise, or be operatively coupled with, one or more valves. In some embodiments, a valve is disposed between the sieve enclosure and the removal container. The valve may be (i) controllably opened to receive the removed material (e.g., debris) in the removal container, and/or (ii) controllably closed to isolate the interior of the sieve enclosure from the interior of the removal container. The removed material (e.g., debris) may be removed (e.g., discarded) from the removal container. The removal container may comprise, or be operatively coupled with, a valve. The valve may be configured to selectively (e.g., controllably) open for removing material from the removal container.

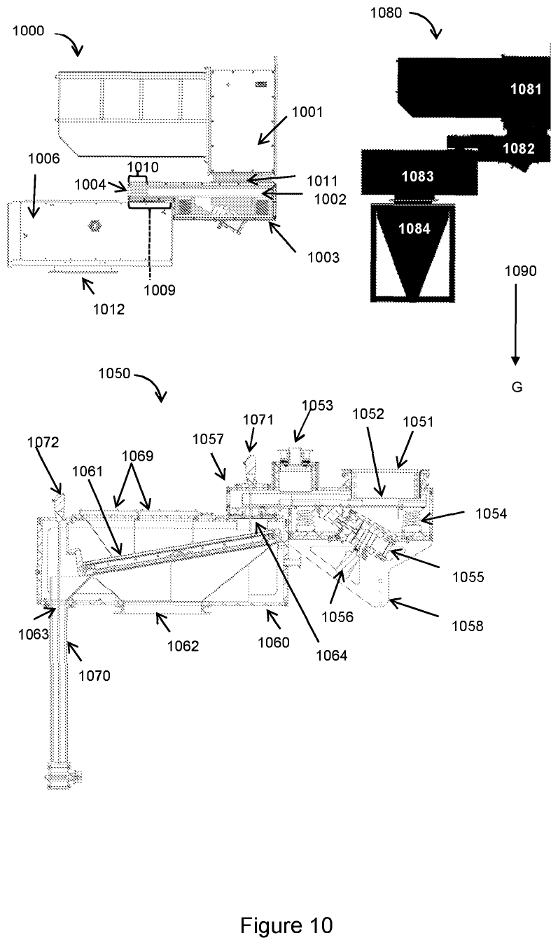

FIG. 10 shows a side view example 1000 of a portion of a manufacturing system that is a three-dimensional printing system. The 3D printing system comprises an ancillary chamber enclosure 1001 coupled with a bounceable plate 1002. The bounceable plate 1002 is disposed in a bounceable plate enclosure 1003. The bounceable plate enclosure 1003 is operatively coupled with a sieve enclosure 1006 comprising a sieve. A lower portion of the bounceable plate enclosure 1003 overlaps a roof of the sieve enclosure 1006 with an overlap 1009. The bounceable plate 1002 extends horizontally from one side of its bounceable plate enclosure 1003 to the other side, leaving a gap 1010 between a side of the bounceable plate 1002 and wall 1004. The sieve enclosure 1006 has a bottom opening 1012. The bounceable plate enclosure 1003 comprises a top opening 1011 disposed at the roof the bounceable plate enclosure 1003. The top opening 1011 is operatively coupled with the ancillary chamber 1001. The bounceable plate enclosure 1003 comprises a bottom opening disposed in area 1009. FIG. 10 also shows a silhouette side view example 1080 of a portion of the three-dimensional printing system. The 3D printing system comprises an ancillary chamber 1081, a bounceable plate enclosure 1082, a sieve enclosure 1083, and a material reservoir 1084. FIG. 10 also shows in a vertical cross-sectional example 1050 of a portion of the three-dimensional printing system. A bounceable plate 1052 is disposed in a bounceable plate enclosure 1057. The bounceable plate enclosure 1057 comprises a top opening 1051 and one or more top openings 1053. The bounceable plate 1052 is operatively coupled with springs 1054 and actuator 1055. The actuator 1055 is a pneumatic actuator receiving gas (e.g., air or a gas more inert than air) pressure from a gas source 1056. The bounceable plate enclosure 1057 is supported by a supporting structure 1058 coupled with the bottom of the bounceable plate enclosure 1057. The bounceable plate enclosure 1057 overlaps in a portion of its lower portion distant from the opening 1051, with a sieve enclosure 1060 having a sieve 1061 disposed therein. The sieve 1061 is tilted with respect to the horizon. The sieve enclosure 1060 comprises a first exit opening 1062 disposed at its bottom. The sieve enclosure 1060 comprises a second exit opening 1063 disposed at the bottom towards an edge of the sieve enclosure 1060. The second exit opening 1063 is operatively coupled with a channel 1070 that may lead to a removal container. The sieve enclosure 1060 comprises one or more openings 1064 and 1069 that are covered with a window and/or plaque. The bounceable plate enclosure 1057 comprises at its top a sensor 1071. The sieve enclosure 1060 comprises at its top a sensor 1072. The sensor 1071 extends into the sieve enclosure 1060. The sensor 1072 extends into the channel 1070. Examples 1000, 1080, and 1050 are aligned with respect to gravitational vector 1090 pointing towards an environmental gravitational center (G, e.g., Earth's gravitational center. Up, down, below, above, top, and bottom in relation to FIG. 10, are with respect to gravitational vector 1090.

In some embodiments, the recycling system comprises a sieve enclosure a sieve. The sieve enclosure may be configured to form a space inside it. The space may constitute at least a portion of a material conveyance path. The space may be defined and/or confined by inner surfaces of the sieve enclosure. The space may be a cavity inside the sieve enclosure. The space may be divided into a first space portion and a second space portion by the sieve. The sieve may be enclosed by the sieve enclosure. The first space portion may be defined by (i) a first surface (e.g., top surface) of the sieve, and (ii) a portion of the inner surface of the sieve enclosure. The second space portion may be defined by (i) a second surface opposite to the first surface (e.g., bottom surface) of the sieve, and (ii) the rest portion of the inner surface of the sieve. In some embodiments, the second space portion is in a type of a funnel. Remainder material may be introduced into the first space portion. The remainder material may be initially disposed in a manufacturing enclosure, e.g., at least during manufacturing such as printing. One or more objects may be manufactured in the manufacturing enclosure. The sieve may be configured to filter the remainder material from debris. The debris may comprise a portion that has a fundamental length scale (FLS) larger than a central tendency of the FLS of a starting material. In some embodiments, the debris comprises agglomerates of the remainder material. The remainder material may pass through the sieve. The remainder material may flow away into the second space portion. The remainder may flow away from the second space portion to the rest of the material conveyance path, e.g., to a material reservoir, e.g., through an outlet. The second space portion may be in fluidic communication with the rest of the material conveyance path, e.g., through the outlet. In some embodiments, the rest of the material conveyance path comprises an internal atmosphere of a material reservoir. The material reservoir may be a container such as a pressure container. The debris may be moved into a removal container. An internal atmosphere of the removal container may be in fluidic communication with the first space portion. The sieve enclosure may be monolithic. The sieve enclosure may be modular. In some embodiments, the sieve enclosure comprises a first portion (e.g., upper portion) and a second portion (e.g., lower portion). The sieve may be disposed between the first space portion and the second space portion. Top, bottom, upper and lower may be relative to a gravitational vector pointing towards the gravitational center of the environment. The first space portion and the second space portion may be in fluidic communication during normal operation. At times, the sieve may experience blockage, e.g., may be at least partially blocked (e.g., blinded or clogged) with the remainder material. The sieve experiencing the blockage may hinder the fluidic communication between the first space portion and the second space portion. In some embodiments, during normal operation, the pressure of the second space portion is correlated with the pressure of the first space portion. In some embodiments, during faulty operation, the correlation between the first pressure of the first space portion and the second pressure of the second space portion is compromised (e.g., reduced) as compared to the correlation during the normal operation. The prevention system may be configured to utilize this correlation change (e.g., decrease) to detect sieve blockage. In some embodiments, the first space portion comprises, or is operatively coupled with, a first pressure sensor. In some embodiments, the second space portion comprises, or is operatively coupled with, a second pressure sensor. The first pressure sensor and the second pressure sensor may be operatively coupled with the prevention system. The prevention system may be configured to monitor the correlation between the first pressure and the second pressure. The prevention system may be configured to initiate a prevention operation when the correlation between the first pressure and the second pressure is below a threshold. The monitoring of the correlation may comprise monitoring a normalized cross-correlation coefficient between the first pressure and the second pressure.

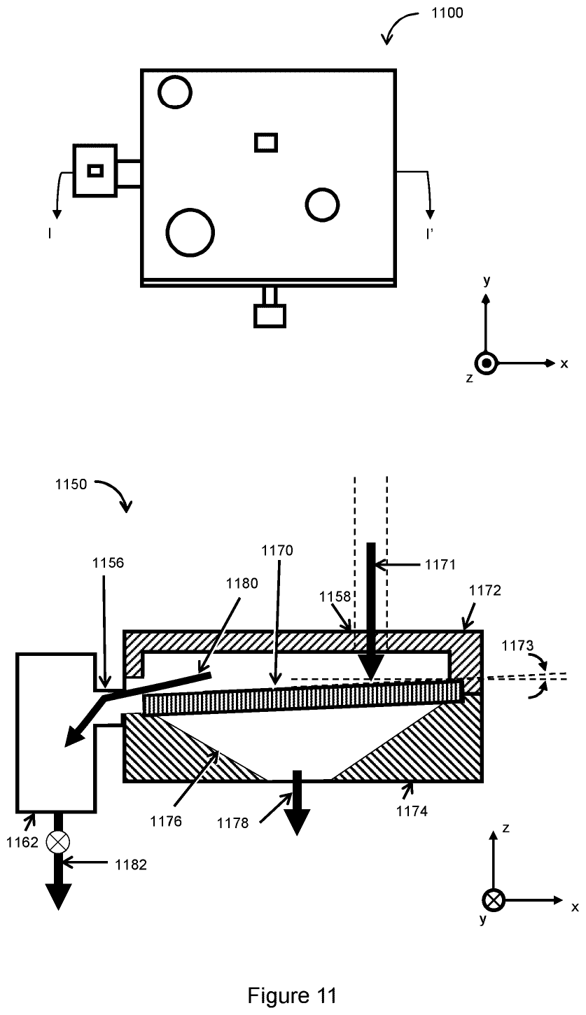

FIG. 11 shows example views of a sieve enclosure. Example 1100 shows an example of a horizontal view of a sieve enclosure. Example 1150 shows an example of a vertical cross section of the sieve enclosure cut along the line I-I′ of example 1100. The sieve enclosure shown in example 1150 comprises a first (top) portion 1172, a second (bottom) portion 1174, a sieve 1170, and a removal container 1162. Bottom is in a direction of a gravitational field vector. Top is in the direction opposite to the direction of the gravitational field vector. Material is introduced into the sieve enclosure via inlet port 1158, as depicted by path 1171. Debris (e.g., aggregates) is removed from a top surface of the sieve 1170 to an interior of the removal container 1162, as depicted by path 1180. An optional channel element 1156 is disposed between the sieve enclosure and the removal container 1162. Discarded material collected in the removal container 1162 is removed from the removal container 1162, as depicted by path 1182. The bottom portion 1174 of the sieve enclosure comprises a surface 1176 for receiving separated (e.g., sieved) material. The separated (e.g., sieved) material is removed from the sieve enclosure, e.g., towards a material conveyance system, as depicted by path 1178. The sieve 1170 is disposed at an angle 1173 with respect to xy-plane. The sieve 1170 is tilted about y-axis such that a z height of the top surface of the sieve 1170 adjacent to the removal container 1162 is higher than a z height of the top surface of the sieve 1170 that is distal from the removal container 1162.

In some embodiments, a sieve enclosure encloses a sieve. The sieve may be reversibly engaged (e.g., affixed or inserted) and disengaged (e.g., removed or extracted) from the sieve enclosure. The engagement and disengagement may be performed at least in part manually. The engagement and disengagement may be performed at least in part automatically, e.g., using at least one controller. The at least one controller may be any controller disclosed herein. In some embodiments, the at least one controller is integrated in a control system of the three-dimensional (3D) printer. An alert may be communicated to engage and/or disengage the sieve. The alert may be communicated to a controller(s) and/or to a user. The sieve enclosure may be supportive of the sieve before, during, and/or after use of the sieve, e.g., to process particulate matter. The sieve enclosure may be configured for sieve placement. In some embodiments, the sieve placement is tilted with respect to a normal to the gravitational vector, e.g., to a horizon. In some embodiments, the sieve placement is (e.g., substantially) parallel to a normal to the gravitational vector, e.g., to the horizon. The gravitational vector may be a vector pointing towards to the gravitational center of the environment. The sieve may be configured to comprise, or be operatively coupled with, an agitation transmitter. The agitation transmitter may be configured to allow propagation of agitations such as vibrations. The agitations may comprise a sonic wave. The agitations may comprise an ultra-sonic wave. The agitation transmitter may comprise (i) one or more strips (e.g., rods) or (ii) one or more connectors. The one or more strips may be disposed on the sieve, e.g., on a surface of the sieve. The one or more strips may be a part of, or be operatively coupled with, the sieve. The one or more strips may be operatively couple with the one or more connectors. The one or more connectors may be operatively coupled with an agitation generator. A wall of the sieve enclosure may comprise openings to allow the one or more connectors to be accessible to the sieve, e.g., to the one or more strips (e.g., rods) of the sieve. The wall may comprise a side wall, a ceiling, or a floor. The propagation of agitations through the connectors may be without (e.g., substantial) damping of the agitations generated by the agitation generator. The propagation of agitations through the connectors may (e.g., substantially) preserve the generated agitations by the agitation generator. The connectors may comprise a straight portion or a curved portion. The connectors may comprise an extendable or adjustable portion, e.g., to accommodate installation of the connectors to the one or more strips (e.g., rods) of the sieve. The extendable or adjustable portion may comprise a (e.g., spring-like) tension. The extendable or adjustable portion may accommodate stretching (e.g., extending) of the portion. The extendable or adjustable portion may accommodate movement of the connectors with respect to the one or more strips (e.g., rods) and/or the sieve enclosure. The connectors may be reversibly engaged and disengaged with the sieve. The sieve enclosure may comprise a translatable support system. The translatable support system may be configured to retain the sieve and reversibly translate the sieve from a first position to a second position. In some embodiments, the translatable support system translates the sieve from a loading position to an operation position. The operation position may correspond to a three-dimensional printing process. The translatable support system may comprise a railing system. The railing system may be configured to facilitate translation of the sieve from the first position to the second position. In some embodiments, the railing system comprises rails located on opposing sides of the sieve. The railing system may comprise open or shielded railing (e.g., labyrinth type railing). The translatable support system may be configured to affix to an outer frame of the sieve, e.g., via mounting hardware. The remainder material (e.g., powder) may be deposited on the sieve. The remainder material may be filtered (e.g., sieved) by the sieve disposed in the sieve enclosure. The rate of remainder material deposition may be at least about 1 kilogram per minute (Kg/min), 2.5 Kg/min, 5 Kg/min, 10 Kg/min, 15 Kg/min, 20 Kg/min, or 50 Kg/min. This rate may also correspond to the rate in which the sieve is sieving the remainder material. The sieve enclosure may operate the sieve before, after, and/or during the three-dimensional printing. The sieve may be configured for continuous operation of at least about 1, 2, 5, 10, or 50 printing cycles. The sieve may be configured for continuous operation of at least about 100 hours, 200 hours, 400 hours, 500 hours, 700 hours, or 1000 hours. The sieve may agitate (e.g., vibrate) during operation. The vibrations may comprise sonic vibrations. The vibrations may comprise mechanical or acoustic vibrations. The vibrations may be at a frequency of at least about 10 kilohertz (kHz), 20 kHz, 40 kHz, 50 kHz, 80 kHz, or 100 kHz. The vibrations may be intermittent (e.g., using a pulsing sequence). The intermittent vibrations may be at a rate of at least about 2.5 pulses per second (pls/sec), 3.6 pls/sec, 4.4 pls/sec, 5.7 pls/sec, or 9.6 pls/sec. The one or more strips (e.g., rods) of the sieve may be waveguide strips. The waveguide strips may be configured to propagate ultrasonic waves onto (i) the sieve and/or (ii) the material disposed on the sieve or adjacent to the sieve.

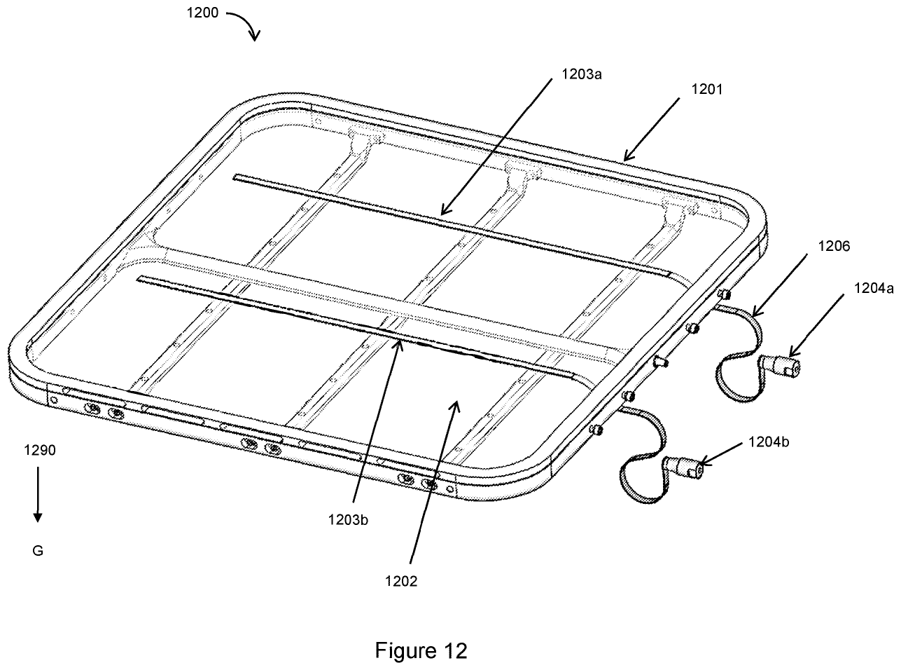

FIG. 12 shows a partial view example of a sieve assembly. A sieve assembly 1200 comprises a sieve 1202 framed by framing 1201. Sieve 1202 is operatively coupled with two strips 1203a and 1203b. The strip 1203a is operatively coupled with a connector 1204a. Strip 1203b is operatively coupled with a connector 1204b. The connectors 1204a and 1204b comprise respective curved portions 1206. The respective curved portions 1206 are operatively coupled with one end of the two strips 1203a and 1203b. Components in FIG. 12 are aligned with respect to gravitational vector 1290 pointing towards an environmental gravitational center (e.g., Earth's gravitational center) G.

In some embodiments, a manufacturing system comprises a manufacturing enclosure for manufacturing object(s). A three-dimensional (3D) printing system may comprise a manufacturing enclosure for printing one or more 3D objects. The manufacturing enclosure may enclose an atmosphere. The atmosphere of the manufacturing enclosure may be different in at least one characteristic compared to that of an ambient atmosphere external to the printing system. The at least one characteristic may comprise a pressure or a level of a reactive agent. In some embodiments, the pressure inside the manufacturing enclosure is greater than the pressure of the ambient atmosphere. The printing may utilize a starting material. The starting material may be dispensed in the manufacturing enclosure by a material dispensing mechanism, e.g., dispenser. The material dispensing mechanism may be a part of a layer dispensing mechanism, e.g., recoater. The layer dispensing mechanism may be operatively coupled with the manufacturing enclosure. The manufacturing enclosure may be configured to accommodate the layer dispensing mechanism. A portion of the dispensed starting material may be utilized for printing the 3D objects. Starting material that is not utilized for the printing may remain in the manufacturing enclosure. The remainder material may be entrained out of the manufacturing enclosure. In an example, the remainder material is removed from the manufacturing enclosure by a material removal mechanism, e.g., remover, as a part of the layer dispensing mechanism. The material removal mechanism may be configured to utilize an attractive force, such as a vacuum source. A layer dispensing operation may comprise a material dispensing operation (e.g., by the dispenser) and a material removal operation (e.g., by the remover). The layer dispensing operation may or may not comprise a material leveling operation. The layer dispensing operation may cause a pressure fluctuation (e.g., pulsation) in the three-dimensional printing system. In some embodiments, the material removal operation utilizes or causes a pressure drop. Pressure equilibration operation may be performed to recover the pressure drop, e.g., before the subsequent layer dispensing operation. The pressure equilibration operation may be configured to maintain the pressure inside the manufacturing enclosure at a requested value or within a requested range. The pressure equilibration operation may be configured to (i) compensate for a pressure drop and/or (ii) alleviate a pressure rise in the manufacturing enclosure. The pressure equilibration operation may be performed between subsequent layer dispensing operations. The pressure equilibration operation may induce a transient perturbation in pressure. The layer dispensing operation and the pressure equilibration operation may be performed repeatedly. The layer dispensing operation and the pressure equilibration operation may induce a (e.g., substantially) repetitive pattern (e.g., sequence) in the pressure inside the three-dimensional printing system, e.g., in the manufacturing enclosure. The three-dimensional printing system may comprise an internal atmosphere that has pressure exhibiting a (e.g., substantial) repetition of a pattern (e.g., sequence) over time, e.g., at least during normal layer dispensing operation.

In some embodiments, a manufacturing system comprises a material conveyance system. A three-dimensional (3D) printing system may comprise a material conveyance system. The material conveyance system may comprise, or be operatively coupled with, a material recycling system. The material recycling system may comprise a separator. The separator may comprise a cyclone and a sieve. The separator may further comprise a material reservoir or a removal container. The sieve may be enclosed by a sieve enclosure. The sieve enclosure may be operatively coupled with the cyclone. In some embodiments, the sieve enclosure is directly coupled with the cyclone, e.g., without an intervention of a component such as a channel. In some embodiments, the sieve enclosure is operatively coupled with the cyclone via a (covered) channel, e.g., comprising a pipe, a hose, or another passage. An outlet of the cyclone may be coupled with an inlet of the sieve enclosure. A gas channel may be operatively coupled with the cyclone. The gas channel may be a pipe or a hose. The cyclone may be operatively coupled with a manufacturing enclosure. The manufacturing enclosure may be configured to enclose a printed 3D object, e.g., at least during the printing. The 3D object may be printed from a starting material. A portion of the starting material that is not utilized to form one or more 3D objects may remain in the manufacturing enclosure. At least a portion of the remainder material may be attracted (e.g., removed) away from the manufacturing enclosure, e.g., by using the material removal mechanism. The attracted (e.g., removed) remainder material may be conveyed to a material recycling system. In some embodiments, a portion of the remainder material is directed to the material recycling system from the manufacturing enclosure and/or an ancillary chamber, without going through the material removal mechanism. The material recycling system may accommodate the remainder material from (i) the manufacturing enclosure, (ii) the ancillary chamber, (iii) the material removal mechanism (e.g., remover), or (iv) a vacuum wand. The remainder material is conveyed to a separator. The remainder material may be conveyed to the sieve enclosure. In some embodiments, the remainder material passes through the cyclone and is conveyed into the sieve enclosure. The cyclone may be configured to separate the remainder material from gas. The gas may be clean gas. The clean gas may carry a lower concentration (e.g., be depleted) of the remainder material. The separated remainder material may exit the cyclone and be conveyed into the sieve enclosure. The separated gas (e.g., clean gas) may be conveyed to the gas channel. The sieve enclosure may comprise a sieve. The sieve may filter material (e.g., agglomerates) that is suitable for re-use for the 3D printing from other material. The material filtered out by the sieve may be conveyed into a removal container. The removal container may be operatively coupled with the sieve enclosure. The material in the removal container may be discarded from the removal container. The remainder material that is suitable for re-use may comprise pre-transformed material such as powder. The sieve may be flat or tilted in relation to the horizon, the horizon being normal to a gravitational vector pointing towards the gravitational center of the environment. In normal operation, the remainder material may pass through the sieve and be conveyed into the rest of the material conveyance system, e.g., a material reservoir. At times, a disruption may occur. In an example, the sieve may be blocked (e.g., blinded or clogged) with the remainder material. The blocked sieve may cause accumulation of the remainder material on the sieve. The accumulation on the sieve may obstruct (e.g., block, blind, or clog) the entrance of the sieve enclosure through which the remainder material is introduced. The material conveyance system may comprise, or be operatively coupled with, one or more sensors. The one or more sensors may comprise a pressure sensor, a temperature sensor, a gas flow sensor, or a material level sensor. The material conveyance system may comprise, or be operatively coupled with, a pressure sensor. The pressure sensor may be operatively coupled with (i) the sieve enclosure, (ii) an exit of the sieve enclosure, or (iii) the material reservoir. In some embodiments, the material reservoir comprises, or operatively couple with, a pressure sensor. The material reservoir may be in fluidic communication with the sieve enclosure. The material reservoir may exhibit (e.g., substantially) identical or similar pressure with the sieve enclosure. The pressure sensor may be configured to sense the pressure inside at least one component of the recycling system. The pressure sensor may be configured to sense the pressure inside the sieve enclosure and/or the material reservoir. During normal operation, the pressure inside the sieve enclosure may exhibit a repetitive pattern. The pressure inside the sieve enclosure may exhibit a repetition of a unit pattern (e.g., unit sequence) over time. The unit pattern may comprise a first amplitude and a first time period (e.g., wavelength). The unit pattern may comprise an increase, a peak, a decrease, a plateau, or a dip. In an example, the pressure inside the sieve enclosure exhibits peaks occurring at (e.g., substantially) equal time intervals. In an example, the pressure inside the sieve enclosure exhibits dips occurring at (e.g., substantially) equal time intervals. An amplitude of the unit pattern may indicate the pressure difference between the maximum pressure and the minimum pressure in the unit pattern. The time period (e.g., wavelength) of the unit pattern may indicate a period during which the unit pattern persists. During faulty operation, the pressure inside the sieve enclosure may exhibit a different pattern as compared to normal operation. The faulty operation may comprise (i) at least partial sieve blockage (e.g., blind), (ii) accumulation of the remainder material on the sieve, or (iii) at least partial blockage of the inlet of the sieve enclosure. In some embodiments, the pressure inside at least a portion of the sieve enclosure exhibits a damping (e.g., attenuating) characteristic during faulty operation, e.g., the portion below the blinded sieve. As compared to pressure fluctuation during normal operation, the damping characteristic during faulty operation may comprise (i) reduced amplitude, (ii) smoothened waveform, or (iii) reduced deviation from a central tendency (e.g., average). The pressure inside the at least the portion of the sieve enclosure may exhibit an irregular pattern during faulty operation. In some embodiments, when the sieve is experiencing at least partial clogging, and the entrance to the sieve enclosure is unobstructed, pressure in the lower space portion downstream of the sieve experiences the change (e.g., damping) in the pressure pattern. In some embodiments, when the sieve is experiencing at least partial clogging, and the entrance to the sieve enclosure is at least partially obstructed, pressure in the space of the sieve enclosure experiences the change (e.g., damping) in the pressure pattern, the space including space portions below and above the sieve. The 3D printing system may comprise, or be operatively coupled with, a prevention system. The prevention system may be operatively coupled with the pressure sensor sensing the pressure inside one or more components of the material recycling system, e.g., in the sieve enclosure, in connecting channel(s), in the cyclone, and/or at least one container such as the material reservoir. The prevention system may be configured to monitor the data received from the pressure sensor(s). The prevention system may be configured to determine faulty operation when it detects a change in the pressure pattern, e.g., change by a threshold. The detection may be based at least in part on the change in the unit pattern, the change being in (i) amplitude, (ii) time period (e.g., wavelength), (iii) waveform, (iii) regularity, or (iv) any combination thereof. In some embodiments, the prevention system is configured to determine the disruption when the pressure exhibits an irregular pressure pattern. In some embodiments, the prevention system is configured to determine the disruption at least when the amplitude decreases within a range of from about 5 kilopascal (kPa) to about 9 kPa. In some embodiments, the prevention system is configured to determine the disruption at least when the amplitude decreases within a range of from about 40% to about 75% of the first amplitude. The prevention may be configured to initiate a prevention operation at least when it detects disruption in the 3D printing system.

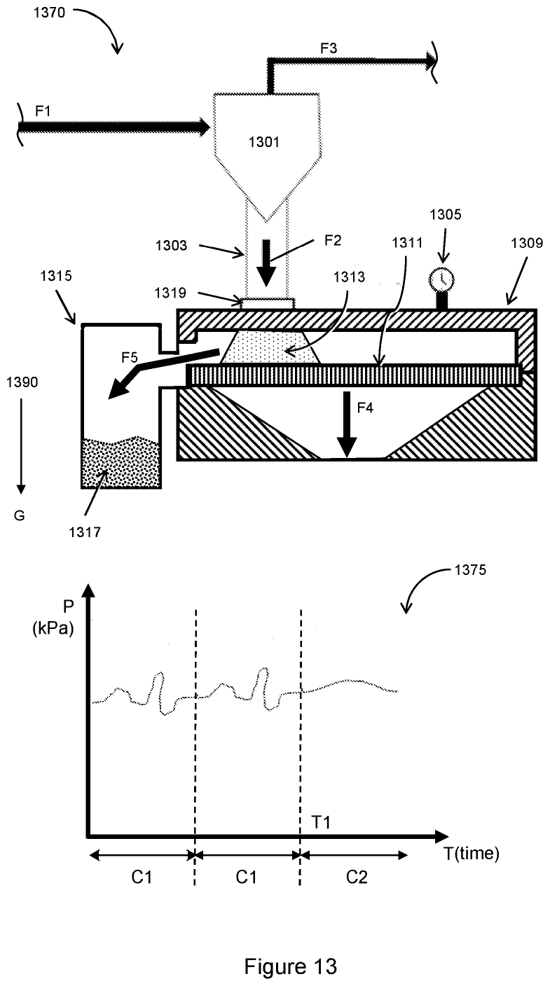

FIG. 13 shows a schematic vertical cross sectional example of a portion of a manufacturing system that is a three-dimensional printing system, and an example of pressure fluctuation as a function of time. Example 1370 shows a portion of a material conveyance system. In example 1370, the material conveyance system comprises a separator comprising a cyclone 1301 and a sieve enclosure 1309. Remainder material is conveyed into cyclone 1301, as depicted by arrow F1. cyclone 1301 separates the remainder material from gas. The separated remainder material is introduced into sieve enclosure 1309 via channel 1303, as depicted by arrow F2. The separated gas is introduced into a gas channel, as depicted by arrow F3. The separated remainder material is filtered (e.g., sieved) by a sieve 1311. During normal operation, the filtered remainder material is conveyed to the rest of the material conveyance system, as depicted by arrow F4. Unfiltered material (e.g., agglomerates) is conveyed to a removal container 1315, as depicted by arrow F5. The unfiltered material 1317 is collected in the removal container 1315. During disrupted operation, the remainder material 1313 accumulates on sieve 1311. The accumulated remainder material 1313 may block an entrance 1319 through which the remainder material is introduced into the sieve enclosure 1309. The sieve enclosure comprises, or operatively couples with, a pressure sensor 1305 that senses the pressure in the interior atmosphere of the sieve enclosure. The pressure sensor 1305 may sense pressure inside the sieve enclosure 1309. Pressure inside sieve enclosure 1309 is schematically depicted in example 1375. As shown in example 1375, during the normal operation C1, the pressure shows (e.g., substantially) repetitive sequence (e.g., pattern). The remainder material (e.g., 1313 in example 1370) may accumulate on the sieve (e.g., 1311 in example 1370) and block the entrance (e.g., 1319 in example 1370), at or around time T1 in example 1375. During the disrupted operation C2, the pressure shows a different pattern compared to operation C1. The pressure during operation C2 exhibits a damping characteristic (e.g., reduced amplitude) during operation C1. The material conveyance system in example 1370 is depicted with respect to gravitational vector 1390 pointing towards the environmental center G. The remainder material flows in a downstream direction along the arrow F2 and F4. The interior of the portion of the material conveyance system can enclose an internal environment different from the environment prevailing at its exterior, e.g., during operation.

In some embodiments, the prevention system is configured to utilize two or more sensors to detect a disruption, such as sieve blinding and/or clogging of the entrance port to the sieve enclosure. The manufacturing (e.g., 3D printing) system may comprise, or be operatively coupled with, two or more pressure sensors comprising a first pressure sensor and a second pressures sensor. The first pressure sensor may be configured to sense a first pressure of a first internal atmosphere. The first pressure sensor may be disposed in the sieve enclosure (e.g., downstream of the sieve) with downstream being along the requested direction of material flow in the recycling system. The first internal atmosphere may be fluidly connected to the internal atmosphere of the manufacturing enclosure (e.g., processing chamber) during normal operation, which fluid connection may be disrupted (e.g., cease) during faulty operation. The first internal atmosphere may be an internal atmosphere of (i) a sieve enclosure such as below the sieve, (ii) an exit of the sieve enclosure, (iii) a material reservoir (e.g., hopper), and/or (iv) any connecting channel(s) between the sieve enclosure and the reservoir. The connecting channel(s) may comprise a gas conveyance channel or a material conveyance channel. The material reservoir may be operatively coupled with the sieve enclosure, e.g., by one or more channels. The material reservoir may be in fluidic communication with the sieve enclosure. The material reservoir may exhibit a pressure associated with the pressure of the sieve enclosure. Associated with may comprise similar to, or (e.g., substantially) identical with. The second pressure sensor may be configured to sense a second pressure of a second internal atmosphere. The second pressure sensor may be disposed upstream of the sieve, upstream being along the requested direction of material flow in the recycling system. The second internal atmosphere may be different than the first internal atmosphere, e.g., during faulty operation. The first internal atmosphere may be fluidically connected with the second internal atmosphere during normal operation. The second internal atmosphere may be fluidly connected to the internal atmosphere of the manufacturing enclosure (e.g., processing chamber) during faulty operation and during normal operation. The second internal atmosphere may be an internal atmosphere of (i) a sieve enclosure portion above the sieve, (ii) an entrance of the sieve enclosure, (iii) a cyclone, and/or (iv) any connecting channel(s). The connecting channel(s) may comprise a gas conveyance channel or a material conveyance channel. In some embodiments, the first pressure sensor is operatively coupled with the material reservoir. The first pressure sensor may be configured to sense pressure inside the material reservoir which exhibits (e.g., substantially) identical or similar pressure with the pressure inside the sieve enclosure. In some embodiments, the second pressure sensor is operatively coupled with the gas channel. The second pressure sensor may be configured to sense the pressure inside the gas channel. The gas channel may be configured to facilitate the flow of gas separated from the cyclone. The first pressure may exhibit a (e.g., substantial) repetition of a first unit sequence (e.g., pattern) during normal operation. The second pressure may exhibit a (e.g., substantial) repetition of a second unit sequence (e.g., pattern) during normal operation. The first pressure may correlate with (e.g., track) the second pressure (e.g., in the manufacturing enclosure such as the processing chamber) during normal operation. A correlation between two pressures may comprise having coupled and/or associated pressure patterns over time. A correlation between two pressures may comprise having (e.g., substantially) the same or similar patterns over time. In some embodiments, a change in the first pressure is met with a corresponding change in the second pressure. Changes may comprise increase, decrease, a peak, a plateau, or a dip. During normal operation, a correlation coefficient between the first pressure and the second pressure may be above a threshold. The correlation coefficient may indicate a strength and direction of a (e.g., linear) relationship between the two pressure data sensed by the two sensors. The threshold may comprise a value or a function. At times, a disruption may occur. The disruption may comprise sieve blockage (e.g., sieve blinding or clogging) with the remainder material. The blockage may be a full blockage or a partial blockage. The blocked sieve may cause accumulation of the remainder material on the sieve. The accumulation on the sieve may obstruct (e.g., block or clog) the entrance of the sieve enclosure through which the remainder material is introduced, e.g., cause blockage in the entrance port to the sieve enclosure. The blockage of the entrance may disrupt and/or hinder the fluidic connection between the first atmosphere and the second atmosphere. During such disrupted operation (e.g., per the blockages), the first pressure may exhibit a different pattern compared to the pressure pattern observed during normal operation, e.g., in the manufacturing enclosure. The pressure inside at least the lower portion of the sieve enclosure may exhibit a change during disrupted operation. The change may comprise a dissociation and/or lack of coupling of the pressure (e.g. pattern) between the sensed pressure by the first sensor, and the pressure fluctuations observed in the manufacturing enclosure such as in the processing chamber. The pressure change may have a damping (e.g., attenuating) characteristic. The damping characteristic may comprise (i) reduced amplitude, (ii) smoothened waveform, or (iii) reduced deviation from a central tendency (e.g., average). Such pressure change observed by the first sensor (e.g., inside the material reservoir) may cause a reduction in the correlation between the first pressure and the second pressure. In an example, the correlation coefficient between the first pressure and the second pressure decreases. The prevention system may calculate and/or monitor the correlation coefficient between the first pressure and the second pressure. The correlation coefficient may be measured by (e.g., normalized) cross correlation method. The prevention system may, continuously or intermittently, monitor the correlation coefficient. The correlation coefficient may be above a threshold during normal operation. The correlation coefficient may be larger than or equal to the maximum value of the threshold range during normal operation. The threshold range of the correlation may be at least about 0.75, 0.80, 0.82, 0.85, 0.90, 0.92, or more. The threshold range of the correlation may be at most 0.90, 0.92, 0.95, 0.99, 0.995 or less. The threshold range of the correlation may be any value between the afore-mentioned values, e.g., from about 0.75 to about 0.995, or from about 0.80 to about 0.99. The disruption (e.g., sieve blockage) may reduce the degree of correlation between the first pressure and the second pressure. The correlation coefficient between the first pressure and the second pressure may drop below the threshold range during faulty operation. The prevention system may execute, or direct the execution of, initiating a prevention operation. The prevention operation may be performed manually (e.g., by a user) or automatically (e.g., by a controller). The prevention operation may comprise (i) triggering an alarm, (ii) generating a report, (iii) generating an instruction, (iv) prescribing a remedial operation by an operator (e.g., user), (v) initiating a prescribed agitation scheme to recover (e.g., de-blind) the sieve, or (vi) any combination thereof. The agitation scheme may comprise agitating the sieve, e.g., using vibrations. The agitation scheme may not involve interrupting the operation of the printing system. The agitation scheme may alleviate blockage in the sieve. The vibrations may comprise acoustic vibrations, e.g., ultrasound vibrations. The vibrations may propagate through the wave guide(s) disposed along the sieve, e.g., as in FIG. 12, 1203a-b. The prevention operation may reduce the possibility of disrupting the manufacturing system. The sieve may be recovered (e.g., de-blinded) automatically and/or manually, during and/or after the manufacturing (e.g., printing) process.

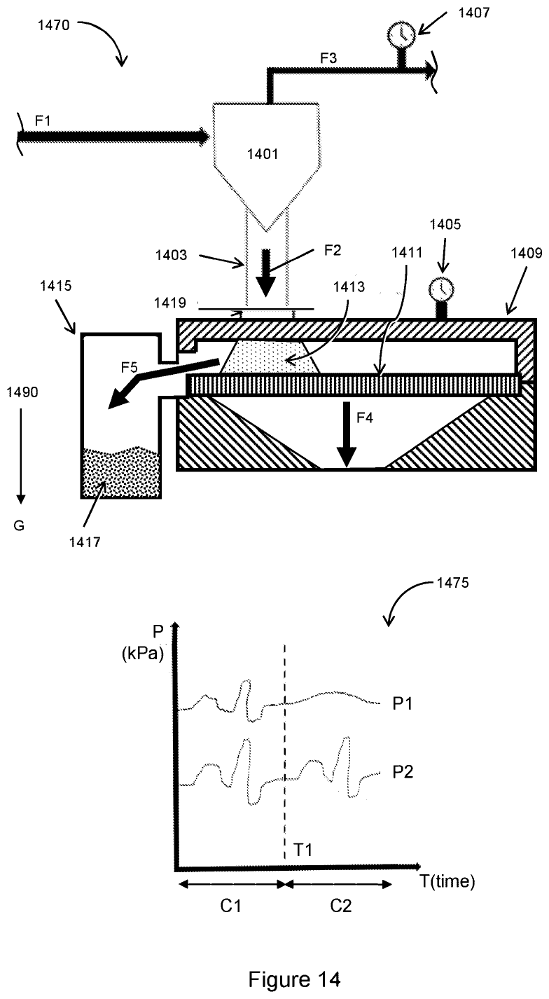

FIG. 14 shows a vertical cross sectional example of a portion of a manufacturing system that is a three-dimensional printing system, and an example of pressure fluctuation as a function of time. Example 1470 shows a portion of a material conveyance system. In example 1470, the material conveyance system comprises a separator comprising a cyclone 1401 and a sieve enclosure 1409. Remainder material is conveyed into the cyclone 1401, as depicted by arrow F1. The cyclone 1401 separates the remainder material from gas. The separated remainder material is introduced into the sieve enclosure 1409 via a channel 1403, as depicted by arrow F2. The separated gas is introduced into a gas channel, as depicted by arrow F3. The separated remainder material is filtered (e.g., sieved) by a sieve 1411. During normal operation, the filtered remainder material is conveyed downstream to the rest of the material conveyance system, as depicted by arrow F4. Unfiltered material (e.g., debris and/or agglomerates) is conveyed to a removal container 1415, as depicted by arrow F5. The unfiltered material 1417 is collected in the removal container 1415. During faulty operation, the remainder material 1413 accumulates on the sieve 1411. The accumulated remainder material 1413 may block an entrance 1419 through which the remainder material is introduced into the sieve enclosure 1409. The sieve enclosure comprises, or operatively couple with, a first pressure sensor 1405. The gas channel comprises, or is operatively couple with, a second pressure sensor 1407. A first pressure in an interior environment of the sieve enclosure is sensed by the first pressure sensor 1405, the first pressure sensed being schematically depicted as P1 in example 1475. A second pressure sensed by the second pressure sensor 1407 is disposed upstream of the cyclone 1401, is schematically depicted as P2 in example 1475. As shown in example 1475, during normal operation C1, the first pressure P1 and the second pressure P2 correlate with each other. The remainder material (e.g., 1413 in example 1470) accumulates on the sieve (e.g., 1411 in example 1470) and blocks the entrance (e.g., 1419 in example 1470), at or around time T1. During faulty operation C2, the first pressure P1 and the second pressure P2 do not correlate with each other. The material conveyance system is depicted with respect to gravitational vector 1490 pointing towards the environmental center G. The remainder material flows in a downstream direction along the arrow F2 and F4.

In some embodiments, the manufacturing system is configured to (e.g., at least in part) utilize pressure differential to dispense and/or convey material. During operation, the pressure differential may increase and/or decrease, e.g., in a repetitive and/or characteristic manner. The pressure differential may experience equilibration efforts, e.g., that may result in pressure fluctuations. In an example, the pressure fluctuations are associated with the layer dispensing operations coupled with pressure equilibration efforts. During normal operation, the pressure fluctuations in the manufacturing system may exhibit a repetition of a unit pressure pattern over time. The unit pressure pattern may correspond to (e.g., be associated with) each of the layer dispensing operations. At times, the manufacturing system may experience malfunction. The malfunction may comprise an (e.g., uncontrolled) release in at least a portion of the manufacturing system, e.g., through a channel. The malfunction may comprise an (e.g., uncontrolled) blockage in at least a portion of the manufacturing system, e.g., blockage by accumulation of conveyed pre-transformed material. In some embodiments, the malfunction comprises the sieve experiencing blockage (e.g., at least partially blocked, blinded, or clogged) by the remainder material. During such faulty operation, the downstream of the sieve may lose fluidic connectivity with the atmosphere upstream of the sieve, such as the atmosphere of the manufacturing enclosure. The pressure within the downstream section of the sieve may exhibit a different pressure pattern in comparison to its pressure pattern during normal operation. In some embodiments, the pressure of the atmosphere within the downstream section of the sieve exhibits a damping characteristic. The damping characteristic may comprise (i) reduced amplitude, (ii) smoothened waveform, or (iii) reduced deviation from a central tendency, such as average. In some embodiments, the pressure within an atmosphere downstream section of the sieve has reduced correlation with the pressure of an atmosphere within the upstream section of the sieve compared to normal operation. In an example, the upstream section of the sieve comprises the manufacturing enclosure or cyclone. The pressure within the downstream section of the sieve may be disconnected from the repetition of the unit pattern corresponding to the layer dispensing operation, e.g., and exhibit a different unit pattern or no unit pattern. A prevention system may be configured to detect and/or prevent malfunction in the manufacturing system. To detect the malfunction, the prevention system may be configured to utilize the pressure change (e.g., variation) within the downstream section of the sieve. The prevention system may be configured to detect (i) the pressure change (e.g., irregularity and/or damping characteristic) within an atmosphere in the downstream section of the sieve, or (ii) the correlation change (e.g., correlation decrease) between the pressure in an atmosphere within the downstream section of the sieve as compared to the pressure in an atmosphere within the upstream section of the sieve. Upstream and downstream may be along a requested direction of material flow in the recycling system during operation. The prevention system may initiate a prevention operation when it determines the malfunction. In some embodiments, the prevention operation comprises an agitation scheme of the sieve. The agitation scheme may be configured to alleviate (e.g., resolve) the sieve blockage, e.g., without interrupting the manufacturing system. The agitation scheme may be performed automatically and/or manually.

In some embodiments, operation of the manufacturing system causes and/or utilizes, pressure variations. A manufacturing (e.g., 3D printing) system may be configured to (e.g., at least in part) utilize a pressure differential to convey material. In some embodiments, a layer dispensing mechanism (e.g., recoater) is configured to (i) dispense a starting material in a manufacturing enclosure and/or (ii) remove a remainder material from the manufacturing enclosure. The layer dispensing mechanism may be configured to utilize a pressure differential to dispense and/or remove the material. In some embodiments, a material removal mechanism (as a part of the layer dispensing mechanism) is configured to (e.g., at least in part) utilize pressure differentials to remove the remainder material from the manufacturing enclosure. The material removal mechanism may be configured to utilize an attraction force, e.g., a vacuum force. The operation of the material removal mechanism may cause a pressure fluctuation in the printing system, e.g., in the manufacturing enclosure and/or in the material conveyance system. The remainder material may be recycled by a recycling system. The recycled remainder material may be utilized as the starting material for a subsequent layer dispensing operation. The remainder material may flow away into a material recycling system, e.g., through a material conveyance system. Flow away may comprise utilizing an attractive force, a compressive force, and/or a gravitational force. The recycled remainder material may be conveyed to the layer dispensing mechanism for subsequent operation. A pressure differential scheme may be (e.g., at least in part) utilized to convey the remainder material, e.g., (a) from the material removal mechanism to the material conveyance system, and/or (b) from the recycling system to the layer dispensing mechanism. The pressure differential may be temporary, e.g., preside for a limited time. The pressure differential(s) may occur periodically, e.g., sequentially. The pressure differential may preside during operation of the manufacturing system, e.g., during printing. Such pressure differential may cause pressure fluctuations in the manufacturing system, e.g., in its manufacturing enclosure, in its gas conveyance system, and/or in its material conveyance system. The layer dispensing mechanism may move between the manufacturing enclosure (e.g., where it presides during its operating mode) and an ancillary chamber (e.g., where it presides during its idle mode). The movement and/or layer dispensing operation of the layer dispensing mechanism may induce pressure fluctuation in one or more sections of the manufacturing system. The manufacturing system may comprise a pressure equilibration mechanism. The pressure equilibration mechanism may be configured to facilitate pressure stabilization in the manufacturing system, e.g., in the manufacturing enclosure. The pressure equilibration mechanism may be configured to maintain the pressure in the manufacturing system within a requested range. The requested range may comprise (i) a requested pressure range and/or (ii) a requested time span. Pressure change beyond the requested range in the manufacturing enclosure may (e.g., at least in part) cause the starting material (e.g., powder) to displace from its original position. This displacement may cause an unwanted result such as degrading the planarity of an exposed surface of a material bed or generating gas-borne debris. The pressure equilibrium mechanism may facilitate reducing the unwanted result by stabilizing the pressure inside the manufacturing enclosure. The pressure equilibration mechanism may be configured to (i) compensate for pressure drop and/or (ii) alleviate pressure rise in the one or more sections of the manufacturing system. The pressure inside the one or more section of the manufacturing system may be affected by the layer dispensing operation and/or pressure equilibrium operation. In an example, the pressure inside the manufacturing system drops when the material removal mechanism removes the remainder material from the manufacturing enclosure. In an example, the pressure inside the manufacturing system drops when the remainder material is conveyed from the material removal mechanism to the material conveyance system. In an example, the pressure inside the manufacturing system fluctuates when the layer dispensing mechanism changes its mode between (i) the idle (e.g., resting) mode and (ii) the operating mode. In an example, the pressure inside the manufacturing system rises when the pressure equilibration system operates to compensate for the pressure drops. In some embodiments, the remainder material may be removed (a) from the manufacturing enclosure and/or an ancillary chamber (b) to the recycling system. The manufacturing enclosure and/or the ancillary chamber may comprise ports (e.g., openings such as holes) configured to facilitate the removal of the remainder material. The pressure inside the manufacturing system may decrease during the removal.

In some embodiments, the manufacturing system comprises, or is operatively coupled to, a recycling system. The recycling system may comprise a separator. The separator may comprise sieve enclosure(s) or cyclone(s). The remainder material may flow away into the cyclone, e.g., while it is flowing downstream through the material conveyance system. The cyclone may be configured to separate the remainder material from gas. A gas channel may be operatively coupled with the cyclone. The gas may exit from the cyclone to the gas channel of the gas conveyance system. The cyclone may be configured to utilize and/or cause a pressure differential separating the gas from the remainder material. The separated gas may have a pressure lower than the pressure in the enclosure, e.g., in the processing chamber. The separated remainder material may be introduced into the sieve enclosure enclosing a sieve. The sieve may be configured to filter (e.g., sieve) the remainder material. Debris having a FLS larger than a central tendency of the FLS of the starting material may be filtered out. The separator may further comprise, or is operatively coupled with, the material reservoir and/or the removal container. The debris may flow to a removal container. The removal container may be used to collect and discard the debris. The remainder material that passes through the sieve may flow downstream into a material reservoir, e.g., hopper. There may be one or more material reservoirs operatively coupled downstream of the sieve enclosure, e.g., for redundancy. In some embodiments, the separator is operatively coupled with two material reservoirs, each of which is operatively coupled with the sieve enclosure. The material reservoir(s) may be fluidically connected to the sieve enclosure. The material reservoir(s) may facilitate collection of the sieved material from the sieve enclosure. The material reservoir (e.g., each of the material reservoirs) may be separated from a fluid connection with the sieve enclosure, e.g., by closing a valve. Status of the valve may be controlled by one or more controllers, e.g., as disclosed herein such as of the control system of the manufacturing system. The pressure inside the sieve enclosure may exhibit a pressure fluctuation during normal operation, e.g., during a layer dispensing operation. The interior atmosphere of the material reservoir may exhibit a pressure fluctuation coupled with (e.g., similar to, or (e.g., substantially) identical with) the pressure of the atmosphere inside the sieve enclosure and/or the pressure in the atmosphere of the manufacturing enclosure. The pressure inside the manufacturing system may exhibit a regular (e.g., and periodic) increase and decrease over time, e.g., during operation such as during printing. One or more components of the manufacturing system may exhibit associated and/or coupled pressure variation over time. The (e.g., unit) pressure variation may comprise increase, decrease, (e.g., substantially) constant, peak, or dip. Under normal operation, the pressure inside one or more components of the manufacturing system may exhibit a (e.g., substantial) repetition of a unit pressure pattern over time. The unit pressure pattern may have a repetitive time frame. In some embodiments, the unit pressure pattern is associated with the layer dispensing operation(s) occurring repetitively during manufacturing. The manufacturing system may comprise, or be operatively coupled with, one or more sensors. In some embodiments, the one or more sensors comprises a first sensor and a second sensor. In some embodiments, the first sensor is configured to sense a pressure at a location experiencing disruption (e.g., decoupling) of the sieve enclosure atmosphere (or a portion thereof) from its fluid connection with the manufacturing enclosure comprising the processing chamber, the ancillary chamber or the build module. Location of the first sensor can be in the sieve enclosure downstream of its material entry port, e.g., above or below the sieve, Location of the first sensor can be at any component downstream of the sieve enclosure. The first sensor may be configured to sense the pressure inside the sieve enclosure or the material reservoir disposed downstream of the sieve enclosure. In some embodiments, the second sensor is configured to sense a pressure at a location not experiencing disruption (e.g., decoupling) in pressure, when the sieve enclosure atmosphere (or a portion thereof) experience blockage and compromise the fluid connection of at least a portion of the sieve enclosure with the manufacturing enclosure comprising the processing chamber, the ancillary chamber or the build module. Location of the first sensor can be in the sieve enclosure, e.g., downstream of its material entry port, above or below the sieve. Location of the first sensor can be at any component downstream of the sieve enclosure. The second sensor may be configured to sense the pressure inside the gas channel operatively coupled with the cyclone. The sensors such as the first sensor and the second sensor, may be operatively coupled with a prevention system. The prevention system may monitor the pressure such as the first pressure and the second pressure, during manufacturing. The prevention system may monitor a correlation coefficient between the pressures such as between the first pressure and the second pressure. The correlation coefficient may be measured by normalized cross correlation. During normal operation, the atmospheres exhibiting the pressures (e.g., exhibiting the first pressure and the second pressure) may be in fluidic communication, e.g., such that they facilitate coupling and/or equilibration. The correlation coefficient between the pressures such as between the first pressure and the second pressure, may be above a threshold during normal operation. The threshold may be a value or a function. In some embodiments, the threshold comprises a value within a range of about 0.70 and about 0.82.

At times, the separator malfunctions. In some embodiments, the remainder material arriving to the sieve (e.g., from the cyclones) accumulates on the sieve disposed in the sieve enclosure. Such accumulation may be (e.g., at least in part) caused by sieve blockage such as sieve blinding. The sieve may comprise pores such as holes. The sieve may comprise a mesh. Sieve blinding may be caused by blocking such as clogging of the pores of the sieve. The pores of the sieve may have a central tendency of a FLS that is (e.g., substantially) the same as, or similar to, that of the remainder material. In some embodiments, the remainder material (e.g., powder) blocks the pores of the sieve. Debris may comprise a portion that has a FLS larger than the central tendency of the remainder material. The debris may comprise agglomerates of the remainder material. In some embodiments, debris that has a FLS larger than that of the pores causes the sieve blinding. The sieve blinding may induce an accumulation of the remainder material on an upper surface of the sieve. The accumulated material may block the entrance (e.g., port such as inlet) of the sieve enclosure. The entrance of the sieve enclosure may be an inlet opening through which the remainder material flows into the sieve enclosure. Blockage of the entrance of the sieve enclosure and/or of the sieve, may compromise (e.g., disrupt such as disconnect) the fluid connection between the internal atmosphere of the sieve enclosure (e.g., of a portion thereof downstream of the sieve) and the internal atmosphere of the manufacturing enclosure. Blockage of the entrance of the sieve enclosure and/or of the sieve, may affect (e.g., alter) the pressure inside the sieve enclosure, e.g., of a portion thereof downstream of the sieve. During normal operation, the pressure inside the sieve enclosure may comprise a (e.g., substantial) repetition of unit pattern over time. During normal operation, the pressure inside the sieve enclosure above and below (e.g., upstream and downstream of) the sieve may comprise a (e.g., substantial) repetition of unit pattern over time. In some embodiments, the pressure inside the sieve enclosure exhibits pulsation. The pulsation may be associated and/or coupled with pulsation of the pressure in the manufacturing chamber. During faulty operation where the entrance to the sieve enclosure experiences blockage, the pressure inside the sieve enclosure exhibits a different pattern from the regular unit pattern observed during normal operation. During faulty operation where the sieve experiences blockage, at least the pressure downstream of the sieve in the sieve enclosure exhibits a different pattern from the regular unit pattern observed during normal operation. During faulty operation, the different pressure inside at least the lower portion of the sieve enclosure may exhibit a damping characteristic. The damping characteristic may comprise (i) reduced amplitude, (ii) smoothened waveform, or (iii) reduced deviation from a central tendency, such as average. In some embodiments, during faulty operation, the pressure inside at least the lower portion of the sieve enclosure below the sieve exhibits irregular pattern. In some embodiments, during faulty operation, the pressure inside at least the lower portion of the sieve enclosure below the sieve, does not exhibit a repetitive time frame. In some embodiments, during faulty operation, the pressure inside at least the lower portion of the sieve enclosure below the sieve and up to the pressure in the sieve enclosure, evens out until it reaches a state of equilibrium. The equilibrium pressure may be within a range between (i) the pressure inside the manufacturing enclosure and (ii) the exit of the cyclone (e.g., the gas channel operatively coupled with the cyclone). In some embodiments, during faulty operation, the pressure inside at least the lower portion of the sieve enclosure below the sieve and up to the pressure in the sieve enclosure, does not exhibit pulsation during faulty operation. The pressure of inside at least the lower portion of the sieve enclosure below the sieve and up to the pressure in the sieve enclosure, may correlate with the pressure inside the material reservoir, such as hopper. The manufacturing system may comprise the first sensor configured to sense the pressure inside the sieve enclosure (or portion thereof) and/or material reservoir. The manufacturing system may comprise the second sensor configured to sense the pressure downstream of the manufacturing enclosure and before the sieve enclosure. The manufacturing system may comprise the second sensor configured to sense the pressure downstream of the cyclone(s), e.g., in the gas channel coupled with the cyclone and connected to the sieve enclosure. The manufacturing system may comprise the first sensor configured to sense the pressure in the sieve enclosure such as downstream of the portion of the sieve enclosure below the sieve, or downstream of the sieve enclosure. At times, the second sensor is coupled to the sieve enclosure above the sieve, and the first sensor is coupled to the sieve enclosure below the sieve. At times, the second sensor is coupled to a component of the recycling system above the sieve enclosure, and the first sensor is coupled to the sieve enclosure above or below the sieve. Location of the first sensor and second sensor may be configured to sense a sufficiently large discrepancy in the pressure (e.g., have a sufficiently high sensitivity) for early alert of compromising pre-transformed material flow (i) through the sieve flow and/or (ii) through the entrance port to the sieve enclosure. The prevention system may operatively couple with the pressure sensor(s) such as the first sensor and the second sensor. The prevention system may monitor (i) the sensor(s) such as the first pressure and/or (ii) correlation between the pressure sensors such as correlation between first pressure and the second pressure. In some embodiments, the prevention system determines a compromise in the sieve when the first pressure deviates from the repetition of the regular unit pattern. The compromise may be a harmful compromise, or likely to cause a harmful compromise during the current manufacturing cycle, e.g., print cycle. The harmful compromise may be of any harm type disclosed herein. In an example, the harmful compromise leads, or is highly likely to lead, to interruption in the build cycle. The high likelihood may be more than 50%, 80%, 90%, 95%, or 99%. The high likelihood may be any value between the aforementioned likelihood values, e.g., above about 50% and up to 99%. The high likelihood may be above about 50% and up to 100%. According to the degree of the pressure change (e.g., decoupling with the manufacturing enclosure pressure) downstream of the sieve (e.g., and downstream of the sieve enclosure), the prevention system may assess the degree of clogging in the sieve enclosure. According to the degree of the pressure coefficient change (e.g., decoupling) between the first pressure sensor and the second pressure sensor, the prevention system may assess the degree of clogging in the sieve enclosure. In some embodiments, the prevention system determines sieve compromise, or high likelihood for sieve compromise (e.g., blinding), when the correlation is below the threshold. The prevention system is configured to initiate a prevention operation when it detects, or is highly likely to detect, sieve blinding. The prevention operation may comprise a notification or a procedure. The prevention operation may comprise (i) triggering an alarm, (ii) generating a report, (iii) generating an instruction, (iv) prescribing a remedial operation, (v) interrupting the printing (e.g., build), (vi) performing an agitation scheme, or (vii) any combination thereof. In some embodiments, the prevention system performs, or directs the performance of, the agitation scheme, e.g., as disclosed herein. The agitation scheme may comprise agitating the sieve and/or the remainder material accumulated on the sieve. The agitation scheme may be configured to utilize an agitation transmitter. The agitation transmitter may be operatively coupled with the sieve. The agitation may facilitate migration of debris having FLS larger than the sieve holes, the migration being to the removal container, e.g., FIG. 13, 1315, or FIG. 14, 1415.

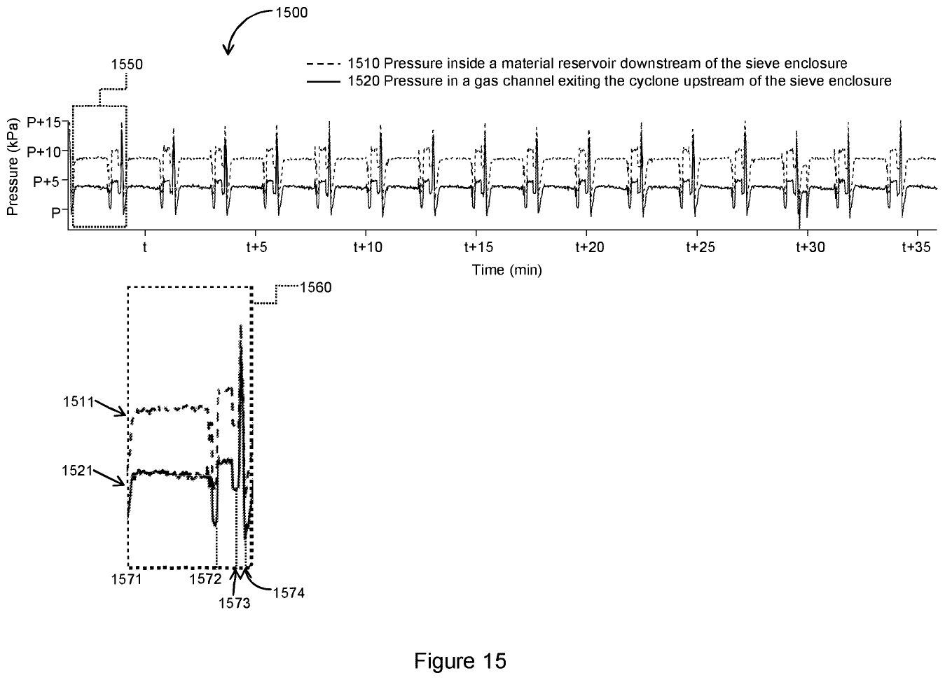

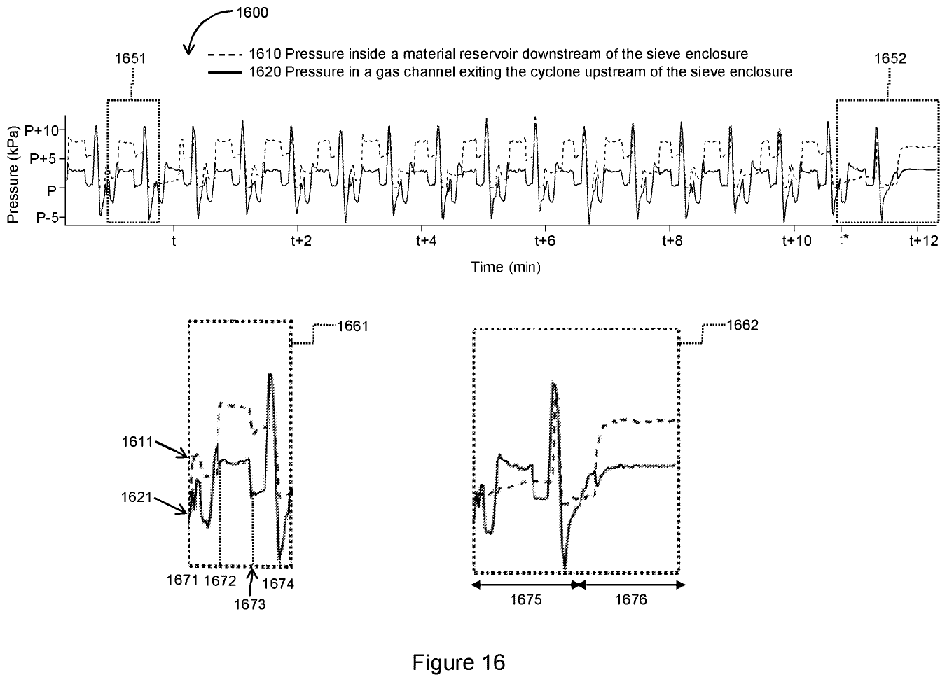

FIG. 15 shows an example of a pressure graph during normal operation as a function of time. Graph 1500 shows pressure fluctuations during layer dispending operation followed by pressure equilibration, occurring in the manufacturing enclosure. A first pressure depicted by dashed line 1510 indicates pressure in one of the material reservoirs (e.g., hoppers) of the material recycling system located downstream to the sieve enclosure. The material reservoir is in fluidic communication with the sieve enclosure. A second pressure depicted by solid line 1520 indicates pressure in a gas channel after cyclone and upstream of the sieve enclosure e.g., sensor 1407 of FIG. 14. Section 1550 of graph 1500 is enlarged as section 1560. The first pressure 1510 exhibits a (e.g., substantial) repetition of a first pattern 1511 over time. The second pressure 1520 exhibits a (e.g., substantial) repetition of a second pattern 1521 over time. The first pressure 1510 and the second pressure 1520 show a (e.g., substantially) identical waveform. Every change in the first pressure 1510 is met with a corresponding change in the second pressure 1520. The first pressure 1510 is larger than the second pressure 1520 by a gap. As shown in 1560, the first pattern 1511 and the second pattern 1521 have a (e.g., substantially) identical period, e.g., repetition unit. The time period of the repetition unit (e.g., repetition interval) in FIG. 15 is greater than that in FIG. 16. The time period of the repetition unit may be associated with layer deposition timing and/or a period of manufacturing in the manufacturing enclosure. During the time interval between 1571 and 1572, the first pattern 1511 and the second pattern 1521 each exhibit a (e.g., substantially) constant pressure, e.g., a pressure plateau. The time interval between 1571 and 1572 may correspond to an idle time of a layer dispensing mechanism. During the idle time, a portion of the starting material may be converted to a transformed material to form at least a portion of the 3D object. At time 1572, the first pattern 1511 and the second pattern 1521 each exhibit a dip. The time 1572 may correspond to a transition of the layer dispensing mechanism from an idle mode to an operating mode. During the time interval between 1572 and 1573, the first pattern 1511 and the second pattern 1521 each exhibit a substantially constant pressure. The time interval between 1572 and 1573 may correspond to (i) a material dispensing operation and/or (ii) a leveling operation, in relation to a material bed. At time 1573, the first pattern 1511 and the second pattern 1521 exhibit a dip. The time 1573 may correspond to a material removing operation from the material removal mechanism to a material conveyance system. During the time interval between 1573 and 1574, the first pattern 1511 and the second pattern 1521 each exhibit a peak. The time interval between 1573 and 1574 may correspond to a pressure equilibrium operation. The pressure equilibrium operation may comprise decreasing speed of a pump for valve changes. At time 1574, the first pattern 1511 and the second pattern 1521 each exhibit a dip. The time 1574 may correspond to a material removing operation of remainder material from the enclosure and/or ancillary chamber. The remainder material may comprise a portion of a starting material derived from the material bed, e.g., by a leveling operation. Experimental conditions related to graph 1500 are detailed in “Example 1” disclosed herein.

FIG. 16 shows an example of a pressure graph portion during normal operation and a pressure graph portion during faulty operation of the sieve enclosure, as a function of time. The faulty operation of the sieve enclosure may include (a) faulty operation of the sieve or (b) faulty operation of the sieve and of the sieve entrance port, e.g., inlet opening. Graph 1600 shows pressure fluctuations during layer dispensing operation followed by pressure equilibration, occurring in the manufacturing enclosure. A first pressure depicted by dashed line 1610 indicates pressure in pressure in one of the material reservoirs (e.g., hoppers) of the recycling system located downstream to the sieve enclosure. The material reservoir may have fluidic communication with the sieve enclosure. A second pressure depicted by solid line 1620 indicates pressure in a gas channel after cyclone and upstream of the sieve enclosure e.g., sensor 1407 of FIG. 14. Experimental conditions related to graph 1600 are detailed in “Example 1” disclosed herein. Section 1651 of graph 1600, which represents normal operation, is enlarged as section 1661. Section 1652 of graph 1600, which represents faulty operation of the sieve enclosure, is enlarged as section 1662. The first pressure 1610 exhibits a (e.g., substantial) repetition of a first pattern 1611 section of pressure measured during normal operation and section 1652 of pressure measured during faulty operation of the sieve enclosure, as a function of time. The second pressure 1620 exhibits a (e.g., substantial) repetition of a second pattern 1621 during normal operation and during onset of the faulty operation of the sieve enclosure of the sieve enclosure, as sensed during a portion of the time in section 1652. Changes in the first pressure 1610 tends to be met (e.g., coupled or associated) with a corresponding change in the second pressure 1620, up to the time t* indicated in the beginning of section 1652. The first pressure 1610 is larger than the second pressure 1620 by a gap. As shown in section 1661, the first pattern 1611 and the second pattern 1621 have a (e.g., substantially) identical period, e.g., repetition unit. The time period of the repetition unit (e.g., repetition interval) in FIG. 15 is greater than that in FIG. 16. The time period of the repetition unit may be associated with layer deposition timing and/or a period of manufacturing in the manufacturing enclosure. During the time interval between 1671 and 1672, the first pattern 1611 and the second pattern 1621 exhibit pressure fluctuation. The time interval between 1671 and 1672 may correspond to a transition of a layer dispensing mechanism from an idle mode to an operating mode. During the time interval between 1672 and 1673, the first pattern 1611 and the second pattern 1621 exhibits a (e.g., substantially) constant pressure, a pressure plateau. The time interval between 1672 and 1673 may correspond to (i) a material dispensing operation and/or (ii) a leveling operation, in relation to a material bed disposed in the manufacturing enclosure. At time 1673, the first pressure 1611 and the second pressure 1621 exhibit a pressure drop. The time 1673 may correspond to a material removing operation from the material removal mechanism to a material conveyance mechanism. During the time interval between 1673 and 1674, the first pattern 1611 and the second pattern 1621 each exhibit a peak. The time interval between 1673 and 1674 may correspond to a pressure equilibration operation. The pressure equilibrium operation may comprise decreasing speed of a pump for valve changes. At time 1674, the first pattern 1611 and the second pattern 1621 each exhibit a dip. The time 1674 may correspond to a material removing operation of remainder material from the enclosure and/or ancillary chamber. The remainder material may comprise a starting material deviated from the material bed by a leveling operation. Section 1662 shows pressure measured during faulty operation of the sieve enclosure. The first pressure 1610 departs from (e.g., does not exhibit) the first pattern 1611 during time interval 1675, while the second pressure 1620 continues to depict the normal operation pattern. Thus, a correlation between the first pressure 1610 and the second pressure 1620 decreased. The prevention system may determine the faulty operation of the sieve enclosure during the time interval 1675, and initiate mitigating measures, e.g., to circumvent interrupting the manufacturing process. The mitigating measure may comprise initiation of an agitation scheme to agitate the sieve and/or to agitate the entrance opening port. During the time interval 1676, the first pressure 1611 and the second pressure 1612 exhibits a (e.g., substantially) constant pressure, e.g., pressure plateau. The time interval 1676 may correspond to a situation where the manufacturing process has been compromised, e.g., due to sieve blinding and/or due to clogging of the entrance port to the sieve enclosure.

In some embodiments, it is advantageous to measure a level of material in a container. The container may comprise an enclosure or a reservoir. The enclosure may comprise the sieve enclosure. In some embodiments, it is advantageous to measure the level of the remainder material accumulated on the sieve in the sieve enclosure, e.g., during operation of the sieve such as in situ and in real time. The measurement may be facilitated by at least one sensor. The sensor may comprise a material level sensor. The material level sensor may comprise a proximity sensor, or a weight sensor. The material level sensor may comprise an optical sensor or an acoustic sensor. The sensor may utilize a guided wave. The sensor may comprise a guided wave radar (abbreviated herein as “GWR”). The sensor may utilize GWR technology. The sensor may utilize electromagnetic waves such as radio-waves, microwaves, infrared light, or electromagnetic waves of another frequency range. The sensor may utilize (e.g., generate and/or detect) an electromagnetic wave(s) comprising a wavelength of at least about 0.03 cm, 0.05 cm, 0.08 cm, 0.1 cm, 0.3 cm, 0.5 cm, 0.8 cm, 1 cm, 3 cm, 5 cm, 8 cm, or 10 cm. The sensor may utilize an electromagnetic wave(s) comprising a wavelength of at most about 0.03 cm, 0.05 cm, 0.08 cm, 0.1 cm, 0.3 cm, 0.5 cm, 0.8 cm, 1 cm, 3 cm, 5 cm, 8 cm, 10 cm, or 15 cm. The sensor may utilize an electromagnetic wave(s) between any of the aforementioned wavelengths, e.g., from about 0.03 cm to about 15 cm, from about 0.03 cm to about 1 cm, from about 0.1 cm to about 5 cm, or from about 1 cm to about 15 cm. The generated electromagnetic waves may be generated as pulses (e.g., at a prescribed frequency) or as continuous waves. The sensor may utilize contact with the pre-transformed material or avoid contacting the pre-transformed material whose level in the container/enclosure is to be ascertained. The generated electromagnetic waves may propagate via a waveguide. The waveguide may comprise one or more components. For example, the waveguide may comprise a hollow member such as a casing. The waveguide may comprise an inner member and an outer member. The outer member may comprise a casing of the inner member. The casing may be the hollow member. The waveguide may be devoid of an inner member. The sensor may be configured to detect a reflection from a reflective interface of the material. The sensor may determine the distance to the reflective interface of the material. The waveguide may (e.g., substantially) confine transmission of the energy of the electromagnetic wave to a direction of propagation in the structure of the waveguide. The inner member and the outer member may be separated by a gap. The electromagnetic waves may propagate in the gap between the inner member and the outer member. In some embodiments, the casing encases sides of the inner member, e.g., and not a distal end of the internal member. In some embodiments, the casing encases sides and a distal end of the inner member. The material whose level in a container is of interest may be liquid or particulate matter. The hollow member may comprise open pores, e.g., holes or perforations. The open pores may be configured to allow (i) ingress of the particulate material into the interior waveguide space (e.g., gap) and/or (i) egress of the particulate material into the interior waveguide space (e.g., gap). The hollow member (e.g., casing) may be configured to allow penetration of the particulate material into its interior volume in which the radiation propagates (e.g., the gap between the permeable casing and the inner member). A waveguide having such a permeable hollow member, may measure an interface between an atmosphere and particulate material disposed in its interior volume. The interior volume of the hollow member may be configured to (e.g., reliably) reflect the level of material (e.g., particulate material) in the container, e.g., in real time during changes occurring in the level of the material in the container, e.g., as the changes occur.

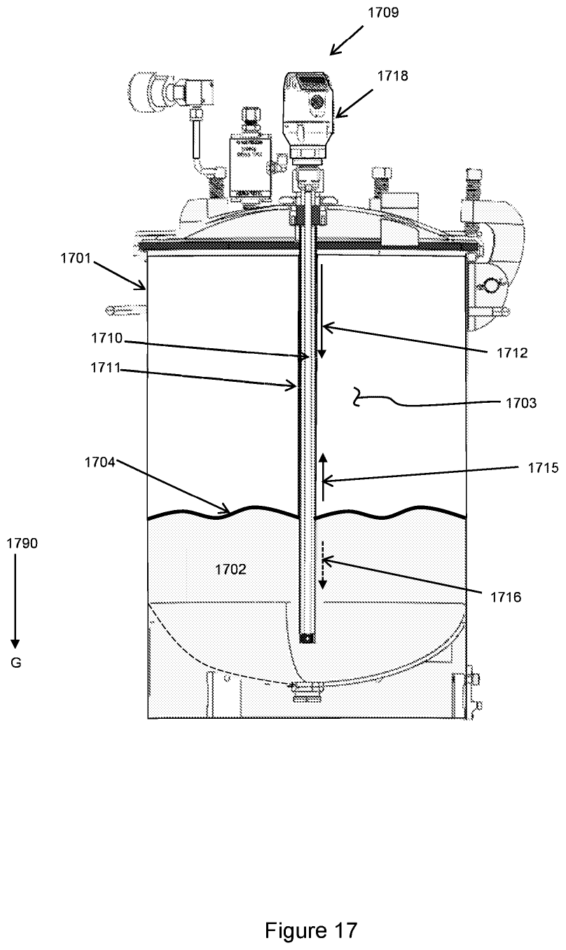

FIG. 17 shows a vertical cross-sectional example of container 1701 having material 1702. The level of the material 1702 in the container is of interest. Container 1701 comprises an atmosphere in enclosed space 1703. Interface 1704 is the interface between material 1702 and the atmosphere in enclosed space 1703. The container 1701 is operatively coupled with a material level sensor 1709. The sensor 1709 comprises a waveguide inner member 1710 (e.g., rod). The inner member 1710 is encased in a waveguide outer hollow member (e.g., casing) 1711. Portion 1718 of the sensor 1709 comprises an electromagnetic wave generator that generates electromagnetic waves. The electromagnetic waves may propagate in direction 1712 in a gap between the inner member 1710 and the outer member 1711. Some of the radiation propagating in the direction 1712 may enter into the material 1702 in direction 1716, e.g., and become absorbed in the material. Some of the radiation may reflect from interface 1704 and be measured by the detector, e.g., as a part of portion 1718 of the sensor 1709. The radiation may reflect back in the direction 1715 once it interacts with the interface 1704 between the atmosphere and a material in the gap. The container 1701 is depicted with respect to gravitational vector 1790 pointing towards gravitational center G. The waveguide comprising the inner (e.g., internal) member 1710 and casing 1711 is aligned vertically. The electromagnetic radiation is generated in one end (e.g., portion 1718) of the waveguide and travels in direction 1712 to an opposing end of the waveguide along gravitational vector 1790.

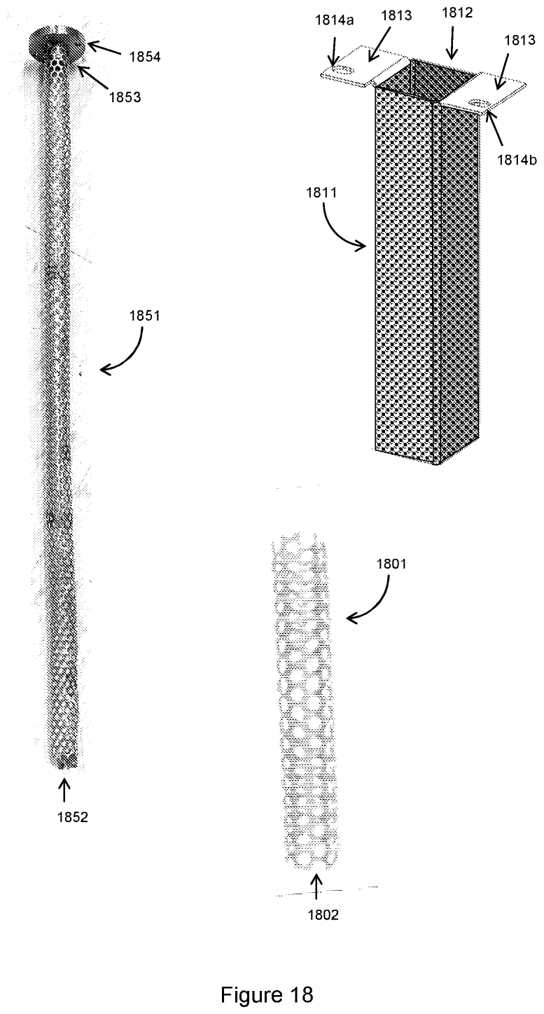

FIG. 18 shows a schematic perspective view example of waveguide casing 1801 shaped as a tube having open holes. Casing 1801 comprises a hollow interior in the direction of 1802. A waveguide inner member (e.g., rod) may be placed in the hollow interior. FIG. 18 shows a perspective view example of photographed waveguide casing 1851 shaped as a tube. Casing 1851 comprises open holes. Casing 1851 comprises a hollow interior in the direction of 1852. A waveguide inner member (e.g., rod) may be placed in the hollow interior. Casing 1851 has connector portions 1853 having holes 1854 for fasteners (e.g., screws), e.g., configured to facilitate fastening the casing 1851 to a container's lid. FIG. 18 shows a schematic perspective view example of waveguide hollow outer member casing 1811 shaped as a box having holes. Casing 1811 comprises a hollow interior in the direction of 1812. A waveguide inner member may be placed in the hollow interior. Casing 1811 comprises connector portions 1813 having holes 1814a and 1814b for fasteners (e.g., screws), e.g., configure to facilitate fastening the casing to a container's lid.

In some embodiments, the material conveyance system comprises a material recycling system. The material recycling system may comprise a separator. The separator may comprise a cyclone or a sieve enclosure. The cyclone may receive a remainder material, e.g., the remainder material initially disposed in an enclosure. The cyclone may separate the remainder material from gas. The separated remainder material from the cyclone may be conveyed into the sieve enclosure. The separated gas from the cyclone may be conveyed into a gas channel. The separator may comprise one or more sensors. The one or more sensors may comprise a pressure sensor, a temperature sensor, a gas flow sensor, or a material level sensor. In some embodiments, the sieve enclosure comprises one or more sensors. The sieve enclosure may comprise (i) a pressure sensor or (ii) a material level sensor. The pressure sensor may be configured to sense pressure inside the sieve enclosure. The material level sensor may be configured to sense a level (e.g., surface level) of the remainder material exiting from the cyclone and accumulating on the sieve, e.g., above a threshold level. The remainder material may be conveyed into the sieve enclosure through an inlet opening (e.g., entrance port) of the sieve enclosure. The inlet opening of the sieve enclosure may be coupled (i) directly with (e.g., an outlet opening of) the cyclone, or (ii) through a channel connected to (e.g., an outlet opening of) cyclone. The material level sensor may be disposed adjacent to the inlet opening of the sieve enclosure. The material level sensor may or may not at least partially overlap with the inlet opening of the sieve enclosure, as seen from the opening of inlet such as a horizontal view of the inlet opening. In some embodiments, at least a portion of the material level sensor (e.g., waveguide) is disposed below the inlet opening of the sieve enclosure such that the material level sensor at least partially horizontally overlaps with the inlet opening of the sieve enclosure. In an example, at least a portion of the material level sensor is disposed below the center of the inlet opening, as seen from the opening of inlet such as a horizontal view of the inlet opening. In some embodiments, the material level sensor is separated from the inlet opening of the sieve enclosure as seen from the opening of inlet such as a horizontal view of the inlet opening. The material level sensor may not overlap with the inlet opening of the sieve enclosure. In some embodiments, the waveguide of the material level sensor is (e.g., substantially) perpendicular to the upper surface of the sieve. A portion of the material level sensor may be disposed outside of the sieve enclosure. The material level sensor may penetrate a wall (e.g., ceiling) of the sieve enclosure. The material level sensor may detect a remainder material that accumulates on the sieve in the sieve enclosure, e.g., in situ and in real time. The accumulation of the remainder material may caused (e.g., at least in part) sieve blind. The accumulation of the remainder material on the sieve may interrupt (e.g., stop) the manufacturing process, e.g., when no mitigation measures are taken at a timely fashion. The one or more sensors (e.g., the pressure sensor and/or the material level sensor) may be configured to facilitate reducing the possibility of interruption that may cause harm such as interrupting the manufacturing process. The material level sensor may comprise a contact level sensor or a non-contact level sensor. The material level sensor may comprise a capacitance level sensor, float level sensor, silo-pilot level sensor, servo level sensor, displacer level sensor, ultrasonic level sensor, guide wave radar level sensor, laser level sensor, or radiometric level sensor. In an example, the material level sensor is a guide wave radar (GWR) level sensor. The material level sensor may comprise a waveguide, e.g., as disclosed herein. Electromagnetic wave (e.g., pulses) may be generated and propagate along the waveguide of the material level sensor. The waveguide may comprise an inner member and an outer member. The outer member may be permeable to the remainder material. The outer member may comprise pores having a FLS sufficient for the remainder material to pass through. The pulses may be reflected by the surface of the remainder material. A portion of energy of the electromagnetic wave pulses may be reflected back up the waveguide to the sensor. A time difference between the generated and reflected pulse may be converted into a distance. The surface level of the remainder material may be calculated from the distance. At least a portion of the waveguide may be submerged in the residual material. The material level sensor may be operatively coupled with a prevention system, e.g., as disclosed herein. The material level sensor may transmit data of the surface level of the remainder material to the prevention system, e.g., in real time. The prevention system may comprise a threshold surface level. The waveguide may or may not contact the sieve. The prevention system determines accumulation of the remainder material, when the material level sensor detects the surface level of the remainder material being above a threshold. The prevention system may be configured to initiate, or direct the initiation of, a prevention operation, e.g., as disclosed herein. The prevention operation may reduce the possibility of interrupting (e.g., stopping) the manufacturing process. The material level sensor may or may not be disposed perpendicularly to the sieve. In some embodiments, the waveguide of the material level sensor is disposed perpendicularly to the sieve. In some embodiments, the waveguide of the material level sensor is tilted with respect to the sieve. The waveguide of the material level sensor may form an angle with (e.g., an upper surface of) the sieve. The angle may be about 90 degrees. The angle may be smaller or larger than 90 degrees. The sieve may be planar. The sieve may be disposed parallel (e.g., flat) with respect to a horizon. The sieve may be disposed as tilted with respect to a horizon. The horizon may be a direction normal to a direction of gravitational vector pointing towards the gravitational center of the ambient environment. The accumulated remainder material on the sieve may form an angle of repose. The angle of repose may be an angle between the upper surface of the sieve and the external surface of the remainder material pile generated when the remainder material (e.g., particulate matter such as powder) accumulates on being pored through the inlet opening. The angle of repose may change (e.g., decrease) as the remainder material accumulates on the sieve. The material level sensor may identify sieve blinding when the angle of repose deviates from a predetermined angle range.

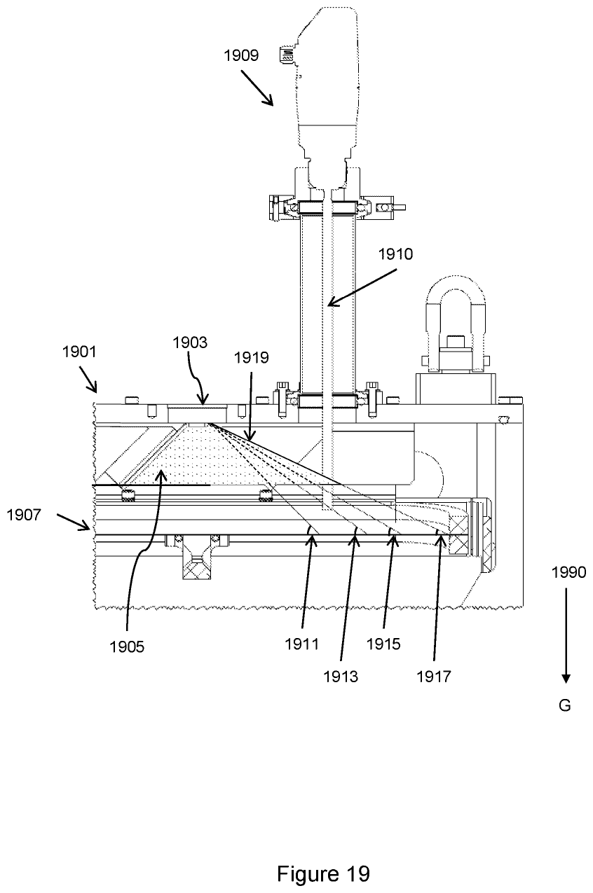

FIG. 19 shows an example of a sieve enclosure coupled with a sensor. The sieve enclosure 1901 comprises an inlet opening 1903. Remainder material 1905 is conveyed through the inlet opening 1903. During normal operation (now shown here), the remainder material would be filtered (e.g., sieved) through the sieve 1907. At times, e.g., during faulty operation, the remainder material 1905 accumulates on sieve 1907. A material level sensor 1909 is configured to detect the remainder material 1905 accumulated on sieve 1907, e.g., in situ and in real time. The accumulated remainder material 1905 above sieve 1907 comprises an exposed surface, e.g., exposed surface 1919. The exposed surface of the remainder material 1905 accumulate above sieve 1906 forms an angle of repose (e.g., 1911, 1913, 1915 or 1917) with the planar and horizontally disposed surface of sieve 1907. The angle of repose decreases (e.g., from 1911 to 1917) as the remainder material accumulates on the sieve 1907. Waveguide 1910 of the material level sensor 1909 disposed at a gap from sieve 1907. Waveguide 1910 is not in contact with remainder material 1905, when the angle of repose is below a predetermined angle, e.g., when the angle of repose is represented as 1911. The waveguide 1910 is in contact with remainder material 1905, when the repose angle is below the predetermined angle, e.g., when the angle of repose is represented as the angle between the exposed surface of the remainder material accumulating above sieve 1907 and the planar surface of sieve 1907, e.g., angles 1913, 1915, or 1917. A prevention system may be operatively coupled with the material level sensor 1909. The prevention system may become triggered when waveguide 1910 senses the remainder material, e.g., reaching angle of repose as depicted in angles 1913, 1915, or 1917. For example, while the waveguide may sense the remainder material in 1913, triggering the prevention system may occur when the waveguide senses the material as in angle 1915 or angle 1917. The example components shown in FIG. 19 are depicted with respect to gravitational vector 1990 pointing towards the environmental center G. The material level sensor 1909 is aligned vertically with respect to the planar and horizontal sieve 1907. The remainder material flows vertically into the sieve enclosure through inlet opening (e.g., entrance port) 1903.

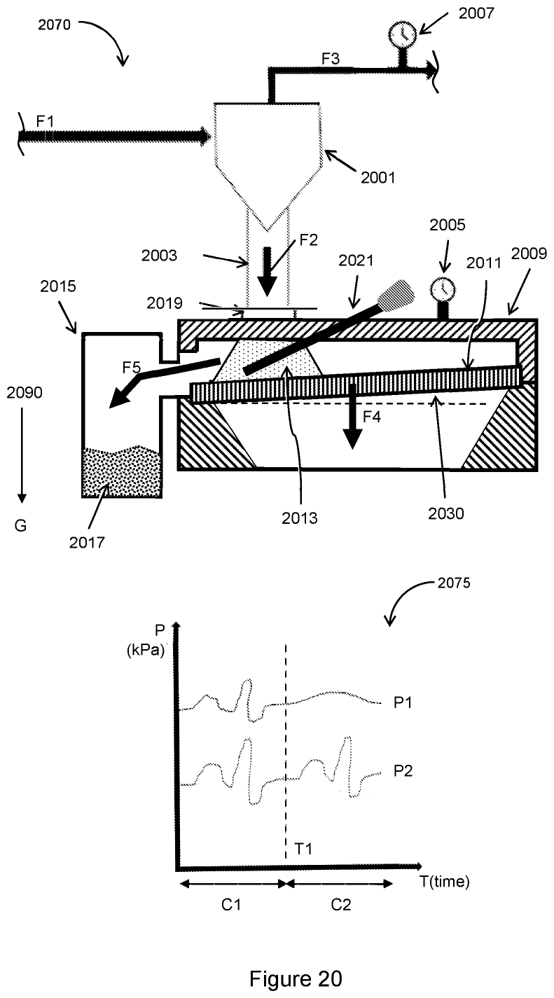

FIG. 20 shows an example of a portion of a manufacturing system that is a three-dimensional printing system, and a schematic graph of a pressure fluctuation as a function of time. Example 2070 shows an example of a portion of a material conveyance system. In example 2070, the material conveyance system comprises a cyclonic separator 2001 (also herein “cyclone”) and a sieve enclosure 2009. Remainder material is conveyed into the cyclone 2001, as depicted by arrow F1. Cyclone 2001 is configured to separate the remainder material from gas. The separated remainder material is to be introduced into sieve enclosure 2009 via channel 2003, as depicted by arrow F2. The separated gas is introduced into a gas channel, as depicted by arrow F3 disposed upstream of sieve enclosure 2009. The separated remainder material is to be filtered (e.g., sieved) by sieve 2011. During normal operation, the filtered remainder material is conveyed to the rest of the material conveyance system after passage through sieve 2011, as depicted by arrow F4. During normal operation, unfiltered material is conveyed to a removal container 2015, as depicted by arrow F5. The unfiltered material 2017 is collected in the removal container 2015. During faulty operation, the remainder material 2013 accumulates on the sieve 2011. The accumulated remainder material 2013 may block an entrance port 2019 (inlet opening) through which the remainder material is to be introduced into the sieve enclosure 2009. The sieve enclosure comprises, or is operatively couple with (i) a first pressure sensor 2005, and (ii) a material level sensor 2021, e.g., comprising a waveguide such as disclosed herein. The gas channel flowing gas in direction F3 comprises, or operatively couple with, a second pressure sensor 2007. Material level sensor 2021 is separated from planar sieve 2011 by a gap. Material level sensor 2021 is in contact with the accumulated remainder material 2013, beyond a threshold comprising the gap. The material level sensor 2021 is configured to detect a level of an exposed surface of the accumulated remainder material 2013 on sieve 2011. Sieve 2011 is planar and disposed at angle 2030 with respect to the horizon. Material level sensor 2021 is tilted with respect to planar sieve 2011, and a portion of material sensor 2021 overlaps horizontal cross section of entrance port 2019. A first pressure sensed by the first pressure sensor 2005 is schematically depicted as P1 in example 2075. A second pressure sensed by the second pressure sensor 2007 is schematically depicted as P2 in example 2075. As shown in example 2075, during normal operation during time span C1, the first pressure P1 and the second pressure P2 correlate with each other. The remainder material (e.g., 2013 in example 2070) accumulates on the sieve (e.g., 2011 in example 2070) and blocks the entrance (e.g., 2019 in example 2070), at or around time T1. During faulty operation, at time span C2, the first pressure P1 and the second pressure P2 have a compromised correlation (e.g., do not correlate) with each other. Such compromised correlation may entail initiating prevention measures or halting the manufacturing (e.g, printing) operation. Example 2070 is depicted with respect to gravitational vector 2090 pointing towards the environmental center G.

In some embodiments, a material recycling system comprises one or more sensors. The one or more sensors may comprise a pressure sensor, a temperature sensor, a gas flow sensor, or a material level sensor. In some embodiments, the material recycling system comprises one or more material level sensors. The material recycling system may comprise a channel, a cyclone, a sieve enclosure or a removal container. The channel(s) may comprise a gas conveyance channel or a material conveyance channel. Remainder material disposed in the enclosure may be attracted away from the enclosure and be conveyed into the sieve enclosure. The remainder material may be initially disposed in the manufacturing enclosure, e.g., during and/or after the printing. The remainder material may pass through the cyclone. The (e.g., separated) remainder material may be sieved by a sieve in the sieve enclosure. The sieved remainder material may be used as a starting material in a subsequent printing operation. Material unsuitable for reuse in the subsequent printing operation may be filtered out by the sieve. In some embodiments, it is advantageous to measure a level of material in the sieve enclosure. In an example, it is advantageous to measure (i) the level of the remainder material accumulated on the sieve and/or (ii) the level of the debris collected in the removal container. This measurement may at least in part facilitate prevention of the interruption in the manufacturing such as in the printing. The sieve enclosure may comprise, or be operatively couple with, a material level sensor. The removal container may comprise at least one other level sensor. At least two of the sensors may be of the same sensor type. At least two of the sensors may be of a different type. The material level sensor(s) of the sieve enclosure may detect the remainder material accumulated on the sieve. At times, the remainder material may not be filtered through the sieve and may accumulate on the sieve. The sieve may be at least partially blocked (e.g., blinded) by the remainder material. The material level sensor(s) may be configured to detect the level of the accumulated remainder material on the sieve. At least one of the material level sensors may comprise a waveguide. In some embodiments, the waveguide of the material level sensor is in contact with the remainder material when the remainder material accumulates on the sieve, e.g., above a threshold level. The removal container may be disposed downstream of the sieve enclosure. The removal container may comprise, or be operatively couple with, at least one material level sensor. At least two of the sensors may be of the same sensor type. At least two of the sensors may be of a different type. The material level sensor(s) of the removal container may be configured to detect the level of the debris collected in the removal container, e.g., above a threshold level. In some embodiments, the waveguide of a material level sensor is in contact with the collected material when an amount of the collected material exceeds a predetermined level. The material level sensor of the sieve enclosure and/or the removal container may be operatively coupled with a prevention system. The prevention system may receive data from the material level sensor(s). The prevention system may initiate, or direct initiation of, a prevention operation, when (i) the accumulated remainder material on the sieve exceeds a threshold and/or (ii) the collected material (e.g., debris and/or agglomerates) in the removal container exceeds a threshold. The sieve enclosure and/or the removal container may comprise additional sensor(s), other than the material level sensors. In some embodiments, the sieve enclosure and/or the removal container further comprises a pressure sensor, a temperature sensor, or a gas flow sensor.

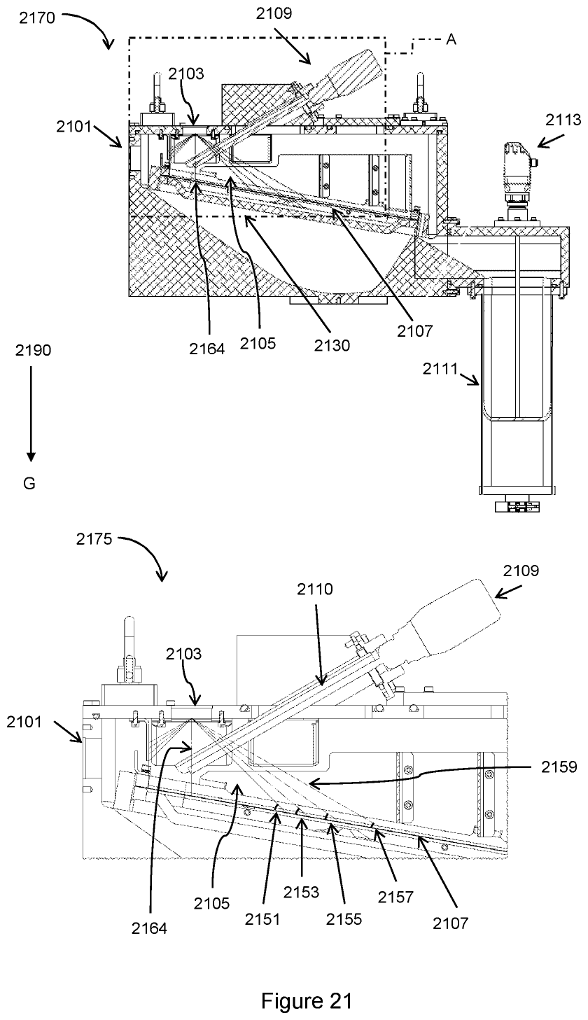

FIG. 21 shows various example views of a portion of a manufacturing system that is a three-dimensional printing system. Example 2170 shows an example of a portion of a material recycling system shown as a vertical cross section. Example 2175 shows a vertical cross section of an enlarged view depicted as section A in example 2170. The material recycling system comprises a sieve enclosure 2101 and a removal container 2111 for a portion of the remainder material unsuitable as a starting material, e.g., having FLS that is too large. A material level sensor 2113 is operatively coupled with the removal container 2111. The material level sensor 2113 may be configured to sense a level of the material collected in the removal container 2111. In the example shown in FIG. 21, 2170, material level sensor 2109 and 2113 are of the same type and are GWR sensors. The sieve enclosure 2101 comprises an inlet opening 2103. Remainder material is conveyed through the inlet opening 2103. During normal operation, the remainder material is filtered (e.g., sieved) through sieve 2107 disposed in the sieve enclosure 2101. At times, e.g., during faulty operation such as sieve blinding, remainder material accumulates on the sieve 2107 at a remainder material level having a vertical cross section 2105. Sieve 2107 is planar and disposed at an angle 2130 with respect to the horizon. The angle can be of at most about 80 degrees (°), 60, 60, 45°, 30°, 20°, 10°, or 5° with respect to the horizon. The accumulated remainder material may accumulate on the sieve to the extent that it blocks at least a portion of inlet opening 2103. A material level sensor 2109 may be configured to detect accumulated remainder material, e.g., above a threshold level. A waveguide 2110 (in example 2175) of the material level sensor 2109 has a portion that is located below a horizontal cross section of the inlet opening 2103. Waveguide 2110 is extended beyond a central axis 2164 of inlet opening 2103. Waveguide 2110 of material level sensor 2109 can be submerged in the accumulated remainder material when it reaches the remainder material level depicted in 2105. The material level sensor 2109 may be configured to detect a level of surface 2159 of the accumulated remainder material level depicted from 2105, 2151, 2153, 2155, and/or 2153. The level of the exposed surface 2159 of the accumulated remainder material above sieve 2107 varies depending on the amount of the accumulated remainder material above sieve 2107. An angle of repose (e.g., 2151, 2153, 2155, and 2157) between an exposed surface of the sieve 2107 and the exposed surface 2159 of the accumulated remainder material varies depending at least in part on the amount of the accumulated remainder material above sieve 2107.

In some embodiments, a material conveyance system comprises a channel. The channel may operatively couple with an enclosure, a separator, a bounceable plate enclosure, a layer dispensing mechanism, and/or a reservoir. The channel may be configured to convey material. The material may comprise remainder material. The remainder material may be a starting material that is not utilized to form one or more 3D objects. The remainder material may comprise pre-transformed material, debris or agglomerates. The channel may comprise an internal atmosphere having positive pressure relative to an atmospheric pressure external to the three-dimensional printer. A carriage may be connected to the channel. The carriage may be a part of, or operatively coupled with, a moving system. The moving system may be configured to facilitate the movement of the channel. The carriage may be configured to facilitate coupling of the channel to the moving system. The channel may be a flexible hose. The channel may have a diameter of at most about 1.0 inch (″), 2.0″, 2.25″, 2.5″, 2.75″, 3.0″, or less. The channel may have a diameter having a value between any of the aforementioned values, e.g., from about 1.0″ to about 3.0″, or from about 2.0″ to about 2.75″. The channel may be operatively coupled with a material removal mechanism (e.g., remover) as part of a layer dispensing mechanism (e.g., recoater). The pre-transformed material may be removed from the enclosure through the material removal mechanism using an attraction force, e.g., vacuum pump. The channel may be operatively coupled with a wall (e.g., floor) of the enclosure (e.g., processing chamber) and/or the ancillary chamber (e.g., garage). The channel may be operatively coupled with the moving system. The material removal mechanism may be mounted to the moving system. The moving system may move during operation. The channel may comprise one or more openings. The openings of the channel may be configured to facilitate coupling(s) with (i) the moving system, (ii) the layer dispensing mechanism (e.g., remover), and/or (iii) the wall opening (e.g., of the enclosure and/or ancillary chamber). The coupling may be adjustable. The channel may be flexible. In some embodiments, the channel comprises (i) a flexible material and/or (ii) a flexible structure, e.g., the channel may be made at least in part from a flexible material. The (e.g., flexible) channel may facilitate the movement of the remover along with the moving system. The channel may comprise portions with different hardness. The channel may comprise rigid portion(s) that are harder than other portions of the channel. The channel may comprise flexible portion(s) that are softer than other portions of the channel. The rigid portion(s) may comprise a portion that is coupled with (i) the remover, (ii) the ancillary chamber (e.g., an exit opening from the garage), or (iii) the enclosure (e.g., an exit opening from the processing chamber). The flexible portion(s) may facilitate folding and unfolding of the channel during movement of the layer dispensing mechanism. The flexible portion may comprise a hose. The rigid portion may comprise a pipe. The flexible portion of the channel may comprise a flexible polymer or a flexible resin. The rigid portion of the channel may comprise an elemental metal, a metal alloy, a ceramic, an allotrope of elemental carbon, a rigid polymer, or a rigid resin. The channel may be configured to facilitate movement of the layer dispensing mechanism (i) to the end of a material bed closest to the opening of the enclosure (e.g., processing chamber), and (ii) to an interior of the ancillary chamber (e.g., garage). When the channel is in the interior of the ancillary chamber, a door of the ancillary chamber may be able to be closed. The layer dispensing mechanism (e.g., material dispenser) may be configured to (e.g., may be able to) receive pre-transformed material from a reservoir (e.g., a doser).

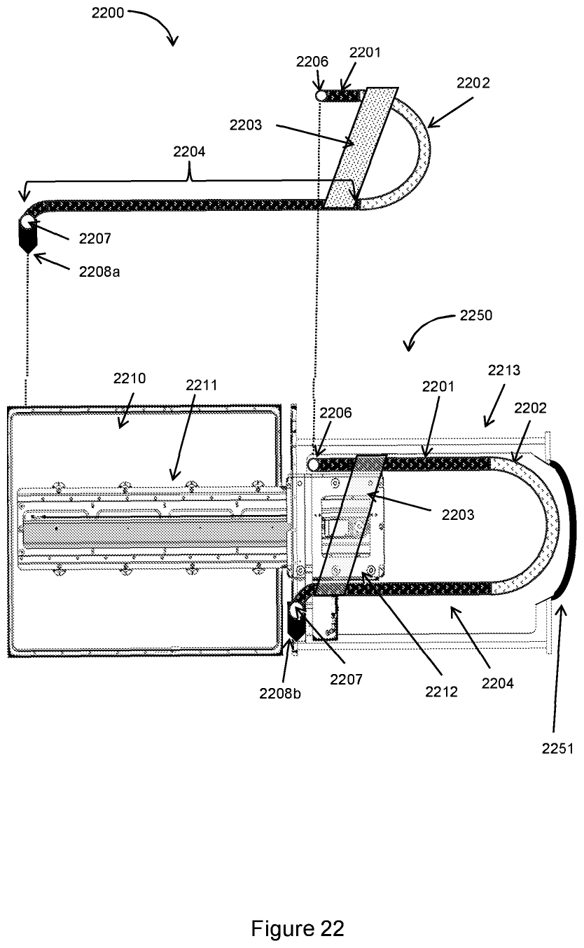

FIG. 22 shows a side view example of a channel. Example 2200 shows an example of a side view of an extended (e.g., stretched) channel. Example 2250 shows an example of a side view of a retracted (e.g., folded) channel. The channel comprises three sections: a first (e.g., upper) rigid portion 2201, a flexible portion 2202, and a second (e.g., lower) rigid portion 2204. The channel comprises a first (e.g., upper) opening 2206 and a second (e.g., lower) opening 2207. The second opening 2207 is coupled with a remover 2208a and 2208b as part of a layer dispensing mechanism. In example 2250, the flexible portion 2202 of the channel reaches the end of garage 2213. Garage 2213 comprises extension 2251 to accommodate the channel. A reservoir (e.g., doser) 2203 contains material that may be supplied to the layer dispensing mechanism. A processing chamber comprises a wall 2210. Railing 2211 is attached to wall 2210 of the processing chamber. Carriage 2212 is coupled with the wall 2210 of the processing chamber. A remover 2208a and 2208b of the layer dispensing mechanism is coupled with carriage 2212. In example 2200, the head of the remover 2208a is aligned with the end of the processing chamber. In example 2250, The head of the remover 2208b is aligned with the front of the garage facing the processing chamber.

In some embodiments, a material conveyance system comprises a channel. The material conveyance system may convey pre-transformed material (e.g., and gas) through the channel. The pre-transformed material may comprise a starting material or a remainder material. In some embodiments, the channel is operatively coupled with a manufacturing enclosure. In some embodiments, the channel is operatively coupled with an ancillary chamber. The ancillary chamber may be operatively coupled with the enclosure, e.g., with the processing chamber of the enclosure. The ancillary chamber may be configured to accommodate a layer dispensing mechanism in its resting (e.g., idle) position. The channel may convey the remainder material to a recycling system, the remainder material being conveyed from the manufacturing enclosure and/or from the ancillary chamber. The remainder material may comprise an elemental metal, a metal alloy, a ceramic, or an allotrope of elemental carbon. In some embodiments, the remainder material comprises metallic powder. The remainder material may be conveyed in an atmosphere having a pressure above an atmospheric pressure external to channel, e.g., and external to the manufacturing system. The channel may be any channel disclosed herein. The channel may comprise flexible material. The channel may comprise a flexible polymer or a flexible resin. The channel may comprise polyvinylchloride (PVC), polyurethane, or rubber. The channel may comprise flexible structure, e.g., bellow structure or foldable structure. The channel may comprise a rigid material that is structured in a flexible manner, e.g., a metallic bellow. The channel may comprise, or be operatively coupled with, a supportive structure. The supportive structure may comprise a guiding chain or a railing. The guiding chain may comprise, or be operatively couples with the railing, e.g., with a rail. The guiding chain and the rail may facilitate movement of the channel along a path. In some embodiments, the channel is configured to move without the need for a supportive structure such as a guiding chain. The channel may be operatively coupled with the rail. The channel may comprise a plurality of channel layers. In some embodiments, the channel comprises an inner channel and an outer channel. In an example, an inner channel is encased by an outer channel to form a two layer channel. The outer channel may encase (e.g., surround) at least a portion of the inner channel. In some embodiments, the inner channel and the outer channel are concentric. The inner channel and the outer channel may form an interstitial space. The interstitial space may be a space between an internal surface of the outer channel and an external surface of the inner channel. In some embodiments, an interstitial volume between the inner channel and the outer channel is closed. The closure may enclosure any leaking pre-transformed material from the inner channel to the interstitial space. The closure may be hermetic and/or gas tight. The closure may facilitate maintaining in the interstitial space an atmosphere different from an ambient atmosphere external to the outer channel. The outer channel may or may not comprise a restrictor configured to allow (e.g., a limited and/or controlled flow of) gas to be expelled from the interstitial space to the ambient environment. The restrictor may allow unidirectional gas flow therethrough, or bidirectional gas flow therethrough. The restrictor may comprise an orifice, e.g., an adjustable orifice. The restrictor may be configured to facilitate fluidic communication between (i) an ambient environment external to the channel (e.g., and external to the manufacturing system) and (ii) the interstitial space, e.g., at least during operation such as manufacturing, pre-transformed material flow through the channel, and/or recycling. The restrictor may facilitate equilibrating the interstitial pressure with the atmospheric pressure external to the printing system. The restrictor may facilitate allowing equilibration efforts between the interstitial pressure with the atmospheric pressure external to the printing system, e.g., even if the efforts do not result in pressure equilibration between the ambient environment and the interstitial space atmosphere. The restrictor may be configured to prevent pressure equilibration between the ambient environment and the interstitial space atmosphere. The interstitial space may comprise an interstitial atmosphere having an interstitial pressure. The interstitial pressure may be (e.g., substantially) identical with the ambient pressure. The interstitial pressure may be above the ambient pressure. The interstitial pressure may be below a pressure presiding in an atmosphere inside the inner channel. The inner channel may be configured to convey the reminder material via dense phase or dilute phase conveyance, e.g., as disclosed herein. In an example, the inner channel is configured to convey the reminder material via dilute phase conveyance, e.g., carried by gas. The inner channel may be configured to facilitate flow of the remainder material. At times, the flow of the remainder material may result in damage to wall(s) of inner channel, e.g., over such usage of the channel such as over a prolonged usage. Without wishing to be bound to theory, the remainder material may harmfully interact with wall(s) of the inner channel, e.g., to scrape, scratch, erode, corrode, abrase, and/or otherwise (e.g., chemically) react with wall(s) of the inner channel. Without wishing to be bound to theory, the remainder material may cause damage of the inner channel by causing at least one hole, crack, and/or rupture. The damage may cause a malfunction of the inner channel. The malfunction may comprise in ability of the channel to maintain the internal atmosphere different from the ambient atmosphere such as inability to maintain a pressure of the internal atmosphere of the inner channel. The malfunction may comprise inability of the channel to facilitate flow of the remainder material therethrough. The malfunction may comprise inability of the channel to maintain the remainder material in the interior of the internal channel during its flow through the internal channel. In an example, the remainder material expels from the inner channel to the interstitial space due to damage in the inner channel. The outer channel may be configured to enclose the remainder material when the inner channel malfunctions, e.g., to the extent that material is spilled into the interstitial space. The outer channel may be configured to enclose the atmosphere of the inner channel when the inner channel malfunctions, e.g., to the extent the inner channel is unable to maintain the pressure in the inner channel due to a defect that allows gas to flow to the interstitial space. The outer channel may be configured to facilitate the flow of the remainder material through the inner channel when some of the remainder material is spilled into the interstitial space. The outer channel may be configured to maintain the inner atmosphere in the inner channel when some of the remainder material and/or inner atmosphere flows to the interstitial space. The channel may comprise one or more sensors. The one or more sensors may be a pressure sensor, temperature sensor, gas flow sensor, material level sensor. The sensor(s) may comprise an optical sensor, a sonic sensor, or an electrical sensor. The sensor(s) may comprise a proximity sensor. In some embodiments, the channel comprises one or more pressure sensors. At least two of the sensors may be of the same type. At least two of the sensors may be of a different type. The channel may comprise at least one pressure sensor configured to sense the interstitial pressure. he channel may comprise at least one pressure sensor configured to sense the pressure inside the inner channel. The one or more pressure sensors may transmit pressure data to a prevention system. The prevention system may be a part of a control system of the manufacturing system. The prevention system may be separated from the control system of the manufacturing system. The prevention system may monitor (e.g., track) the interstitial pressure and/or the pressure in the internal atmosphere of the inner channel. The prevention system may detect change (e.g., alteration or fluctuation) in the interstitial pressure, e.g., as compared to the pressure in the manufacturing enclosure and/or as compared to the pressure in the manufacturing enclosure in the inner channel. The atmosphere of the inner channel is operatively coupled with the atmosphere of the manufacturing enclosure. The manufacturing enclosure may comprise an overpressure, e.g., during operation. In some embodiments, the prevention system detects a pressure rise above a threshold in the interstitial pressure, e.g., signaling pressure equilibration efforts with the internal atmosphere of the inner channel. The atmosphere of the manufacturing enclosure may experience (e.g., regular) pressure fluctuations during operation. In some embodiments, the prevention system detects a pressure variation pattern in the interstitial pressure, the pressure variation pattern in the interstitial pressure being associated with (a) the pressure variation pattern in the manufacturing enclosure and/or (b) the pressure variation pattern in the inner atmosphere of the inner channel. Such pressure variation pattern sensed in the interstitial volume may signal pressure equilibration efforts with the internal atmosphere of the inner channel. According to the degree of the pressure change detected in the interstitial volume, the prevention system may assess the degree of damage in the inner channel. The prevention system may initiate a prevention operation when the prevention system detects the change in the interstitial pressure. The prevention operation may comprise triggering an alarm, generating a report, generating an instruction, prescribing a remedial operation by an operator, or initiating a prescribed remedial scheme. The prevention operation may be performed automatically and/or manually.

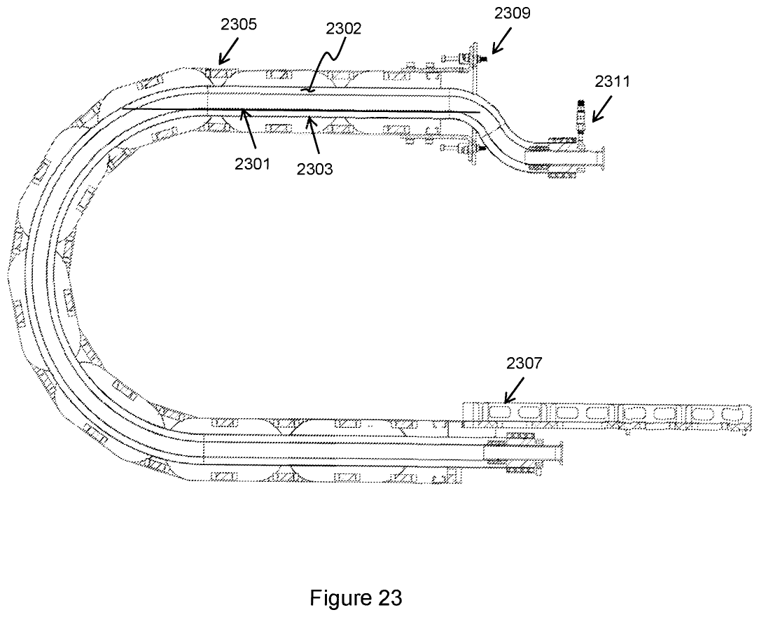

FIG. 23 shows an example of a channel of material conveyance system, e.g., as part of a recycling system. The channel comprises an inner channel 2301 and an outer channel 2303. An external surface of the inner channel 2301 and an internal surface of the outer channel 2303 forms interstitial space 2302. The channel is operatively coupled with sensor 2309. The sensor 2309 may be configured to sense at least one characteristic (e.g., pressure) of the interstitial space 2302. The outer channel 2303 comprises restrictor 2311. The channel is operatively coupled with a supportive structure in the form of guiding chain 2305. The guiding chain 2305 is operatively coupled with rail 2307.

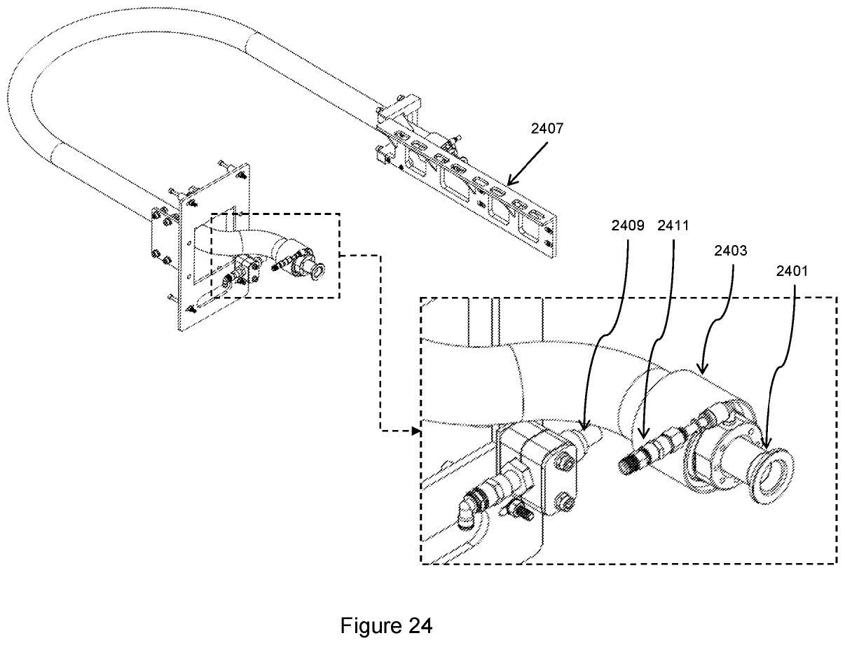

FIG. 24 shows an example of a channel of a material conveyance system, e.g., as part of a recycling system. The channel comprises an inner channel 2401 and an outer channel 2403. An external surface of the inner channel 2401 and an internal surface of the outer channel 2403 forms an interstitial space. The channel is operatively coupled with sensor 2409. The sensor 2409 may be configured to sense at least one characteristic (e.g., pressure) of the interstitial space. The outer channel 2403 comprises restrictor 2411. The channel is operatively coupled with rail 2407.

In some embodiments, a manufacturing system encloses an internal atmosphere, e.g., in a manufacturing enclosure thereof. During operation of the manufacturing system, pressure of the internal atmosphere may fluctuate over time, e.g., pressure of the manufacturing enclosure atmosphere. The fluctuation may be (e.g., at least in part) caused by the operation of one or more components of the manufacturing system such as 3D printing system. In an example, the pressure of the internal atmosphere drops (i) when the remover (e.g., of the layer dispensing mechanism) attracts (e.g., vacuums) remainder material from the manufacturing enclosure, and/or (ii) when the remainder material flows away from the layer dispensing mechanism downstream to the material conveyance system, e.g., to the recycling system. In an example, the pressure of the internal atmosphere fluctuates when the layer dispensing mechanism changes its position between the ancillary chamber and the processing chamber. The manufacturing system may comprise a pressure equilibration mechanism. The pressure equilibration mechanism may be configured to (i) compensate for a pressure drop in the enclosure and/or (ii) alleviate a pressure rise in the enclosure. The pressure equilibration mechanism may (e.g., at least in part) cause the pressure fluctuation in the internal atmosphere of the manufacturing system. The layer dispensing mechanism may repeat a layer dispensing operation over time, e.g., during printing. The layer dispensing operation may comprise (i) dispensing of the starting material or (ii) removing the remainder material. In some embodiments, the layer dispensing operation comprises a leveling operation. The repetition of layer dispensing operation may induce a repetition of such fluctuation in the pressure of the internal atmosphere of the manufacturing system, over time. The pressure fluctuation in the pressure may comprise an increase, a plateau, a maximum, a minimum, or a decrease. In some embodiments, the pressure of the internal atmosphere of the manufacturing system (e.g., of the manufacturing enclosure) exhibits a pulsation over time, e.g., regular and/or repetitive unit pulse. In some embodiments, the pressure of the internal atmosphere of the manufacturing system exhibits a (e.g., substantial) repetition of a unit pattern. The unit pressure pattern may comprise a peak, a dip, an increase, a plateau, or a decrease, of the pressure. The unit pattern may correspond to a layer dispensing operation cycle. The internal atmosphere of the manufacturing system may comprise an internal atmosphere of (i) the manufacturing enclosure, (ii) the material conveyance system, (iii) the material recycling system, or (iii) channel(s) (e.g., material conveying channel and/or gas conveying channel) connecting one or more components of the manufacturing system. In some embodiment, the internal atmosphere of the manufacturing system comprises an internal atmosphere of an inner channel. The inner channel may be configured to confine (e.g., enclose) the remainder material and/or gas, e.g., during traversal of the remainder material through the inner channel. The inner channel may be a part of, or may be operatively coupled with, (i) the material conveyance system and/or (ii) the gas conveyance system. In some embodiments, the inner channel is operatively coupled with the material removal mechanism of the layer dispensing mechanism. The inner channel may be configured to facilitate removal of the remainder material away from (i) the manufacturing enclosure, (ii) ancillary chamber, and/or (iii) the material removal mechanism of the layer dispensing mechanism. The inner channel may at least in part be encased by an outer channel. The inner channel may be separated from the outer channel by a gap. An interstitial space may be formed in the gap between an external surface of the inner channel and an internal surface of the outer channel. In some embodiments, during normal operation, the interstitial atmosphere presiding in the interstitial space, is decoupled from the atmosphere in the manufacturing enclosure and/or in the inner channel. In some embodiments, during normal operation, an interstitial pressure of the interstitial atmosphere, is decoupled from the pressure in the manufacturing enclosure and/or in the inner channel. In some embodiments, during normal operation, the interstitial pressure of the interstitial atmosphere has a (e.g., substantially) constant pressure. The normal operation comprises flow of a remainder material in an in-tact inner channel. The normal operation excludes malfunction of the inner channel. In some embodiments, the interstitial pressure equilibrates, or makes an effort to equilibrate, with a pressure of an ambient atmosphere external to the three-dimensional printing system, during the normal operation. The outer channel may comprise a restrictor. The restrictor may be configured to allow efforts to equilibrate the interstitial pressure with the ambient pressure. The equilibration efforts may or may not result in equilibration. In some embodiments, the interstitial space is configured to maintain in the interstitial space an atmosphere different by at least one characteristic (e.g., as disclosed herein) from the ambient atmosphere. In some embodiments, the interstitial space is configured to hold a (e.g., substantially) constant pressure above the ambient pressure. The outer channel may not comprise a restrictor. An insignificant damage in the internal channel wall(s) may allow pressure equilibration efforts between the inner atmosphere of the inner channel and the interstitial atmosphere, e.g., allow gas flow therebetween. Such equilibration efforts may cause the interstitial atmosphere to have coupled and/or associated pressure alteration with internal atmosphere of the inner channel and/or of the manufacturing enclosure, e.g., which pressure fluctuations may be sensed by the interstitial pressure sensor. The sensed interstitial pressure change(s) may cause triggering of the detection system, and since the damage is insignificant, this may constitute a false trigger. Implementation of the restrictor(s) disposed between the interstitial space and the ambient atmosphere, may reduce such false triggering the detection system.

At times, the inner channel malfunctions. The malfunction may comprise a damage in the inner channel, such as a hole, crack, and/or rupture. The damage in the inner channel may be any damage disclosed herein. The damage in the inner channel may allow (e.g., induce) spillage of the remainder material and/or gas to the outer channel. Without wishing to be bound to theory, the damage in the inner channel may be caused by (i) the remainder material (e.g., collision of the remainder material to the internal wall of the inner channel) and/or (ii) internal pressure of the inner channel being above the atmospheric pressure. The outer channel may be configured to encase at least a portion of the inner channel. when the inner channel malfunctions to the extent that remainder material spills from the inner channel into the interstitial space, the outer channel may be configured to (i) facilitate flow of remainder material through the inner channel, (ii) facilitate flow of remainder material through the outer channel (iii) enclose (e.g., confine) the remainder material in the outer channel, and/or (iv) enclose an internal atmosphere in the inner channel that is different by at least one characteristic (e.g., as disclosed herein) from the ambient atmosphere external to the outer channel. The at least on characteristic may comprise overpressure. When the inner channel malfunctions, the interstitial pressure may rise, e.g., above a threshold. The threshold may comprise a value or a function. When the inner channel malfunctions, the interstitial pressure may fluctuate, e.g., in association with the pressure fluctuation in the manufacturing enclosure such as processing chamber. In some embodiments, the interstitial pressure rises and reaches a state of equilibrium. In some embodiments, the interstitial pressure becomes correlated with the pressure of the internal pressure of the inner channel. The internal pressure of the inner channel may exhibit a similar or (e.g., substantially) same pressure change tendency with the rest of the manufacturing system, e.g., with the manufacturing enclosure. The internal atmosphere of the manufacturing enclosure may exhibit a regular pressure fluctuation such as increase and decrease of pressure. The internal atmosphere of the manufacturing enclosure may exhibit a pulsation. The internal atmosphere of the manufacturing enclosure may exhibit a (e.g., substantial) repetition of a first unit pattern. during faulty operation, the interstitial pressure may follow (e.g., track) the pressure fluctuation repetition of the manufacturing enclosure. The interstitial pressure may exhibit a pulsation. The interstitial pressure may exhibit a (e.g., substantial) repetition of a second unit pattern. The second unit pattern may have a (e.g., substantially) same time period (e.g., wavelength) as that of the first unit pattern. The first unit pattern and the second unit pattern may comprise a peak, a plateau, an increase, a decrease, or a dip, respectively. In some embodiments, a peak of the second unit pattern occurs at (e.g., substantially) the same time as a peak of the first unit pattern. In some embodiments, a dip of the second unit pattern occurs at (e.g., substantially) the same time as a dip of the first unit pattern. In some embodiments, change in the first unit pattern tends to be met with a corresponding change in the second unit pattern. In some embodiments, the first pressure pattern may be linked, coupled, and/or associated with the second pressure pattern. The linkage may be measured as a correlation between the first pressure pattern and the second pressure pattern (e.g., as disclosed herein), the correlation having a coefficient. The degree of the linkage (e.g., correlation) between the first pressure pattern and the second pressure pattern may be indicative of the degree of damage in the inner channel. A prevention system may be operatively coupled with the one or more sensors. The first pressure pattern may be sensed by a pressure sensor in the manufacturing enclosure, between the manufacturing enclosure and the inner channel, or in the inner channel. The second pressure pattern may be sensed by a pressure configured to sense pressure in the interstitial space. In some embodiments, the prevention system is configured to monitor the interstitial pressure. The prevention system may be configured to initiate a prevention operation when the interstitial pressure is above a threshold. The threshold may comprise a value or a function. The prevention system may be configured to initiate a prevention operation when the correlation is above a threshold. In some embodiments, the prevention system is configured to monitor (i) the interstitial pressure, and (ii) the pressure of the internal atmosphere of the rest of the printing system. The rest of the printing system may comprise the manufacturing enclosure, the manufacturing system component(s) linking the manufacturing enclosure with the inner channel, or the inner channel. The rest of the printing system may comprise (e.g., at least a part of) the material conveyance system or the gas conveyance system. In some embodiments, the rest of the printing system comprises a gas channel configured to facilitate flow of gas exited from the cyclone. The prevention system may be configured to monitor the correlation coefficient between (i) the interstitial pressure, and (ii) the pressure of the internal atmosphere of the rest of three-dimensional printing system. The correlation coefficient may be measured by a (e.g., normalized) cross-correlation. The correlation coefficient may be below a threshold during normal operation. The prevention system may be configured to determine a malfunction when it detects the correlation coefficient to be above the threshold. The prevention system may be configured to determine how alike are the first pressure fluctuation pattern from the second pressure fluctuation pattern. The prevention system may be configured to determine how different are the first pressure fluctuation pattern from the second pressure fluctuation pattern. The prevention system may be configured to initiate, or direct initiation of, a prevention operation when it determines a malfunction. The greater the first fluctuation pattern is similar to the second fluctuation pattern, the greater the damage in the inner channel.

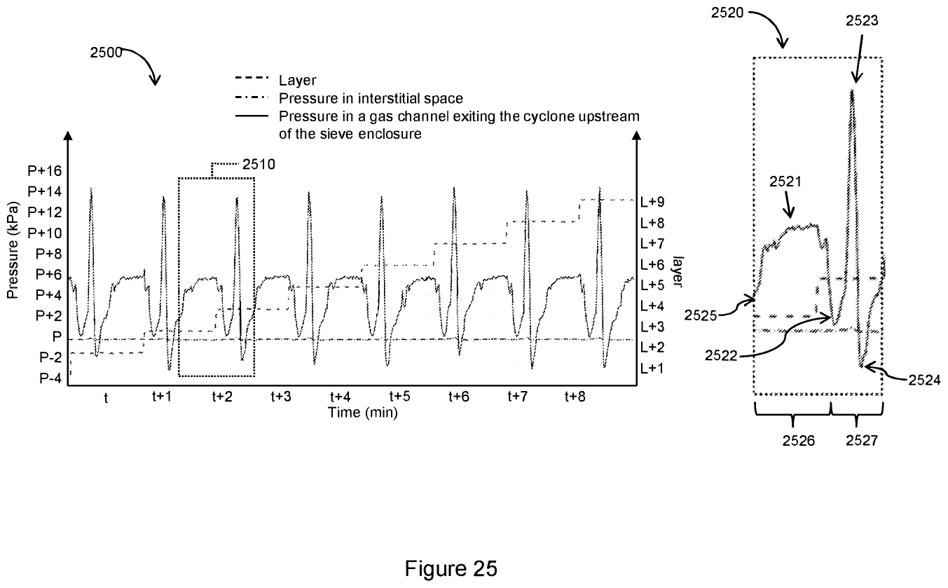

FIG. 25 shows an example of a pressure graph of a material conveyance channel comprising an internal channel, and external channel, and an interstitial space formed between the internal channel and external channel. Graph 2500 shows various pressures measured in the channel portions during normal operation of the two layered material conveyance channel as a function of time, and during layer dispending operation. A dashed line indicates an idle time of the layer dispensing mechanism, e.g., after it dispensed a layer of starting material in the manufacturing enclosure. A dashed-single dotted line indicates pressure measured in the interstitial space of the double layered channel. The interstitial space is a space between (i) an external surface of an inner channel and (ii) an internal surface of an outer channel. The internal channel is operatively coupled to the manufacturing enclosure. A solid line indicates pressure in the internal atmosphere of a gas channel operatively coupled with an exit of a cyclone upstream of the sieve enclosure, e.g., sensor 1407 of FIG. 14. Pressure in the gas channel (e.g., depicted by solid line) shows a (e.g., substantial) repetition of unit pattern 2510 that is coupled with pressure fluctuations in the manufacturing enclosure. Each of the unit patterns is affected by a layer dispensing operation occurring during that timeframe in the manufacturing enclosure. Unit pattern 2510 is enlarged as portion 2520. As shown in portion 2520, during interval 2526, the pressure increases (e.g., from 2525 to 2521) and decreases (e.g., from 2521 to 2522). The pressure shows a (e.g., substantially) constant pressure (e.g., 2521—plateau) during interval 2526. During interval 2527, The pressure increases (e.g., from 2522 to 2523) and decreases (e.g., from 2523 to 2524). The section 2521 may correspond to a material dispensing operation. A dip 2522 may correspond to a material (e.g., remainder material) removing operation from the enclosure, e.g., by utilizing a material removing mechanism (also referred to herein as a “remover”). A peak 2523 may correspond to a pressure equilibration operation followed by pressure equilibration, occurring in the manufacturing enclosure. A dip 2524 may correspond to a material removing operation as part of the layer dispensing, e.g., and removal of remainder material from the remover to the material conveyance system. One layer of the starting material are stacked on each other in successive layer dispensing operations as part of a 3D printing, as indicative by the dashed line in graph 2500 indicating the number of layer dispersed. As depicted by the dashed-single dotted line in graph 2500, the pressure in the interstitial space remains (e.g., substantially) constant during the layer dispensing operation occurring in the manufacturing disclosure. Experimental conditions related to graph 2500 are detailed in “Example 14” disclosed herein.

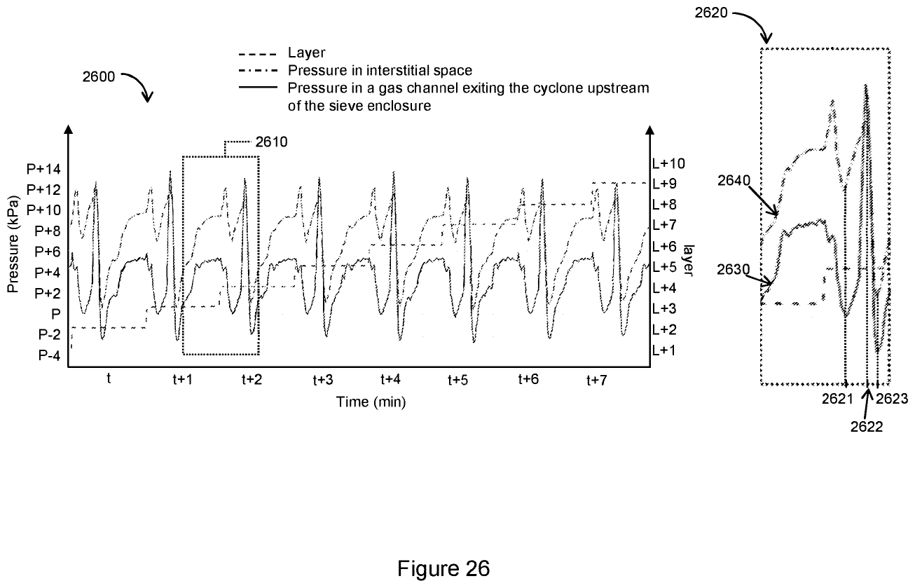

FIG. 26 shows a pressure graph of the double layered channel of FIG. 25, depicted in FIG. 26 during a faulty operation, as a function of time. The faulty operation may comprise a malfunction of the inner channel caused by damage such as hole, crack and/or rupture. Graph 2600 shows pressure fluctuations during layer dispending operation occurring in the manufacturing enclosure. A dashed line indicates the number of stacked layer of starting material dispensed in the manufacturing enclosure. A dashed-single dotted line indicates pressure as measured in the interstitial space of the double layered channel. A solid line indicates pressure in internal atmosphere of the gas channel operatively coupled with the exit of the cyclone e.g., sensor 1407 of FIG. 14. Section 2610 is enlarged as section 2620. As shown in section 2620, the pressure in the gas channel shows a substantial repetition of first unit pattern 2630, which is coupled with pressure fluctuations in the manufacturing enclosure; and the pressure in the interstitial space (as depicted by dashed-single dotted line) shows a (e.g., substantial) repetition of second unit pattern 2640 coupled with the pressure fluctuations in the internal channel's atmosphere. The unit pattern is affected by a layer dispensing operation followed by pressure equilibration, occurring during that timeframe in the manufacturing enclosure. The first unit pattern 2630 and the second unit pattern 2640 show association (e.g., coupling) of their pressure fluctuation behavior, e.g., shown a similar pressure change tendency. Change in first unit pattern 2630 tends to be met with the change in the second unit pattern 2640. For example, the first unit pattern 2630 and the second unit pattern 2640 show (i) a dip at time 2621, (ii) a peak at time 2622, and (iii) a dip at time 2623. Experimental conditions related to graph 2600 are detailed in “Example 14” disclosed herein.

In some embodiments, the 3D printing system comprises a control system. The control system may comprise one or more controllers. The control system may comprise, or be operatively coupled with, one or more devices, apparatuses, and/or systems of the 3D printing system, including any component of the device(s), apparatuses(s), and/or system(s). The controllers or control mechanisms (e.g., comprising a computer system) may be programmed to implement methods of the disclosure.

In some embodiments, the 3D printer comprises a controller. The controller may monitor and/or direct (e.g., physical) alteration of the operating conditions of the apparatuses, software, and/or methods described herein. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from a sensor). The controller may deliver an output. The controller may be part of a control system comprising multiple controllers. The controller may receive multiple inputs. The controller may generate multiple outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control scheme(s). The controller may comprise a closed loop control scheme. The controller may comprise an open loop control scheme. The controller may utilize one or more wired and/or wireless networks for communication, e.g., with other controllers or devices, apparatuses, or systems of the 3D printing system and its components. For example, wired ethernet technologies, e.g., a local area networks (LAN). For example, wireless communication technologies, e.g., a wireless local area network (WLAN). The controller may utilize one or more control protocols for communication, for example, with other controller(s) or one or more devices, apparatuses, or systems of the 3D printing system or any of its components. Control protocols can comprise one or more protocols of an internet protocol suite, e.g., transmission control protocol (TCP) or transmission control protocol/internet protocol (TCP/IP). Control protocols can comprise one or more serial communication protocols. Control protocols can comprise one or more of controller area networks or another message-based protocol, e.g., for communication with microcontrollers and devices. Control protocols can interface with one or more serial bus interfaces for communication with the 3D printing system and its components. The controller may comprise a user interface. The user interface may comprise a keyboard, keypad, mouse, touch screen, microphone, speech recognition package, camera, imaging system, or any combination thereof. The outputs may include a display (e.g., screen), speaker, or printer. Examples of controller, control protocols, control systems, 3D printing systems, apparatuses, devices, and any of their components, and 3D printing processes can be found in International Patent Application Serial No. PCT/US17/18191, filed Feb. 16, 2017, titled “ACCURATE THREE-DIMENSIONAL PRINTING,” which is incorporated herein by reference in their entirety.

Control may comprise regulate, modulate, adjust, maintain, alter, change, govern, manage, restrain, restrict, direct, guide, oversee, manage, preserve, sustain, restrain, temper, or vary.

In some embodiments, the methods, systems, device, software and/or the apparatuses described herein comprise a control system. The control system can be in communication with one or more components of the 3D printing system. The control system can be in communication with one or more components facilitating the 3D printing methodologies. The control system can be in communication with one or more energy sources, optical systems, gas flow system, material flow systems, energy (e.g., energy beams), build platform assembly, and/or with any other component of the 3D printing system.

In some embodiments, the 3D printing system comprises a controller. The controller may include one or more components. The controller may comprise a processor. The controller may comprise a specialized hardware (e.g., electronic circuit). The controller may be a proportional-integral-derivative controller (PID controller). The control may comprise dynamic control (e.g., in real time during the 3D printing process). For example, the control of the (e.g., transforming) energy beam may be a dynamic control (e.g., during the 3D printing process). The PID controller may comprise a PID tuning software. The PID control may comprise constant and/or dynamic PID control parameters. The PID parameters may relate a variable to the required power needed to maintain and/or achieve a setpoint of the variable at any given time. The calculation may comprise calculating a process value. The process value may be the value of the variable to be controlled at a given moment in time. For example, the process controller may control a height of at least one portion of the layer of hardened material that deviates from the average surface of the target surface (e.g., exposed surface of the material bed) by altering the power of the energy source and/or power density of the energy beam, wherein the height measurement is the variable, and the power of the energy source and/or power density of the energy beam are the process value(s). The variable may comprise a temperature or metrological value. The parameters may be obtained and/or calculated using a historical (e.g., past) 3D printing process. The parameters may be obtained in real time, during a 3D printing process. During a 3D printing process, may comprise during the formation of a 3D object, during the formation of a layer of hardened material, or during the formation of a portion of a layer of hardened material. The calculation output may be a relative distance (e.g., height) of the material bed (e.g., from a cooling mechanism, bottom of the enclosure, optical window, energy source, or any combination thereof). The controller may comprise a feedback control scheme. The feedback control scheme may comprise an open feedback loop control scheme. The feedback loop control scheme may comprise a closed feedback loop control scheme. Feedback control scheme may comprise hardware compensation. Feedback control scheme may comprise software compensation. Control system may comprise, or be operatively coupled with, a metrological detection system and configured to receive measurement data from the metrological detection system, e.g., height mapper. The control system may be configured to generate control signals responsive to the measurement data collected by the metrological detection system.

In some embodiments, a controller of a 3D printing system comprises a metrological detection system. The metrological detection system may be used in the control of 3D printing processes of the 3D printing system. The metrological detection system may be configured to detect distance variations such as vertical distance variations, e.g., height variations. The metrological detection system may be configured to detect distance variations such as horizontal distance variations, e.g., variations with respect to an XY plane. For example, a horizontal distance variation along an X-axis that is oriented parallel to a direction of translation of a translatable component (e.g., a translation mechanism). For example, a horizontal distance variation along a Y-axis that is orientated perpendicular to the direction of translation of the translatable component (e.g., the translation mechanism) and perpendicular to a gravitational vector. The metrological detection system may be configured to detect a vertical (e.g., height) variations in a planar surface, e.g., a planar exposed surface of a material bed. The metrological detection system may comprise a height mapper system. The metrological detection system may comprise an interferometric optical system. The metrological detection system may comprise a position sensitive device system. The metrological detection system may comprise an optical detector. The metrological detection system may include, or be operatively coupled with, an image processor. The metrological detection system may comprise an imaging detector to monitor irregularities. The image detector may comprise a camera such as a charged coupled device (CCD) camera. The image detector may comprise detecting a location or an area of the printed 3D object and convert it to a pixel in the X-Y (e.g., horizontal) plane. The image detector may comprise detecting an interference pattern generated by an interferometric beam path. The image detector may comprise detecting position of a beam incident on the image detector relative to an imaging region of the image detector. The controller may comprise one or more computational schemes to convert data (e.g., measurement data) from the metrological detection system to generate a result. The one or more computational schemes may be utilized to determine one or more aspects of the build platform assembly, the optical system, and/or of the target surface, e.g., the exposed surface of the material bed or the build platform surface. The one or more aspects may comprise positional aspects, or localization aspects. The one or more aspects may be absolute or relative. For example, an aspect can include a physical orientation of a moving component of the build module, the moving component comprising a base, substrate, or build platform assembly, the build module assembly comprising the base (also herein “build platform”). For example, an aspect can include a physical orientation of a moving component of the optical system, e.g., of one or more optical assemblies, energy beam paths, or processing cones incident on the target surface. The physical orientation may comprise a relative orientation (e.g., relative to a requested orientation) or an absolute orientation (e.g., relative to a coordinate axis). For example, an aspect may comprise a relative orientation of the target surface or at least one optical assembly (e.g., a plurality of optical assemblies) with respect to an enclosure (e.g., the processing chamber) with respect to a requested orientation, e.g., characterizing offset value(s) of the position (e.g., XY position) of the optical assembly or target surface from the requested value(s). For example, an aspect may include (a) a height (e.g., along a z-axis) of the target surface, (b) an XY position (c) a rotation of the target surface, or (d) any combination of (a), (b), and (c). The orientation may include (A) pitch or roll (e.g., due to movement around the horizontal axis). The controller may utilize one or more computational schemes to measure a height (e.g., along a z-axis) of the target surface (e.g., a phase shift computational scheme). The controller may utilize one or more computational schemes to measure a position (e.g., about the XY plane). The computational scheme may comprise an algorithm. The controller may utilize a computational scheme comprising a (e.g., digital) modulation scheme that conveys data by changing (e.g., modulating) the phase of a reference signal (e.g., carrier wave). Measurements collected by the metrological detection system may be utilized by one or more controllers, for example, to provide feedback controls to one or more control systems. For example, the one or more controllers may process, or direct processing, the measurements at a time including before, after and/or during the 3D printing process (e.g., in real time). The one or more controllers may be integrated in a control system that controls the 3D printing process (e.g., the recoater, gas flow system, and/or energy beam(s)). The control system may be any control system disclosed herein. For example, the control system may be a hierarchical control system. For example, the control system may comprise at least three hierarchical control levels, e.g., at least three, four, or five control levels.

Methods, apparatuses, and/or systems of the present disclosure can be implemented by way of one or more computational schemes. A computational scheme can be implemented by way of software upon execution by one or more computer processors. For example, the processor can be programmed to calculate the path of the energy beam and/or the power per unit area emitted by the energy source (e.g., that should be provided to the material bed in order to achieve the requested result). Other control and/or algorithm examples may be found in International Patent Application Serial No. PCT/US17/18191, filed Feb. 16, 2017, titled “ACCURATE THREE-DIMENSIONAL PRINTING;” which is incorporated herein by reference in their entirety.

At times, the 3D object printed by the 3D printing system is a high fidelity 3D object. At times, the generated 3D object (e.g., the hardened cover) is substantially smooth. The generated 3D object may have a deviation from an ideal planar surface (e.g., atomically flat or molecularly flat) of at most about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μ), 1.5 μm, 2μ, 3μ, 4 μm, 5 μm, 10 μm, 15 μm, 20 μm, 25 μm, 30 μm, 35 μm, 100 μm, 300 μm, 500 μm, or less. The generated 3D object may have a deviation from an ideal planar surface of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or more. The generated 3D object may have a deviation from an ideal planar surface between any of the afore-mentioned deviation values. The generated 3D object may comprise a pore. The generated 3D object may comprise pores. The pores may be of an average FLS (diameter or diameter equivalent in case the pores are not spherical) of at most about 1.5 nanometers (nm), 2 nm, 3 nm, 4 nm, 5 nm, 10 nm, 15 nm, 20 nm, 25 nm, 30 nm 35 nm, 100 nm, 300 nm, 500 nm, 1 micrometer (μm), 1.5 μm, 2 μm, 3 μm, 4 μm, 5 μm, 10 μm, 15 μm, or 20 μm. The pores may be of an average FLS of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, or 20 μm. The pores may be of an average FLS between any of the afore-mentioned FLS values (e.g., from about 1 nm to about 20 μm). The 3D object (or at least a layer thereof) may have a porosity of at most about 0.05 percent (%), 0.1% 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have a porosity of at least about 0.05%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have porosity between any of the afore-mentioned porosity percentages (e.g., from about 0.05% to about 80%, from about 0.05% to about 40%, from about 10% to about 40%, or from about 40% to about 90%). In some instances, a pore may traverse the generated 3D object. For example, the pore may start at a face of the 3D object and end at the opposing face of the 3D object. The pore may comprise a passageway extending from one face of the 3D object and ending on the opposing face of that 3D object. In some instances, the pore may not traverse the generated 3D object. The pore may form a cavity in the generated 3D object. The pore may form a cavity on a face of the generated 3D object. For example, pore may start on a face of the plane and not extend to the opposing face of that 3D object.

The resolution of the printed 3D object may be at least about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, or more. The resolution of the printed 3D object may be at most about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, or less. The resolution of the printed 3D object may be any value between the above-mentioned resolution values. At times, the 3D object may have a material density of at least about 99.9%, 99.8%, 99.7%, 99.6%, 99.5%, 99.4%, 99.3%, 99.2% 99.1%, 99%, 98%, 96%, 95%, 94%, 93%, 92%, 91%, 90%, 80%, or 70%. At times, the 3D object may have a material density of at most about 99.5%, 99%, 98%, 96%, 95%, 94%, 93%, 92%, 91%, 90%, 80%, or 70%. At times, the 3D object may have a material density between the afore-mentioned material densities. The resolution of the 3D object may be at least about 100 dots per inch (dpi), 300 dpi, 600 dpi, 1200 dpi, 2400 dpi, 3600 dpi, or 4800 dpi. The resolution of the 3D object may be at most about 100 dpi, 300 dpi, 600 dpi, 1200 dpi, 2400 dpi, 3600 dpi, or 4800 dpi. The resolution of the 3D object may be any value between the afore-mentioned values (e.g., from 100 dpi to 4800 dpi, from 300 dpi to 2400 dpi, or from 600 dpi to 4800 dpi). The height uniformity (e.g., deviation from average surface height) of a planar surface of the 3D object may be at least about 100 μm, 90 μm, 80 μm, 70 μm, 60 μm, 50 μm, 40 μm, 30 μm, 20 μm, 10 μm, or 5 μm. The height uniformity of the planar surface may be at most about 100 μm, 90 μm, 80 μm, 70 μm, 60 μm, 50 μm, 40 μm, 30 μm, 20 μm, 10 μm, or 5 μm. The height uniformity of the planar surface of the 3D object may be any value between the afore-mentioned height deviation values (e.g., from about 100 μm to about 5 μm, from about 50 μm to about 5 μm, from about 30 μm to about 5 μm, or from about 20 μm to about 5 μm). The height uniformity may comprise high precision uniformity.

In some embodiments the control system comprises a laser control system. The laser control system may comprise, or may be operatively coupled with, an optical translation control system. The laser control system may comprise, or be operatively coupled with, a laser system (e.g., optical system) of the 3D printing system, e.g., energy sources, optical components, translation mechanism, optical systems, motors, encoders, or the like. At times, the laser control system is operable to control operations of the optical system (e.g., comprising one or more optical assemblies) of the 3D printing system. The control system may be operable to adjust operations of the optical system (e.g., of the one or more optical assemblies) in response to a measured positional deviation of one or more aspects of the translatable optical system. The laser control system may be operable to adjust (e.g., calibrate) one or more characteristics of the irradiating energy (e.g., the energy beam) incident on the target surface, e.g., the exposed surface of the material bed. Adjusting one or more characteristics of the irradiating energy beam may comprise a software adjustment (e.g., calibration). Adjusting one or more characteristics of the irradiating energy beam may comprise a hardware adjustment (e.g., calibration).

In some embodiments, the laser control system is configured to calibrate one or more characteristics of the irradiating energy (e.g., energy beam) in response to a positional deviation of the target surface, translational mechanism, optical system component(s), build platform assembly, or build platform, from a requested position. For example, the laser control system may be configured to calibrate one or more characteristics of the irradiating energy in response to a positional deviation of the target surface about an XY plane and/or about a rotational axis of the target surface (e.g., rotation about a central axis). For example, the laser control system may calibrate (i) the position at which the irradiating energy contacts a surface (e.g., the target surface), (ii) the shape of the footprint of the energy beam at the (e.g., target) surface, (iii) the XY offset of a first energy beam position at the (e.g., target) surface with respect to a second energy beam position at the (e.g., target) surface, and/or (iv) the XY offset of the energy beam with respect to the (e.g., target) surface. The position at which the energy beam contacts the surface is the position at which the energy beam impinges on the surface.

In some embodiments, the laser control system is configured to calibrate one or more characteristics of the irradiating energy (e.g., energy beam). A calibration may include a comparison of a commanded (e.g., instructed) energy beam position (e.g., at the target surface) compared with an actual (e.g., measured) energy beam position at the target surface. The characteristics of the energy beam may be calibrated along a field of view of the optical system (e.g., and/or detector). The laser control system may calibrate characteristics of a processing cone of the energy (e.g., laser beam). The calibration of the focus mechanism may achieve a requested spot or footprint size for various locations in the field of view of the irradiating energy (e.g., intersection of the processing cone with the target surface and/or calibration structure surface). The power density distribution measure may be calibrated (e.g., substantially) identically, or differently, along the field of view of the irradiating energy. In some embodiments, different positions in the field of view may require different focus offsets and/or or footprint size. Processing cone coverage of the material bed can depend in part on dimensions of one or more of the mirrors of a scanner, e.g., galvanometric scanner, utilized to direct a path of the energy beam about the target surface. Laser control systems, control systems, controllers and operation thereof, 3D printing systems and processes, apparatus, methods, computer programs, are disclosed in International Patent Application Serial No. PCT/US19/14635 filed Jan. 22, 2019, and U.S. Provisional Patent Application Ser. No. 63/290,878 filed on Dec. 17, 2021, each of which is incorporated herein by reference in its entirety.

At times, a calibration comprises generating a compensation for one or more characteristics of the laser system. A compensation may be effectuated at least in part by a (e.g., energy beam) calibration. At times, an energy beam calibration comprises formation of one or more (e.g., physically printed or optically projected) alignment markers using at least one energy beam directed at a target surface. The one or more alignment markers may form an arrangement (e.g., a pattern). The position(s) of the marker(s) may be according to a requested (e.g., pre-determined) arrangement (e.g., a reference pattern). Requested may be according to a commanded arrangement as directed by commands to a guidance system for directing the energy beam(s). The arrangement (e.g., position(s)) of the one or more alignment markers may be detected by a detection system. The detected position(s) (e.g., measured position(s)) of the alignment marker(s) may be compared to commanded (e.g., requested) position(s). The energy beam calibration may comprise correction (e.g., compensation) of any deviation of the detected position(s) from the commanded position(s). The deviation of the detected position(s) from the commanded position(s) may be caused in part by (a) thermal effects on the energy beam and/or optical components, (b) position deviation of the target surface, (c) a non-uniformity of layer deposition, or (d) a combination thereof. Following application of the (e.g., initial) compensation to the energy beam (e.g., to the guidance system directing the energy beam), further (e.g., additional) calibration may be performed. Further calibration may (e.g., iteratively) improve the compensation of the any deviation between the detected position(s) from the commanded position(s) of the energy beam at the target surface. The deviation may depend on the nature and/or geometry of one or more optical elements of the optical system. The calibration may comprise altering the one or more elements (e.g., position thereof) of the optical system. The calibration may comprise altering a command to one or more elements of the optical system and/or to the energy source.

In some embodiments, the control system utilizes data from a metrological detection system. The control system may use the data to control one or more parameters of the 3D printing. For example, the control system may use the metrology data to control one or more positions of the optical system. At times, the control system may utilize a control scheme comprising a feedback control loop that utilizes alignment data, e.g., collected from one or more metrological detection systems to update control parameters of one or more control systems. Data collected from one or more metrological detection systems may comprise alignment data indicative of a position of at least one component of the optical system, for example, a position of (A) an optical assembly, (B) the array of optical assemblies, (C) the translation mechanism, (D) energy beam(s) of the optical system incident on the target surface, or (E) any combination of (A) to (D). The data collected from one or more metrological detection systems can be utilized by a feedback control loop to adjust a position of the component of the optical system, for example, a position of (A) an optical assembly, (B) the array of optical assemblies, (C) the translation mechanism, (D) energy beam(s) of the optical system incident on the target surface, or (E) any combination of (A) to (D). At times, a control scheme comprises a feedforward control that utilizes alignment data to update control parameters of one or more control systems. Alignment data may comprise historical data, e.g., data collected after a three-dimensional process performed by a three-dimensional printer. Historical data (e.g., historical measurements) may comprise characterization of three-dimensional objects formed utilizing the three-dimensional printer. The historical data may be utilized in a feedforward control to adjust a position of (A) an optical assembly, (B) the array of optical assemblies, (C) the translation mechanism, (D) energy beam(s) of the optical system incident on the target surface, or (E) any combination of (A) to (D). The control system may use the metrology data to control one or more parameters of the energy source and/or energy beam. The one or more measurements from the metrological detection system may be used to alter (e.g., in real time, and/or offline) the computer model. For example, the metrological detection system measurement(s) may be used to alter the optical proximity correction data. For example, the metrological detection system measurement(s) may be used to alter the printing instruction of one or more successive layers (e.g., during the printing of the 3D object).

In some embodiments, the detector and/or controller(s) averages at least a portion of the detected signal over time (e.g., period). In some embodiments, the detector and/or controller(s) reduces (at least in part) noise from the detected signal (e.g., over time). The noise may comprise detector noise, sensor noise, noise from the target surface, or any combination thereof. The noise from the target surface may arise from a deviation from planarity of the target surface (e.g., when a target surface comprises particulate material (e.g., powder)). The reduction of the noise may comprise using a filter, noise reduction algorithm, averaging of the signal over time, or any combination thereof.

In some embodiments, the controller(s) (e.g., continuously or intermittently) calculates an error value during the control time. The intermittent calculation may or may not be periodic. The error value may be the difference between a requested setpoint and a measured process variable. The control may be continuous control (e.g., during the 3D printing process, during formation of the 3D object, and/or during formation of a layer of hardened material). The control may be discontinuous. For example, the control may cause the occurrence of a sequence of discrete events. The control scheme may comprise a continuous, discrete, or batch control. The requested setpoint may comprise a temperature, power, power density, or a metrological (e.g., height) setpoint. The metrological setpoint may relate to the target surface (e.g., the exposed surface of the material bed). The metrological setpoints may relate to one or more height setpoints of the target surface (e.g., the exposed (e.g., top) surface of the material bed). The controller(s) may attempt to minimize an error (e.g., temperature and/or metrological error) over time by adjustment of a control variable. The control variable may comprise a direction and/or (electrical) power supplied to any component of the 3D printing apparatus and/or system. For example, direction and/or power supplied to the: energy beam, scanner, motor translating the platform, optical system component, optical diffuser, or any combination thereof.

In some embodiments, the systems, apparatuses, and/or components thereof comprise one or more controllers. The one or more controllers can comprise one or more central processing unit (CPU), input/output (I/O) and/or communications module. The CPU can comprise electronic circuitry that carries out instructions of a computer program by performing basic arithmetic, logical, control and I/O operations specified by the instructions. The controller can comprise a suitable software (e.g., operating system). The control system may optionally include a feedback control and/or feed-forward control loop. The controllers may be shared between one or more systems or apparatuses. Each apparatus or system may have its own controller. Two or more systems and/or its components may share a controller. Two or more apparatuses and/or its components may share a controller. The controller may be any controller (e.g., a controller used in 3D printing) such as, for example, the controller disclosed in Provisional Patent Application Ser. No. 62/252,330 that was filed on Nov. 6, 2015, titled “APPARATUSES, SYSTEMS AND METHODS FOR THREE-DIMENSIONAL PRINTING,” or in Provisional Patent Application Ser. No. 62/325,402 that was filed on Apr. 20, 2016, titled “METHODS, SYSTEMS, APPARATUSES, AND SOFTWARE FOR ACCURATE THREE-DIMENSIONAL PRINTING,” or in PCT Patent Application serial number PCT/US16/59781, that was filed on Oct. 31, 2016, titled “ADEPT THREE-DIMENSIONAL PRINTING”, all three of which are incorporated herein by reference in their entirety.

At times, multiple of tuning schemes can be generated for the one or more controllers, each tuning scheme selectable for a set of operating conditions and/or powder characteristics. For example, tuning scheme may utilize (i) a look-up table (LUT), (ii) historical data, (iii) experiments, (iv) physics simulation, (v) artificial intelligence, (vi) data analysis, and/or (vii) the like. The artificial intelligence may comprise training a plant model (a machine-learned model). The artificial intelligence may comprise data analysis. The training model may be trained utilizing (i) a look-up table (LUT), (ii) historical data, (iii) experiments, (iv) synthesized results from physics simulation, or (v) the like. In some embodiments, control scheme(s) can use a single plant model and project changes due to the temperature based on previously identified models. The control scheme(s) may be inscribed as program instructions (e.g., software).

In some embodiments, the control scheme used the controller(s) disclosed herein involve data analysis. The data analysis techniques involve one or more regression analys(es) and/or calculation(s). The regression analysis and/or calculation may comprise linear regression, least squares fit, Gaussian process regression, kernel regression, nonparametric multiplicative regression (NPMR), regression trees, local regression, semiparametric regression, isotonic regression, multivariate adaptive regression splines (MARS), logistic regression, robust regression, polynomial regression, stepwise regression, ridge regression, lasso regression, elasticnet regression, principal component analysis (PCA), singular value decomposition (SVD)), probability measure techniques (e.g., fuzzy measure theory, Borel measure, Harr measure, risk-neutral measure, Lebesgue measure), predictive modeling techniques (e.g., group method of data handling (GMDH), Naive Bayes classifiers, k-nearest neighbors algorithm (k-NN), support vector machines (SVMs), neural networks, support vector machines, classification and regression trees (CART), random forest, gradient boosting, generalized linear model (GLM)), or any other suitable probability and/or statistical analys(es). A learning scheme may comprise neural networks. The leaning scheme may comprise machine learning. The learning scheme may comprise pattern recognition. The learning scheme may comprise artificial intelligence, data miming, computational statistics, mathematical optimization, predictive analytics, discrete calculus, or differential geometry. The learning schemes may comprise supervised learning, reinforcement learning, unsupervised learning, semi-supervised learning. The learning scheme may comprise bias-variance decomposition. The learning scheme may comprise decision tree learning, associated rule learning, artificial neural networks, deep learning, inductive logic programming, support vector machines, clustering, Bayesian networks, reinforcement learning, representation learning, similarity and metric learning, sparse dictionary learning, or genetic algorithms (e.g., evolutional algorithm). The non-transitory computer media may comprise any of the algorithms disclosed herein. The controller and/or processor may comprise the non-transitory computer media. The software may comprise any of the algorithms disclosed herein. The controller and/or processor may comprise the software. The learning scheme may comprise random forest scheme.

In some embodiments, the control system utilizes a physics simulation in, e.g., in a computer model (e.g., comprising a prediction model, statistical model, a thermal model, or a thermo-mechanical model). The computer model may provide feedforward information to the control system. The computer model may provide the feed forward control scheme. There may be more than one computer models (e.g., at least 1, 2, 3, 4, 5, 6, 7, 8, 9 or 10 different computer models). The controller may (e.g., dynamically) switch between the computer models to predict and/or estimate the behavior of the optical elements. Dynamic includes changing computer models (e.g., in real time) based at least in part on a sensor input or based on a controller decision that may in turn be based at least in part on monitored target temperature. The dynamic switch may be performed in real-time, e.g., during operation of the optical system and/or during printing 3D object(s). The controller may be configured (e.g., reconfigured) to include additional one or more computer models and/or readjust the existing one or more computer models. A prediction may be done offline (e.g., predetermined) and/or in real-time. Examples of the calibration, control systems, controllers, and operation thereof, 3D printing systems and processes, apparatus, methods, and computer programs, are disclosed in International Patent Application serial number PCT/US19/14635, filed Jan. 22, 2019, titled “CALIBRATION IN THREE-DIMENSIONAL PRINTING,” which is incorporated herein by reference in its entirety.

In some instances, the processing unit includes one or more cores. The computer system may comprise a single core processor, multi core processor, or a plurality of processors for parallel processing. The processing unit may comprise one or more central processing unit (CPU) and/or a graphic processing unit (GPU). The multiple cores may be disposed in a physical unit (e.g., Central Processing Unit, or Graphic Processing Unit). The processing unit may include one or more processing units. The physical unit may be a single physical unit. The physical unit may be a die. The physical unit may comprise cache coherency circuitry. The multiple cores may be disposed in close proximity. The physical unit may comprise an integrated circuit chip. The integrated circuit chip may comprise one or more transistors. The close proximity may allow substantial preservation of communication signals that travel between the cores. The close proximity may diminish communication signal degradation. A core as understood herein is a computing component having independent central processing capabilities. The computing system may comprise a multiplicity of cores, which may be disposed on a single computing component. The multiplicity of cores may include two or more independent central processing units. The independent central processing units may constitute a unit that read and execute program instructions. The independent central processing units may constitute parallel processing units. The parallel processing units may be cores and/or digital signal processing slices (DSP slices). The multiplicity of cores can be parallel cores. The multiplicity of DSP slices can be parallel DSP slices. The multiplicity of cores and/or DSP slices can function in parallel. In some processors (e.g., FPGA), the cores may be equivalent to multiple digital signal processor (DSP) slices (e.g., slices). The plurality of DSP slices may be equal to any of plurality core values mentioned herein. The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One-point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS).

In some instances, the computer system includes hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by Nvidia, ATI Technologies, S3 Graphics, Advanced Micro Devices (AMD), or Matrox. The processing unit may be able to process algorithms comprising a matrix or a vector. The core may comprise a complex instruction set computing core (CISC), or reduced instruction set computing (RISC).

In some instances, the computer system includes an electronic chip that is reprogrammable (e.g., field programmable gate array (FPGA)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise an algorithm.

In some instances, the computer system includes configurable computing, partially reconfigurable computing, reconfigurable computing, or any combination thereof. The computer system may include a FPGA. The computer system may include an integrated circuit that performs the algorithm. For example, the reconfigurable computing system may comprise FPGA, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration. The FPGA may comprise configurable FPGA logic, and/or fixed-function hardware comprising multipliers, memories, microprocessor cores, first in-first out (FIFO) and/or error correcting code (ECC) logic, digital signal processing (DSP) blocks, peripheral Component interconnect express (PCI Express) controllers, ethernet media access control (MAC) blocks, or high-speed serial transceivers. DSP blocks can be DSP slices.

In some examples, the computing system includes an integrated circuit. The computing system may include an integrated circuit that performs the algorithm (e.g., control algorithm). In some instances, the controller uses calculations, real time measurements, or any combination thereof to regulate the energy beam(s).

In some embodiments, a user develops at least one 3D printing instruction and directs the 3D printer (e.g., through communication with the 3D printer processor) to print in a requested manner according to the developed at least one 3D printing instruction. A user may or may not be able to control (e.g., locally or remotely) the 3D printer controller, e.g., depending on permission preferences. For example, a client may not be able to control the 3D printing controller (e.g., maintenance of the 3D printer).

In some embodiments, the user (e.g., other than a client) processor may use real-time and/or historical 3D printing data of one or more 3D printers. The 3D printing data may comprise metrology data. The user processor may comprise quality control. The quality control may use a statistical method (e.g., statistical process control (SPC)). The user processor may log excursion log, report when a signal deviates from the nominal level, or any combination thereof. The user processor may generate a configurable response. The configurable response may comprise a print/pause/stop command (e.g., automatically) to the 3D printer (e.g., to the 3D printing processor). The configurable response may be based on a user defined parameter, threshold, or any combination thereof. The configurable response may result in a user defined action. The user processor may control the 3D printing process and ensure that it operates at its full potential. For example, at its full potential, the 3D printing process may make a maximum number of 3D object with a minimum of waste and/or 3D printer down time. The SPC may comprise a control chart, design of experiments, and/or focus on continuous improvement.

In some embodiments, the 3D printing system comprises a computer system. The computer system can control (e.g., direct, monitor, and/or regulate) various features of printing methods, apparatuses and systems of the present disclosure, such as, for example, control force, translation, heating, cooling and/or maintaining the temperature of a powder bed, process parameters (e.g., chamber pressure), scanning rate (e.g., of the energy beam and/or the platform), scanning route of the energy source, position and/or temperature of the cooling member(s), application of the amount of energy emitted to a selected location, or any combination thereof. The computer system can be part of, or be in communication with, a 3D printing system or apparatus. The computer may be coupled with one or more mechanisms disclosed herein, and/or any parts thereof. For example, the computer may be coupled with one or more sensors, valves, switches, motors, pumps, scanners, optical components, or any combination thereof.

In some embodiments, the computer system utilizes program instructions to execute, or direct execution of, operation(s). The program instructions can be inscribed in a machine executable code. Methods as described herein can be implemented by way of machine (e.g., computer processor) executable code stored on an electronic storage location of the computer system, such as, for example, on the memory, or electronic storage unit. The machine executable or machine-readable code can be provided in the form of software. During use, the processor can execute the code. In some cases, the code can be retrieved from the storage unit and stored on the memory for ready access by the processor. In some situations, the electronic storage unit can be precluded, and machine-executable instructions are stored on memory. The code can be pre-compiled and configured for use with a machine having a processer adapted to execute the code or can be compiled during runtime. The code can be supplied in a programming language that can be selected to enable the code to execute in a pre-compiled or as-compiled fashion.

In some embodiments, the computer system comprises a memory. The memory may comprise a random-access memory (RAM), dynamic random access memory (DRAM), static random access memory (SRAM), synchronous dynamic random access memory (SDRAM), ferroelectric random access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NAND) or NOR logic gates. A NAND gate (negative-AND) may be a logic gate which produces an output which is false only if all its inputs are true. The output of the NAND gate may be complemented to that of the AND gate. The storage may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

In some embodiments, the computer system comprises an electronic storage unit. The electronic storage unit can be a data storage unit (or data repository) for storing data. In some embodiments, the storage unit stores files, such as drivers, libraries, and saved programs. The storage unit can store user data (e.g., user preferences and user programs). In some cases, the computer system can include one or more additional data storage units that are external to the computer system, such as located on a remote server that is in communication with the computer system through the network (e.g., an intranet or the Internet).

Aspects of the systems, apparatuses, and/or methods provided herein, such as the computer system, can be embodied in programming (e.g., using a software). Various aspects of the technology may be thought of as “product,” “object,” or “articles of manufacture” typically in the form of machine (or processor) executable code and/or associated data that is carried on or embodied in a type of machine-readable medium. Machine-executable code can be stored on the electronic storage unit, such memory (e.g., read-only memory, random-access memory, flash memory) or a hard disk. The storage may comprise non-volatile storage media. “Storage” type media can include any or all of the tangible memory of the computers, processors or the like, or associated modules thereof, such as various semiconductor memories, tape drives, disk drives, external drives, and the like, which may provide non-transitory storage at any time for the software programming.

In some embodiments, the computer system may comprise a processor or a plurality of processors. The processor may be a processing unit. The processing unit may include one or more processing units. The processor (e.g., 3D printer processor) may be programmed to implement methods of the disclosure. The processing unit can execute a sequence of machine-readable instructions, which can be embodied in a program or software. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system can be included in the circuit.

The processor may be configured to process control protocols, e.g., communicate with one or more components of the 3D printer system using the control protocols. Control protocols can be one or more of the internet protocol suite, e.g., transmission control protocol (TCP) or transmission control protocol/internet protocol (TCP/IP). Control protocols can be one or more of serial communication protocols. Control protocols can be one or more of controller area networks or another message-based protocol, e.g., for communication with microcontrollers and devices. Control protocols can interface with one or more serial bus interfaces for communication with the 3D printing system and its components. The control protocol can be any control protocol disclosed herein.

In some embodiments, the plurality of processors may form a network architecture. At least two of the plurality of the 3D printer processors may interact with each other. In some embodiments, a 3D printer processor interacts with at least one processor that acts as a 3D printer interface (also referred to herein as “machine interface processor”). The one or more machine interface processors may be connected to at least one 3D printer processor. The connection may be through a wire (e.g., cable) and/or be wireless (e.g., via Bluetooth technology). In some embodiments, the machine interface processor directs 3D print job production, 3D printer management, 3D printer monitoring, or any combination thereof.

The computer system can be operatively coupled with a computer network (“network”), e.g., with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled with the computer system to behave as a client or a server.

In some embodiments, the 3D printer comprises communicating through the network. The computer system can communicate with one or more remote computer systems through the network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. A user (e.g., client) can access the computer system via the network.

In some instances, all or portions of the software are at times communicated through the Internet and/or other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium or media that participate(s) in providing instructions to a processor for execution.

In some embodiments, the 3D printer comprises a communication technology. The communication may comprise wired or wireless communication. For example, the systems, apparatuses, and/or parts thereof may comprise Bluetooth, wi-fi, or global positioning system (GPS), or radio-frequency (RF) technology. The RF technology may comprise ultrawideband (UWB) technology. Systems, apparatuses, and/or parts thereof may comprise a communication port. The communication port may be a serial port or a parallel port. The communication port may be a Universal Serial Bus port (e.g., USB). The systems, apparatuses, and/or parts thereof may comprise USB ports. The USB can be micro or mini-USB. The surface identification mechanism may comprise a plug and/or a socket (e.g., electrical, AC power, DC power). The systems, apparatuses, and/or parts thereof may comprise an electrical adapter (e.g., AC and/or DC power adapter). The systems, apparatuses, and/or parts thereof may comprise a power connector. The power connector can be an electrical power connector. The power connector may comprise a magnetically attached power connector. The power connector can be a dock connector. The connector can be a data and power connector. The connector may comprise pins. The connector may comprise at least about 10, 15, 18, 20, 22, 24, 26, 28, 30, 40, 42, 45, 50, 55, 80, or 100 pins.

In some instances, the system and/or apparatus described herein (e.g., controller) and/or any of their components comprise an output and/or an input device. The input device may comprise a keyboard, touch pad, or microphone. The output device may be a sensory output device. The output device may include a visual, tactile, or audio device. The audio device may include a loudspeaker. The visual output device may include a screen and/or a printed hard copy (e.g., paper). The output device may include a printer. The input device may include a camera, a microphone, a keyboard, or a touch screen.

In some instances, the computer system comprises an electronic display. The computer system can include or be in communication with an electronic display that comprises a user interface (UI) for providing, for example, a model design or graphical representation of a 3D object to be printed. Examples of UI's include, without limitation, a graphical user interface (GUI) and web-based user interface. The computer system can monitor and/or control various aspects of the 3D printing system. The control may be manual and/or programmed. The control may rely on feedback mechanisms (e.g., from the one or more sensors). The control may rely on historical data. The feedback mechanism may be pre-programmed. The feedback mechanisms may rely on input from sensors (described herein) that are connected to the control unit (i.e., control system or control mechanism e.g., computer) and/or processing unit. The computer system may store historical data concerning various aspects of the operation of the 3D printing system. The historical data may be retrieved at predetermined times and/or at a whim. The historical data may be accessed by an operator and/or by a user. The historical, sensor, and/or operative data may be provided in an output unit such as a display unit. The output unit (e.g., monitor) may output (e.g., display) various parameters of the 3D printing system (as described herein) in real time or in a delayed time. The output unit may output the current 3D printed object (e.g., real time display of the 3D object as it is being printed), the requested 3D printed object (e.g., according to a model), the printed 3D object or any combination thereof. The output unit may output the cleaning progress of the object, or various aspects thereof. The output unit may output the printing progress of the 3D printed object. The output unit may output at least one of the total time, time remaining, and time expanded on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the pre-transformed material. The output unit may display the amount of a certain gas in the chamber. The output unit may output the amount of oxidizing gas (e.g., oxygen), hydrogen, water vapor, or any of the gases mentioned herein, and pressure in the printing chamber (i.e., the chamber where the 3D object is being printed). The computer may generate a report comprising various parameters of the 3D printing system, method, and or objects at predetermined time(s), on a request (e.g., from an operator), and/or at a whim. The output unit may comprise a screen, printer, or speaker. The control system may provide a report. The report may comprise any items recited as optionally output by the output unit.

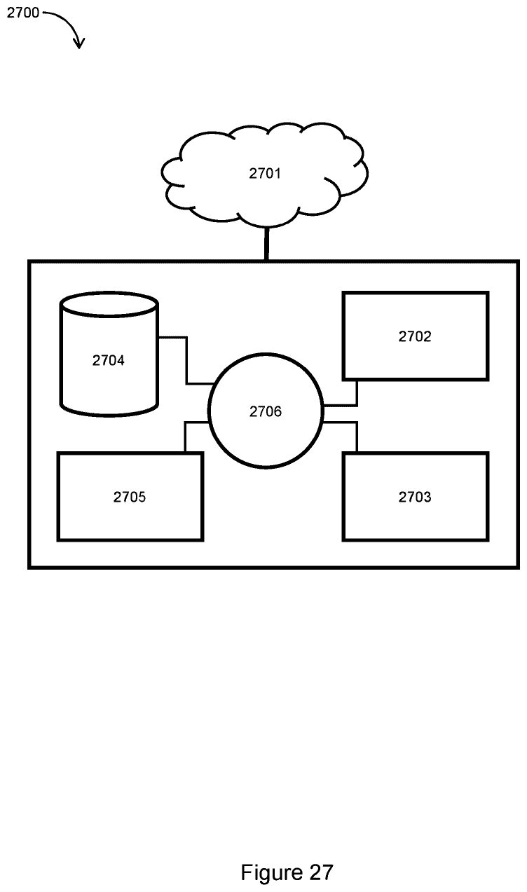

FIG. 27 is a schematic example of a computer system 2700 that is programmed or otherwise configured to facilitate the formation of a 3D object according to the methods provided herein. The computer system 2700 can include a processing unit 2706 (also “processor,” “computer” and “computer processor” used herein). The computer system may include memory or memory location 2702 (e.g., random-access memory, read-only memory, flash memory), electronic storage unit 2704 (e.g., hard disk), communication interface 2703 (e.g., network adapter) for communicating with one or more other systems, and peripheral devices 2705, such as cache, other memory, data storage and/or electronic display adapters. The memory 2702, storage unit 2704, interface 2703, and peripheral devices 2705 are in communication with the processing unit 2706 through a communication bus (solid lines), such as a motherboard.

Examples. The following are illustrative and non-limiting examples of methods of the present disclosure.

Example 1: In a processing chamber, SX500 powder having an average diameter of about 32 micrometers with an error of +/−10 micrometers was dispensed by a layer dispensing mechanism (e.g., recoater), the powder being dispensed above a build plate having a diameter of about 315 mm to form a powder bed. A layer dispensing mechanism was used to form a powder bed. When idle, a layer dispensing mechanism was parked in an ancillary chamber (e.g., garage) coupled with the processing chamber in which the build plate was disposed. The ancillary chamber was separated from the processing chamber by a door. The layer dispensing mechanism comprised a powder dispenser and a powder remover. The powder remover was configured to attract a portion of the dispensed powder to form a planar exposed surface of the powder bed using vacuum. The attracted powder was conveyed using a material (e.g., powder) conveyance system for recycling and reuse in by the layer dispensing mechanism. The atmosphere in the material conveyance system was similar to the one used in the processing chamber. The processing chamber was under an atmosphere that is less reactive with the powder than the ambient atmosphere external to the processing chamber. The internal processing chamber atmosphere comprised argon, oxygen, and humidity. The oxygen was at a concentration of at most about 1000 ppm, and the humidity had a dew point from about −55° C. to about −15° C. The internal processing chamber atmosphere had a pressure of about 16 KPa above atmospheric pressure (e.g., above about 101 KPa), and was at ambient temperature. The processing chamber was equipped with two optical windows made of sapphire. Each laser beam was guided by an optical setup in an optical system enclosure, the optical system enclosure disposed above the processing chamber, the optical system enclosure comprising a galvanometer scanner. Each of the laser beams originated from a fiber laser and traversed its respective optical window into the processing chamber to impinge on an exposed surface of the powder bed to print layerwise a 3D object. Each of the laser beam had a maximum power of about one (1) Kilo Watt, and a wavelength of about 1060 nanometers. A user was able to view the laser beams during printing using three circular viewing window assemblies. Each of the viewing window assembly was similar to the one depicted in FIG. 3, 302. The viewing assembly comprised a reflective coating (as disclosed herein) facing the interior of the processing chamber. The layer dispensing mechanism formed a powder bed by sequential layerwise deposition, the powder bed being disposed in a build module above the build plate. The build plate was disposed above a piston. The build plate traversed down at increments of about 50 μm at a precision of +/−2 micrometers using an optical encoder. The powder bed was used for layerwise printing the 3D object using the lasers. The removed powder was recycled using a recycling system as part of the powder recycling system that is part of the material conveyance system. The powder that was not utilized for the printing (e.g., the remainder material) was removed from the enclosure by the remover. The removed powder was conveyed to the powder recycling system for recycling through a powder conveying channel. The recycled powder was reused by the layer dispensing mechanism, e.g., recoater. The powder recycling system comprised a separator. The separator comprised two cyclones, a sieve enclosure, and two material reservoirs (e.g., hoppers). The two cyclones, sieve enclosure, and the two redundant material reservoirs were coupled in a similar manner as depicted in FIG. 7. Unlike FIG. 7, the separator comprised two redundant material reservoirs, each of which was operatively coupled with the sieve enclosure. The removed powder was separated from gas through the cyclones. The separated powder was conveyed and sieved in the sieve enclosure. A first pressure sensor was operatively coupled with a gas channel where the separated gas from the cyclone exited. The gas channel was operatively coupled with the cyclone. A second pressure sensor was operatively coupled with the two material reservoirs. A prevention system was operatively coupled with the first and second sensors. The prevention system monitored (i) a correlation coefficient between the pressure inside one of the two material reservoirs and the pressure inside the gas channel, and (ii) a correlation coefficient between the pressure inside the other of the two material reservoirs and the pressure inside the gas channel. The correlation coefficients were measured by normalized cross-correlation. The prevention system was configured to determine a malfunction when at least one of the correlation coefficients becomes below a threshold. The prevention system interrupted the printing as a prevention operation, when it determined the malfunction. Graphs 1500 and 1600 depict pressure variations measured under conditions of this example as disclosed in the description of FIGS. 15 and 16 respectively, the descriptions relating to these graphs.

Example 2: As experiment 1 above, where instead of the powder being SX500, the powder was Inconel 718 having an average diameter of about 32 micrometers with an error of about +/−10 micrometers.

Example 3: As experiment 1 above, where instead of the powder being SX500, the powder was Inconel 625 having an average diameter of about 32 micrometers with an error of about +/−10 micrometers.

Example 4: As experiment 1 above, where instead of the powder being SX500, the powder was GRCOP-42 having an average diameter of about 32 micrometers with an error of about +/−10 micrometers.

Example 5: As experiment 1 above, where instead of the powder being SX500, the powder was Ti-6Al-4V having an average diameter of about 36 micrometers with an error of about +/−10 micrometers.

Example 6: As experiment 1 above, where instead of the powder being SX500, the powder was Al F357 having an average diameter of about 40 micrometers with an error of about +/−10 micrometers.

Example 7: As experiment 1 above, where instead of the powder being SX500, the powder was Haynes 214 having an average diameter of about 32 micrometers with an error of about +/−10 micrometers.

Example 8: As experiment 1 above, where instead of the powder being SX500, the powder was Williams W807 having an average diameter of about 32 micrometers with an error of about +/−10 micrometers.

Example 9: As experiment 1 above, where instead of the powder being SX500, the powder was CA6NM steel having an average diameter of about 70 micrometers with an error of about +/−10 micrometers.

Example 10: As experiment 1 above, where instead of the powder being SX500, the powder was M300 steel having an average diameter of about 32 micrometers with an error of about +/−10 micrometers.

Example 11: As experiment 1 above, where instead of the powder being SX500, the powder was Alloy C22 having an average diameter of about 32 micrometers with an error of about +/−10 micrometers.

Example 12: As experiment 1 above, where instead of the powder being SX500, the powder was Aluminum CS11 having an average diameter of about 40 micrometers with an error of about +/−10 micrometers.

Example 13: As experiment 1 above, where instead of the powder being SX500, the powder was Copper C18150 having an average diameter of about 40 micrometers with an error of about +/−10 micrometers.

Example 14: In a processing chamber, Inconel 625 powder having an average diameter of about 32 micrometers with an error of about +/−10 micrometers was dispensed by a layer dispensing mechanism (e.g., recoater), the powder being dispensed above a build plate having a diameter of about 315 mm to form a powder bed. A layer dispensing mechanism was used to form a powder bed. When idle, a layer dispensing mechanism was parked in an ancillary chamber (e.g., garage) coupled with the processing chamber in which the build plate was disposed. The ancillary chamber was separated from the processing chamber by a door. The layer dispensing mechanism comprised a powder dispenser and a powder remover. The powder remover was configured to attract a portion of the dispensed powder to form a planar exposed surface of the powder bed using vacuum. The attracted powder was conveyed using a material (e.g., powder) conveyance system for recycling and reuse in by the layer dispensing mechanism. The atmosphere in the material conveyance system was similar to the one used in the processing chamber. The processing chamber was under an atmosphere that is less reactive with the powder than the ambient atmosphere external to the processing chamber. The internal processing chamber atmosphere comprised argon, oxygen, and humidity. The oxygen was at a concentration of at most about 1000 ppm, and the humidity had a dew point from about −55° C. to about −15° C. The internal processing chamber atmosphere had a pressure of about 16 KPa above atmospheric pressure (e.g., above about 101 KPa), and was at ambient temperature. The processing chamber was equipped with two optical windows made of sapphire. Each laser beam was guided by an optical setup in an optical system enclosure, the optical system enclosure disposed above the processing chamber, the optical system enclosure comprising a galvanometer scanner. Each of the laser beams originated from a fiber laser and traversed its respective optical window into the processing chamber to impinge on an exposed surface of the powder bed to print layerwise a 3D object. Each of the laser beam had a maximum power of about one (1) Kilo Watt, and a wavelength of about 1060 nanometers. A user was able to view the laser beams during printing using three circular viewing window assemblies. Each of the viewing window assembly was similar to the one depicted in FIG. 3, 302. The viewing assembly comprised a reflective coating (as disclosed herein) facing the interior of the processing chamber. The layer dispensing mechanism formed a powder bed by sequential layerwise deposition, the powder bed being disposed in a build module above the build plate. The build plate was disposed above a piston. The build plate traversed down at increments of about 50 μm at a precision of +/−2 micrometers using an optical encoder. The powder bed was used for layerwise printing the 3D object using the lasers. The removed powder was recycled using a recycling system as part of the powder recycling system that is part of the material conveyance system. The powder that was not utilized for the printing was removed from the enclosure by the remover. The removed powder was conveyed from the material bed, through the layer removal mechanism, to the powder recycling system for recycling through a powder conveying channel. The layer removal mechanism was part of the layer dispensing mechanism that comprises a powder dispenser. The recycling system was similar to the one depicted in FIG. 7. The powder conveying channel comprised an inner channel and an outer channel similar to the ones depicted in FIG. 23. The outer channel encased the inner channel. The recycled powder was reused by the layer dispensing mechanism, e.g., recoater. The powder recycling system comprised a separator. The separator comprised two cyclones, a sieve enclosure, and a material reservoir (e.g., hopper). The removed powder was separated from gas through the cyclones. The separated powder was conveyed and sieved in the sieve enclosure. A first pressure sensor was operatively coupled with an interstitial space between an external surface of the inner channel and an internal surface of the outer channel. A second pressure sensor was operatively coupled with a gas channel, the gas channel being operatively coupled with an exit of one of the cyclones e.g., sensor 1407 of FIG. 14. The separated gas from the cyclones exited through the gas channel. A prevention system was operatively coupled with the first sensor and the second sensor. The prevention system initiated triggering an alarm as a prevention operation when the pressure from the first sensor correlates with the pressure from the second sensor. Graphs 2500 and 2600 depict pressure variations of this example as disclosed in the description of FIGS. 25 and 26 respectively, the descriptions relating to these graphs.

While preferred embodiments of the present invention have been shown, and described herein, it will be obvious to those skilled in the art that such embodiments are provided by way of example only. It is not intended that the present disclosure be limited by the specific examples provided within the specification. While the present disclosure has been described with reference to the afore-mentioned specification, the descriptions and illustrations of the embodiments herein are not meant to be construed in a limiting sense. Numerous variations, changes, and substitutions will now occur to those skilled in the art without departing from the present disclosure. Furthermore, it shall be understood that all aspects of the present disclosure are not limited to the specific depictions, configurations, or relative proportions set forth herein which depend upon a variety of conditions and variables. It should be understood that various alternatives to the embodiments described herein might be employed in practicing the present disclosure. It is therefore contemplated that the present disclosure shall also cover any such alternatives, modifications, variations, or equivalents. It is intended that the following claims define the scope of the present disclosure and that methods and structures within the scope of these claims and their equivalents be covered thereby.

What is claimed is:

1. A device for printing one or more three-dimensional (3D) objects, the device comprising:
a sensor operatively coupled with a separator, the sensor configured to sense (i) a level of a remainder material when the remainder material accumulates in the separator above a first threshold or (ii) a pressure over time in an internal atmosphere of the separator operatively coupled with a printing enclosure, the pressure over time having a repetition of a first pattern, the separator being configured to receive the remainder material initially disposed in the printing enclosure, the remainder material comprising a starting material not used to print the one or more 3D objects, the printing enclosure being configured to, during the printing, enclose the one or more 3D objects printed from the starting material, the printing enclosure being part of a 3D printer; and
a prevention system operatively coupled with the sensor, the prevention system being configured to initiate a prevention operation (i) when the sensor is configured to sense the level of the remainder material accumulating in the separator, and the sensor senses the remainder material above a second threshold indicative of greater level of material accumulation than the first threshold or (ii) when the sensor is configured to sense the pressure, and data sensed by the sensor includes a second pattern, the second pattern including a portion that exhibits a change as compared with the first pattern.

2. The device of claim 1, wherein the first pattern comprises a first amplitude and the portion of the second pattern comprises a second amplitude, the first amplitude being the difference between a maximum value and a minimum value of the first pattern, the second amplitude being the difference between a maximum value and the minimum value of the second pattern, the second amplitude being smaller than the first amplitude by a third threshold.

3. The device of claim 2, wherein the third threshold is within a range of about 5 kPa to about 9 kPa.

4. The device of claim 2, wherein the third threshold is within a range of about 40% to about 75% of the first amplitude.

5. The device of claim 1, wherein the second pattern comprises an irregular pattern.

6. The device of claim 1, wherein the first pattern comprises a first peak and a second peak, the second peak having an amplitude different than that of the second peak.

7. The device of claim 1, wherein the sensor is a first sensor, the first sensor being configured to sense a first pressure in a first internal atmosphere of the separator, and further comprising a second sensor, the second sensor being configured to sense a second pressure in a second internal atmosphere of a component other than the first internal atmosphere of the separator.

8. The device of claim 1, wherein the prevention system is configured to (i) operate when a standard deviation of a pressure of the 3D printer is equal at least to a third threshold or higher, and (ii) deactivate when the standard deviation of the pressure of an internal atmosphere of the 3D printer is at most a fourth threshold or lower, the fourth threshold being smaller than the third threshold.

9. A method for printing one or more three-dimensional (3D) objects, the method comprising:
providing a sensor operatively coupled with a separator;
sensing, via the sensor, (I) a level of a remainder material when the remainder material accumulates in the separator above a first threshold or (II) a pressure over time in an internal atmosphere of the separator operatively coupled with a printing enclosure, the pressure over time having a repetition of a first pattern, the separator being configured to receive the remainder material initially disposed in the printing enclosure, the remainder material comprising a starting material not used to print the one or more 3D objects, the printing enclosure being configured to, during the printing, enclose the one or more 3D objects printed from the starting material, the printing enclosure being part of a 3D printer;
providing a prevention system operatively coupled with the sensor; and
operating the prevention system (i) when the sensor is configured to sense the level of the remainder material accumulating in the separator, and the sensor senses the remainder material above a second threshold or (ii) when the sensor is configured to sense the pressure, and a data sensed by the sensor comprises a second pattern, the second pattern having a portion that exhibits a change as compared with the first pattern.

10. The method of claim 9, wherein providing a sensor comprised providing a first sensor and a second sensor;
sensing, via the first sensor, a first pressure in a first internal atmosphere of the separator; and
sensing, via the second sensor, a second pressure in a second internal atmosphere of a component other than the first internal atmosphere of the separator.

11. The method of claim 9, wherein the second pattern further comprises an irregular pattern.

12. The method of claim 9, wherein the first pattern comprises a first peak and a second peak, the second peak having an amplitude different than that of the second peak.

13. The method of claim 9, operating the prevention system when a standard deviation of a pressure of the 3D printer is equal at least to a third threshold or higher; and
deactivating the prevention system when the standard deviation of the pressure of an internal atmosphere of the 3D printer is at most a fourth threshold or lower, the fourth threshold being smaller than the third threshold.

14. The method of claim 9, wherein the first pattern comprises a first amplitude and the portion of the second pattern comprises a second amplitude, the first amplitude being the difference between a maximum value and a minimum value of the first pattern, the second amplitude being the difference between a maximum value and the minimum value of the second pattern, the second amplitude being smaller than the first amplitude by a third threshold.

15. An apparatus for printing one or more three-dimensional (3D) objects, the apparatus comprising at least one controller configured to:
operatively couple with a first sensor and a second sensor;
direct the first sensor to sense a first pressure in a first internal atmosphere of a separator, the first sensor being operatively coupled with the separator, the separator being operatively coupled with a printing enclosure and configured to receive a remainder material initially disposed in the printing enclosure, the remainder material being a starting material not used to print the one or more 3D objects, the printing enclosure being configured to, during the printing, enclose the one or more 3D objects printed from the starting material, the printing enclosure being part of a 3D printer;
direct the second sensor to sense a second pressure in a second internal atmosphere of a component other than the separator, the second sensor being operatively coupled with the component, the component being operatively coupled with the 3D printer; and
when a coefficient is below a threshold, direct a prevention system to initiate a prevention operation, the coefficient being a correlation between the first pressure and the second pressure, the prevention system being operatively coupled with the first sensor and the second sensor.

16. The apparatus of claim 15, wherein the first pattern comprises a first amplitude and the portion of the second pattern comprises a second amplitude, the first amplitude being the difference between a maximum value and a minimum value of the first pattern, the second amplitude being the difference between a maximum value and the minimum value of the second pattern, the second amplitude being smaller than the first amplitude by a third threshold.

17. The apparatus of claim 16, wherein the third threshold is within a range of about 5 kPa to about 9 kPa.

18. The apparatus of claim 16, wherein the third threshold is within a range of about 40% to about 75% of the first amplitude.

19. The apparatus of claim 15, wherein the second pattern comprises an irregular pattern.

20. The apparatus of claim 15, wherein the first pattern comprises a first peak and a second peak, the second peak having an amplitude different than that of the second peak.
